(19) United States
(12) Patent Application Publication
(10) Pub. No.: US 2026/0211833 A1
(43) Pub. Date: Jul. 23, 2026

(54) Processor with CXL, NVLink, or UALink Ports Implemented in a Repurposed Area of a Silicon Die

(71) Applicant: UnifabriX Ltd., Haifa (IL)

(72) Inventors: Ronen Aharon Hyatt, Haifa (IL); Gaya Opal Hyatt, Haifa (IL); Ethan Sharon Hyatt, Haifa (IL); Gil Thieberger, Kiryat Tivon (IL)

(73) Assignee: UnifabriX Ltd., Haifa (IL)

(21) Appl. No.: 19/576,823

(22) Filed: Mar. 24, 2026

Related U.S. Application Data
(63) Continuation-in-part of application No. 19/371,779, filed on Oct. 28, 2025.
Application No. 19/371,779 is a continuation of application No. 19/017,420, filed on Jan. 11, 2025, now Pat. No. 12,613,826.
Application No. 19/017,420 is a continuation-in-part of application No. 18/981,443, filed on Dec. 13, 2024.
(60) Provisional application No. 63/609,833, filed on Dec. 13, 2023.
(60) Provisional application No. 63/641,404, filed on May 1, 2024.
(60) Provisional application No. 63/652,165, filed on May 27, 2024.
(60) Provisional application No. 63/678,045, filed on Jul. 31, 2024.
(60) Provisional application No. 63/695,957, filed on Sep. 18, 2024.
(60) Provisional application No. 63/701,554, filed on Sep. 30, 2024.
(60) Provisional application No. 63/719,640, filed on Nov. 12, 2024.
(60) Provisional application No. 63/734,031, filed on Dec. 13, 2024.
(60) Provisional application No. 63/743,658, filed on Jan. 10, 2025.
(60) Provisional application No. 63/752,940, filed on Feb. 3, 2025.
(60) Provisional application No. 63/784,089, filed on Apr. 5, 2025.
(60) Provisional application No. 63/811,859, filed on May 25, 2025.
(60) Provisional application No. 63/826,342, filed on Jun. 18, 2025.
(60) Provisional application No. 63/856,653, filed on Aug. 3, 2025.
(60) Provisional application No. 63/874,393, filed on Sep. 2, 2025.
(60) Provisional application No. 63/895,053, filed on Oct. 7, 2025.
(60) Provisional application No. 63/906,709, filed on Oct. 28, 2025.
(60) Provisional application No. 63/931,124, filed on Dec. 4, 2025.
(60) Provisional application No. 63/991,122, filed on Feb. 25, 2026.

(51) Int. Cl. G06F 13/42

(52) U.S. Cl. CPC G06F 13/4221; G06F 2213/0026

(57) ABSTRACT

AI processors integrate dense arrays of processing cores alongside memory controllers and interconnect fabric, where every square millimeter of silicon carries both cost and yield implications. Some implementations of a modified processing unit (MxPU) include a silicon die having processing cores coupled via a coherent interconnect, memory channels for communicating with external memory, and a repurposed area occupying a space equivalent to at least one processing core. The repurposed area, originally designed to accommodate at least one processing core, instead accommodates at least one of a communication port or a resource provisioning unit (RPU). The communication port is selected from a CXL endpoint, a CXL switch port, an NVLink port, or a UALink port, and receives messages comprising physical addresses within a second physical address space. The RPU translates those physical addresses to a first physical address space utilized by the processing cores.

### CROSS-REFERENCE TO RELATED APPLICATIONS

This Application claims priority to: U.S. Provisional Patent Application No. 63/991,122, filed Feb. 25, 2026; U.S. Provisional Patent Application No. 63/931,124, filed Dec. 4, 2025; U.S. Provisional Patent Application No. 63/906,709, filed Oct. 28, 2025; U.S. Provisional Patent Application No. 63/895,053, filed Oct. 7, 2025; U.S. Provisional Patent Application No. 63/874,393, filed Sep. 2, 2025; U.S. Provisional Patent Application No. 63/856,653, filed Aug. 3, 2025; U.S. Provisional Patent Application No. 63/826,342, filed Jun. 18, 2025; U.S. Provisional Patent Application No. 63/811,859, filed May 25, 2025; and U.S. Provisional Patent Application No. 63/784,089, filed Apr. 5, 2025. This Application is also a Continuation-In-Part of U.S. patent application Ser. No. 19/371,779, filed Oct. 28, 2025, which claims priority to: U.S. Provisional Patent Application No. 63/752,940, filed Feb. 3, 2025; U.S. Provisional Patent Application No. 63/743,658, filed Jan. 10, 2025; and U.S. Provisional Patent Application No. 63/734,031, filed Dec. 13, 2024. U.S. patent application Ser. No. 19/371,779 is a Continuation of U.S. patent application Ser. No. 19/017,420, filed Jan. 11, 2025, which claims priority to: U.S. Provisional Patent Application No. 63/719,640, filed 12 Nov. 2024; U.S. Provisional Patyent Application No. 63/701,554, filed 30 Sep. 2024; U.S. Provisional Patent Application No. 63/695,957, filed 18 Sep. 2024; U.S. Provisional Patent Application No. 63/678,045, filed 31 Jul. 2024; U.S. Provisional Patent Application No. 63/652,165, filed 27 May 2024; and U.S. Provisional Patent Application No. 63/641,404, filed 1 May 2024. U.S. patent application Ser. No. 19/017,420 is also a Continuation-In-Part of U.S. patent application Ser. No. 18/981,443, filed Dec. 13, 2024, which claims priority to U.S. Provisional Patent Application No. 63/609,833, filed 13 Dec. 2023.

### BACKGROUND

Some processing units, such as CPUs, incorporate processing cores coupled via a coherent interconnect on a silicon die. These processing units access external memory, such as DRAM, through memory channels, and may utilize various physical address spaces to manage memory access across system components. Manufacturing processing units with large numbers of processing cores on a silicon die presents yield challenges. Defects occurring in the silicon during fabrication may render one or more processing cores non-functional, potentially causing an entire die to be rejected during production testing. Manufacturers may address yield concerns through product segmentation techniques, such as disabling defective processing cores and selling the resulting devices as lower-tier product variants. The die size and layout of the processing unit are typically maintained across such product variants to preserve compatibility with established packaging, substrates, and thermal solutions.

Various interconnect standards exist for communicating between processing units, accelerators, memory devices, and other system components. Compute Express Link (CXL) provides an interface for host-device communication, supporting memory access and cache coherency between hosts and attached devices. CXL-attached devices may function as memory expansion devices that expose device-attached memory to hosts. NVLink provides a high-bandwidth interconnect for communication among GPUs and other processing units in computing systems. Ultra Accelerator Link (UALink) provides a high-bandwidth interconnect for communication among accelerators and switches in computing systems, supporting data transfers within and across system nodes.

### SUMMARY

In computing systems, different components may utilize different physical address spaces to manage their respective memory resources. Translating between different physical address spaces may be involved when one component accesses memory resources associated with another component that utilizes a different physical address space. Some of the described implementations relate to a modified processing unit (MxPU) and methods for designing, manufacturing, and operating the MxPU. In various implementations, an MxPU comprises memory channels capable of communicating with memory located outside the MxPU; a silicon die comprising processing cores, coupled via a coherent interconnect, configured to utilize a first physical address space to access the memory via the memory channels, and a repurposed area occupying a space equivalent to at least one processing core; a communication port, selected from a CXL endpoint, a CXL switch port, an NVLink port, or a UALink port, configured to receive messages comprising physical addresses within a second physical address space; and a resource provisioning unit (RPU) configured to translate physical addresses within the second physical address space to physical addresses within the first physical address space; wherein the repurposed area, which was originally designed to accommodate at least one processing core, accommodates at least one of the communication port or the RPU. In some implementations, the repurposed area may include a repurposed impaired area comprising at least one electrically disabled processing core. The communication port or the RPU may draw operating power through power rails originally designed to supply the repurposed area, and may receive clock signals through clock distribution networks originally designed for the repurposed area. The MxPU may be derived from an established CPU or GPU design while retaining a comparable die size, memory controllers, and CXL root ports of the established design.

In other implementations, a method for improving manufacturing yield of processor devices comprises identifying at least one processing core area in a processor design for repurposing as an impaired area; configuring the processor design to exclude the at least one processing core area from functional testing requirements while retaining a same die size; implementing at least one of a communication port or an RPU in the impaired area, wherein the communication port is selected from a CXL endpoint, a CXL switch port, an NVLink port, or a UALink port, and the RPU is configured to translate between physical addresses associated with different physical address spaces; and manufacturing processor devices based on the configured processor design, whereby defects occurring within the impaired area do not cause rejection of the processor devices during production testing.

In yet other implementations, a method for operating an MxPU comprises utilizing, by processing cores of the MxPU coupled via a coherent interconnect, a first physical address space to access memory located outside the MxPU via memory channels; receiving, via a communication port selected from a CXL endpoint, a CXL switch port, an NVLink port, or a UALink port, messages comprising physical addresses within a second physical address space; translating, by an RPU, physical addresses within the second physical address space to physical addresses within the first physical address space; and operating at least one of the communication port or the RPU from a silicon die area that excludes at least one processing core present in an established processor design from which the MxPU was derived.

### BRIEF DESCRIPTION OF THE DRAWINGS

FIG. 1A illustrates an example of a silicon device functioning as an established xPU design before modification;

FIG. 1B illustrates an example of a silicon device capable of providing the functionality of a CXL MHD;

FIG. 1C illustrates an example of a silicon device capable of providing the functionality of a UALink Switch;

FIG. 2A illustrates a system comprising a prior art xPU design, such as a processor design, that includes a repurposed area;

FIG. 2B illustrates an example of a Multi-Headed Device (MHD) implementation that may be based on an xPU or an MxPU design, such as a processor design, that includes a repurposed area;

FIG. 2C illustrates an example of a processor comprising termination circuits implemented at interfaces between silicon die areas;

FIG. 3A illustrates an example of a system that may function as an NVLink memory switch appliance or an NVLink memory pool;

FIG. 3B illustrates an example of a TFD depicting a multi-entity memory access scenario wherein GPUs access memory mapped to physical address spaces through NVLink to ARM CHI translations;

FIG. 4A illustrates an example of a system comprising a cable configured to translate between CXL and NVLink;

FIG. 4B illustrates an example of a TFD demonstrating translating between CXL.mem M2S MemRd request and NVLink read request;

FIG. 5A illustrates an example of a system comprising an RPU that translates between UALink-based traffic and CXL.mem-based traffic;

FIG. 5B illustrates an example of a TFD demonstrating translations between UPLI request and CXL.mem M2S Req MemRd;

FIG. 6A illustrates an example of a system comprising an RPU that enables UALink-based entities to access CXL-based resources coupled to the RPU;

FIG. 6B illustrates an example of a TFD demonstrating intent-based translation between UPLI and CXL.mem;

FIG. 7A illustrates an example of a system comprising a processor comprising a UALink port enabling external entities to access memory resources mapped to an address space utilized by the processor's coherent interconnect;

FIG. 7B illustrates an example of a TFD demonstrating two UPLI requests forwarded to different memories mapped to an address space utilized by a processor's coherent interconnect;

FIG. 8A illustrates an example of a system comprising a processor comprising a coherent interconnect, a UALink port, and a CXL RP;

FIG. 8B illustrates an example of a TFD demonstrating translating two UPLI requests to a coherent interconnect request and to a CXL.mem request;

FIG. 9A illustrates an example of a system that translates between UALink-based traffic and CXL.mem traffic;

FIG. 9B illustrates an example of a TFD demonstrating translations between UPLI request and CXL. mem request, with an optional speculative memory read;

FIG. 10A illustrates an example of a system comprising a processor including a CXL EP configured to enable an external entity to access memory resources mapped to address space utilized by the processor's coherent interconnect;

FIG. 10B illustrates an example of a TFD demonstrating translation from a CXL.mem M2S request to an M2S request utilized by a processor's coherent interconnect;

FIG. 11A illustrates an example of a system comprising a processor including a CXL device configured to enable an external entity to access memory resources mapped to the address space utilized by the processor's coherent interconnect;

FIG. 11B illustrates an example of a TFD demonstrating two CXL.mem requests mapped to an address space utilized by a processor's coherent interconnect;

FIG. 12A and FIG. 12B illustrate two approaches for transforming an xPU design to a CXL memory device;

FIG. 13 illustrates an example of building a CXL MHD Memory Pool based on an xPU comprising CXL RPs;

FIG. 14 illustrates an example for transforming an xPU design to a CXL memory device;

FIG. 15 illustrates an example of a processor comprising RPUs that translate between different combinations of CXL device types;

FIG. 16A and FIG. 16B illustrate examples of a system comprising an MxPU with an EP or a GFD;

FIG. 17A illustrates an example of a system capable of enabling an external entity to access memory resources mapped to an address space utilized by a processor's coherent interconnect;

FIG. 17B illustrates an example of a transaction flow diagram (TFD) demonstrating RPU translations of CXL. io UIOMRd memory read requests and CXL.mem M2S requests;

FIG. 18A illustrates an example of a system comprising a processor/switch configured to enable external entities to access resources coupled to the processor;

FIG. 18B illustrates an example of a TFD demonstrating translations performed by a processor between first and second CXL.mem utilizing MemRd;

FIG. 19A illustrates an example of a system comprising a processor comprising a CXL device and a CXL RP;

FIG. 19B illustrates an example of a TFD demonstrating translating CXL.io MRd request, CXL.mem M2S request, and CXL.io UIOMRd request;

FIG. 20A illustrates an example of a system comprising a processor comprising a CXL endpoint;

FIG. 20B illustrates an example of a TFD demonstrating translations between CXL.mem and CXL.cache messages;

FIG. 21A illustrates an example of a system comprising a processor comprising a CXL EP coupled to the processor's coherent interconnect via an ISoL interface;

FIG. 21B illustrates an example of a TFD demonstrating a translating a CXL.mem M2S Read request to an ISoL request;

FIG. 22A illustrates an example of a system comprising an entity, such as a processor or a node controller, configured to translate between CXL-based messages and ISoL messages;

FIG. 22B illustrates an example of a TFD demonstrating translations between CXL.mem and Intel UPI;

FIG. 23A illustrates an example of a system comprising a processor, a node controller, or a switch, which includes a CXL device, configured to translate between CXL-based traffic and ISoL traffic;

FIG. 23B illustrates an example of a TFD demonstrating translations between CXL.mem and UPI, including translating error and data corruption indications, such as poison;

FIG. 24A illustrates an example of a system comprising a processor or an RPU, configured to translate between CXL-based traffic and ISoL traffic;

FIG. 24B illustrates an example of a TFD demonstrating translations between CXL.mem messages and ISoL messages;

FIG. 25 illustrates an example of a system wherein inference context data is migrated between accelerator local memory and the CXL memory device across UALink and CXL protocol domains;

FIG. 26A illustrates an example of a system functioning as a UALink memory switch appliance or a UALink memory pool;

FIG. 26B illustrates an example of a TFD depicting a multi-entity memory access scenario wherein GPUs access memory through UPLI-to-ARM CHI translations;

FIG. 27A illustrates an example of a system comprising a processor comprising a UALink port;

FIG. 27B illustrates an example of a system comprising a processor comprising UALink ports and DDR channels;

FIG. 28A illustrates an example of a system comprising a processor comprising UALink and ISoL ports;

FIG. 28B illustrates an example of a TFD demonstrating translating a UPLI request to a request utilized by a processor's coherent interconnect;

FIG. 29A illustrates an example of GPU/CPU coupled to an xPU comprising dies coupled by chip-to-chip interfaces;

FIG. 29B illustrates an example of a custom accelerator comprising an NVLink Fusion chiplet;

FIG. 30A illustrates an example of a system that translates between NVLink-based traffic and CHI-based coherent interconnect traffic;

FIG. 30B illustrates an example of a TFD showing the translation of NVLink read request to CHI ReadOnce request;

FIG. 31A illustrates an example of a system that translates between NVLink-based traffic and ARM CHI traffic;

FIG. 31B illustrates an example of an RPU that translates between NVLink traffic and CHI traffic, utilizing an intermediate protocol based on ARM AMBA ACE-Lite;

FIG. 32A illustrates an example of a system that translates between NVLink traffic and CHI-based traffic;

FIG. 32B illustrates an example of an RPU that translates between NVLink traffic and CHI traffic;

FIG. 33A illustrates an example of a TFD showing translating an NVLink read request to a PCIe UIO read request to an ARM CHI ReadOnce request;

FIG. 33B illustrates an example of a TFD showing translating an NVLink read request to a CXL.cache RdCurr request to an ARM CHI ReadOnce request;

FIG. 34A illustrates an example of a system comprising an external entity coupled to an optional NVLink switch coupled to a processor comprising an RPU comprising an NVLink interface, a Request Agent (RA) Proxy, and a Home Agent (HA) Proxy;

FIG. 34B illustrates an example of a system comprising a processor comprising NVLink chiplets (such as NVLink Fusion) to translate between NVLink and CHI;

FIG. 35A illustrates an example of a system comprising an xPU comprising an RPU that translates between NVLink traffic and CHI traffic;

FIG. 35B illustrates an example of a system comprising an entity including NVLink and CXL ports coupled to CHI interfaces that enable memory access via a processor's coherent interconnect;

FIG. 36A illustrates an example of a system comprising a processor comprising an NVLink chiplet coupled via NVLink-C2C to the processor's coherent interconnect;

FIG. 36B illustrates an example of a system comprising an xPU coupled to a GPU utilizing an RPU that translates between NVLink traffic and CHI-based traffic;

FIG. 37A illustrates an example of a system functioning as a multi-protocol memory switch appliance or a multi-protocol memory pool comprising NVLink-based interfaces;

FIG. 37B illustrates an example of a TFD depicting a multi-entity memory access scenario wherein separate NVLink and UALink transactions utilize the same coherent interconnect infrastructure for memory access; and

FIG. 38 illustrates an example of a heterogeneous computing system comprising an NVLink chiplet coupled to an accelerator based on ARM mesh architecture.

### DETAILED DESCRIPTION

To improve yield and reduce development costs, a processing unit may leverage intentional reservation of silicon area as a repurposed area (which may also be referred to as a designated area) to improve manufacturing yield and reduce time to market. Design blocks that reside in the repurposed areas are not mandatory for correct operation of the un-modified xPU, and may be replaced by other design blocks to create different types of MxPUs with different features and functional behaviors. By reserving an area in a die floorplan of an established xPU silicon design for a repurposed area, it may be possible to reuse the established silicon design, along with its core floorplan, packaging, and substrate, more rapidly compared to developing an entirely new design that removes the repurposed area from the silicon die, potentially reducing development time and associated costs while maintaining the original die size and layout. Additionally, this approach may allow for quicker adaptation of established designs to create new product variants, leveraging established manufacturing processes and potentially minimizing the need for extensive redesign and validation efforts typically associated with the development of new chip layouts, thereby streamlining the overall product development cycle.

In various implementations, a modified processing unit (MxPU) comprising: memory channels capable of communicating with memory located outside the MxPU; a silicon die comprising (i) processing cores, coupled via a coherent interconnect, configured to utilize a first physical address space to access the memory via the memory channels, and (ii) a repurposed area occupying a space equivalent to at least one processing core; a communication port, selected from a Compute Express Link (CXL) endpoint, a CXL switch port, an NVLink port, or a UALink port, configured to receive messages comprising physical addresses within a second physical address space; a resource provisioning unit (RPU) configured to translate physical addresses within the second physical address space to physical addresses within the first physical address space; and wherein the repurposed area, which was originally designed to accommodate at least one processing core, accommodates at least one of the communication port or the RPU.

In some implementations of the MxPU, the repurposed area comprises a repurposed impaired area comprising at least one electrically disabled processing core. The repurposed impaired area may be created by electrically disabling one or more processing cores that were part of the original xPU design. This electrical disabling may be accomplished utilizing various methods such as power gating, clock gating, fuse programming, or other techniques that render the core non-functional while preserving the physical silicon area. By electrically disabling one or more cores rather than physically removing them from the silicon die, the MxPU may maintain the original die dimensions and layout, potentially allowing for the reuse of established packaging, thermal solutions, and manufacturing processes while creating space for implementing alternative functional blocks such as the communication port or RPU.

In some implementations of the MxPU, the at least one of the communication port or the RPU draws operating power through a power rail originally designed to supply power to the repurposed area. The MxPU may leverage existing power distribution infrastructure by repurposing power rails that were originally designed to supply the processing cores in the repurposed area, which may enable efficient power delivery to the communication port or RPU without requiring extensive redesign of the power distribution network. The power rails may include metal layers, vias, and power delivery components that were already optimized for the original die layout, potentially reducing development time and maintaining established power integrity characteristics while supplying the newly implemented functional blocks.

In some implementations of the MxPU, the repurposed area comprises a repurposed impaired area, and wherein the at least one of the communication port or the RPU receives a clock signal through a clock distribution network originally designed to provide clock signals to the repurposed impaired area. The MxPU may utilize existing clock distribution infrastructure by tapping into clock networks that were originally designed for the processing cores in the repurposed impaired area. Clock distribution networks are typically complex structures requiring careful design to minimize skew and jitter, and redesigning these networks late in the development cycle may be costly and time-consuming. By maintaining the existing clock distribution segments and inserting appropriate buffers or clock receivers, the communication port or RPU may obtain necessary clock signals without requiring extensive clock tree re-synthesis or re-layout, potentially preserving timing closure achievements from the original design while reducing development complexity.

In some implementations of the MxPU, the at least one of the communication port or the RPU is coupled to the coherent interconnect via an interconnect port originally designed for coupling the repurposed area to the coherent interconnect. The MxPU may reuse existing interconnect infrastructure by electrically reassigning interconnect fabric ports that were originally allocated to processing cores in the repurposed area. The coherent interconnect typically includes ports for coupling various components, wherein the ports may have associated routing, arbitration circuits, and protocol interfaces. By reusing an existing interconnect port for the communication port or RPU, the MxPU design may minimize changes to global routing and interconnect topology, potentially preserving timing closure margins and reducing verification complexity. This approach may enable the new functional blocks to communicate with other system components through established interconnect pathways without requiring extensive modifications to the interconnect fabric architecture.

In some implementations, the MxPU further comprises a memory management unit (MMU); wherein the memory located outside the MxPU comprises at least 64 GB of dynamic random-access memory (DRAM) coupled via the memory channels, wherein the first physical address space is a Host Physical Address (HPA) space, and the MMU is configured to map addresses within a virtual address space, utilized by an operating system of the MxPU, to physical addresses within the first physical address space. The MMU may enable the operating system running on the MxPU to utilize virtual addressing, which may provide memory protection, process isolation, and flexible memory allocation. The coupling of at least 64 GB of DRAM via the memory channels may provide sufficient memory capacity for memory pooling applications, wherein the MxPU may serve as a memory resource for external entities. The first physical address space being an HPA space may enable coherent memory access across system components and may establish a unified addressing scheme for the MxPU's resources.

In some implementations of the MxPU, the processing cores are configured to execute instructions compatible with an x86 instruction set architecture; and further comprising at least three levels of in-package cache memory coupled to the coherent interconnect, and wherein a third level of the in-package cache memory has a capacity of at least 4 MB. The MxPU may be based on x86 architecture, which may provide compatibility with a wide range of existing software and operating systems. The inclusion of at least three levels of in-package cache memory, with the third level (typically the last level cache or LLC) having at least 4 MB capacity, may provide a cache hierarchy that can improve memory access performance. This cache hierarchy may be beneficial when the MxPU serves as a CXL memory device, as the LLC may cache frequently accessed data from external entities, potentially reducing access latency compared to direct DRAM access.

In some implementations of the MxPU, the processing cores are configured to execute instructions compatible with a RISC-based instruction set architecture selected from ARM instruction set architecture or RISC-V instruction set architecture, and further comprising at least two levels of in-package cache memory coupled to the coherent interconnect, and wherein a last level of the in-package cache memory has a capacity of at least 4 MB. The MxPU may be based on RISC architectures such as ARM or RISC-V, which may provide power efficiency and scalability advantages for memory pooling applications. The inclusion of at least two levels of in-package cache memory, with the last level having substantial capacity of at least 4 MB, may help reduce memory access latency and improve overall system performance. The cache hierarchy may work in conjunction with the coherent interconnect to maintain data consistency across the processing cores and external accesses through the communication port.

In some implementations of the MxPU, the processing cores comprise streaming multiprocessors (SM) configured to execute instructions compatible with NVIDIA's Compute Unified Device Architecture (CUDA) parallel computing platform, and wherein a number of the streaming multiprocessors exceeds 50. The MxPU may be based on GPU architecture utilizing NVIDIA's CUDA platform, wherein the processing cores are implemented as streaming multiprocessors (SM) optimized for parallel computation. Having more than 50 streaming multiprocessors may provide substantial parallel processing capability, which may be beneficial for certain memory access patterns and workloads. This GPU-based MxPU architecture may be suitable for applications that benefit from high memory bandwidth and parallel memory access capabilities, while the repurposed area may accommodate the communication port and RPU functionality needed for CXL-based or UALink-based memory pooling.

In some implementations of the MxPU, a design of the MxPU was derived from an established CPU or GPU design comprising a second silicon die, and wherein the silicon die of the MxPU has a die size within ±9 % of the die size of the second silicon die of the established CPU or GPU design. The MxPU may be manufactured with one or more repurposed impaired areas while retaining a comparable die size of an established CPU or GPU design. This approach may improve the effective manufacturing yield of silicon dies comprising the MxPU devices because the repurposed impaired areas may not be required to pass the stringent functional correctness testing during the production phases of the MxPU, as they were originally required during the production phases of the established CPU or GPU design. Consequently, the impact of defects may be mitigated, leading to a higher effective manufacturing yield, which may contribute to reducing the manufacturing costs associated with the production of such MxPU devices. Additionally or alternatively, utilizing such repurposing and impairment techniques may reduce design and manufacturing costs associated with creating additional product variants, by identifying die areas associated with functionalities that are deemed unnecessary (hence functionally impaired) for specific product variants, and basing those MxPU variants on changes made in the repurposed impaired areas of an established CPU or GPU design. In this context, “established” refers to a design that exists at the time of making the modification, which may be well after the date of filing this patent application, and indicates a pre-existing design without implying a specific timeframe relative to the date of filing this patent application. Alternative words that could convey a similar meaning include current, pre-designed, previously developed, legacy, available, already-designed, in-use, or prevailing. These terms aim to describe a silicon die design that is already in existence and potentially in use at the time the modification, the impairment, and/or the chopping-out is implemented, regardless of when the design was originally created or when this patent application was filed.

In some implementations of the MxPU, a design of the MxPU was derived from an established CPU or GPU design, and the MxPU retains memory controllers of the established CPU or GPU design. The MxPU may be derived from an established CPU/GPU design such that it is manufactured with one or more repurposed areas while retaining the memory controllers supported by the established design. By repurposing one or more processing cores as impaired areas without affecting the memory controller operation, the design may be optimized for its intended purpose in scenarios that require retaining maximum memory capacity. Non-limiting examples of intended purposes include memory pool, memory switch, memory processor, or protocol translator. This modification may allow for more cost-effective production of the MxPU while preserving its ability to provision a larger memory capacity, a capability inherent to the established CPU/GPU design and beneficial for memory-intensive applications and workloads.

In some implementations of the MxPU, a design of the MxPU was derived from an established CPU or GPU design that included CXL root ports, and the MxPU retains the CXL root ports of the established CPU or GPU design. For the purpose of designing and manufacturing a memory processor or a memory switch, repurposing processing cores as impaired areas without affecting the CXL ports of the established CPU/GPU design may enable creating additional stock keeping units (SKUs) with minimal or no redesign of the floorplan and with minimal changes to the masks used during manufacturing. This approach may allow manufacturers to obtain additional product variants without incurring the full costs associated with rebuilding the floorplan layout, potentially reducing time-to-market and development expenses while maintaining the connectivity capabilities of the original design.

In some implementations, the MxPU further comprises an inter-socket link (ISoL) configured to utilize addresses within the first physical address space, wherein the ISoL couples the MxPU to a second MxPU and enables the processing cores to access a second memory coupled via second memory channels to the second MxPU. The MxPU may include an ISoL to support scaling from a single MxPU to a cluster of interconnected homogeneous or heterogeneous MxPUs. An ISoL may enable scaling across multiple MxPU instances, coherent shared memory across sockets, low-latency atomic operations, and workload migration. It may expose remote high-bandwidth memory and I/O, support composable disaggregation, and/or provide redundant paths for RAS features such as fail-over and hot-service. Partitioning target functionality across xPU instances may improve manufacturing yield, allow mixed process nodes, and lower power per bit.

In some implementations of the MxPU, the ISoL is selected from an interconnect based on: AMD Infinity Fabric, NVIDIA NVLink-C2C, ARM CHI C2C, or Intel UPI. The ISoL may be implemented utilizing various industry interconnect technologies, wherein the selection of ISoL technology may depend on the processor architecture of the MxPU and the desired system topology.

In some implementations of the MxPU, the communication port comprises the CXL endpoint, and further comprising a second CXL endpoint configured to communicate with a second entity, wherein the second entity utilizes addresses within a third physical address space, and the RPU is further configured to translate physical addresses within the third physical address space to physical addresses within the first physical address space to enable the second entity to access at least a portion of the memory. The MxPU may include CXL endpoints to support multi-headed configurations wherein external entities can simultaneously access the MxPU's memory resources. The RPU may maintain separate translation contexts for the coupled entities, performing physical address translations from the entities'physical address spaces to the MxPU's first physical address space. This multi-headed capability may enable the MxPU to function as a memory pool resource, providing memory services to hosts while maintaining proper isolation and access control between different entities.

In some implementations of the MxPU, the repurposed area comprises the at least one of the communication port or the RPU and a remaining unassigned area, and wherein the remaining unassigned area is utilized for at least one of on-die decoupling capacitors or spare standard cells. The repurposed area may include not only functional blocks such as the communication port or RPU but also remaining unassigned silicon area. This remaining unassigned area may be utilized for on-die decoupling capacitors, which may help improve power delivery stability and reduce noise in the power distribution network. Alternatively or additionally, the remaining unassigned area may be reserved for spare standard cells or Engineering Change Order (ECO) cells, providing flexibility for late-stage design fixes or modifications without requiring substantial layout changes, and thereby increasing the utility of the repurposed area while maintaining design flexibility.

In some implementations of the MxPU, the communication port comprises an NVLink port, and the second physical address space comprises a network address space. When the MxPU is configured with an NVLink port, the second physical address space may include a network address space utilized by NVLink-connected devices. The network address space may enable NVLink-based devices to address memory resources across the NVLink fabric, wherein the RPU may translate between the network address space and the MxPU's first physical address space.

In some implementations of the MxPU, the first physical address space comprises a GPU physical address space, and the RPU is further configured to translate physical addresses within the network address space to physical addresses within the GPU physical address space. In MxPUs that are based on GPUs, the RPU may function similarly to a link translation lookaside buffer (TLB), translating between network addresses utilized by remote NVLink devices and local GPU physical addresses utilized by the MxPU's processing cores and memory controllers. This translation may enable remote NVLink peers to access the MxPU's GPU memory resources.

In some implementations of the MxPU, the MxPU further comprises a second silicon die coupled to the silicon die within an integrated circuit package of the MxPU, and wherein the second silicon die comprises an NVLink Fusion chiplet that includes the NVLink port and at least a portion of the RPU. The NVLink Fusion chiplet may provide a dedicated die implementing the NVLink port, the RPU, and associated translation logic, coupled to the processor die within the same integrated circuit package. This chiplet-based approach may enable the MxPU to incorporate NVLink connectivity and address translation capabilities without modifying the processor die's floorplan beyond the repurposed area's interconnect interface. In some examples, the NVLink Fusion chiplet may be fabricated utilizing a different process node than the processor die, potentially allowing optimization of the NVLink interface for power or performance independently of the processor die's process technology. Alternatively, the RPU, the NVLink port, and associated CXL interface logic may be implemented as functional blocks on the same die as the processor, or split between silicon dies or chiplets inside the integrated circuit package of the MxPU.

In some implementations, the MxPU further comprises a CXL root port coupled to the coherent interconnect, wherein the RPU is configured to translate messages received via the NVLink port into messages based on CXL, and to forward the translated messages to the coherent interconnect via the CXL root port. The RPU may utilize CXL as an intermediate protocol to bridge between the NVLink domain and the protocol utilized by the coherent interconnect. The RPU may expose a CXL device, such as a CXL endpoint (CXL EP) implementing a Type-1 or a Type-2 CXL device, to the processor via the CXL root port. The CXL root port may be coupled to the coherent interconnect via a coherent interconnect interface, such as a ring-to-CXL (R2CXL) interface, that may communicate with the coherent interconnect according to a protocol utilized by the coherent interconnect. This intermediate translation approach may enable the RPU to leverage existing CXL protocol infrastructure and interfaces already present in the processor design, potentially reducing the complexity of integrating NVLink connectivity into the MxPU. In some examples, the R2CXL interconnect interface may reside within the RPU, complementing the translation path from NVLink, via CXL, to traffic conforming to the protocol utilized by the coherent interconnect.

In some implementations of the MxPU, the MxPU comprises NVLink ports, and the repurposed area accommodates at least some of the NVLink ports. When the MxPU is configured as a processor or a switch with NVLink ports, the repurposed area may accommodate NVLink ports rather than a single port. This multi-port configuration may enable the MxPU to function as a multi-port GPU or an NVLink-based switch device, facilitating interconnection between NVLink-enabled devices in a fabric topology. The NVLink ports may share the RPU resources for address translation and protocol handling.

In some implementations of the MxPU, the second physical address space comprises a Network Physical Address (NPA) space, and the messages comprise UALink-based messages. When the MxPU includes a UALink port, the second physical address space may include an NPA space as defined by the UALink address model. UALink-based messages may conform to UPLI and may include read, write, and atomic operations that carry NPA addresses. The RPU may translate between the NPA space and the MxPU's first physical address space to enable UALink-connected accelerators to access the MxPU's memory resources.

In some implementations of the MxPU, the second physical address space comprises a Network Physical Address (NPA) space, the first physical address space comprises a System Physical Address (SPA) space, and wherein the RPU is further configured to translate physical addresses within the NPA space to physical addresses within the SPA space. In MxPUs that are based on UALink accelerators, the RPU may function as a link MMU that translates NPAs received from remote UALink accelerators to local SPAs utilized by the MxPU's processing cores and memory controllers. This NPA-to-SPA translation may enable the MxPU to participate in a UALink fabric while maintaining its local SPA-based memory addressing scheme.

In some implementations of the MxPU, the second physical address space comprises a Network Physical Address (NPA) space, the first physical address space comprises a Host Physical Address (HPA) space, and wherein the RPU is configured to translate physical addresses within the NPA space to physical addresses within the HPA space. In MxPUs that are based on CPUs, the RPU may translate NPAs received from UALink-connected accelerators to HPAs utilized by the MxPU's processing cores and memory controllers. This configuration may enable a CPU-based MxPU to serve as a UALink switch or a UALink-attached memory resource, providing UALink accelerators with access to the MxPU's host memory via NPA-to-HPA translations.

In some implementations of the MxPU, the MxPU comprises UALink ports, and the repurposed area accommodates at least some of the UALink ports. When the MxPU is configured to operate similarly to a UALink switch, the repurposed area may accommodate UALink ports rather than a single port, which may facilitate interconnection between UALink-enabled devices in a fabric topology. UALink ports may share the RPU resources for address translation and protocol handling.

In some implementations of the MxPU, the memory located outside the MxPU comprises at least 8 GB of dynamic random-access memory (DRAM) coupled via the memory channels, and the communication port comprises CXL endpoints located in the repurposed area, enabling the MxPU to function as a CXL Multi-Headed Device (MHD). The MxPU may be configured as a CXL Multi-Headed Device (MHD) by incorporating CXL endpoints within the repurposed area. This MHD configuration may allow external hosts to simultaneously access the MxPU's memory resources through different CXL connections. Different CXL endpoints may have different address translation contexts managed by the RPU, enabling isolated access to different portions of the DRAM or shared access with appropriate coherency mechanisms. Additionally or alternatively, the repurposed area may be sufficiently large to accommodate both the communication port and the RPU, rather than just one or the other. This configuration may enable the MxPU to implement CXL or UALink functionality within the repurposed silicon area, potentially enabling and/or enhancing memory pooling or switching capabilities while maintaining the original footprint of the silicon die.

The following method claim describes a design and manufacturing approach for creating processor device variants with improved yield by repurposing silicon die areas previously allocated to processing cores. By identifying areas of a processor design for repurposing, manufacturers may create new processor variants that accommodate communication ports and address translation units within the repurposed areas, without requiring a full redesign of the processor die.

In various implementations, a method for improving manufacturing yield of processor devices, comprising: identifying at least one processing core area in a processor design for repurposing as an impaired area; configuring the processor design to exclude the at least one processing core area from functional testing requirements while retaining a same die size; implementing at least one of a communication port or a resource provisioning unit (RPU) in the impaired area, wherein the communication port is selected from a Compute Express Link (CXL) endpoint, a CXL switch port, an NVLink port, or a UALink port, and the RPU is configured to translate between physical addresses associated with different physical address spaces; and manufacturing processor devices based on the configured processor design, whereby defects occurring within the impaired area do not cause rejection of the processor devices during production testing. This method may enable improved manufacturing yield by identifying and repurposing certain areas of a processor die as potential impaired areas that are excluded from stringent functional testing requirements. By implementing alternative functional blocks such as communication ports or RPUs within these repurposed impaired areas, the method may create valuable product variants while reducing the silicon area that must pass stringent functional tests. For example, processing cores are typically tested to operate correctly at high clock rates that significantly exceed the typical clock rates required for communication ports and RPUs. Defects that would normally cause die rejection if they occur in processing cores may be tolerated when they occur in alternative functional blocks in the repurposed impaired area, potentially increasing the percentage of usable dies from the wafers.

The implementations of the following method describe operational aspects of an MxPU derived from an established processor design. During operation, the MxPU utilizes processing cores and a coherent interconnect to access memory via memory channels, while a communication port receives messages from external entities utilizing a different physical address space. A resource provisioning unit (RPU) performs the translations between the external address space and the MxPU's internal address space, enabling the MxPU to serve as a memory resource, a protocol translator, or a switch for externally coupled devices. At least one of the communication port or the RPU operates from a silicon die area that was originally designed for processing cores in the established processor design, thereby leveraging the repurposed area for alternative functionality.

In various implementations, a method for operating a modified processing unit (MxPU), comprising: utilizing, by processing cores of the MxPU coupled via a coherent interconnect, a first physical address space to access memory located outside the MxPU via memory channels; receiving, via a communication port selected from a Compute Express Link (CXL) endpoint, a CXL switch port, an NVLink port, or a UALink port, messages comprising physical addresses within a second physical address space; translating, by a resource provisioning unit (RPU), physical addresses within the second physical address space to physical addresses within the first physical address space; and operating at least one of the communication port or the RPU from a silicon die area that excludes at least one processing core present in an established processor design from which the MxPU was derived. In some implementations, the RPU may dynamically translate between the address spaces during operation, enabling the MxPU to simultaneously serve its local processing workloads and provide memory services or connectivity to externally coupled devices. The silicon die area from which the communication port or RPU operates may correspond to a repurposed area or a repurposed impaired area, wherein processing cores from the established processor design have been excluded, replaced, or electrically disabled to accommodate the alternative functional blocks.

In some implementations of the method, the communication port comprises the CXL endpoint configured to communicate with an entity according to a protocol based on CXL, the first physical address space is a first Host Physical Address (HPA) space utilized by the processing cores, the second physical address space is a second Host Physical Address (HPA) space utilized by the entity, and the translating comprises performing host-to-host physical address translations from the second HPA space to the first HPA space. The method may include performing host-to-host physical address translations that enable external entities to access the MxPU's memory resources utilizing protocols based on CXL. These translations may dynamically map between different HPA spaces during operation, allowing the MxPU to serve memory access requests from external hosts while maintaining physical address space isolation and proper access control.

In some implementations, the method further comprises receiving, via a second communication port, second messages comprising physical addresses within a third physical address space utilized by a second entity; and translating, by the RPU, physical addresses within the third physical address space to physical addresses within the first physical address space to enable the second entity to access at least a portion of the memory. The method may include supporting multi-headed operations wherein external entities simultaneously access the MxPU's memory resources. The RPU may maintain separate translation contexts and perform different address translations for different coupled entities during operation, enabling the MxPU to function as a memory pool resource with concurrent access capabilities while maintaining isolation between different entities'memory accesses.

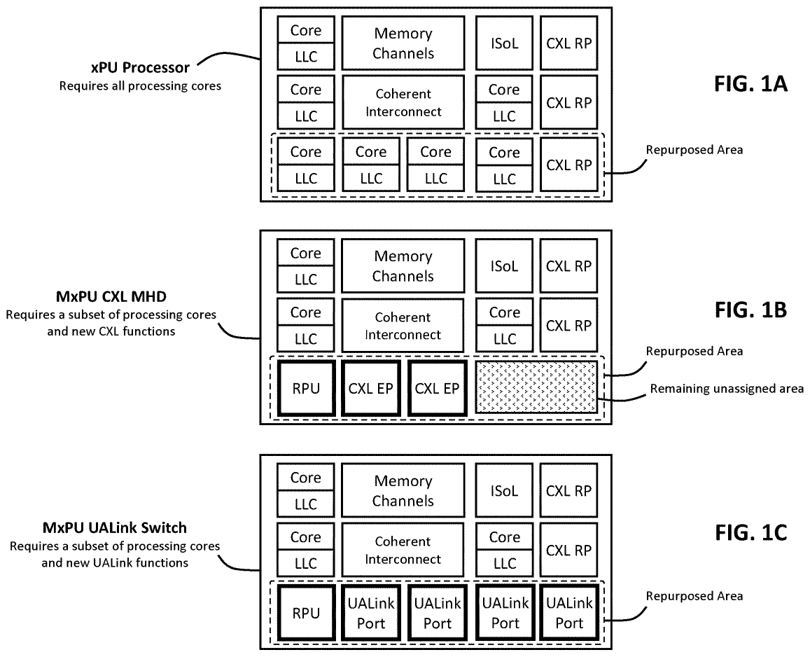

FIG. 1A illustrates an example of a silicon device functioning as an established xPU design before modification, which may include processing cores associated with Last Level Caches (LLCs), coupled through a cache coherent interconnect. The device may also include memory channels for external memory access, an inter-socket link (ISoL) for multi-processor configurations, and CXL root ports (RPs) for peripheral connectivity. The area identified as the repurposed area shown contains four processing cores with their associated LLC and one CXL RP, representing silicon area that may be repurposed in modified designs while maintaining the original die dimensions. The repurposed area may be used to create MxPU derivatives of the original xPU design, or may serve other purposes such as improving manufacturing yield.

FIG. 1B illustrates an example of a silicon device capable of providing the functionality of a CXL Multi-Headed Device (MHD) when coupled to memory, wherein the repurposed area may accommodate an RPU and CXL endpoints instead of the processing cores and optionally CXL root ports that originally resided in the repurposed area as illustrated in FIG. 1A. The RPU performs physical address translations that enable hosts coupled to the CXL MHD MxPU to access memory via the MxPU memory channels. The remaining silicon area within the repurposed area may be utilized for on-die decoupling capacitors or spare/ECO standard cells, maximizing the utility of the repurposed space, which may enable the device to serve as a CXL-attached memory resource for external hosts while maintaining compatibility with the original die size and package.

FIG. 1C illustrates an example of a silicon device (MxPU) capable of providing the functionality of a UALink Switch, wherein the repurposed area may accommodate an RPU and UALink ports instead of the processing cores and the CXL root port that originally resided in the repurposed area. The four UALink ports shown may provide connectivity to UALink-enabled devices, with the RPU performing physical address translations, such as from UALink Network Physical Addresses (NPAs) to MxPU Host Physical Addresses (HPAs) that enable UALink Accelerators coupled to the MxPU to access memory via the MxPU memory channels. The RPU may further enable UALink Accelerators to communicate with each other by translating UALink messages to MxPU interconnect messages and relaying the translated messages between UALink ports. The MHD MxPU example and the Switch MxPU example demonstrate how the same base silicon design may be adapted for different connectivity standards by implementing appropriate functional blocks within the repurposed area.

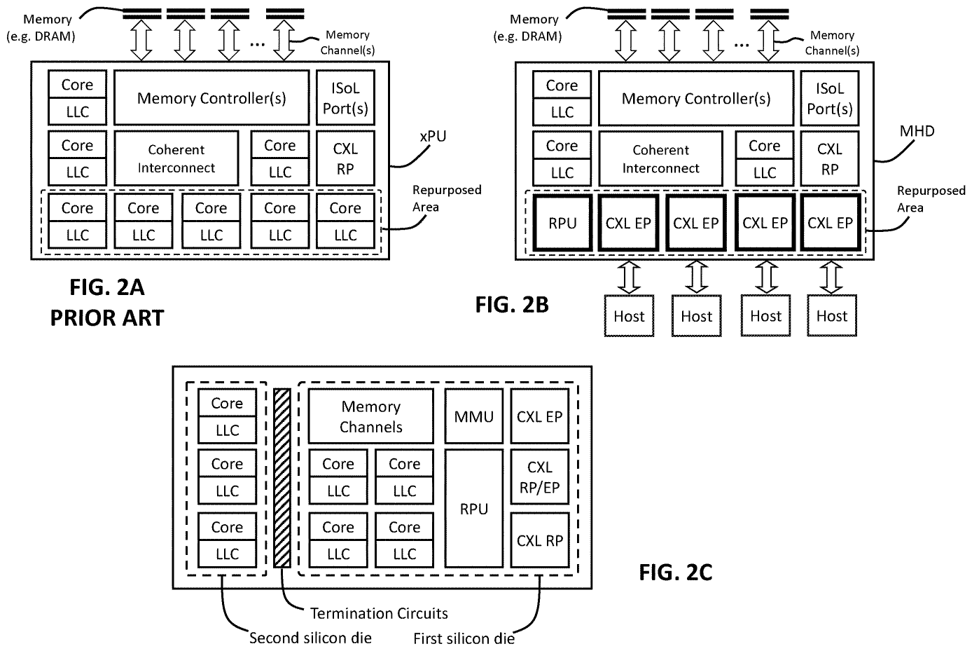

FIG. 2A illustrates a system comprising a prior art xPU design, such as a processor design (e.g., CPU or GPU), that includes a repurposed area (which may also be referred to as a designated area). The xPU may be based on an established xPU design, such as an established processor design, with memory controller(s) coupled to memory channels and to memory such as DRAM, ISoL port(s) such as Intel UPI port(s), a CXL root port (RP), a coherent interconnect, processing cores, and last level cache (LLC) slices, wherein at least some of the processing cores and/or the LLC slices may reside in a repurposed area of the xPU. The repurposed area may represent an intentional reservation of silicon area, such as in a die floorplan of an established xPU design, that may be intentionally disabled for product binning/segmentation, such as for creating different types of MxPUs, or utilized for different purposes, such as in different product Stock Keeping Units (SKUs), wherein different product SKUs may vary by the number of processing cores in the repurposed area, may vary by the type and mix of processing cores in the repurposed area (e.g., combinations of performance cores and efficiency cores, such as P-cores and E-cores, or big/little cores), or may vary by the operating frequency of the processing cores in the repurposed area. The repurposed area may be a repurposed impaired area of an xPU silicon die that may be limited in performance, e.g., limited in operating frequency that may fit slower processing cores, or may fit other functions of an xPU with lower performance requirements, such as communication ports (e.g., CXL ports) or miscellaneous non-core (e.g., uncore) functions.

FIG. 2B illustrates an example of a Multi-Headed Device (MHD) implementation that may be based on an xPU or an MxPU design, such as a processor design (e.g., CPU or GPU), that includes a repurposed area. The MHD may include processing cores, last level cache (LLC) slices, memory controller(s) coupled to memory channels and to memory such as DRAM, ISoL port(s) such as Intel UPI port(s), a CXL root port (RP), a coherent interconnect, and a repurposed area where processing cores of the original xPU may be replaced with one or more CXL endpoint ports, creating an MHD. The repurposed area may also include a Resource Provisioning Unit (RPU) that may enable physical address translations between physical address spaces, such as between Host Physical Address (HPA) spaces. The repurposed area may be modified to accommodate CXL endpoints that may replace processing cores, enabling MHD functionality based on a processor architecture. In some examples, the xPU may be based on an established xPU design, such as an established processor design (e.g., established CPU design or established GPU design).

In various implementations, an apparatus comprising: an integrated circuit comprising processing cores comprising memory management units (MMUs) and coherent caches; wherein the processing cores are configured to respond to snoop requests that utilize physical addresses within a physical address space (PAS), and wherein the MMUs are configured to translate virtual addresses to physical addresses within the PAS; a coherent interconnect coupling the processing cores to memory controllers coupled to memory channels capable of supporting memory having a capacity of at least 64 GB, and wherein the processing cores are configured to execute an operating system (OS) that accesses the memory utilizing the physical addresses within the PAS; a resource provisioning unit (RPU) comprising an NVLink-based interface configured to communicate, according to an NVLink-based protocol, with an entity coupled to the apparatus; and wherein the RPU is further coupled to the coherent interconnect and configured to translate physical addresses associated with the NVLink-based protocol to physical addresses within the PAS; whereby the translate of the physical addresses enables the entity to access the memory via the NVLink-based interface and the memory controllers.

In some implementations of the apparatus, the NVLink-based interface comprises at least one differential pair and is configured to support reliable communication by utilizing at least one of: a replay buffer configured to enable retransmissions of packets that were not positively acknowledged by a receiver, or a Forward Error Correction (FEC) code configured to enable correction of symbol errors.

In some implementations of the apparatus, The apparatus of claim 1, wherein, in addition to the physical address translations, the RPU is further configured to translate between first fields conforming to the NVLink-based protocol message formats, and second fields conforming to message formats of a protocol utilized by the coherent interconnect.

In some implementations of the apparatus, the protocol utilized by the coherent interconnect is based on Coherent Hub Interface (CHI-based protocol), and the RPU is further configured to translate read requests corresponding to the NVLink-based protocol to requests corresponding to the CHI-based protocol carrying ReadOnce or ReadShared. The RPU may further translate CHI responses to NVLink responses, such as CHI responses carrying CompData to NVLink responses. Additionally, the RPU may maintain transaction context to properly correlate requests and responses across the protocol domains. The translation to CHI ReadOnce may be utilized for non-cacheable data accesses, while ReadShared may be utilized for cacheable shared data. The RPU may handle protocol-specific differences in flow control, credit management, and response ordering between the NVLink and CHI domains. The CompData responses from CHI may carry the requested data along with completion status, which the RPU translates into appropriate NVLink response formats.

In some implementations of the apparatus, the protocol utilized by the coherent interconnect is based on an Intel Coherent Processor Interconnect Protocol (ICPIP-based protocol) for scalable multiprocessors with a shared physical address space, and wherein the RPU is further configured to translate memory access requests corresponding to the NVLink-based protocol to requests corresponding to the ICPIP-based protocol, while maintaining coherency state tracking for physical addresses within the PAS that are associated with the coherent caches. Examples of ICPIP include Intel's Ultra Path Interconnect (UPI) and future Intel's Coherent Processor Interconnect Protocols. Optionally, the coherency state tracking between NVLink and ICPIP domains may include monitoring cacheline states and ensuring consistency across protocol boundaries. The RPU may include state machines to track outstanding transactions and their coherency implications. The translation may accommodate differences in data transfer granularity and response timing between NVLink and ICPIP protocols.

In some implementations of the apparatus, the protocol utilized by the coherent interconnect is based on Infinity Fabric (IF-based), and wherein the RPU is further configured to translate NVLink-based traffic to IF-based traffic, while preserving memory ordering required by the entity. The preservation of memory ordering may include tracking command dependencies and enforcing completion ordering as required by both NVLink and Infinity Fabric specifications. The RPU may include ordering enforcement logic that respect producer-consumer relationships and memory barrier semantics across the protocol boundary. The RPU may translate NVLink commands that include partial write indicators to appropriate Infinity Fabric write command types while maintaining data integrity.

In some implementations of the apparatus, the RPU is further configured to translate commands or encodings associated with the NVLink-based protocol to commands or opcodes associated with a protocol utilized by the coherent interconnect, based on a mapping between request types of the NVLink-based protocol and corresponding request types of the protocol utilized by the coherent interconnect. The mapping may be implemented utilizing lookup tables, state machines, or programmable translation logic. The RPU may handle various NVLink categories including memory reads, memory writes, and atomic operations, translating them to appropriate coherent interconnect opcodes while preserving transaction semantics.

In some implementations of the apparatus, the RPU is further configured to translate a request corresponding to the NVLink-based protocol to at least one message corresponding to the protocol utilized by the coherent interconnect; wherein the at least one message causes prefetch to a cache of a processor comprising the processing cores. The RPU may translate NVLink requests, such as requests carrying explicit or implicit prefetch hints, to messages of a protocol utilized by the coherent interconnect that effectively prefetch data into a cache of the processor, enabling reduced memory access latency for anticipated future accesses. An example of a prefetch hint may include a case wherein the RPU detects a pattern of reading pairs of addresses that are adjacent to each other or separated by a distinguishable stride.

In some implementations of the apparatus, the RPU is further configured to utilize an intermediate protocol selected from Peripheral Component Interconnect Express (PCIe) or Compute Express Link (CXL) when translating between the NVLink-based protocol and a protocol utilized by the coherent interconnect. The use of an intermediate protocol may facilitate translation by leveraging existing protocol conversion logic. When utilizing PCIe as an intermediate protocol, the RPU may translate NVLink traffic to PCIe Transaction Layer Packets (TLPs) and subsequently to coherent interconnect transactions. When utilizing CXL as an intermediate protocol, the RPU may leverage CXL.cache or CXL.mem as appropriate for the transaction type. The intermediate protocol stage may enable reuse of existing protocol bridges and translation logic.

In some implementations of the apparatus, the RPU is further configured to maintain mappings between transaction identifiers utilized by the NVLink-based protocol and transaction identifiers utilized by the coherent interconnect, enabling correlation of requests and responses across domains. The transaction identifier mappings may accommodate different identifier formats, sizes, and allocation schemes between NVLink and the coherent interconnect. Transaction identifiers may be used to identify a transaction, such as when supporting outstanding requests in-flight through the RPU, or may be used to convey properties associated with messages or transactions, such as trace identifiers used for debugging and performance measurements, or authorization identifiers used for security. The RPU may include identifier pools and allocation mechanisms to prevent identifier exhaustion and may support identifier recycling upon transaction completion. The mapping structures may be optimized for fast lookup during high-frequency transaction processing and may utilize on-silicon SRAM, content-addressable memory (CAM) or Ternary Content-Addressable Memory (TCAM) structures.

In some implementations of the apparatus, the RPU is further configured to: maintain a transaction tracking structure to monitor outstanding transactions from the entity, allocate coherent interconnect transaction identifiers for transactions initiated by the RPU, and release identifiers upon transaction completion. The transaction tracking structure may be implemented using content-addressable memories, linked lists, or circular buffers optimized for the expected transaction rates. The RPU may include timeout logic to handle lost or excessively delayed transactions and may support error recovery procedures. The tracking structure may maintain additional transaction attributes such as timestamps, retry counts, or quality-of-service parameters.

In some implementations of the apparatus, the RPU is further configured to enable bidirectional access by translating requests between messages conforming to the NVLink-based protocol and messages conforming to the protocol utilized by the coherent interconnect; whereby the entity accesses the memory according to the NVLink-based protocol, and the processing cores access resources attached to the entity via the coherent interconnect. The bidirectional access capability may enable memory pooling and memory sharing architectures wherein system memory and entity-attached memory form a memory space accessible from both domains via translations. The RPU may maintain separate translation contexts for each direction and may apply different translation policies based on the initiator and target of each transaction. The bidirectional capability may support various computing paradigms including GPU-direct operations and peer-to-peer transfers. When processing cores access entity-attached resources, such as High-Bandwidth Memory (HBM) resources, the RPU may handle different memory attributes between the two domains.

In some implementations of the apparatus, the entity comprises at least one of: high-bandwidth memory (HBM), High-Bandwidth Flash (HBF), Low-Power Double Data Rate (LPDDR) memory, or Graphics Double Data Rate (GDDR) memory; and wherein the RPU is further configured to map a portion of the entity memory into the PAS, enabling the processing cores to access the entity memory based on memory-mapped operations. The mapping of entity memory such as HBM, HBF, LPDDR, or GDDR memory into PAS may include establishing memory windows with specific attributes optimized for the memory type. The RPU may handle differences in memory access granularity, bandwidth characteristics, and latency profiles between system memory and entity memory. The memory-mapped operations may be subject to caching policies and coherency protocols appropriate for cross-domain memory access.

In some implementations of the apparatus, the RPU is further configured to provide access control by validating the physical addresses associated with the NVLink-based protocol against permitted address ranges for the entity, and blocking NVLink-based traffic targeting prohibited address ranges. The permitted address ranges may be configured utilizing secure configuration registers or loaded from trusted firmware during system initialization. The RPU may support different access control contexts for different operational modes or security domains. The blocking of prohibited traffic may generate error responses conforming to NVLink error reporting logic and may trigger security event logging.

In some implementations of the apparatus, the RPU is further configured to evaluate transaction attributes associated with the NVLink-based protocol, including source identifiers and access types, and to apply security policies to allow or deny traffic based on preconfigured security rules. The security policies may consider combinations of transaction attributes including source device identification, vendor-defined commands or fields, transaction type, address range, and temporal factors. The RPU may provide role-based access control wherein different entities have different access privileges. The security rules may be updateable utilizing authenticated channels and may support both static and dynamic security policy enforcement.

In some implementations of the apparatus, the RPU is further configured to detect access patterns in NVLink-based traffic from the entity, and generates prefetch requests based on predicted future accesses; and wherein the prefetch requests are routed via the coherent interconnect and the memory controllers. The access pattern detection may utilize algorithms such as stride detection, stream buffers, or correlation-based prediction algorithms. The RPU may maintain pattern history tables to track access behaviors and may adapt prefetching aggressiveness based on prefetch accuracy metrics. The prefetch requests may be tagged with lower priority to avoid interfering with demand requests and may be cancelled if subsequent access patterns diverge from predictions.

In some implementations of the apparatus, the RPU is further configured to coalesce coherent interconnect transactions targeting contiguous or nearby addresses into fewer NVLink-based transactions; whereby the coalescing improves memory bandwidth utilization. The request coalescing may consider factors including address proximity, request types, and timing windows when determining which transactions to combine. The RPU may include write combining buffers for write transactions and may support read coalescing for sequential read patterns. In one example, coherent interconnects may use up to 64-byte transfers, that may reflect a nominal cacheline size utilized by the coherent interconnect, whereas NVLink may use larger transfers up to 256 bytes, making coalescing beneficial for bandwidth efficiency.

In some implementations of the apparatus, the NVLink-based interface is configured to support virtual channels, and the RPU is further configured to map the virtual channels to quality-of-service (QoS) attributes in a protocol utilized by the coherent interconnect. The virtual channel to QoS mapping may enable differentiated service levels for different traffic classes, such as bulk data transfers versus latency-sensitive communications. The RPU may include programmable mapping tables to allow flexible QoS policy configuration. The mapping may consider both NVLink virtual channel priorities and coherent interconnect QoS mechanisms to maintain end-to-end service level objectives.

In some implementations of the apparatus, the memory comprises dynamic random-access memory (DRAM), and the entity comprises a graphics processing unit (GPU) or an accelerator coupled to the apparatus via the NVLink-based interface; and wherein the RPU enables the entity to access the DRAM with cache-line granularity. An entity, such as a GPU or an accelerator, may utilize the NVLink interface for memory access to memory resources attached to the processor. Optionally, when the entity is coupled through an NVLink switch, the RPU may handle switch-specific routing information and may support entities sharing the NVLink interface through switch-based connectivity. The GPU or accelerator entity may utilize the NVLink interface for high-bandwidth memory access patterns characteristic of parallel computing workloads. The RPU may optimize translations for the specific access patterns and bandwidth requirements of GPU or accelerator workloads.

In various implementations, a method for enabling an entity to access memory via an NVLink-based interface, comprising: operating a processor comprising processing cores, memory management units (MMUs), and coherent caches; wherein the processing cores respond to snoop requests that utilize physical addresses within a physical address space (PAS), and the MMUs translate virtual addresses to physical addresses within the PAS; communicating, via a coherent interconnect, between the processing cores and memory controllers that communicate with memory channels coupled to memory having a capacity of at least 64 GB; executing, by the processing cores, an operating system (OS) that accesses the memory utilizing the physical addresses within the PAS; communicating according to an NVLink-based protocol with the entity via an NVLink-based interface; and translating physical addresses associated with the NVLink-based protocol to physical addresses within the PAS.

In some implementations, the method further comprises translating from non-address fields conforming to the NVLink-based protocol message formats to corresponding fields conforming to message formats of a protocol utilized by the coherent interconnect; and wherein the translating of the physical addresses is performed by a resource provisioning unit (RPU) coupled between the NVLink-based interface and the coherent interconnect.

In some implementations of the method, the protocol utilized by the coherent interconnect is based on Coherent Hub Interface (CHI-based protocol); and wherein the translating between non-address fields comprises translating NVLink-based protocol read commands to CHI-based protocol opcodes or commands comprising ReadOnce or ReadShared. The method may further include translating CHI response opcodes to NVLink response opcodes, such as translating CHI responses carrying CompData to NVLink responses.

In some implementations of the method, the protocol utilized by the coherent interconnect is based on an Intel Coherent Processor Interconnect Protocol (ICPIP-based protocol) for scalable multiprocessors with a shared physical address space; and wherein the translating between non-address fields comprises translating NVLink-based protocol memory access commands to ICPIP-based protocol requests while maintaining coherency state tracking between domain of the NVLink-based protocol and domain of the ICPIP-based protocol.

In some implementations of the method, the protocol utilized by the coherent interconnect is based on Infinity Fabric (IF-based); and wherein the translating between non-address fields comprises translating NVLink-based commands to IF-based commands while preserving memory ordering required by the entity.

In some implementations, the method further comprises translating NVLink-based commands to commands associated with a protocol utilized by the coherent interconnect, based on a mapping between NVLink-based transaction types and corresponding transaction types of the protocol utilized by the coherent interconnect. It is noted that in the context of such implementations, NVLink-based commands and NVLink-based encodings may be used interchangeably.

In some implementations of the method, the translating of the physical addresses comprises utilizing an intermediate protocol selected from Peripheral Component Interconnect Express (PCIe) or Compute Express Link (CXL) as an intermediate stage between the NVLink-based protocol and a protocol utilized by the coherent interconnect.

In some implementations, the method further comprises translating transaction identifiers utilized by the NVLink-based protocol to transaction identifiers utilized by the coherent interconnect, maintaining a transaction tracking structure to monitor outstanding transactions from the entity, allocating coherent interconnect transaction identifiers for RPU-initiated transactions, and releasing identifiers upon transaction completion.

In some implementations, the method further comprises validating the physical addresses associated with the NVLink-based protocol against permitted address ranges for the entity, and blocking NVLink-based traffic targeting prohibited address ranges; and further comprising evaluating NVLink-based traffic attributes including source identifiers and access types, and applying security policies to allow or deny traffic based on preconfigured security rules.

In some implementations, the method further comprises detecting access patterns in NVLink-based traffic from the entity, and generating prefetch requests based on predicted future accesses, wherein the prefetch requests are routed via the coherent interconnect and the memory controllers.

In various implementations, a system comprising: a host processor; a memory having a capacity of at least 64 GB; a coherent interconnect architecture coupling processing elements to the memory, wherein the processing elements utilize a local physical address space to access the memory; and a resource provisioning unit (RPU) configured to translate physical addresses associated with an NVLink-based protocol, utilized by an entity coupled to the RPU via an NVLink-based interface, to physical addresses within the local physical address space; whereby the translate of the physical addresses enables the entity to utilize the memory as disaggregated memory accessed via the NVLink-based interface and the memory controllers.

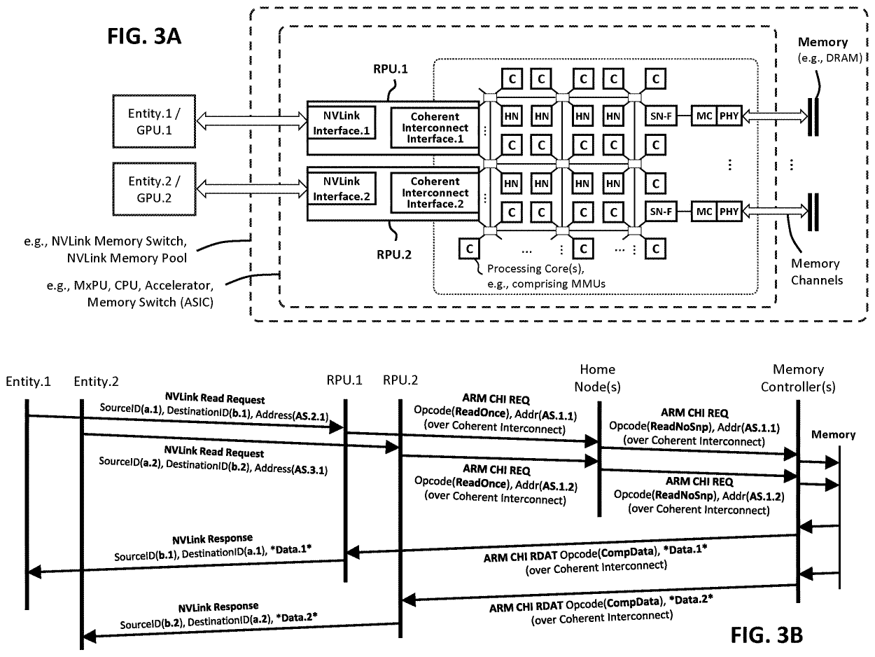

FIG. 3A illustrates an example of a system that may function as an NVLink memory switch appliance or an NVLink memory pool, and may include an MxPU, CPU, accelerator, or a memory switch ASIC, that is coupled to two entities denoted as Entity.1/ GPU.1 and Entity.2/GPU.2. The MxPU includes processing cores and memory controllers coupled to a coherent interconnect that may be based on CHI. The MxPU utilizes translations, performed by the RPUs, between NVLink-based interfaces and an MxPU's coherent interconnect. The first RPU (RPU.1) may enable Entity.1/GPU.1 to access resources mapped to a physical address space utilized by the MxPU's coherent interconnect, wherein the access is via the first NVLink interface and the MxPU's coherent interconnect. Examples of resources mapped to the physical address space utilized by the MxPU's coherent interconnect include DRAM or other memory resources of the MxPU. Correspondingly, the second RPU (RPU.2) may enable Entity.2/GPU.2 to access, via the second NVLink interface and the MxPU's coherent interconnect, resources mapped to a physical address space utilized by the MxPU's coherent interconnect, such as memory resources of the MxPU.

FIG. 3B illustrates an example of a TFD depicting a multi-entity memory access scenario wherein first and second entities/GPUs access memory mapped to one or more physical address spaces utilized by the coherent interconnect (CohInterMappedMemory), through NVLink to ARM CHI translations. Entity.1/GPU.1 initiates a first NVLink request: Read with SourceID(a.1) to identify the source GPU, DestinationID(b.1) to identify the destination GPU, and Address(AS.2.1) representing an NVLink network address from a second physical address space. RPU.1 translates the first NVLink request to ARM CHI REQ carrying Opcode(ReadOnce), and Addr(AS.1.1) from a first physical address space utilized by the coherent interconnect. Concurrently or sequentially, Entity.2/GPU.2 may initiate a second NVLink request: Read with SourceID(a.2), DestinationID(b.2), and Address(AS.3.1) representing an NVLink network address optionally from a third physical address space or from the second physical address space. RPU.2 translates the second NVLink request to ARM CHI REQ carrying Opcode(ReadOnce) and Addr(AS.1.2) from the first physical address space utilized by the coherent interconnect.

Both transactions flow through the coherent interconnect to one or more home nodes, which may send respective ARM CHI REQ messages to one or more memory controllers with Opcode(ReadNoSnp) and the addresses Addr(AS.1.1) and Addr(AS.1.2), respectively. The memory controller(s) retrieve the requested data from the CohInterMappedMemory and send first and second ARM CHI RDAT messages with Opcode(CompData) carrying Data.1* and *Data.2*, representing the data retrieved from the addresses AS.1.1 and AS.1.2, respectively. RPU.1 translates the first ARM CHI RDAT message to NVLink response with SourceID(b.1), DestinationID(a.1), and Data.1* for Entity.1/GPU.1. RPU.2 translates the second ARM CHI RDAT message to NVLink response with SourceID(b.2), DestinationID(a.2), and *Data.2* for Entity.2/GPU.2. The illustrated example demonstrates how entities/GPUs may share access to the same CohInterMappedMemory through different RPUs that translate between NVLink and ARM CHI, including physical address translations. Alternatively, the illustrated example may be viewed as two separate NVLink transactions that utilize the same coherent interconnect infrastructure to access CohInterMappedMemory, wherein the GPU entities may access the CohInterMappedMemory via a shared or separate address spaces that are translated to the shared coherent interconnect physical address space. Still alternatively, the response and read data paths may be implemented according to other designs, such as wherein the memory controller(s) may send the data to the home node(s) that send it to the respective RPUs, or the home node(s) send responses to the RPUs while the memory controller(s) send the data to the RPUs.

Depending on system characteristics, such as implementation choices and platform configurations, different physical addresses, such as (AS.1.1) and (AS.1.2), within a physical address space utilized by the coherent interconnect, may be typically partitioned, such as via hashing or interleaving schemes, across a set of home nodes. Such partitioning is typically performed in order to reduce bottleneck effects in the system and spread the load of transaction processing across home nodes of the coherent interconnect, and may result in mapping the different physical addresses, such as (AS.1.1) and (AS.1.2), to the same home node, or to different home nodes. Similarly, different physical addresses may be associated with one memory controller, or with different memory controllers, such as according to a separate mapping scheme, which may be different from the mapping scheme utilized for selecting a home node for processing the request. Alternatively, other implementations may co-locate the home node function with a specific memory controller, utilizing a unified mapping scheme that selects both a home node and a memory controller.

In computing environments where a host, such as a CPU, accesses memory resources on a device, such as an accelerator, the device may expose memory regions to the host via CXL. Different memory regions may have different coherency requirements and may be backed by different types of memory. For example, a first memory region may be backed by local memory coupled to the device, such as HBM and/or High-Bandwidth Flash (HBF), and may benefit from device coherency where the device participates in cache coherency with the host. A second memory region may be backed by memory accessible via a UALink network, such as memory residing on remote accelerators, and may not require device coherency participation. The CXL specification defines different HDM types and device type flows that correspond to different coherency models, and a device may expose concurrent HDM regions utilizing different device type flows. An RPU or translation logic within the device may translate between CXL protocol messages received from the host and UPLI messages for accessing memory in the UALink domain, while maintaining the appropriate coherency semantics for each memory region.

In various implementations, a method comprising: exposing, by a device coupled to a host via a Compute Express Link (CXL) link, a first memory region via a first CXL device type flow and a second memory region via a second CXL device type flow, wherein the first CXL device type flow is different from the second CXL device type flow; wherein the first memory region is associated with a first memory; wherein the second memory region is associated with a second memory accessible via an Ultra Accelerator Link (UALink)-based protocol; and translating, by the device, between a protocol based on CXL and UALink Protocol Level Interface (UPLI) for at least one of the first memory region or the second memory region. The method may be implemented in hardware, firmware, software, or combinations thereof, and may be performed by various types of devices, such as an accelerator, an RPU, a semiconductor device, or a chiplet within an IC package. The first and second CXL device type flows may correspond to any combination of CXL Type-2 and Type-3 device flows, and may further include CXL Type-1 device flows in some examples. The device may expose additional memory regions beyond the first and second memory regions, each utilizing different or the same CXL device type flows. Translations between the protocol based on CXL and UPLI may include translations of opcodes, addresses, Tags, and additional fields, and may further include address translations between different address spaces such as a Host Physical Address (HPA) space and a Network Physical Address (NPA) space. The first memory may include memory coupled to the device, such as HBM, HBF, DRAM, or GDDR, while the second memory may include memory accessible via a UALink switch, a UALink network, or remote accelerators within a UALink domain. The elements may communicate through one or more intermediary components, such as a switch, a retimer, or other suitable entity that facilitates information transfer.

In some implementations of the method, the first CXL device type flow comprises a CXL Type-2 device flow and the first memory region comprises a Host-managed Device Memory with Device coherency (HDM-D) region, and the second CXL device type flow comprises a CXL Type-3 device flow and the second memory region comprises a Host-managed Device Memory with Host-only coherency (HDM-H) region; and wherein the device participates in cache coherency with the host for the first memory region and does not participate in cache coherency with the host for the second memory region. The CXL Type-2 device flow may enable the device to utilize both CXL.mem and CXL.cache protocols for the HDM-D region, allowing the device to maintain cached copies of data and participate in coherency negotiations with the host. The CXL Type-3 device flow may utilize CXL.mem without CXL. cache for the HDM-H region, where the host manages coherency without device cache participation.

In some implementations, the method further comprises receiving, from the host, a CXL.mem Master-to-Subordinate (M2S) request comprising MemRd* and an address targeting the first memory region, wherein the CXL.mem M2S request further comprises a SnpType field, a MetaField field, and a MetaValue field; translating the CXL.mem M2S request to a UPLI request; receiving a UPLI response comprising data; and sending to the host a CXL mem Subordinate-to-Master No Data Response (S2M NDR) comprising Cmp-S or Cmp-E indicating a cache state of a cacheline at the address, and a CXL.mem Subordinate-to-Master Data Response (S2M DRS) comprising MemData and the data. The SnpType, MetaField, and MetaValue fields in the CXL.mem M2S request may indicate the cacheline state intent of the host, such as requesting a shared copy (SnpData) or an exclusive copy (SnpInv). The device may utilize these fields to determine the appropriate coherency response. The device coherency engine (DCOH) may select Cmp-S when the device retains a cached copy of the data, or Cmp-E when the device relinquishes its cached copy. The device may translate the CXL.mem M2S request to a UPLI request to fetch the data from the UALink domain before responding.

In some implementations of the method, the device comprises a cache; and wherein the device stores the data from the UPLI response in the cache and sends the CXL.mem S2M NDR comprising Cmp-S indicating that the device retains a cached copy of the cacheline at the address. By caching the fetched data and responding with Cmp-S, the device may enable subsequent accesses to the same cacheline to be served from its local cache without requiring another UPLI transaction. A device with cache, or a device that controls or utilizes a cache, may include a cache memory, a cache controller, or cache allocation and eviction logic.

In some implementations of the method, the UPLI request comprises a ReqSrcPhysAccID field, a ReqDstPhysAccID field, a ReqTag field, a ReqAddr field, and a ReqCmd field comprising a read command; and further comprising translating a Tag of the CXL.mem M2S request to the ReqTag of the UPLI request. The ReqSrcPhysAccID and ReqDstPhysAccID fields may carry identifiers utilized by the UALink network for routing the UPLI request. The Tag translation may involve maintaining a bidirectional mapping between CXL.mem Tag values and UPLI ReqTag values, enabling proper correlation of UPLI responses with their corresponding CXL.mem requests.

In some implementations, the method further comprises receiving, from the host, a CXL.mem Master-to-Subordinate (M2S) request comprising MemRd* and an address targeting the second memory region; translating the CXL.mem M2S request to a UPLI request; receiving a UPLI response comprising data; and sending to the host a CXL.mem Subordinate-to-Master Data Response (S2M DRS) comprising MemData and the data. For the second memory region, the device may operate as a passthrough translator that fetches data from the UALink domain and returns it to the host without maintaining cached copies or participating in coherency negotiations. The CXL.mem S2M DRS may carry MemData without an accompanying S2M NDR indicating Cmp-S or Cmp-E, because the device does not track cache state for this memory region.

In some implementations of the method, the UPLI response further comprises a RdRspDataError field indicating a data error; and further comprising translating the RdRspDataError field to a Poison field of the CXL.mem S2M DRS sent to the host. The RdRspDataError field in the UPLI response may serve as a per-beat data poison indicator. The translation of error indications across protocol boundaries may enable the host to detect data corruption that originated in the UALink domain and to take appropriate recovery actions.

In some implementations of the method, for the first memory region, the device communicates with the host via CXL.cache; and wherein the device issues CXL.cache Device-to-Host (D2H) requests to the host comprising an opcode selected from RdOwn, RdShared, RdCurr, or RdAny. The CXL.cache D2H requests may enable the device to initiate coherency transactions with the host for data in the first memory region. RdOwn may acquire exclusive ownership, RdShared may acquire a shared copy, RdCurr may request a non-cacheable current value, and RdAny may accept any coherency state.

In some implementations of the method, the first memory comprises at least one of High Bandwidth Memory (HBM) or High-Bandwidth Flash (HBF) coupled to the device, the second memory comprises memory accessible via a UALink switch or a UALink network, and the device comprises an accelerator. The accelerator may be a GPU, a TPU, or other processing unit with HBM and/or HBF that may benefit from device coherency for its local memory. The UALink switch or fabric may couple the accelerator to remote accelerators, and the second memory may reside on the remote accelerators or on other memory resources within the UALink domain.

In some implementations, the method further comprises translating, by the device, between a first address associated with a first address space utilized by the host and a second address associated with a second address space utilized by the UALink-based protocol; wherein the first address space comprises a Host Physical Address (HPA) space, and the second address space comprises a Network Physical Address (NPA) space or a System Physical Address (SPA) space. The address translation may be implemented utilizing lookup tables, page tables, base-and-offset calculations, or programmable translation functions. The HPA space may represent the host's view of the memory, while the NPA or SPA space may represent the address used by the UALink network for routing and accessing memory resources.

In some implementations of the method, at least one of the first memory region or the second memory region comprises a Host-managed Device Memory with Back-Invalidate (HDM-DB) region; and wherein the device sends a CXL.mem Subordinate-to-Master Back-Invalidate Snoop (S2M BISnp) to the host, and the host responds with a CXL.mem Master-to-Subordinate Back-Invalidate Response (M2S BIRsp). The HDM-DB region may enable the device to snoop the host's cache when the device needs to modify or evict cached data. The S2M BISnp may carry opcodes such as BISnpInv, BISnpData, or BISnpCur, and the M2S BIRsp may carry opcodes such as BIRspI, BIRspS, or BIRspE indicating the resulting host cache state. HDM-DB may be utilized with either CXL Type-2 or CXL Type-3 device flows.

In some implementations, the method further comprises receiving, from the host, a CXL.mem Master-to-Subordinate Request with Data (M2S RwD) comprising MemWr* and write data; translating the CXL.mem M2S RwD to a UPLI request comprising a write command and the write data; and sending a CXL.mem Subordinate-to-Master No Data Response (S2M NDR) to the host. The write command in the UPLI request may include Write or WriteFull commands. The device may send the S2M NDR before or after the UPLI write completes, depending on ordering requirements and system configuration.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages.

In computing systems where a host accesses memory resources on a device coupled via CXL, the device may expose memory regions with different coherency characteristics to the host. A first memory region associated with local memory, such as HBM, may be exposed via a CXL device type flow that supports device coherency, enabling the host and device to maintain coherent cached copies of data. A second memory region associated with memory accessible via a UALink port may be exposed via a different CXL device type flow that does not require device coherency participation. The device may include an RPU or translation logic configured to translate between CXL protocol messages and UPLI messages for memory access operations targeting the UALink-accessible memory. A UALink switch may couple the device to one or more remote accelerators whose memory resources form the second memory region.

In various implementations, a system comprising: a host; a device coupled to the host via a Compute Express Link (CXL) link; and a first memory coupled to the device; wherein the device is configured to expose to the host a first memory region via a first CXL device type flow and a second memory region via a second CXL device type flow, wherein the first CXL device type flow is different from the second CXL device type flow; wherein the first memory region is associated with the first memory; wherein the second memory region is associated with a second memory accessible via an Ultra Accelerator Link (UALink) port of the device; and wherein the device is configured to translate between a protocol based on CXL and UALink Protocol Level Interface (UPLI) for requests targeting at least one of the first memory region or the second memory region. The system may enable a host to access both local and remote memory resources on the device through a CXL link, with differentiated coherency semantics for different memory regions. The device may include an RPU, translation logic, or a combination of hardware and firmware that performs the translations between CXL and UPLI. The device may configure the boundaries between the first and second memory regions dynamically or statically, for example utilizing HDM decoder registers or programmable address range registers.

In some implementations of the system, the first CXL device type flow comprises a CXL Type-2 device flow and the first memory region comprises a Host-managed Device Memory with Device coherency (HDM-D) region, and the second CXL device type flow comprises a CXL Type-3 device flow and the second memory region comprises a Host-managed Device Memory with Host-only coherency (HDM-H) region. The CXL Type-2 device flow may enable the device to negotiate CXL.io, CXL.cache, and CXL.mem for the HDM-D region, while the CXL Type-3 device flow may negotiate CXL.io and CXL.mem for the HDM-H region. In some examples, the assignment of HDM types to memory regions may be configurable at system initialization or runtime.

In some implementations of the system, for CXL.mem requests targeting the first memory region, the device is configured to send a CXL mem Subordinate-to-Master No Data Response (S2M NDR) comprising Cmp-S or Cmp-E indicating a cache state; and for CXL.mem requests targeting the second memory region, the device is configured to translate the CXL. mem requests to UPLI requests and send a CXL.mem Subordinate-to-Master Data Response (S2M DRS) comprising MemData. The differentiated response behavior may reflect the different coherency models of the first and second memory regions. For the first memory region, the Cmp-S or Cmp-E indication may inform the host of the cache state of the cacheline at the device. For the second memory region, the device may translate the request to UPLI, fetch the data from the UALink domain, and return the data.

In some implementations of the system, the host communicates with the device via CXL.mem and CXL.cache for the first memory region, and the host communicates with the device via CXL.mem without CXL.cache for the second memory region. The use of CXL.cache for the first memory region may enable the device to initiate coherency transactions and respond to host snoops, supporting scenarios where the device and host may both cache data from the first memory region. The absence of CXL.cache for the second memory region may simplify the memory access path for remote memory.

In some implementations of the system, the device comprises an accelerator comprising a resource provisioning unit (RPU), and the first memory comprises at least one of High Bandwidth Memory (HBM) or High-Bandwidth Flash (HBF) coupled to the accelerator; and further comprising a UALink switch coupling the UALink port of the device to one or more remote accelerators, wherein the second memory is accessible via the UALink switch. The RPU may be implemented as an IP block embedded within the accelerator, or as a chiplet within an IC package containing the accelerator. The UALink switch may route UPLI traffic based on destination accelerator identifiers carried in the UPLI requests. The one or more remote accelerators may each have their own HBM, HBF, or other memory that collectively forms the second memory accessible from the device.

In computing environments where a host, such as a CPU, accesses memory resources on a device coupled via CXL, the device may expose memory regions to the host with different connectivity. A first memory region may be backed by local memory coupled to the device, while a second memory region may be backed by memory accessible via an NVLink fabric, such as memory residing on GPUs or other NVLink-connected devices. NVLink provides high-bandwidth communication between GPUs and accelerators, and may support distributed memory models where devices access memory via other devices. The device may translate between CXL protocol messages received from the host and NVLink messages for accessing memory in the NVLink domain, while exposing different CXL device type flows for different memory regions to provide appropriate coherency semantics. NVLink messages may carry fields such as source and destination identifiers for routing, addresses for memory location, transaction tags for response correlation, length fields for transfer size, and data payloads.

In various implementations, a method comprising: exposing, by a device coupled to a host via a Compute Express Link (CXL) link, a first memory region via a first CXL device type flow and a second memory region via a second CXL device type flow, wherein the first CXL device type flow is different from the second CXL device type flow; wherein the first memory region is associated with a first memory; wherein the second memory region is associated with a second memory accessible via an NVLink-based protocol; and translating, by the device, between a protocol based on CXL and the NVLink-based protocol for at least one of the first memory region or the second memory region. The method may be implemented in hardware, firmware, software, or combinations thereof, and may be performed by various types of devices, such as an accelerator, an RPU, a semiconductor device, an active cable, or a chiplet within an IC package. The first and second CXL device type flows may correspond to any combination of CXL Type-2 and Type-3 device flows. Translations between CXL and NVLink may include translations of opcodes, addresses, transaction identifiers, and additional fields. NVLink messages may carry functional fields corresponding to source identifiers, destination identifiers, addresses, transaction tags, transfer lengths, and data payloads; the specific field names may vary across NVLink versions or implementations, and the translation may accommodate such variations. The first memory may include memory coupled to the device, such as HBM and/or HBF, while the second memory may include memory accessible via GPUs or other NVLink-connected devices. The device may be positioned in an active cable, in a module coupled to a CXL port, or within a computing platform, and may provide a bridge between the CXL domain and the NVLink domain. The elements may communicate through one or more intermediary components, such as an NVLink switch or other suitable entity that facilitates information transfer.

In some implementations of the method, the first CXL device type flow comprises a CXL Type-2 device flow and the first memory region comprises a Host-managed Device Memory with Device coherency (HDM-D) region, and the second CXL device type flow comprises a CXL Type-3 device flow and the second memory region comprises a Host-managed Device Memory with Host-only coherency (HDM-H) region; and wherein the device participates in cache coherency with the host for the first memory region and does not participate in cache coherency with the host for the second memory region. The CXL Type-2 device flow may enable the device to maintain cached copies of data from the first memory and to participate in coherency negotiations with the host via CXL. cache. The CXL Type-3 device flow for the HDM-H region may enable simpler passthrough access to NVLink-accessible memory without device coherency overhead.

In some implementations, the method further comprises receiving, from the host, a CXL.mem Master-to-Subordinate (M2S) request comprising MemRd* and a first address targeting the second memory region; translating the CXL.mem M2S request to an NVLink read request comprising a SourceID, a DestinationID, a second address, a Tag, and a Length; receiving an NVLink read response comprising *Data*; and sending to the host a CXL.mem Subordinate-to-Master Data Response (S2M DRS) comprising MemData and data from the NVLink read response. The SourceID may identify the device or RPU that originated the NVLink read request, while the DestinationID may identify the target entity, such as a GPU, in the NVLink fabric. The second address may be an NVLink network address that may be utilized to route the NVLink read request to its destination, and may go through additional address translation phases facilitated by one or more Link TLBs in the NVLink domain. The Tag may be a transaction identifier maintained by the device for correlating the NVLink read response with the original CXL.mem M2S request. The Length may indicate the requested transfer size. The *Data* in the NVLink read response may represent data carried in one or more response packets. Different NVLink versions or implementations may use different naming conventions for these functional fields; for example, a source identifier may alternatively be referred to as a requester identifier, a source node identifier, or a similar designation, and a destination identifier may alternatively be referred to as a target identifier, a destination node identifier, or a similar designation.

In some implementations, the method further comprises receiving, from the host, a CXL.mem Master-to-Subordinate (M2S) request comprising MemRd* and an address targeting the first memory region; accessing the first memory to obtain data; and sending to the host a CXL.mem Subordinate-to-Master No Data Response (S2M NDR) comprising Cmp-S or Cmp-E indicating a cache state of a cacheline at the address, and a CXL.mem Subordinate-to-Master Data Response (S2M DRS) comprising MemData and the data. For the first memory region, the device may access local memory, such as HBM and/or HBF, without performing protocol translation to NVLink. The device may respond with Cmp-S or Cmp-E based on the device's caching policy and the host's requested coherency state as indicated by SnpType and MetaValue fields in the M2S request.

In some implementations of the method, for the first memory region, the device communicates with the host via CXL.cache; and wherein the device issues CXL.cache Device-to-Host (D2H) requests to the host comprising an opcode selected from RdOwn, RdShared, RdCurr, or RdAny. The CXL.cache D2H requests may enable the device to initiate coherency transactions with the host for data in the first memory region, such as when the device needs to read or modify data that the host may have cached.

In some implementations, the method further comprises translating, by the device, between a first address associated with a Host Physical Address (HPA) space utilized by the host and a second address associated with an NVLink network address space utilized by the NVLink-based protocol. The address translation may be implemented utilizing lookup tables, page tables, base-and-offset calculations, or programmable translation functions. The NVLink network address may be utilized to route NVLink transactions to specific GPUs or memory resources within the NVLink fabric.

In some implementations of the method, a non-transitory computer-readable medium comprising instructions which, when executed by a processor, cause the processor to perform the method.

In computing systems where a host accesses memory resources on a device coupled via CXL, the device may expose memory regions with different connectivity and coherency models. A first memory region may be backed by local memory coupled to the device, and may be exposed via a CXL device type flow that supports device coherency. A second memory region may be backed by memory accessible via an NVLink port, such as memory residing on GPUs or other NVLink-connected devices, and may be exposed via a different CXL device type flow. The device may include an RPU or translation logic configured to translate between CXL protocol messages and NVLink messages for memory access operations targeting the NVLink-accessible memory. An NVLink switch, such as NVSwitch, may couple the device to one or more GPUs whose memory resources form the second memory region.

In various implementations, a system comprising: a host; a device coupled to the host via a Compute Express Link (CXL) link; and a first memory coupled to the device; wherein the device is configured to expose to the host a first memory region via a first CXL device type flow and a second memory region via a second CXL device type flow, wherein the first CXL device type flow is different from the second CXL device type flow; wherein the first memory region is associated with the first memory; wherein the second memory region is associated with a second memory accessible via an NVLink port of the device; and wherein the device is configured to translate between a protocol based on CXL and an NVLink-based protocol for requests targeting at least one of the first memory region or the second memory region. The system may enable a host to access both local and NVLink-domain memory resources on the device through a CXL link, with differentiated coherency semantics for different memory regions. The device may include an RPU, translation logic, or a combination of hardware and firmware that translate between CXL and the NVLink-based protocol. The device may be an accelerator, an RPU, a bridge device, or a component within an active cable positioned between the CXL domain and the NVLink domain. The device may configure the boundaries between the first and second memory regions dynamically or statically, for example utilizing HDM decoder registers or programmable address range registers. The system may be deployed in datacenter environments where CXL-enabled CPUs participate with NVLink GPUs in inference or training of AI models.

In some implementations of the system, the first CXL device type flow comprises a CXL Type-2 device flow and the first memory region comprises a Host-managed Device Memory with Device coherency (HDM-D) region, and the second CXL device type flow comprises a CXL Type-3 device flow and the second memory region comprises a Host-managed Device Memory with Host-only coherency (HDM-H) region. The CXL Type-2 device flow may enable the device to negotiate CXL.io, CXL.cache, and CXL.mem for the HDM-D region, while the CXL Type-3 device flow may negotiate CXL.io and CXL.mem for the HDM-H region.

In some implementations of the system, for CXL.mem requests targeting the first memory region, the device is configured to send a CXL.mem Subordinate-to-Master No Data Response (S2M NDR) comprising Cmp-S or Cmp-E indicating a cache state; and for CXL.mem requests targeting the second memory region, the device is configured to translate the CXL.mem requests to NVLink read requests and send a CXL.mem Subordinate-to-Master Data Response (S2M DRS) comprising MemData. The differentiated response behavior may reflect the different coherency models of the first and second memory regions. For the first memory region, the Cmp-S or Cmp-E indication may inform the host of the cache state maintained by the device. For the second memory region, the device may translate the request to an NVLink read request, receive data from the NVLink domain, and return the data to the host.

In some implementations of the system, the device comprises an accelerator or a resource provisioning unit (RPU), and the first memory comprises at least one of High Bandwidth Memory (HBM) or High-Bandwidth Flash (HBF) coupled to the device; and further comprising an NVLink switch coupling the NVLink port of the device to one or more GPUs, wherein the second memory is accessible via the NVLink switch. The NVLink switch may be an NVSwitch or similar switch device that provides high-bandwidth routing between the device and GPUs within an NVLink fabric. The one or more GPUs may each have their own HBM, HBF, or other memory that collectively forms the second memory accessible from the device via the NVLink port.

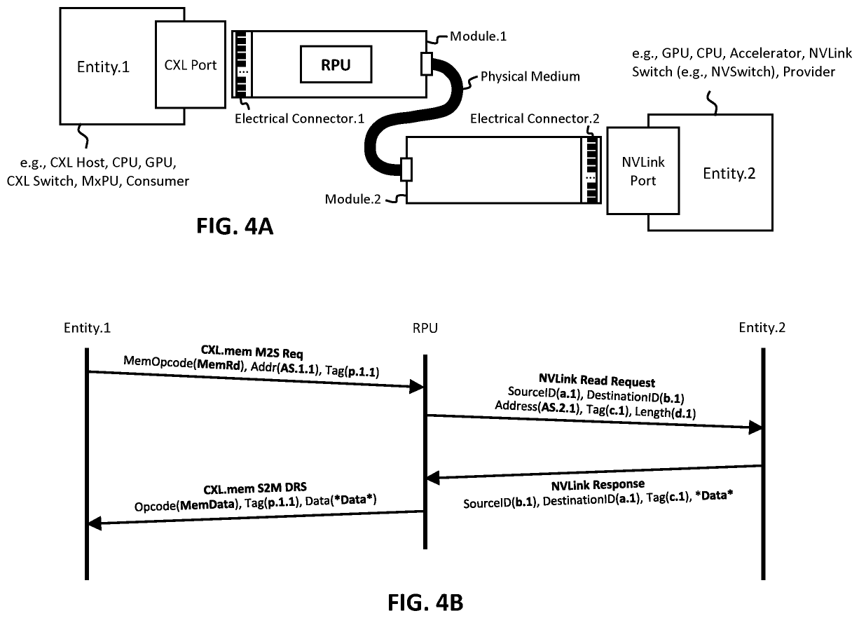

FIG. 4A illustrates an example of a system comprising an active cable that includes an RPU. The cable comprises a first pluggable module (Module.1) and a second pluggable module (Module.2) coupled by a Physical Medium. Module.1 includes the RPU and is coupled via a first electrical connector (Electrical Connector.1) to a CXL Port of a first entity (Entity.1). Module.2 is coupled via a second electrical connector (Electrical Connector.2) to an NVLink Port of a second entity (Entity.2). Entity.1 may be a CXL Host, CPU, GPU, CXL Switch, MxPU, or Consumer. Entity.2 may be a GPU, CPU, Accelerator, NVLink Switch (e.g., NVSwitch), or Provider. The RPU may be placed in various locations as a function of the requirements. In one example, the RPU is placed in Module.1 closer to the CXL Port of Entity.1, since CXL, which runs over PCIe electricals, is designed as a shorter-reach interface utilized for connecting devices to CPUs within a compute platform. Some versions of NVLink incorporate electrical signaling characteristics compatible with Ethernet and/or InfiniBand connectivity, designed for longer-reach interconnects that fit rack-level deployments and beyond. Placing the RPU closer to the CXL port may improve signal integrity. Additionally, NVLink typically utilizes a signaling rate higher than CXL, and consequently NVLink may require fewer lanes than CXL for the same bandwidth, which may allow for reducing the amount of copper wires or optical fibers in the Physical Medium.

FIG. 4B illustrates an example of a TFD demonstrating an RPU that translates between CXL.mem requests and NVLink requests. The TFD shows three entities: Entity.1/Consumer on the left, the RPU in the center, and Entity.2/Provider on the right. Entity.1 may send a CXL.mem M2S Req comprising MemOpcode(MemRd), Addr(AS.1.1), and Tag(p.1.1) to the RPU. Address (AS.1.1) may be an HPA of a Host, such as a CXL-enabled CPU coupled to the RPU. The RPU may translate the CXL.mem M2S Req to an NVLink Request Read comprising SourceID(a.1), DestinationID(b.1), Address(AS.2.1), Tag(c.1), and Length(d.1). Address (AS.2.1) may be an NVLink Network Address utilized to route the NVLink request to its destination on the NVLink fabric. In the response direction, Entity.2 may send an NVLink Response comprising SourceID(b.1), DestinationID(a.1), Tag(c.1), and *Data* to the RPU. The RPU may translate the NVLink Response to a CXL.mem S2M DRS comprising Opcode(MemData), Tag(p.1.1), and Data(*Data*), and may send the CXL.mem S2M DRS to Entity.1. The RPU may map the Tag from the NVLink response back to the original CXL.mem Tag (p.1.1) to enable proper transaction completion at Entity.1. In some examples, the NVLink Network Address may go through additional address translation phases, which may be facilitated by one or more Link TLBs residing on the transaction path. For example, in a GPU, a Link TLB may translate an NVLink Network Address to a GPU Physical Address that may reference memory resources integrated in or adjacent to the destination GPU. The RPU may perform another address translation to translate the HPA utilized by CXL.mem to the NVLink Network Address before the NVLink request is sent. Moreover, NVLink provides a distributed memory model where GPUs may access memory via other GPUs. This example provides a generic CXL.mem bridge/gateway for other, possibly non-NVLink compute elements, such as CPUs, to access memory residing on the NVLink Fabric, for example, where x86 GP-CPUs participate with NVLink GPUs in inference or training of AI models.

In environments where entities may utilize different protocols while requiring coordinated access to shared resources, there may be scenarios where a first entity communicating according to UALink UPLI, such as an accelerator, needs to access memory resources coupled to a second entity communicating according to CXL, such as CXL.mem. An RPU may translate between UPLI and CXL. mem to facilitate memory operations, data transfers, and/or resource sharing across different protocol domains while maintaining the requirements of each protocol. The RPU may translate opcodes, commands, addresses, Tags, and additional fields between UPLI and CXL.mem messages, and may further perform address translations between different address spaces, such as between a Network Physical Address (NPA) space utilized by UALink-based traffic and a Host Physical Address (HPA) space utilized by CXL-based traffic, or between addresses within the same address space, such as a global address space, a partitioned global address space (PGAS), a pod address space, a virtual pod address space, or a fabric address space. The RPU may be implemented as a discrete component, as an IP block embedded in a processor, or as a chiplet within an IC package.

In various implementations, a method for translating from Ultra Accelerator Link (UALink) Protocol Level Interface (UPLI) requests to Compute Express Link (CXL) requests, comprising: communicating with a first entity according to UPLI; communicating with a second entity according to CXL.mem; receiving, from the first entity, a UPLI request comprising a read command and a first physical address; translating the UPLI request to a CXL.mem Master-to-Subordinate request comprising: a MemRd* and a second physical address (CXL.mem M2S Req MemRd*); and sending the CXL.mem M2S Req MemRd* to the second entity. The translation may enable entities communicating according to UPLI to access memory resources coupled to entities communicating according to CXL.mem. The method may be implemented in hardware, firmware, software, or combinations thereof, and may be performed by various types of devices, such as a processor, a switch, a bridge, an RPU, or a semiconductor device. MemRd* may refer to MemRd, MemRdData, MemRdTEE, MemRdDataTEE, or other memory read opcode variants defined or to be defined in CXL.mem. The first physical address may be associated with a first address space, such as an NPA space, and the second physical address may be associated with a second address space, such as an HPA space or an SPA space, wherein the translating may include translating the first physical address to the second physical address. Additionally or alternatively, the first and second physical addresses may be associated with the same address space, such as a global address space, a PGAS, a pod address space, a virtual pod address space, or a fabric address space. The elements may communicate through one or more intermediary components, such as a switch, a retimer, or other suitable entity that facilitates information transfer.

In some implementations of the method, the UPLI request further comprises a ReqSrcPhysAccID field, a ReqDstPhysAccID field, a ReqLen field, a ReqTag field, a ReqAddr field comprising the first physical address, and a ReqCmd field comprising the read command; and further comprising translating the ReqTag to a Tag associated with the CXL.mem M2S Req. The ReqSrcPhysAccID and ReqDstPhysAccID fields may carry identifiers that may be utilized by the RPU for routing the UPLI request to its target, and may be further utilized for constructing response routing information. The ReqLen field may indicate a transfer size of up to 256 Bytes of data. When the ReqLen indicates a transfer size exceeding a CXL. mem cacheline size (e.g., 64 Bytes), the RPU may translate a UPLI request to multiple CXL.mem M2S requests. The Tag translation may involve maintaining a bidirectional mapping between UPLI ReqTag values and CXL.mem Tag values, enabling proper correlation of CXL.mem responses with their corresponding UPLI requests.

In some implementations, the method further comprises receiving, from the second entity, a CXL.mem Subordinate-to-Master Data Response (S2M DRS) comprising MemData, a Tag, and data; translating the CXL.mem S2M DRS to a UPLI read response (RdRsp) comprising a RdRspSrcPhysAccID field, a RdRspDstPhysAccID field, a RdRspTag field, and RdRspData comprising the data; and sending the UPLI RdRsp to the first entity. The RdRspSrcPhysAccID may correspond to the ReqDstPhysAccID from the original UPLI request, and the RdRspDstPhysAccID may correspond to the ReqSrcPhysAccID, reflecting the routing path for the response. The RdRspTag may be retrieved from the bidirectional mapping maintained by the RPU, enabling the first entity to correlate the response with its original request. In some examples, the RPU may accumulate data from one or more CXL.mem S2M DRS messages before sending the data via the UPLI RdRsp, such as when CXL.mem M2S requests were generated from a UPLI request.

In some implementations of the method, the CXL mem S2M DRS further comprises a Poison field, and the UPLI RdRsp further comprises a RdRspDataError field; and further comprising translating the Poison field of the CXL.mem S2M DRS to the RdRspDataError field of the UPLI RdRsp. The Poison field in CXL.mem S2M DRS may indicate that the returned data contains an error. The RdRspDataError field in UPLI may serve as a per-beat data poison indicator. The translation of error indications across protocol boundaries may enable the first entity to detect data corruption that originated in the CXL domain, and to take appropriate recovery actions, such as discarding the corrupted data, retrying the request, or reporting the error to system management software.

In some implementations of the method, the read command comprises a Read Class Vendor Defined Command, the first entity comprises an accelerator or a UALink switch, the second entity comprises a CXL device, and the second physical address is a host physical address (HPA) utilized by the second entity. Read Class VDCs may correspond to ReqCmd encodings and may enable vendor-specific memory access operations that extend beyond the standard UPLI read commands. The CXL device may include a CXL memory expander, a CXL memory pool, a Global Fabric-Attached Memory (G-FAM) Device (GFD), or a CXL accelerator. The HPA may represent an address within the address space utilized by the second entity for servicing memory requests.

In some implementations of the method, the UPLI request indicates an I/O-coherent read, and the CXL.mem M2S Req MemRd* further comprises a SnpType field comprising SnpCur, a MetaField field comprising Meta0-State (MS0), and a MetaValue field comprising Invalid (I). The SnpType(SnpCur), MetaField(MS0), and MetaValue(I) combination in the CXL.mem M2S request may indicate an intent to perform an I/O-coherent read by requesting a non-cacheable but current value of the data. This combination may correspond to the I/O-coherency model utilized by UALink, wherein a read from peer memory returns the most recent coherent copy from memory or a cache within the destination's system node. The RPU may select the SnpType, MetaField, and MetaValue values based on a predefined, predetermined, configurable, rule-based, or dynamic intent mapping between the UPLI I/O-coherent read semantics and CXL.mem coherency fields.

In some implementations, the method further comprises sending to the second entity a CXL.mem M2S request comprising MemSpecRd. The speculative memory read may be initiated by the RPU to facilitate data availability from the second entity before, or without, the first entity explicitly requesting that data. The decision to initiate speculative reads may be based on pattern recognition algorithms analyzing the first entity's memory access behavior, statistical models predicting future access locations, configurable prefetch policies defining aggressiveness and scope of speculation, and/or bandwidth availability assessments determining when speculative operations will not interfere with demand requests. When utilizing the MemSpecRd opcode, some of the CXL.mem M2S Req fields, such as Tag, MetaField, MetaValue, and SnpType, may be reserved. Additionally or alternatively, the RPU may issue reads (e.g., CXL.mem M2S requests comprising MemRd or MemRdData) to prefetch data from the second entity, and may buffer the returned data for satisfying subsequent demand requests from the first entity.

In some implementations of the method, the first physical address is associated with a first address space, the second physical address is associated with a second address space different from the first address space, and the translating further comprises translating the first physical address to the second physical address. The first address space may include an NPA space utilized by the UALink-based traffic, and the second address space may include an HPA space utilized by CXL-based traffic. The first and second address spaces may have different sizes, different base addresses, different memory layouts, or different granularities, and the translation may accommodate these differences while maintaining the meaning of the memory operations.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In computing environments where external entities, such as accelerators, may access memory resources coupled to a processing unit, there may be scenarios where the processing unit provides access to memory resources via different memory paths. For example, a processing unit may include a first memory path from a UALink port to a first memory via a memory controller, and a second memory path from the UALink port to a second memory via a CXL port. The processing unit may include an RPU that translates between a UALink-based protocol, such as UPLI, and the protocols utilized for accessing the first and second memories. The RPU may perform physical address translations, such as from NPAs to HPAs, to enable external entities to access both memory resources via the UALink port.

In various implementations, a system comprising: a processing unit comprising an Ultra Accelerator Link (UALink) port, a memory controller coupled to a first memory, and a Compute Express Link (CXL) port coupled to a second memory; wherein the UALink port is configured to communicate with an entity according to a UALink-based protocol; wherein the processing unit is configured to provide a first memory path from the UALink port to the first memory via the memory controller, and a second memory path from the UALink port to the second memory via the CXL port; and wherein the processing unit further comprises a resource provisioning unit (RPU) configured to receive a first UALink Protocol Level Interface (UPLI) request from the entity and forward a first translated request to the first memory via the first memory path, and to receive a second UPLI request from the entity and forward a second translated request to the second memory via the second memory path. The processing unit may be implemented as a processor, a system-on-chip (SoC), or as chiplets within an IC package. The first memory may include DRAM coupled to the memory controller, and the second memory may include a CXL memory expander, a CXL memory pool, or a CXL device that exposes memory resources. The RPU may perform physical address translations to determine whether a given UPLI request targets the first memory or the second memory, and may route the translated request to the appropriate memory path accordingly. The entity may include an accelerator, a CPU, or a switch that communicates with the processing unit via the UALink port according to UPLI. In some examples, the requested data may be provided by a cache of the processing unit, such as by LLC, instead of by the first or second memory.

In some implementations of the system, the processing unit further comprises a coherent interconnect, and wherein the first memory path and the second memory path traverse a portion of the coherent interconnect. The coherent interconnect may include a mesh network, a ring interconnect, a crossbar, a Network on Chip (NoC), or other types of interconnect fabrics that maintain cache coherency among processing cores and other components of the processing unit. The first memory path may traverse the coherent interconnect from the RPU to the memory controller, and the second memory path may traverse the coherent interconnect from the RPU to the CXL port. In some examples, the RPU may translate between the UALink-based protocol, such as UPLI, and a protocol utilized by the coherent interconnect. The paths from the RPU to the different memories may traverse other components coupled to the coherent interconnect, such as caching/home agent (CHA) slices, snoop filter (SF) slices, or LLC slices, optionally for resolving coherency.

In some implementations of the system, the CXL port comprises a CXL/PCIe root port (RP) coupled to the coherent interconnect. The CXL/PCIe RP may be a separate component on the coherent interconnect, enabling the processing unit to communicate with CXL devices coupled to the second memory. In other examples, the CXL/PCIe RP may be included within the RPU.

In some implementations of the system, the processing unit further comprises processing cores, caching/home agent (CHA), snoop filter (SF), and Last Level Cache (LLC) slices coupled to the coherent interconnect; and further comprising at least one of: a PCIe root port coupled to an I/O device, or an inter-socket link (ISoL) port coupled to a second processing unit. The processing cores, CHA/SF/LLC slices, and additional ports may be coupled to the coherent interconnect, enabling coordinated access to memory resources. The PCIe RP may be coupled to an I/O device, such as a network controller, an Ethernet NIC, an InfiniBand adapter, or a PCIe GPU. The ISoL port may utilize NVIDIA NVLink-C2C, ARM CHI C2C, or ICPIP for inter-socket or inter-chip communication.

In some implementations of the system, the UALink port, the CXL port, and the memory controller are located in a same integrated circuit (IC) package; and wherein the RPU is further configured to translate physical addresses associated with the UALink-based protocol to physical addresses associated with the processing unit, enabling the entity to access the first memory and the second memory. The IC package may be implemented as a monolithic die or as chiplets within a multi-chip module. The physical address translation may include translating Network Physical Addresses (NPAs) carried in UPLI requests to Host Physical Addresses (HPAs) utilized by the processing unit's address space. The translated addresses may be utilized by the processing unit to determine whether a given request targets the first memory or the second memory, and to route the translated request to the appropriate memory path.

In some implementations of the system, the second translated request comprises a CXL.mem Master-to-Subordinate (M2S) request comprising MemRd*, and the CXL port is configured to send the CXL.mem M2S request to the second memory; and wherein the CXL port is further configured to receive a CXL.mem Subordinate-to-Master Data Response (S2M DRS) comprising MemData and data from the second memory, and the RPU is further configured to translate the CXL.mem S2M DRS to a UPLI read response (RdRsp) comprising the data and send the UPLI RdRsp to the entity. The second memory path may utilize CXL.mem for communication between the CXL port and the second memory, wherein the RPU may translate between UPLI and CXL.mem, including translations of addresses, Tags, and opcodes. The second memory may include a CXL memory expander or a CXL device that responds to CXL.mem M2S requests with CXL.mem S2M DRS messages carrying the requested data.

In computing environments where a cluster of accelerators may be coupled via a switch, the accelerators may need to access memory resources that are external to the UALink domain. For example, memory resources such as CXL memory expanders, CXL memory pools, or GFDs may be coupled to the cluster via an RPU that translates between the UALink-based protocol utilized by the accelerators and CXL. mem utilized by the CXL memory devices. In some configurations, the RPU may be coupled to multiple distinct CXL memory devices, and may route translated requests to different CXL memory devices based on the physical addresses carried in the UPLI requests received from the accelerators. The RPU may thus enable accelerators within the cluster to access a pool of CXL memory resources distributed across devices, while the switch provides the communication fabric among the accelerators and between the accelerators and the RPU.

In various implementations, a system comprising: a switch; accelerators coupled to the switch, wherein the accelerators communicate according to a UALink-based protocol; a resource provisioning unit (RPU) coupled to the switch; a first Compute Express Link (CXL) memory device coupled to the RPU; and a second CXL memory device coupled to the RPU; wherein the RPU is configured to receive a first UALink Protocol Level Interface (UPLI) request and a second UPLI request from a first accelerator of the accelerators via the switch, translate the first UPLI request to a first CXL.mem Master-to-Subordinate (M2S) request and send the first CXL.mem M2S request to the first CXL memory device, and translate the second UPLI request to a second CXL.mem M2S request and send the second CXL.mem M2S request to the second CXL memory device. The system may enable accelerators within a UALink cluster to access CXL memory resources that reside outside the UALink domain, without requiring modifications to the accelerators'UALink interfaces or protocols. The RPU may determine which CXL memory device to target for each translated request based on the physical address carried in the UPLI request, for example by comparing the address against address range registers or translation tables that map address ranges to specific CXL memory devices. The first and second CXL memory devices may have different capacities, different performance characteristics, different address ranges, or different device types. The RPU may be implemented as a discrete component coupled to the switch, as an IP block embedded within one of the accelerators, or as a chiplet within an IC package. The RPU may translate between UPLI and CXL.mem including translations of opcodes, addresses, Tags, and additional fields. In some examples, the RPU may be coupled to more than two CXL memory devices, and may distribute translated requests across the CXL memory devices based on address, load balancing policies, or other criteria. The method may be implemented in hardware, firmware, software, or combinations thereof.

In some implementations of the system, at least one of the first CXL memory device or the second CXL memory device comprises a Global Fabric-Attached Memory Device (GFD); and wherein the RPU is further configured to receive a CXL.mem Subordinate-to-Master Data Response (S2M DRS) from the GFD, translate the CXL.mem S2M DRS to a UPLI read response (RdRsp), and send the UPLI RdRsp to the first accelerator via the switch. The GFD may provide large-capacity memory resources accessible via CXL.mem, and may be shared among requesters including accelerators via the RPU and hosts via direct CXL.mem access. The RPU may translate the CXL.mem S2M DRS, including by translating the Tag back to the original UPLI ReqTag and formatting the data as UPLI RdRspData for delivery to the first accelerator.

In some implementations, the system further comprises a host coupled to at least one of the first CXL memory device or the second CXL memory device via CXL.mem; wherein both the first accelerator, via the RPU, and the host access the at least one of the first CXL memory device or the second CXL memory device. The shared access configuration may enable both accelerators and hosts to access the same CXL memory resources, potentially for data sharing, producer-consumer communication, or tiered memory management. The host may access the CXL memory device via CXL.mem without translation, while the accelerators access the same CXL memory device via the RPU that translates between UPLI and CXL.mem.

In some implementations, the system further comprises a CXL fabric coupling the RPU to the first CXL memory device and the second CXL memory device; wherein at least one of the first CXL memory device or the second CXL memory device comprises at least one of: a CXL memory expander, a CXL memory pool, or a Global Fabric-Attached Memory Device (GFD). The CXL fabric may include one or more CXL switches, and may provide connectivity between the RPU and CXL memory devices. The CXL fabric may enable the RPU to reach CXL memory devices that are not directly coupled to the RPU.

In some implementations of the system, the first UPLI request comprises a first physical address associated with a first address space, and the second UPLI request comprises a second physical address associated with the first address space; wherein the first CXL.mem M2S request comprises a third physical address associated with a second address space, and the second CXL.mem M2S request comprises a fourth physical address associated with the second address space; and wherein the RPU translates the first physical address to the third physical address and the second physical address to the fourth physical address; and wherein the first address space comprises a Network Physical Address (NPA) space or a System Physical Address (SPA) space, and the second address space comprises a Host Physical Address (HPA) space. The address translation may be implemented utilizing lookup tables, page tables, base-and-offset calculations, range-based mapping, and/or programmable translation functions. The RPU may determine which CXL memory device to target based on the translated address, for example by comparing the third or fourth physical address against address ranges assigned to the first and second CXL memory devices. In some examples, the first and second address spaces may be the same address space, such as a global address space or a fabric address space, and the RPU may perform routing without address translation.

In some implementations of the system, the switch comprises a UALink switch comprising a route table, and the UALink switch routes the first UPLI request and the second UPLI request from the first accelerator to the RPU based on a Destination Accelerator ID carried in the first UPLI request and the second UPLI request; and wherein the accelerators communicate with the UALink switch via UPLI request channels and UPLI response channels. The UALink switch may route UPLI traffic based on the ReqDstPhysAccID field in each UPLI request, utilizing the route table to map the Destination Accelerator ID to an egress port coupled to the RPU. The RPU may thus appear to the accelerators as a UALink endpoint identified by an Accelerator ID, enabling the accelerators to send UPLI requests to the RPU using standard UALink routing mechanisms. The route table may be programmed by a Pod Controller or other management entity. The UPLI request channels may carry read, write, atomic, and vendor defined commands, and the UPLI response channels may carry corresponding read responses and write responses.

In environments where entities communicating according to UPLI need to write data to memory resources coupled to entities communicating according to CXL.mem, an RPU or other translating device may translate between UPLI write requests and CXL.mem write requests. The write path involves translating from UPLI request and Originator Data channels to CXL.mem M2S RwD messages, and translating the CXL.mem S2M NDR completion back to a UPLI write response (WrRsp). The RPU may translate opcodes, commands, addresses, Tags, byte enables, and completion status between the two protocol domains. In some examples, the RPU may split a UPLI write request carrying a transfer size exceeding a CXL.mem cacheline size into multiple CXL.mem M2S RwD requests, and may aggregate the corresponding completions before returning the UPLI WrRsp to the originating entity.

In various implementations, a method for translating from Ultra Accelerator Link (UALink) Protocol Level Interface (UPLI) write requests to Compute Express Link (CXL) write requests, comprising: communicating with a first entity according to UPLI; communicating with a second entity according to CXL.mem; receiving, from the first entity, a UPLI request comprising a write command, a first physical address, and write data; translating the UPLI request to a CXL. mem Master-to-Subordinate Request with Data (M2S RwD) comprising a MemWr* and a second physical address; sending the CXL.mem M2S RwD and the write data to the second entity; receiving, from the second entity, a CXL.mem Subordinate-to-Master No Data Response (S2M NDR) comprising Cmp*; translating the CXL.mem S2M NDR to a UPLI write response (WrRsp); and sending the UPLI WrRsp to the first entity. The write translation may enable entities communicating according to UPLI to store data in memory resources coupled to entities communicating according to CXL.mem. The method may be implemented in hardware, firmware, software, or combinations thereof, and may be performed by various types of devices, such as a processor, a switch, a bridge, an RPU, or a semiconductor device. The first physical address may be associated with a first address space, such as an NPA space, and the second physical address may be associated with a second address space, such as an HPA space, wherein the translating may include translating the first physical address to the second physical address. Additionally or alternatively, the first and second physical addresses may be associated with the same address space, such as a global address space, a PGAS, a pod address space, a virtual pod address space, or a fabric address space. The UPLI write command may include a Write, a WriteFull, or a Write Class Vendor Defined Command as defined by the UPLI specification.

In some implementations of the method, the UPLI request further comprises a ReqSrcPhysAccID field, a ReqDstPhysAccID field, a ReqTag field, and a ReqAddr field comprising the first physical address; wherein the write data is received on a UPLI Originator Data (OrigData) channel comprising OrigDataByteEn; and further comprising translating the ReqTag to a Tag associated with the CXL.mem M2S RwD. The ReqSrcPhysAccID and ReqDstPhysAccID fields may carry identifiers utilized for routing the UPLI request and for constructing response routing information. The OrigDataByteEn field may carry per-byte enable bits indicating which bytes of the write data are valid. The Tag translation may involve maintaining a bidirectional mapping between UPLI ReqTag values and CXL.mem Tag values, enabling proper correlation of CXL.mem S2M NDR completions with their corresponding UPLI write requests.

In some implementations of the method, the MemWr* comprises MemWrPtl, and the write data comprises a partial cacheline update; and wherein byte enables associated with a UPLI Originator Data channel are utilized to indicate which bytes of the cacheline are to be written by the second entity. The MemWrPtl opcode may indicate a partial write where only a subset of bytes within a CXL.mem cacheline are updated. The byte enables from the UPLI OrigDataByteEn field may be propagated to the CXL.mem domain, enabling the second entity to update only the specified bytes while preserving the remaining bytes of the cacheline.

In some implementations of the method, the UPLI WrRsp further comprises a WrRspTag field and a WrRspStatus field, and the CXL.mem S2M NDR further comprises a Cmp* completion opcode; and further comprising translating a Tag of the CXL.mem S2M NDR to the WrRspTag of the UPLI WrRsp, and translating a completion status of the CXL.mem S2M NDR to the WrRspStatus of the UPLI WrRsp. The WrRspTag may be retrieved from the bidirectional mapping maintained by the RPU, enabling the first entity to correlate the write response with its original write request. The WrRspStatus may indicate success or failure of the write operation. The translation of completion status across protocol boundaries may enable the first entity to detect write failures that originated in the CXL domain and to take appropriate recovery actions.

In some implementations of the method, the first entity comprises an accelerator, the second entity comprises a CXL device comprising at least one of: a CXL memory expander, a CXL memory pool, or a Global Fabric-Attached Memory Device (GFD); the first physical address is associated with a Network Physical Address (NPA) space; and the second physical address is associated with a Host Physical Address (HPA) space; and wherein the translating further comprises translating the first physical address to the second physical address. The address translation from NPA to HPA may be implemented utilizing lookup tables, page tables, base-and-offset calculations, range-based mapping, and/or programmable translation functions. The GFD may provide large-capacity memory resources accessible via CXL.mem and shared among requesters.

In some implementations of the method, the UPLI request further comprises a ReqLen field indicating a transfer size exceeding a CXL.mem cacheline size; and wherein the translating further comprises generating CXL.mem M2S RwD requests from the UPLI request, each of the CXL.mem M2S RwD requests comprising a respective MemWr* and a respective portion of the write data. UPLI write requests may carry a ReqLen indicating a transfer size of up to 256 bytes, while CXL.mem M2S RwD messages may carry up to 64 bytes of data per request. When the ReqLen exceeds the CXL.mem cacheline size, the RPU may split the UPLI write request into CXL.mem M2S RwD requests, each carrying a respective portion of the write data with a respective translated address. The RPU may aggregate the corresponding CXL.mem S2M NDR completions before returning a UPLI WrRsp to the first entity.

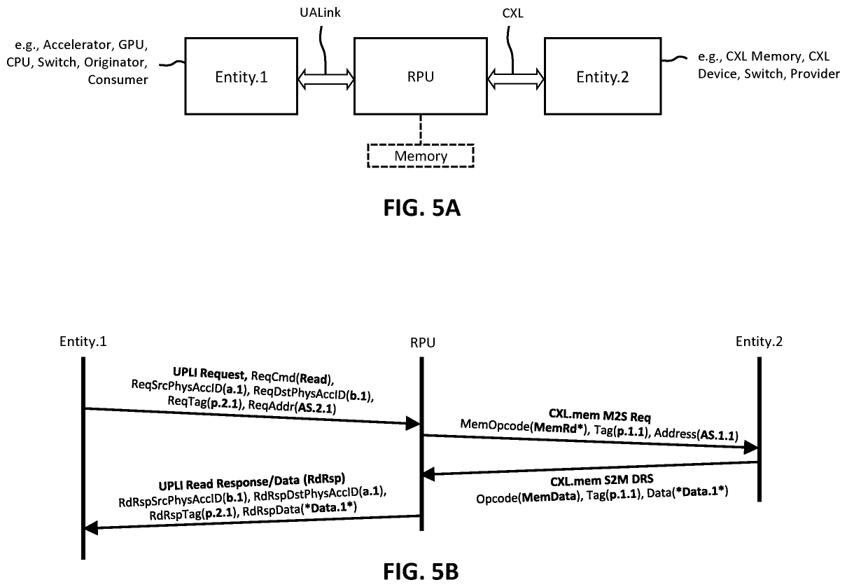

FIG. 5A illustrates an example of a system comprising an RPU, which may be coupled to memory, wherein the RPU may enable external entities to access resources coupled to the RPU. The RPU may translate between a UALink-based protocol (such as UPLI) and a CXL-based protocol (such as CXL.mem). Additionally or alternatively, the RPU may translate between UPLI and CXL.io, and/or between UPLI and CXL.cache. In some examples, the RPU may be implemented as a discrete component, such as on a PCB, coupled to other components such as CPUs, GPUs, accelerators, switches, or CXL devices. In other examples, the RPU may be embedded in another silicon design, such as an IP within a processor, or may be implemented as a chiplet within an IC package. The RPU is coupled to a first entity (Entity.1), which may be an accelerator, a GPU, a CPU, a switch, an originator, or a consumer, wherein the RPU may communicate with the first entity according to a UALink-based protocol, such as UPLI. The RPU is further coupled to a second entity (Entity.2), which may be a CXL memory, a CXL device, a switch, or a provider, wherein the RPU may communicate with the second entity according to a CXL-based protocol, such as at least one of CXL.mem, CXL.io, or CXL.cache. In some examples, the UALink-based traffic, such as UPLI traffic, may be associated with a first address space, such as an NPA space, and the CXL-based traffic, such as CXL.mem traffic, may be associated with a second address space, such as a System Physical Address (SPA) space or a Host Physical Address (HPA) space; wherein the RPU may perform address translations between addresses within the first and second address spaces, respectively, such as between addresses within the NPA space and addresses within the SPA space or the HPA space. In other examples, the UALink-based traffic and the CXL-based traffic may be associated with the same physical address space, such as with a global address space, a partitioned global address space (PGAS), a pod address space, a virtual pod address space, or a fabric address space; wherein the RPU may perform address translations between addresses within the same address spaces. The RPU may perform further translations, such as opcode, command, or TLP translations, e.g., translating between commands in requests conforming to the UALink-based protocol (e.g. UPLI vendor-defined read command) to opcodes in requests conforming to the CXL-based protocol (e.g., CXL.mem MemRd). The RPU may further translate between messages conforming to the UALink-based protocol and messages conforming to the CXL-based protocol, Tag translations, traffic class (TC) translations, and/or cross-field translations such as between CXL.mem Tag and UPLI ReqTag, and/or between UPLI RdRspTag and CXL.mem Tag. Additionally, the RPU may maintain tracking between Tags in the UPLI domain and Tags in the CXL domain, such as in order to associate responses with their corresponding requests. The RPU may further translate error indications, such as poison.

FIG. 5B illustrates an example of a TFD demonstrating translations performed by an RPU, between UALink-based traffic, such as UPLI traffic, utilized for communicating with a first entity (Entity.1), such as an accelerator, a GPU, a CPU, a switch, an originator, or a consumer, and CXL-based traffic, such as CXL.mem traffic, utilized for communicating with a second entity (Entity.2), such as a CXL device, a CXL memory, or a CXL switch. Additionally or alternatively, the RPU may translate between UPLI and CXL.io requests, and/or between UPLI and CXL.cache requests. The first entity may initiate a UPLI transaction that may include a UPLI request (Req) comprising Request Command (e.g., ReqCmd(Read)), Request Source Physical Accelerator ID (e.g., ReqSrcPhysAccID(a.1)), Request Destination Physical Accelerator ID (e.g., ReqDstPhysAccID(b.1)), Request Tag (e.g., ReqTag(p.2.1)), and Request Address (e.g., ReqAddr(AS.2.1)). The RPU may translate the UPLI transaction to a CXL.mem transaction that may include a CXL.mem M2S request comprising MemOpcode(MemRd*), Tag(p.1.1), and Address(AS.1.1), and may send the CXL.mem M2S request to the second entity. The asterisks in the translated CXL.mem M2S request MemRd indicate that this could represent any suitable superset combination of read opcodes, commands, or operations, supported by CXL.mem, such as MemRd, MemRdData, MemRdTEE, MemRdDataTEE, etc. The RPU may further translate between other fields of the UPLI transaction and fields of the CXL.mem transaction, such as between address fields, Tag fields, QoS-related fields, or identification (ID) fields that may serve to route the UPLI request to its target.

Upon receiving a response from the second entity, that may include a CXL.mem S2M DRS comprising Opcode(MemData), Tag(p.1.1), and Data(*Data.1*), the RPU may translate the CXL.mem S2M DRS to a UPLI read response/data (RdRsp) comprising Read Response Source Physical Accelerator ID (e.g., RdRspSrcPhysAccID(b.1)), Read Response Destination Physical Accelerator ID (e.g., RdRspDstPhysAccID(a.1)), Read Response Transaction Tag (e.g., RdRspTag(p.2.1)), and Read Response Data (e.g., RdRspData(*Data.1*)). Optionally, the RPU may act as an endpoint, or may act as a completer device, and may terminate the UPLI transactions. The RPU may issue the CXL.mem transactions, optionally acting as an independent protocol initiator, such as a CXL host, and may utilize translated fields from the UPLI transaction for constructing the CXL.mem transaction. The RPU may perform further translations, such as opcode or command translations, e.g., translating between vendor-defined read commands in UPLI requests and MemRd in CXL.mem requests. The RPU may further translate between messages conforming to UPLI and messages conforming to CXL.mem, translate Tags, and/or translate error indications, such as poison.

In some examples, the RPU may translate a UPLI transaction to multiple CXL.mem transactions, such as when the UPLI request may include a request length field, such as ReqLen, that may carry values representing a read of up to 256 Bytes of data, wherein the RPU may translate such UPLI requests to CXL.mem M2S requests, such that each may carry up to 64 Bytes of data that may represent a cacheline. The RPU may further translate between CXL.mem responses, such as CXL.mem S2M NDR and/or CXL.mem S2M DRS, and UPLI responses, such as UPLI read response, and may forward read data carried in CXL.mem DRS messages into the UPLI read response. In some examples, the RPU may accumulate data from one or more CXL.mem DRS messages before sending the data via the UPLI read response.

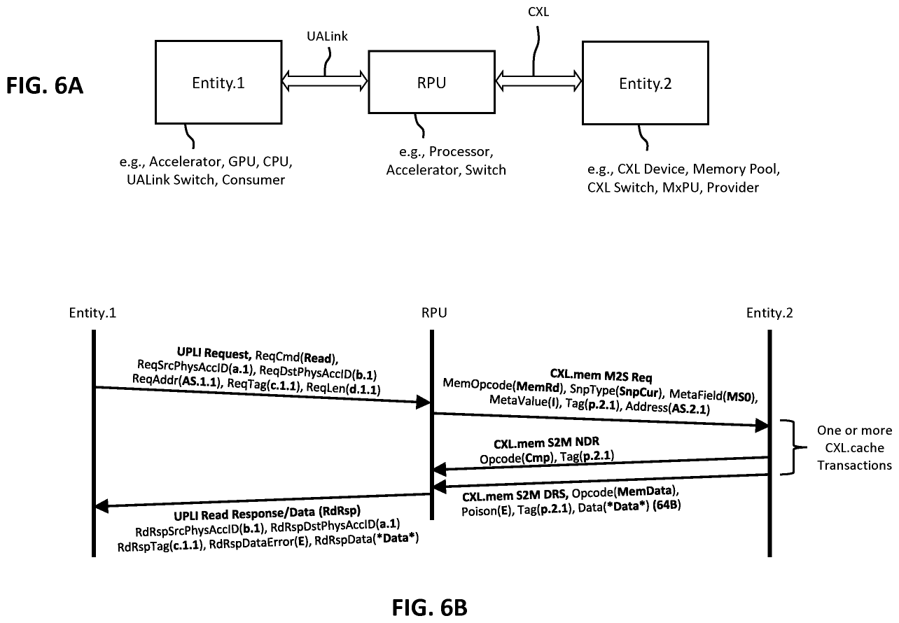

FIG. 6A illustrates an example of a system comprising an RPU (such as a processor, an accelerator, or a switch) that enables external entities to access resources coupled to the RPU, such as CXL devices or CXL memory. The RPU is coupled to a first entity (Entity.1), which may be an accelerator, a GPU, a CPU, a UALink switch, or a consumer, wherein the RPU may communicate with the first entity according to a UALink-based protocol, such as a UPLI. The RPU is further coupled to a second entity (Entity.2), which may be a CXL device, CXL memory, CXL-based memory pool, a CXL switch, an MxPU, or a provider, wherein the RPU may communicate with the second entity according to a CXL-based protocol, such as CXL.mem. In some examples, the UALink-based protocol, such as UPLI, may be associated with a first address space, such as an NPA space, and the CXL-based protocol, such as CXL.mem, may be associated with a second address space, such as an HPA space; wherein the RPU may perform address translations between addresses within the first and second address spaces, respectively, such as between addresses within the NPA space and addresses within the HPA space. In other examples, the UALink-based protocol, such as UPLI, and the CXL-based protocol, such as CXL.mem, may be associated with the same physical address space, such as a global address space; wherein the RPU may perform address translations between addresses within the same address spaces. The RPU may perform further translations, such as opcode or command translations, e.g., translating between Read commands in UPLI requests and MemRd in CXL.mem requests. The RPU may further translate between messages conforming to UPLI and messages conforming to CXL.mem, translate Tags, and/or translate error indications, such as poison.

FIG. 6B illustrates an example of a TFD demonstrating an RPU that may translate between UALink-based traffic, such as UPLI traffic, and CXL-based traffic, such as CXL.mem traffic. Additionally or alternatively, the RPU may translate between UPLI and CXL.io, and/or between UPLI and CXL.cache. The RPU may provide intent-based translation between protocols, such as between UPLI and CXL.mem, identifying the intent of a received transaction, and generating a translated transaction that may convey a corresponding intent, or convey an intent based on a predefined, predetermined, configurable, rule-based, or dynamic mapping between intentions. The RPU may receive from a first entity (Entity.1), such as an accelerator, a UALink UPLI transaction that may include a UPLI request comprising Request Command (e.g., ReqCmd(Read)), Request Source Physical Accelerator ID (e.g., ReqSrcPhysAccID(a.1)), Request Destination Physical Accelerator ID (e.g., ReqDstPhysAccID(b.1)), Request Address (e.g., ReqAddr(AS.1.1)), Request Tag (e.g., ReqTag(c.1.1)), and Request Length (e.g., ReqLen(d.1.1)). The received UPLI transaction may indicate an intent to perform an I/O-coherent read, e.g., a request for the most recent copy of the data, corresponding to an I/O-coherency model that may be typical for UALink.

The RPU may translate the UPLI transaction to a CXL.mem transaction, that may include a CXL.mem M2S request comprising Memory Operation (e.g., MemOpcode(MemRd)), Snoop Type (e.g., SnpType(SnpCur)), Metadata Field (e.g., MetaField(MS0)), Metadata Value (e.g., MetaValue(I)), Tag(p.2.1), and Address(AS.2.1). This translation from UPLI to CXL.mem may indicate an intent to perform an I/O-coherent read, via a CXL.mem request for a non-cacheable but current value of the data, wherein the data may be represented as 64 B cachelines that correspond to the Request Length (e.g., ReqLen(d.1.1)) in the UPLI request. The RPU may further translate between other values of the UPLI transaction and the CXL.mem transaction, such as between addresses, Tags, QoS-related values, or identifications (IDs) that may serve to route the UPLI request to its destination.

In some examples, the RPU may translate a UPLI transaction to multiple CXL.mem transaction, such as when the UPLI request comprises a request length field (e.g., ReqLen), which may carry values indicating a read of more than 64 Bytes of data, wherein the RPU may translate such UPLI requests to CXL.mem M2S requests, such that each may carry up to 64 Bytes of data, possibly representing a 64 Byte cacheline. The RPU may further translate between CXL.mem responses, such as CXL.mem S2M NDR and/or CXL.mem S2M DRS, and UPLI responses, such as UPLI read responses, and may forward read data carried in CXL.mem DRS messages via UPLI read responses.

In some examples, the RPU may receive a response from the second entity (Entity.2), which may include a CXL.mem S2M NDR comprising Opcode(Cmp) and Tag(p.2.1), and may further include a CXL.mem S2M DRS comprising Opcode(MemData), Poison(E), Tag(p.2.1), and Data(*Data*). The RPU may translate the CXL.mem S2M DRS to a UPLI read response/data (RdRsp) comprising Read Response Source Physical Accelerator ID (e.g., RdRspSrcPhysAccID(b.1)), Read Response Destination Physical Accelerator ID (e.g., RdRspDstPhysAccID(a.1)), Read Response Transaction Tag (e.g., RdRspTag(c.1.1)), Read Response Data Error (e.g., RdRspDataError(E)), and Read Response Data (e.g., RdRspData(*Data*)). This translation demonstrates that the RPU may propagate error responses from the CXL domain to the UPLI domain, such as by translating error indications carried in CXL.mem S2M DRS messages, such as poison, to error indications carried in UPLI RdRsp messages, such as Read Response Data Error (e.g. RdRspDataError). Additionally, the RPU may accumulate data from one or more CXL.mem DRS messages before sending the data via the UPLI read response.

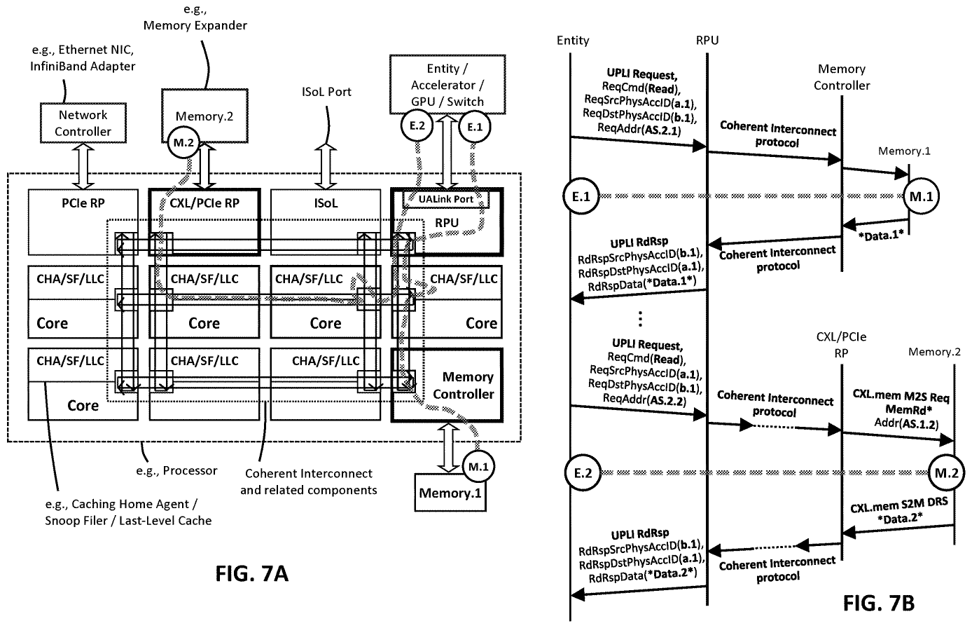

FIG. 7A illustrates an example of a system comprising a processor, including a coherent interconnect, capable of enabling an external entity, such as a GPU or an accelerator, to access memory resources mapped to an address space utilized by the coherent interconnect, such as via one or more of the two illustrated paths denoted as (E.1)-(M.1) and (E.2)-(M.2). The processor may include processing cores, caching/home agent (CHA), snoop filter (SF), and LLC, optionally implemented as distributed slices coupled to the coherent interconnect. The processor may further include a PCIe RP that may be coupled to a Network Controller, such as an Ethernet NIC or an InfiniBand Adapter, a CXL/PCIe RP, a memory controller that may be coupled to a first memory (Memory.1), such as DRAM, and an ISoL port, such as a port utilizing NVIDIA NVLink-C2C, ARM CHI C2C, or Intel Coherent Processor Interconnect Protocol (ICPIP), such as Intel UPI. The processor may be coupled to a second memory (Memory.2), such as a CXL memory expander, and may further include an RPU that includes or is coupled to a UALink port that may communicate with the entity according to a UALink-based protocol, such as UPLI, wherein the RPU may perform physical address translations to enable the entity to access the first memory, such as over the path (E.1)-(M.1), and/or access the second memory, such as over the path (E.2)-(M.2). The illustrated RPU may be coupled to the coherent interconnect, and may translate between the UALink-based protocol and a protocol utilized by the coherent interconnect. The processor may be implemented as an IP block embedded into a silicon design, such as a switch or an accelerator. In other examples, the processor may be implemented as a monolithic die, as chiplets within an IC package, or as components on a board, and may utilize a mesh-based coherent interconnect, may utilize a ring, a crossbar, a Network on Chip (NoC) or other types of coherent interconnects.

FIG. 7B illustrates an example of a TFD demonstrating two UPLI requests, such as UPLI read requests, received from an entity, such as a GPU or an accelerator, processed by an RPU and forwarded, possibly using a protocol utilized by a coherent interconnect, to different memories mapped to an address space utilized by the coherent interconnect. The paths from the RPU to the different memories may traverse other components, such as CHA/SF/LLC slices, memory controllers, or in other examples traverse a home agent or a home node, optionally for resolving coherency. The RPU may perform physical address translations, such as from Network Physical Addresses (NPAs) to Host Physical Addresses (HPAs), to enable the entity to access the processor's memories. The processor may have multiple memory resources, such as first memory (Memory.1), which may be a DRAM coupled to a memory controller of the processor, and/or second memory (Memory.2), which may be a CXL memory expander coupled to a CXL/PCIe RP of the processor. The RPU may further perform additional translations, such as protocol translations from a UALink-based protocol, such as UPLI, to a protocol utilized by the coherent interconnect, and may send the optionally translated request to the coherent interconnect, requesting a read from memory. In some examples, the requested data may be provided by a processor cache, such as by an LLC, instead of by the memory. The data may then return over the coherent interconnect to the RPU, wherein the RPU provides UPLI read response/data (RdRsp) to the requesting entity.

The TFD illustrates two exemplary transactions between the entity and the RPU, corresponding to two distinct memory read paths denoted as (E.1)-(M.1) and (E.2)-(M.2), each associated with a different physical address mapped to different memory resources. The first exemplary transaction includes a first UPLI request (Req) comprising physical address (AS.2.1), which may be an NPA, which the RPU translates and forwards via the coherent interconnect protocol and via the memory controller to the first memory (Memory.1), resulting in the retrieval of *Data.1*, that is sent to the entity via the coherent interconnect protocol and via the RPU with the first UPLI RdRsp. The second exemplary transaction includes a second UPLI request comprising physical address (AS.2.2), which may be an NPA, which the RPU may translate to physical address (AS.1.2) and forward to the second memory (Memory.2), via the coherent interconnect protocol and via the CXL/PCIe RP, utilizing a CXL.mem M2S request. *Data.2* is retrieved from the second memory utilizing a CXL.mem S2M DRS, and sent to the RPU via the coherent interconnect protocol. The RPU may then send *Data.2* to the entity via the second UPLI RdRsp. It is noted that the physical addresses (AS.2.1) and (AS.2.2) may refer to different memory regions within an NPA address space exposed via the UALink port, enabling the entity to access memory resources based on the RPU's translation capabilities.

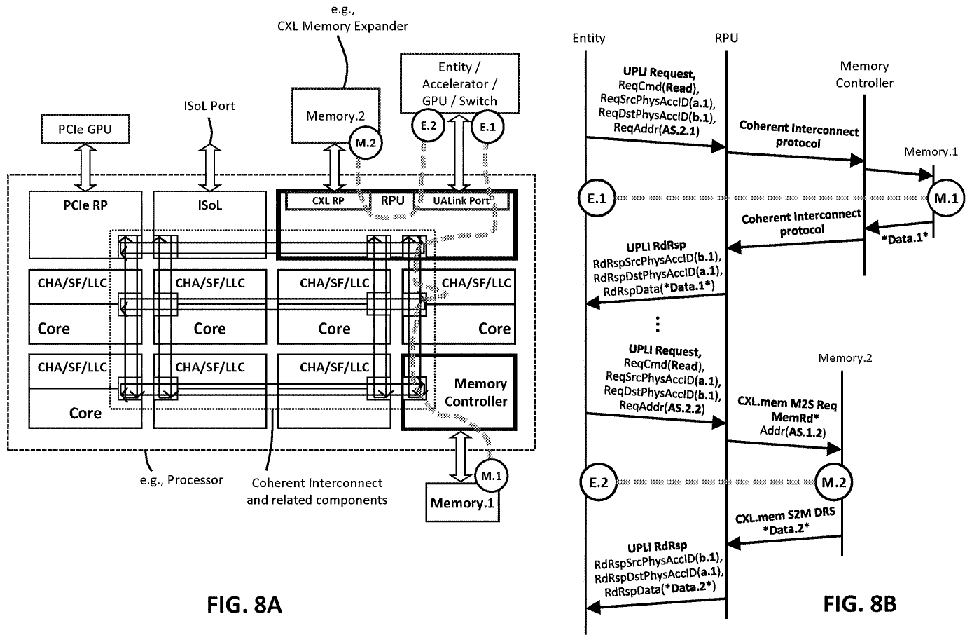

FIG. 8A illustrates an example of a system comprising a processor, including a coherent interconnect, capable of enabling an external entity, such as a GPU or an accelerator, to access memory resources mapped to an address space utilized by the coherent interconnect, such as via one or more of the two illustrated paths denoted as (E.1)-(M.1) and (E.2)-(M.2). The processor may include processing cores, caching/home agent (CHA), snoop filter (SF), and LLC, optionally implemented as distributed slices coupled to the coherent interconnect. The processor may further include a PCIe RP that may be coupled to a PCIe GPU, a memory controller that may be coupled to a first memory (Memory.1), such as DRAM, and an ISoL port, such as a port utilizing NVIDIA NVLink-C2C, ARM CHI C2C, or Intel Coherent Processor Interconnect Protocol (ICPIP), such as Intel UPI. The processor may include an RPU that includes or is coupled to a UALink port that may communicate with the entity according to a UALink-based protocol, such as UPLI, wherein the RPU further includes a CXL RP coupled to a second memory (Memory.2), such as a CXL memory expander. The RPU may perform physical address translations to enable the entity to access the first memory, such as over the path (E.1)-(M.1), and/or access the second memory, such as over the path (E.2)-(M.2). The illustrated RPU may be coupled to the coherent interconnect, and may translate between the UALink-based protocol and a protocol utilized by the coherent interconnect. The processor may utilize a mesh-based coherent interconnect, or in other examples may utilize a ring, a crossbar, a Network on Chip (NoC) or other types of coherent interconnects.

FIG. 8B illustrates an example of a TFD demonstrating two UPLI requests, such as UPLI read requests, received from an entity, such as a GPU or an accelerator, processed by an RPU and forwarded, possibly using a protocol utilized by a coherent interconnect of a processor, to different memories mapped to an address space utilized by the coherent interconnect. The paths from the RPU to the different memories may traverse other components, such as CHA/SF/LLC slices, memory controllers, or in other examples traverse a home agent or a home node, optionally for resolving coherency. The RPU may perform physical address translations, such as from Network Physical Addresses (NPAs) to Host Physical Addresses (HPAs), or from NPAs to System Physical Addresses (SPAs), to enable the entity to access memory resources of the processor. The processor may have multiple memory resources, such as first memory (Memory.1), which may be a DRAM coupled to a memory controller of the processor, and/or second memory (Memory.2), which may be a CXL memory expander coupled to a CXL RP of the processor, wherein the CXL RP may be included in the RPU. The RPU may further perform additional translations, such as protocol translations, between a UALink-based protocol, such as UPLI, and a protocol utilized by the coherent interconnect, wherein the RPU may send the optionally translated UPLI requests to the coherent interconnect, requesting reads from memory, such as from the first memory or from the second memory. The RPU may further translate between UALink-based traffic, such as UPLI traffic, and CXL-based traffic, such as at least one of CXL.mem, CXL.io, or CXL.cache traffic, wherein the RPU may send the optionally translated UPLI traffic to the second memory via the CXL RP. In some examples, the requested data may be provided by a cache of the processor, such as by an LLC, instead of by the memory. The data may then return over the coherent interconnect to the RPU, wherein the RPU provides UPLI read response/data (RdRsp) to the requesting entity.

The TFD illustrates two exemplary transactions between the entity and the RPU, corresponding to two distinct memory read paths denoted as (E.1)-(M.1) and (E.2)-(M.2), each associated with a different physical address mapped to different memory resources. The first exemplary transaction corresponds to the memory read path denoted as (E.1)-(M.1), and may include a first UPLI request (Req) comprising physical address (AS.2.1), which may be an NPA, which the RPU may translate and forward via the coherent interconnect protocol and via the memory controller to the first memory, resulting in the retrieval of *Data.1*, that is sent to the entity via the coherent interconnect protocol and via the RPU with the first UPLI RdRsp. The second exemplary transaction corresponds to the memory read path denoted as (E.2)-(M.2), and may include a second UPLI request comprising physical address (AS.2.2), which may be an NPA. The RPU may translate the second UPLI request to a CXL.mem M2S request comprising MemRd* and Address(AS.1.2), wherein the RPU may send the translated request to the second memory via the CXL RP. *Data.2* is retrieved from the second memory utilizing a CXL.mem S2M DRS, and sent to the RPU via the CXL RP, wherein the RPU may send *Data.2* to the entity utilizing the second UPLI RdRsp.

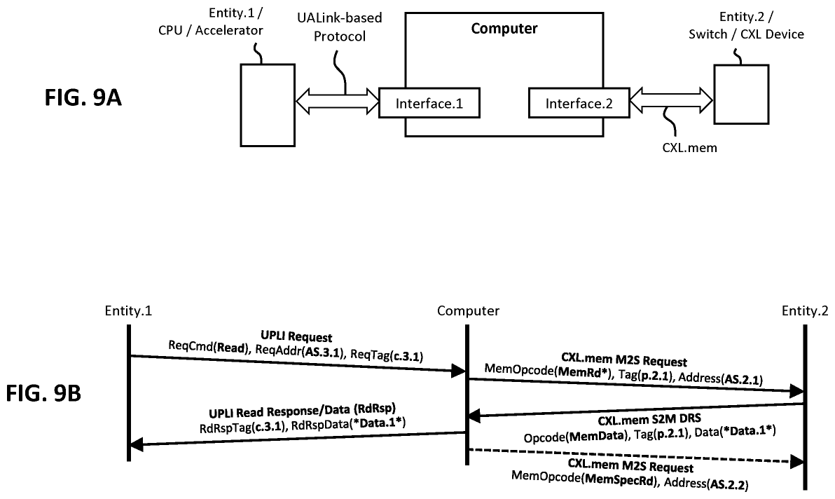

FIG. 9A illustrates an example of a system comprising a computer, that may be included in a switch or in a bridge, comprising a first interface (Interface.1) and a second interface (Interface.2). The first interface may communicate according to a UALink-based protocol, such as UPLI, with a first entity (Entity.1), which may be a CPU or an accelerator. The second interface may communicate according to CXL.mem, with a second entity (Entity.2), such as a switch, or a CXL device which may be a CXL memory expander, a CXL memory pool, a GFD, or a CXL accelerator. The computer may extract addresses from requests received via the first interface, wherein these addresses may refer to a first address space, such as a Network Physical Address (NPA) space utilized by the first entity. The computer may further translate these addresses, and generate requests carrying the translated addresses for transmission via the second interface; wherein these translated addresses may refer to a second address space utilized by the second entity. In other examples, the first address space and the second address space may be associated with the same address space, such as a common address space, a global address space, a pod address space, or a fabric address space, wherein the computer may perform address translations between addresses within the same common address space. The computer may be implemented in an IC package having high-speed differential I/O balls positioned according to a ball grid array layout defined by a retimer specification.

FIG. 9B illustrates an example of a TFD demonstrating translations, such as address translations, performed by a computer, between: (1) first physical addresses, such as Network Physical Addresses (NPAs), carried in UALink-based requests, such as UPLI requests, received from a first entity (Entity.1), which may be a CPU or an accelerator; and (2) second physical addresses, such as Host Physical Addresses (HPAs), carried in CXL requests, such as CXL.mem requests, sent to a second entity (Entity.2), which may be a switch or a CXL device, possibly enabling the first entity to access resources mapped to an address space utilized by the second entity. The first entity may initiate a UPLI transaction that may include a UPLI request comprising ReqCmd(Read), ReqAddr(AS.3.1), and ReqTag(c.3.1). The computer may translate the UPLI transaction to a CXL transaction that may include a CXL.mem M2S request comprising MemOpcode(MemRd*), Tag(p.2.1), and Address(AS.2.1), and may send the CXL.mem M2S request to the second entity. Upon receiving one or more responses from the second entity, which may include a CXL.mem S2M DRS comprising Opcode(MemData), Tag(p.2.1), and Data(*Data.1*), the computer may translate the one or more responses, such as translating the CXL.mem S2M DRS to a UPLI read response/data (RdRsp) comprising RdRspTag(c.3.1) and RdRspData(*Data.1*), and send the UPLI RdRsp to the first entity.

The computer may further initiate speculative memory reads targeting the second entity, wherein the speculative memory reads may include a CXL.mem M2S request comprising MemOpcode(MemSpecRd) and Address(AS.2.2), and wherein the computer may utilize the speculative memory reads, optionally on behalf of the first entity, to facilitate data prefetches and potentially reduce read latency from the second entity. When utilizing the MemSpecRd opcode, some of the CXL.mem M2S Req fields, such as Tag, MetaField, MetaValue, and SnpType, may be reserved. The computer may perform further translations, such as protocol translations, opcode translations, command translations, TLP type translations, and translations between the UALink-based domain and the CXL domain. In some examples, the computer may issue multiple CXL.mem reads in response to receiving a UPLI request from the first entity. For example, the computer may issue CXL.mem M2S requests comprising MemRd or MemRdData, such as when splitting a UPLI request for a large block of data (e.g., 256 B) to smaller CXL.mem reads (e.g., 64 B each), or when prefetching data from the second entity utilizing CXL.mem reads. The computer may translate requests or transactions initiated from the UALink-based domain to the CXL domain, may translate requests or transactions initiated from the CXL domain to the UALink-based domain, or may translate requests or transactions initiated from both domains.

In various implementations, an apparatus comprising: memory channels capable of communicating with memory located outside the apparatus; processing cores, coupled via a coherent interconnect, configured to utilize physical addresses within a first physical address space to access the memory via the memory channels, and to respond to snoop requests that include physical addresses within the first physical address space; memory management units (MMUs) configured to translate virtual addresses to physical addresses within the first physical address space in response to memory access requests from the processing cores; a port capable of receiving, from a host located outside the apparatus, messages comprising Compute Express Link (CXL) requests and physical addresses within a second physical address space; and a resource provisioning unit (RPU) configured to translate physical addresses within the second physical address space to physical addresses within the first physical address space to enable the host to access resources accessible utilizing the first physical address space. It is noted that the MMUs may translate virtual addresses not only for memory access but also for memory-mapped I/O operations, device register access, configuration space access, interrupt controller registers, performance monitoring unit registers, system management registers, PCIe configuration spaces, accelerator control registers, network interface card (NIC) registers, storage controller registers, and/or other system resources that are mapped into the physical address space. In data center environments, MMUs may additionally handle address translation for accessing shared resources such as remote direct memory access (RDMA) regions, GPU memory spaces, persistent memory (PMEM) regions, storage class memory (SCM), and virtualized device interfaces. The first physical address space may therefore encompass, in addition to the memory accessible through the memory channels, also these various memory-mapped resources, allowing the processing cores and other components within the apparatus to access both memory and I/O resources utilizing a unified addressing scheme.

In the context of this implementation, “resources” encompasses a broad range of system components and capabilities that may be accessed via a physical address space. Resources may include memory resources and/or memory-mapped devices. Memory resources may include DRAM, SRAM, non-volatile memory, or storage class memory (SCM) accessible through memory channels. Memory-mapped devices may include processors, accelerators, input/output devices, and other components that are accessible utilizing memory-mapped I/O operations. Examples of memory-mapped devices include GPUs, NICs, Host Bus Adapters (HBAs), NVMe SSDs, cryptographic accelerators, compression/decompression engines, machine learning accelerators, and other specialized processing units. The RPU may translate physical addresses to enable external hosts to access at least some of these resources utilizing the unified addressing scheme provided by the first physical address space, thereby allowing integration of diverse system components.

In some implementations of the apparatus, the apparatus is a semiconductor device, at least one of the resources comprises dynamic random-access memory (DRAM) having a capacity of at least 8GB, and the memory channels are Double Data Rate (DDR) channels. Memory channels in semiconductor devices provide high-bandwidth communication pathways between the processing cores and external memory components. The memory channels may support various memory interface standards, such as DDR5, and may include memory controllers, physical interfaces, and associated circuitry for managing data transfers and memory operations. Memory channels may operate in parallel to increase memory bandwidth and capacity. Optionally, the size of the memory may be at least 32 GB, 64 GB, 128 GB, 256 GB, 0.5 TB, or 1 TB.

In some implementations of the apparatus, at least one of the resources comprises at least a portion of the memory located outside the apparatus, and the apparatus is capable of exposing to the host the at least one of the resources as a CXL-attached memory. The apparatus may function as a memory pooling device that aggregates memory resources for access by external hosts. The CXL-attached memory may appear to the host as local memory accessible utilizing standard memory operations, while the actual memory may be physically located outside the apparatus and coupled via the memory channels. The apparatus may implement memory abstraction layers that hide the physical location and characteristics of the memory from the host, providing a unified memory interface. The RPU may handle the applicable address translations and protocol conversions to enable access to the external memory as if it were attached to the host. The apparatus may support various memory topologies, including directly attached memory modules, memory coupled through memory buffers or expanders, and hierarchical memory configurations with tiers of memory devices.

In some implementations of the apparatus, the apparatus is further configured to: expose the CXL-attached memory to hosts, implement memory interleaving across the memory channels, and provide memory capacity expansion beyond a native memory limit of an average host out of the hosts. An average host, in the context of this implementation, may be a host whose native memory capacity falls between that of the most capable and the least capable of the hosts. Providing memory capacity expansion beyond the native memory limit of such an average host may enable the apparatus to supplement memory for a broad range of hosts. The CXL-attached memory may be, or function as, a CXL Type-3 device.

In some implementations of the apparatus, at least one of the resources comprises a memory mapped device selected from at least one of: a Graphics Processing Unit (GPU), a Network Interface Card (NIC), a Host Bus Adapter (HBA), or a Non-Volatile Memory Express Solid-State Drive (NVMe SSD). The memory mapped devices accessible as resources may be coupled to the apparatus through various interconnect technologies such as PCIe, UCIe, CXL, or proprietary interconnects. When a GPU is accessed as a memory mapped device, the RPU may translate addresses to enable the host to access GPU memory regions, control registers, and computation resources. For NICs, the accessible resources may include packet buffers, descriptor rings, and control registers for network configuration. HBAs may expose storage command queues, data buffers, and status registers utilizing memory-mapped regions. NVMe SSDs may provide access to submission and completion queues, controller registers, and data buffers through the memory-mapped interface. The RPU may implement device-specific translation logic to properly map host accesses to the appropriate regions of the memory mapped devices while maintaining proper ordering and coherency requirements for the different device types.

In some implementations of the apparatus, at least one of the resources comprises at least a portion of the memory located outside the apparatus, the apparatus further comprises a CXL device coupled to the port, the CXL device configured to communicate with the host according to CXL.mem and to expose a Host-managed Device Memory (HDM) region to the host. The HDM region exposed to the host may be configured utilizing CXL HDM decoder registers that specify the size, base address, and attributes of the memory region. The apparatus may support HDM decoders to expose memory regions with different characteristics or to different hosts. CXL.mem enables the host to perform memory reads and writes to the HDM region using standard load/store semantics, while the apparatus handles the protocol conversion and address translation to access the actual memory resources. The HDM region may be backed by various types of memory including volatile DRAM, persistent memory, or a combination thereof, and the apparatus may implement appropriate memory controller logic to manage the different memory types transparently to the host.

In some implementations of the apparatus, the port is configured to expose resources associated with a CXL device that communicates according to CXL.io, and to support CXL non-transparent bridging (NTB). CXL non-transparent bridging may enable the apparatus to isolate the host's address space from the internal address space while still allowing controlled access to resources. The NTB functionality may include address translation windows that map specific regions of the host's address space to corresponding regions in the apparatus's internal address space. The apparatus may implement doorbell registers, message registers, and scratchpad registers to facilitate communication between the host and the apparatus across the non-transparent bridge. The RPU may work in conjunction with the NTB logic to perform the applicable address translations while maintaining proper isolation and security between different address domains. CXL.io may be used for configuration, messaging, and data transfers across the non-transparent bridge.

In some implementations of the apparatus, the port is configured to expose resources associated with a CXL device that communicates according to CXL.cache, and to support exchanging messages comprising at least one of: (i) opcodes indicative of requested cacheline states that can be selected from at least two states comprising: modified, exclusive, shared, or invalid cacheline states; or (ii) snoop requests associated with cachelines. When supporting CXL.cache, the apparatus may participate in cache coherency protocols with the host to maintain data consistency across caching agents. The opcodes for requested cacheline states may follow the MESI (Modified, Exclusive, Shared, Invalid) protocol or extensions thereof such as MOESI or MESIF. The apparatus may process various CXL.cache opcodes including RdCurr for reading current data, RdOwn for obtaining exclusive ownership, RdShared for shared access, and RdAny for flexible memory reads. Snoop requests may be initiated by the host to query the apparatus about cached data, and the apparatus may respond with appropriate snoop responses indicating the presence and state of requested cachelines. The RPU may maintain coherency state information for cachelines accessed utilizing address translation to maintain proper coherency protocol operation across address space boundaries.

In some implementations of the apparatus, the apparatus further comprises a CXL device coupled to the port, and the apparatus is further configured to implement at least one of: (i) Device-to-Host (D2H) cache coherency flows; or (ii) back-invalidation snoop flows for maintaining coherency. D2H cache coherency flows may enable the apparatus to maintain cache coherency when acting as a caching agent for data owned by the host. The apparatus may send D2H requests to obtain cachelines from host memory, update cacheline states, or writeback modified data. Back-invalidation snoop flows allow the host to invalidate cachelines held by the apparatus when the host needs exclusive access or when cachelines are being evicted from host caches. The apparatus may implement snoop filters or directories to track which cachelines are held by various agents and optimize snoop traffic. The coherency mechanisms may support various coherency models including home agent-based coherency, or broadcast-based coherency wherein coherency messages are sent to the participating agents.

In some implementations, the apparatus further comprises a root port, wherein the RPU enables the host to communicate with a device coupled to the root port via the coherent interconnect. The root port may be a PCIe root port or a CXL root port.

In some implementations of the apparatus, the port is selected from: a CXL upstream switch port, a CXL downstream switch port, or a CXL fabric port. When the port is configured as a CXL upstream switch port, the apparatus may aggregate downstream CXL connections and present them as an upstream connection to the host. As a CXL downstream switch port, the apparatus may distribute CXL traffic from an upstream port to downstream devices while maintaining proper routing and coherency. When configured as a CXL fabric port, the apparatus may participate in a larger CXL fabric topology that enables flexible connectivity between hosts and devices. The switch port functionality may include virtual hierarchy support, multicast capabilities, and Quality-of-Service mechanisms for prioritizing different types of CXL traffic. The RPU may adapt its address translation behavior based on the port configuration to properly handle the different traffic patterns and routing requirements of different port types.

In some implementations of the apparatus, the processing cores comprise level 1 (L1) caches, and wherein the processing cores are configured to maintain cache coherency between the L1 caches utilizing the snoop requests. The apparatus may include various cache architectures to improve memory access performance. Optionally, a centralized last-level cache may be shared by the processing cores, wherein the centralized last-level cache may filter snoop requests before forwarding them to the processing cores, reducing snoop traffic and improving system efficiency. In other examples, the apparatus may implement distributed cache banks associated with subsets of the processing cores, wherein the distributed cache banks may coordinate cacheline ownership utilizing a cache coherency protocol, providing scalable cache capacity and bandwidth across the processing cores.

In some implementations of the apparatus, the coherent interconnect is an on-chip coherent interconnect designed to couple the memory channels, the processing cores, the MMUs, and the RPU, which are disposed in an integrated circuit package. The on-chip coherent interconnect may be implemented as a mesh, ring, crossbar, or hierarchical topology that provides high-bandwidth, low-latency communication between the various components within the IC package. The interconnect may support virtual channels for different traffic classes, implement flow control to prevent congestion, and provide ordering guarantees for memory and I/O operations. The integration of the memory channels, processing cores, MMUs, and RPU on the same interconnect enables efficient data sharing and reduces the latency of address translation operations. The interconnect may support various coherency protocols such as MESI, MOESI, or proprietary protocols, and may include coherency controllers or directories to manage cacheline states across the different components. The IC package may utilize advanced packaging technologies such as 2.5D or 3D integration to achieve high interconnect density and bandwidth.

In some implementations of the apparatus, the processing cores are configured to execute instructions compatible with an x86 instruction set architecture, at least one of the MMUs is designed to support first-level address translation, and further comprising a secondary translation unit for second-level address translation (SLAT) for hardware-assisted virtualization. In one example, the SLAT is selected from Intel's Extended Page Tables (EPT) or AMD's Rapid Virtualization Indexing (RVI) technologies.

In some implementations, the apparatus further comprises at least three levels of in-package cache memory, having a minimum capacity of 4 MB, coupled to the coherent interconnect; and wherein the port comprises at least 4 lanes available for communication with one or more hosts. The three levels of in-package cache memory may be organized as L1, L2, and L3 caches with increasing capacity and latency at each level. The L1 cache may be split into separate instruction and data caches for each processing core, the L2 cache may be private to each core or shared among small groups of cores, and the L3 cache may be shared among the processing cores as a last-level cache. The minimum 4 MB capacity may be distributed across the cache levels, with typical configurations allocating the majority to the L3 cache. The port supporting at least 4 lanes may operate at various CXL link speeds such as 32 GT/s or 64 GT/s per lane, providing aggregate bandwidth suitable for memory-intensive workloads. The lanes may support lane reversal, polarity inversion, and degraded operation with fewer lanes in case of lane failures.

In some implementations of the apparatus, the processing cores are configured to execute instructions compatible with a RISC-based instruction set architecture, at least one of the MMUs is designed to support first-level address translation, and further comprising at least two levels of in-package cache memory coupled to the coherent interconnect, wherein a last level of the in-package cache memory has a capacity of at least 4 MB. The RISC-based instruction set architecture may provide a simplified and regular instruction encoding that facilitates efficient pipeline implementation in the processing cores. The two levels of in-package cache memory may include private L1 caches for the processing cores and a shared L2 or last-level cache that serves the cores. The 4 MB minimum capacity for the last-level cache may be implemented using high-density SRAM arrays with support for way-partitioning, cache allocation policies, and Quality-of-Service features. The cache hierarchy may support various replacement policies such as LRU, pseudo-LRU, or random replacement, and may perform prefetching to hide memory latency. The first-level address translation in the MMUs may support multiple page sizes, translation lookaside buffers (TLBs) with separate entries for different page sizes, and hardware page table walkers for handling TLB misses.

In some implementations of the apparatus, the RISC-based instruction set architecture is selected from a group comprising ARM-class instruction set architecture or RISC-V class instruction set architecture; wherein the port comprises at least 4 lanes available for communication; and further comprising a stage-two translation unit configured to translate guest physical addresses to physical addresses within the first physical address space. The stage-two translation unit may enable nested virtualization by providing an additional level of address translation from guest physical addresses used by virtual machines to host physical addresses used by the hypervisor or host operating system. For ARM architecture, the stage-two translation may be implemented according to the ARMv8 virtualization extensions, supporting features such as intermediate physical addresses (IPAs) and two-stage page table walks. For RISC-V architectures, the stage-two translation may follow the RISC-V hypervisor extension specification. The translation unit may support different page sizes at different translation stages, implement separate TLBs for stage-one and stage-two translations, and provide mechanisms for invalidating translations at either stage. The minimum 4 lanes for communication may support various link widths and speeds depending on the specific implementation and power constraints.

In some implementations of the apparatus, the processing cores comprise at least 50 streaming multiprocessors (SM) configured to execute instructions compatible with NVIDIA's Compute Unified Device Architecture (CUDA) parallel computing platform; wherein the memory channels support at least one of Graphics Double Data Rate (GDDR) memory or High Bandwidth Memory (HBM); and further comprising at least two levels of in-package cache memory coupled to the coherent interconnect, wherein a last level of the in-package cache memory has a capacity of at least 500 KB. Streaming multiprocessors (SMs) may serve as the parallel execution units within GPU-class processing cores, each comprising multiple CUDA cores capable of executing parallel thread blocks simultaneously. GDDR memory channels may provide high-bandwidth, high-throughput access suitable for data-parallel compute workloads, while HBM channels may offer greater bandwidth with lower power consumption in a stacked die configuration. The in-package cache hierarchy may include L1 caches associated with individual SMs and a shared last-level cache, and the RPU may handle address translations for CXL requests targeting memory regions that are also accessible by CUDA kernels executing on the SMs.

In various examples of the apparatus, which may be a semiconductor device, several optional configurations may extend the functionality and adaptability of the system. Optionally, the port or additional ports in the apparatus may support CXL type-3 devices or CXL type-2 devices, providing different levels of functionality and capabilities within the CXL fabric. The apparatus may also include at least one processing core supporting Simultaneous Multithreading (SMT), such as Intel's Hyper-Threading Technology (HTT or HT), enabling threads to run on a core, which may increase parallel processing capabilities and overall performance. Furthermore, the apparatus may be designed to run at least a PC-desktop-grade operating system, such as Windows 11 OS, Redhat Linux, or openSUSE Linux, and/or may be certified by Microsoft to run a desktop version of Windows, which may provide compatibility with software applications and user environments. To support these capabilities, the apparatus may utilize a PC-grade or a server-grade BIOS/UEFI to boot, providing system initialization and configuration. Additionally, the apparatus may incorporate various hardware features and interfaces to enhance functionality and connectivity. These may include an internal Trusted Platform Module (TPM) for cryptographic operations and key storage, or an interface to connect to an external TPM. The apparatus may also feature a CCCI, such as UPI, XGMI, or CHI, to couple caches on at least two devices, which may enable data sharing between processing cores or other components. To facilitate system management and/or monitoring capabilities within a networked/fabric environment, the apparatus may include a connection to a Baseboard Management Controller (BMC), such as an Aspeed 2500/2600 chip, which may allow for remote management and control of the system. Furthermore, the apparatus may incorporate an Ethernet port for network connectivity and/or a SATA port coupled to storage devices, which may expand the system's I/O capabilities and enable integration with various network and storage infrastructures.

In some implementations of the apparatus, at least a subset of the messages further comprises a process identification field, such that for first and second processes running on the host the RPU is further configured to perform different address translations based on the process identification field. The process identification field may be implemented using Process Address Space ID (PASID) as defined in the PCIe specification, or similar process identification schemes. Processes running on the host may be assigned unique identifiers that are included in memory access requests sent to the apparatus. The RPU may maintain separate translation contexts for different process identifiers, enabling fine-grained isolation between different processes accessing the apparatus. This capability may support use cases such as shared virtual memory wherein processes on the host can access device memory with their own virtual address mappings, or multi-tenant scenarios wherein different applications or users require isolated access to device resources. The RPU may implement translation caches indexed by both physical address and process identifier to accelerate repeated accesses from the same process.

In some implementations, the apparatus further comprises a Trusted Platform Module (TPM) and a TPM interface, wherein the RPU is configured to utilize cryptographic keys stored in the TPM to authenticate the CXL requests from the host before performing the translation of physical addresses. The TPM interface may connect to either an integrated TPM module within the apparatus or an external discrete TPM chip. The cryptographic keys stored in the TPM may be used to implement various security mechanisms, including authentication of CXL requests, encryption of data in transit, and attestation of the apparatus'configuration. The RPU may verify digital signatures or message authentication codes included with CXL requests before allowing address translation and resource access. The authentication may support different security levels, from basic password-based authentication to complex cryptographic protocols involving challenge-response and certificate chains. The TPM may also store measurement logs and platform configuration registers that enable remote attestation of the apparatus'security state.

In some implementations of the apparatus, the CXL requests correspond to a first protocol, and the RPU is further configured to translate the CXL requests to second CXL requests that correspond to a second protocol. Translations between different CXL protocols may enable the apparatus to bridge between hosts and devices that support different subsets of the CXL specification. For example, the RPU may translate CXL.mem requests from the host to CXL.cache requests for accessing cache-coherent memory regions, or translate CXL.io requests to CXL.mem requests for memory-mapped I/O operations. The translation may include converting between different transaction types, adjusting transaction attributes, and managing protocol-specific state machines. The RPU may implement translation tables that map opcodes, addresses, and attributes between the different protocols while maintaining proper ordering and intent. The translations may enable heterogeneous CXL topologies wherein devices with different protocol support can interoperate.

In some implementations of the apparatus, the port utilizes an IEEE 802.3 physical medium attachment (PMA). Utilizing an IEEE 802.3 PMA for the port may enable the apparatus to leverage standard Ethernet physical layer components and infrastructure for CXL communication. The IEEE 802.3 PMA may support various data rates such as 25 G, 50 G, 100 G, or higher, possibly providing additional flexibility in bandwidth and/or requirements. The physical layer may include features such as forward error correction (FEC), auto-negotiation, and link training that improve reliability and interoperability. The use of Ethernet physical layer technology may enable longer reach connections compared to traditional PCIe or CXL physical layers, supporting rack-scale or even row-scale disaggregated architectures. The apparatus may implement appropriate protocol adaptation layers to map CXL transactions onto the Ethernet physical layer while maintaining the latency and reliability requirements of memory access operations.

In some implementations of the apparatus, the CXL requests are encapsulated in Ethernet frames. Encapsulating CXL requests in Ethernet frames may enable transporting CXL protocol over standard Ethernet networks, facilitating disaggregated and composable infrastructure deployments. The encapsulation may follow standardized formats such as CXL-over-Ethernet (CXLoE) or proprietary encapsulation schemes suitable for CXL while adding Ethernet headers for routing. The Ethernet frames may include additional fields for quality-of-service marking, virtual LAN Tags, and timestamp information for latency measurement. The apparatus may implement de-encapsulation logic to extract CXL requests from received Ethernet frames and encapsulation logic to package CXL responses into Ethernet frames for transmission. The encapsulation logic may support features such as fragmentation and reassembly for large CXL transactions, flow control to prevent congestion, and error detection and recovery to maintain reliability over the Ethernet network.

In some implementations of the apparatus, the port comprises at least one of: an Ethernet for Scale-Up Networking (ESUN) port, a Scale Up Ethernet (SUE) port, or an Ultra Ethernet Transport (UET) port, and wherein the Ethernet frames comprise at least one Frame Check Sequence (FCS) field utilized to detect communication errors.

In various implementations, a method comprising: communicating, via memory channels of an apparatus, with memory located outside the apparatus; utilizing, by processing cores coupled via a coherent interconnect, physical addresses within a first physical address space to access the memory via the memory channels, and to respond to snoop requests that include physical addresses within the first physical address space; translating, by memory management units (MMUs), virtual addresses to physical addresses within the first physical address space in response to memory access requests from the processing cores; receiving, via a port of the apparatus, messages from a host located outside the apparatus, wherein the messages comprise Compute Express Link (CXL) requests and physical addresses within a second physical address space; and translating, by a resource provisioning unit (RPU), physical addresses within the second physical address space to physical addresses within the first physical address space to enable the host to access resources accessible utilizing the first physical address space. The method may be performed by a semiconductor device such as a processor that integrates a CXL interface alongside its native coherent interconnect. Maintaining two physical address spaces may allow the apparatus to serve both its internal processing cores and external CXL hosts without requiring either to adopt the other's addressing scheme: the MMUs handle virtual-to-physical address translations for the processing cores, while the RPU performs physical-to-physical address translation for CXL requests arriving at the port. This separation may enable the apparatus to expose its internal memory and memory-mapped resources to external hosts via CXL without modifying the internal coherent fabric addressing or requiring the processing cores to be aware of the host's address space.

In some implementations of the method, at least one of the resources comprises at least a portion of the memory located outside the apparatus, and further comprising exposing to the host the at least one of the resources as a CXL-attached memory. Exposing the external memory as CXL-attached memory may enable the host to access the memory utilizing standard CXL memory semantics, without requiring the host to manage the underlying memory channel interface. The RPU may perform the applicable address translations to map host accesses to the appropriate physical addresses within the first physical address space utilized by the memory channels.

In some implementations, the method further comprises exposing the CXL-attached memory to hosts, implementing memory interleaving across the memory channels, and providing memory capacity expansion beyond a native memory limit of an average host out of the hosts. An average host, in the context of this implementation, may be a host whose native memory capacity falls between that of the most capable and the least capable of the hosts. Memory interleaving across the memory channels may distribute host accesses across multiple memory devices to increase aggregate bandwidth. The CXL-attached memory may be, or function as, a CXL Type-3 device.

In some implementations of the method, at least one of the resources comprises at least a portion of the memory located outside the apparatus, and further comprising exposing resources associated with a CXL device that communicates according to CXL.mem via the port, and exposing a Host-managed Device Memory (HDM) region to the host. The HDM region exposed via CXL.mem may be configured utilizing HDM decoder registers that specify its base address, size, and attributes. The method may further comprise responding to M2S requests from the host with S2M DRS and optionally S2M NDR messages, wherein the RPU translates the physical addresses carried in the M2S requests before forwarding them to the memory channels.

In some implementations, the method further comprises exposing resources associated with a CXL device that communicates according to CXL.cache via the port, and supporting exchanging of messages comprising at least one of: (i) opcodes indicative of requested cacheline states that can be selected from at least two states comprising: modified, exclusive, shared, or invalid cacheline states; or (ii) snoop requests associated with cachelines. Supporting CXL.cache may enable the apparatus to act as a caching agent, allowing the processing cores to cache data while maintaining coherency with the host. Cacheline state opcodes following MESI or extended protocols such as MOESI may be exchanged, and snoop requests may allow the host to query the apparatus about cachelines held by the processing cores.

In some implementations, the method further comprises exposing resources associated with a CXL device via the port, and implementing at least one of: (i) Device-to-Host (D2H) cache coherency flows; or (ii) back-invalidation snoop flows for maintaining coherency. D2H cache coherency flows may be initiated by the apparatus when it seeks to acquire or update cachelines owned by the host. Back-invalidation snoop flows may allow the host to invalidate cachelines retained by the apparatus when the host requires exclusive access, enabling the apparatus to participate as a caching agent within the host's coherency domain.

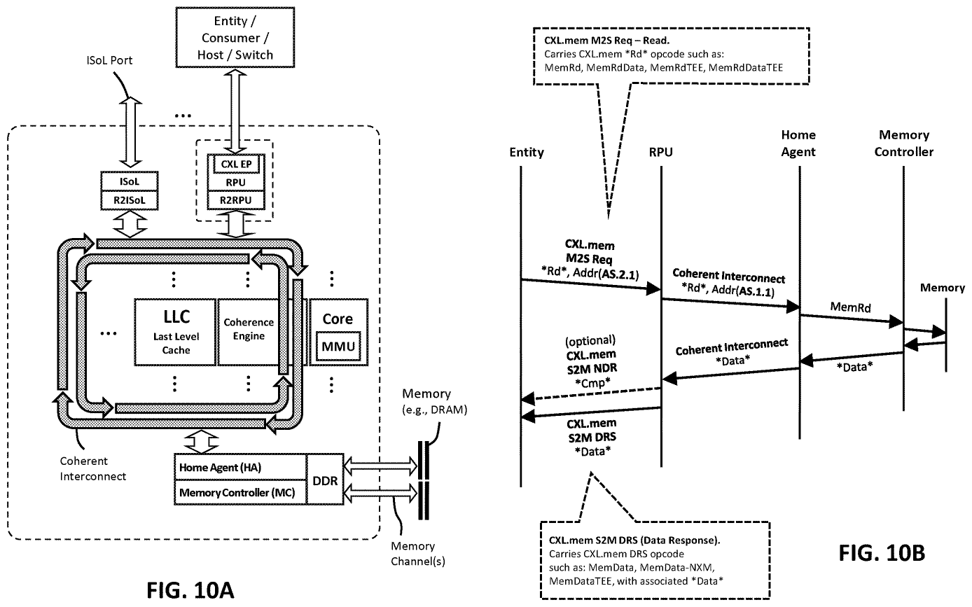

FIG. 10A illustrates an example of a system comprising a processor including a coherent interconnect, enabling an external entity to access memory resources mapped to the address space utilized by the coherent interconnect. Optionally, the processor is an MxPU derived from an established processor design that may include processing cores, a coherent interconnect (such as a ring-based or a mesh-based coherent interconnect), and LLC. The MxPU may further include an ISoL port such as ARM CHI C2C, or Intel UPI, and a memory controller optionally coupled via memory channels to memory, such as DRAM. The MxPU may include a CXL device, such as a Type-3 CXL device or a Type-2 CXL device, that may expose a CXL EP, and may communicate with an entity such as a host according to a protocol based on CXL, such as CXL.mem, wherein an RPU may perform physical address translations to enable the entity to access the memory. The illustrated RPU may be coupled to the coherent interconnect via a Ring-to-RPU (R2RPU) logic. Alternatively, the RPU may be coupled to the coherent interconnect essentially directly. Similarly, the illustrated ISoL port is coupled to the coherent interconnect via a Ring-to-ISoL (R2ISoL) logic. The MxPU may be implemented as a monolithic die, as chiplets within an IC package, such as by utilizing separate compute die(s) and I/O die(s), or as components on a board, and may utilize a ring-based coherent interconnect, or in other examples may utilize a mesh, crossbar, or other types of interconnects.

FIG. 10B illustrates an example of a transaction flow diagram (TFD) demonstrating a CXL.mem read request (M2S request *Rd*) received from an entity, such as a host or a switch, wherein an RPU may translate a physical address (AS.2.1), carried in the M2S request and belonging to a second physical address space, to a physical address (AS.1.1) belonging to a first physical address space utilized by the coherent interconnect. The RPU may perform further translations, such as protocol translations from CXL.mem to a protocol utilized by the coherent interconnect, and may further send the optionally translated request to a home agent (also known as home node), and/or to a memory controller, to request a read at physical address (AS.1.1). In some examples, the requested data may be provided by a processor cache, such as by an LLC, instead of by the memory. The data may then return over the coherent interconnect to the RPU, wherein the RPU provides CXL.mem Data Response (DRS) and optionally CXL.mem No Data Response (NDR) to the requesting entity.

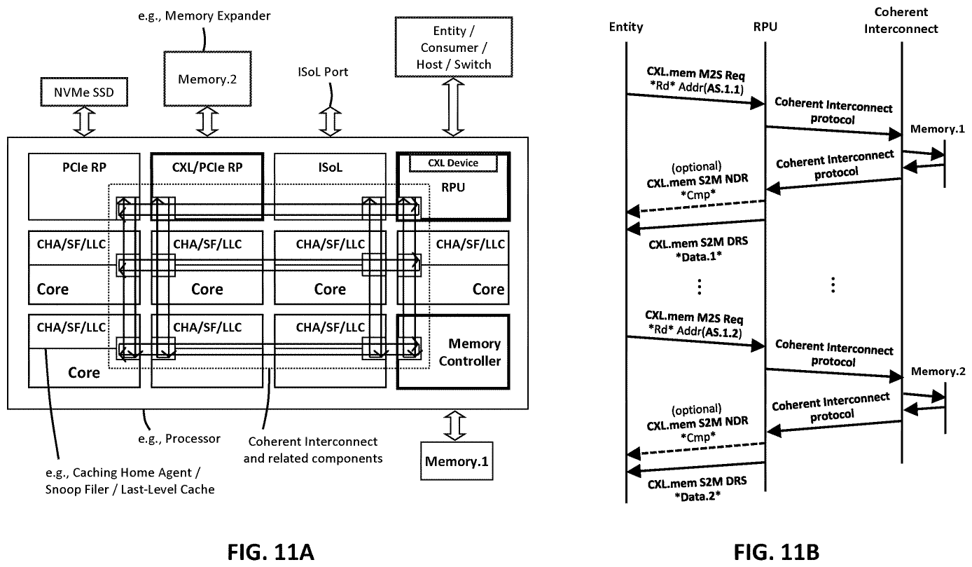

FIG. 11A illustrates an example of a system comprising a processor including a coherent interconnect, capable of enabling an external entity to access memory resources mapped to an address space utilized by the coherent interconnect. Optionally, the processor is an MxPU derived from an established processor design that may include processing cores, caching/home agent (CHA), snoop filter (SF), and last-level cache (LLC), optionally implemented as slices distributed across tiles on the coherent interconnect mesh. The processor may further include a PCIe root port (RP) that may be coupled to an NVMe SSD, a CXL/PCIe RP, a memory controller that may be coupled to a first memory (Memory.1), such as DRAM, and an ISoL port, such as a port utilizing ARM CHI C2C, NVLink-C2C, or Intel Coherent Processor Interconnect Protocol (ICPIP), such as Intel UPI. The processor may be coupled to a second memory (Memory.2), such as a CXL memory expander, and may further include an RPU that may expose a CXL device, such as a Global Fabric-Attached Memory (G-FAM) Device (GFD), a Type-3 CXL device, or a Type-2 CXL device. The CXL device may expose an endpoint (EP), and may communicate with an entity, such as a host, according to at least one protocol based on CXL, such as CXL.mem and/or CXL.io, wherein the RPU may perform physical address translations to enable the entity to access the first memory and/or the second memory. The illustrated RPU may be coupled to the coherent interconnect, and may translate between the at least one protocol based on CXL and a protocol utilized by the coherent interconnect. The processor may be implemented as a monolithic die, as chiplets within an IC package, such as by utilizing separate compute die(s) and I/O die(s), or as components on a board, and may utilize a mesh-based coherent interconnect, or in other examples may utilize a ring, a crossbar, or other types of coherent interconnects.

FIG. 11B illustrates an example of a transaction flow diagram (TFD) demonstrating two CXL requests, such as CXL.mem M2S requests, received from an entity and forwarded to different memories mapped to an address space utilized by the coherent interconnect. An RPU may perform physical address translations to enable the entity to access the processor's memories. The processor may have multiple memory resources, such as DRAM coupled to a memory controller of the processor, and/or memory expanders that may be coupled to CXL RPs of the processor. The paths from the RPU to the different memories may traverse other components, such as CHA/SF/LLC slices, memory controllers, or in other examples traverse a home agent or a home node, optionally for resolving coherency. The RPU may further perform additional translations, such as protocol translations from a protocol based on CXL, such as CXL.mem or CXL.io, to a protocol utilized by the coherent interconnect, and may send the optionally translated request to the coherent interconnect, requesting a read from memory. In some examples, the requested data may be provided by a processor cache, such as by an LLC, instead of by the memory. The data may then return over the coherent interconnect to the RPU, wherein the RPU provides CXL.mem Data Response (DRS) and optionally CXL.mem No Data Response (NDR) to the requesting entity. The TFD illustrates two exemplary transactions carrying different physical addresses mapped to different memory resources. The first exemplary transaction comprises a CXL.mem M2S request comprising physical address (AS.1.1), which the RPU translates and forwards via the coherent interconnect protocol to Memory.1, resulting in the retrieval of *Data.1* that is returned to the entity with the first CXL.mem S2M DRS. The second exemplary transaction comprises a CXL.mem M2S request comprising physical address (AS.1.2), which the RPU translates and forwards via the coherent interconnect protocol to Memory.2, resulting in the retrieval of *Data.2* that is returned to the entity with the second CXL.mem S2M DRS. The physical addresses (AS.1.1) and (AS.1.2) may refer to different memory regions within the address space utilized by the coherent interconnect, enabling the entity to access multiple memory resources based on the RPU's translation capabilities.

In various implementations, an apparatus comprising: processing cores configured to execute instructions; memory channels supporting connections to dynamic random-access memory (DRAM) having a capacity of at least 32 GB; a Compute Express Link (CXL) root port (RP); a coherent interconnect coupling the processing cores with the memory channels and the CXL RP; and a resource provisioning unit (RPU) coupled to the CXL RP via a die-to-die interconnect; wherein the RPU is configured to translate from CXL.mem messages, received from an entity coupled to the apparatus, to CXL.cache messages sent to the CXL RP.

In some implementations of the apparatus, the RPU is further configured to translate from CXL.cache messages received from the CXL RP to CXL.mem messages sent to the entity. It is noted that references to CXL.mem messages and CXL.cache messages may also encompass CXL.mem transactions and CXL.cache transactions, and vice versa, because CXL transactions utilize messages. Examples of entity that may be coupled to the apparatus include a host and a switch coupled to a host.

In some implementations of the apparatus, the RPU is further configured to translate a single CXL.mem message, selected from the CXL.mem messages, to multiple CXL.cache messages sent to the CXL RP. For example, the system may implement mirroring based on translating a single CXL.mem message to multiple corresponding CXL.cache messages. In another example, the RPU implements retransmission based on translating a single CXL.mem message to multiple corresponding CXL.cache messages.

In some implementations of the apparatus, the RPU is disposed in a chiplet; the chiplet, the processing cores, the memory channels, and the CXL RP are in an integrated circuit package; and the RPU is further configured to translate between CXL.io packets communicated with the CXL RP and CXL.io packets communicated with the entity.

In some implementations, the apparatus further comprises a second RPU coupled over a second die-to-die interconnect to a second CXL RP coupled to the coherent interconnect; and wherein the second RPU is configured to translate between (i) CXL.cache messages communicated with a second entity coupled to the apparatus via a CXL type-1 device (T1-D), and (ii) CXL.cache messages communicated with the second CXL RP via a CXL type-1 device (T1-D).

In some implementations, the apparatus further comprises a second RPU coupled over a second die-to-die interconnect to a second CXL RP coupled to the coherent interconnect; and wherein the second RPU is configured to translate from (i) CXL.mem messages and CXL.cache messages received from a second entity coupled to the apparatus via a CXL type-2 device (T2-D), to (ii) CXL.cache messages sent to the second CXL RP via a CXL type-1 device (T1-D).

In some implementations of the apparatus, the entity comprises a host, and the RPU is further configured to translate from physical addresses within host physical address (HPA) space of the host to physical addresses within a local HPA space utilized by at least one of the processing cores.

In some implementations of the apparatus, the instructions are compatible with an x86 instruction set architecture, the apparatus further comprises at least three levels of in-package cache memory coupled to the coherent interconnect, and the RPU further comprises a CXL type-3 device (T3-D) supporting at least 16 lanes available for communication with the entity.

In some implementations of the apparatus, a third level of the in-package cache memory has a capacity of at least 4 MB, and further comprising a memory management unit (MMU) supporting first-level address translation, and a secondary translation unit supporting second-level address translation (SLAT) for hardware-assisted virtualization.

In some implementations of the apparatus, the instructions are compatible with a RISC-based instruction set architecture, the apparatus further comprises at least two levels of in-package cache memory coupled to the coherent interconnect, and the RPU further comprises a CXL type-3 device (T3-D) supporting at least 16 lanes available for communication with the entity.

In some implementations of the apparatus, the RISC-based instruction set architecture is selected from a group comprising ARM-class instruction set or RISC-V class instruction set; and wherein a last level of the in-package cache memory has a capacity of at least 4 MB, and further comprising a memory management unit (MMU) supporting first-level address translation, and a stage two translation to translate guest physical addresses to local physical addresses.

In some implementations of the apparatus, the instructions are compatible with NVIDIA's Compute Unified Device Architecture (CUDA) parallel computing platform, the processing cores are streaming multiprocessors, number of the streaming multiprocessors is above 50, and the RPU further comprises a CXL type-3 device (T3-D) supporting at least 16 lanes available for communication with the entity.

In some implementations, the apparatus further comprises NVIDIA Virtual GPU (vGPU) configured to utilize hardware-assisted virtualization to enable virtual machines to share a GPU, and further comprising at least two levels of in-package cache memory coupled to the coherent interconnect, wherein a last level of the in-package cache memory has a capacity of at least 500 KB.

In some implementations of the apparatus, the coherent interconnect is further coupled to at least two in-package High Bandwidth Memory (HBM) stacks, and wherein the memory channels are a memory interface supporting at least one of Graphics Double Data Rate (GDDR) memory or High Bandwidth Memory (HBM).

In various implementations, an apparatus comprising: processing cores configured to execute instructions; memory channels supporting connections to dynamic random-access memory (DRAM) having a capacity of at least 32 GB; a Compute Express Link (CXL) root port (RP); a coherent interconnect coupling the processing cores with the memory channels and the CXL RP; and a resource provisioning unit (RPU) coupled to the CXL RP via a die-to-die interconnect; wherein the RPU is configured to translate between first CXL.cache messages, communicated with an entity coupled to the apparatus, and second CXL.cache messages sent to the CXL RP.

In some implementations of the apparatus, the RPU is implemented in a chiplet; the chiplet, the processing cores, the memory channels, and the CXL RP are in an integrated circuit package; and the RPU is further configured to translate between CXL.io packets communicated with the CXL RP and CXL.io packets communicated with the entity.

In some implementations, the apparatus further comprises a second RPU coupled over a second die-to-die interconnect to a second CXL RP coupled to the coherent interconnect; wherein the second RPU is configured to translate from (i) CXL.mem messages received from a second entity coupled to the apparatus via a CXL type-3 device (T3-D) to (ii) third CXL.cache messages sent to the second CXL RP via a CXL type-1 device or a CXL type-2 device.

In some implementations, the apparatus further comprises a second RPU coupled over a second die-to-die interconnect to a second CXL RP coupled to the coherent interconnect; wherein the second RPU is configured to translate between (i) CXL.mem messages and third CXL.cache messages communicated with a second entity coupled to the apparatus via a CXL type-2 device (T2-D) and (ii) fourth CXL.cache messages communicated with the second CXL RP via a CXL type-1 device (T1-D).

In some implementations of the apparatus, the entity comprises a host, and the RPU is further configured to translate from physical addresses within host physical address (HPA) space of the host to physical addresses within a local HPA space utilized by at least one of the processing cores. In some implementations of the apparatus, the apparatus utilizes different CQID trackers for the first and second CXL.cache messages.

In some implementations of the apparatus, the entity comprises a host, the instructions are compatible with an x86 instruction set architecture, the apparatus further comprises at least three levels of in-package cache memory coupled to the coherent interconnect, and the RPU further comprises a CXL type-1 device (T1-D) supporting at least 16 lanes available for communication with the host.

In some implementations of the apparatus, a third level of the in-package cache memory has a capacity of at least 4 MB, and further comprising a memory management unit (MMU) supporting first-level address translation, and a secondary translation unit supporting second-level address translation (SLAT) for hardware-assisted virtualization.

In some implementations of the apparatus, the entity comprises a host, the instructions are compatible with a RISC-based instruction set architecture, the apparatus further comprises at least two levels of in-package cache memory coupled to the coherent interconnect, and the RPU further comprises a CXL type-1 device (T1-D) supporting at least 16 lanes available for communication with the host.

In some implementations of the apparatus, the RISC-based instruction set architecture is selected from a group comprising ARM-class instruction set or RISC-V class instruction set; and wherein a last level of the in-package cache memory has a capacity of at least 4 MB, and further comprising a memory management unit (MMU) supporting first-level address translation, and a stage two translation to translate guest physical addresses to local physical addresses.

In some implementations of the apparatus, the instructions are compatible with NVIDIA's Compute Unified Device Architecture (CUDA) parallel computing platform, the processing cores are streaming multiprocessors, number of the streaming multiprocessors is above 50, and the RPU further comprises a CXL type-1 device (T1-D) supporting at least 16 lanes available for communication with the entity.

In some implementations, the apparatus further comprises NVIDIA Virtual GPU (vGPU) configured to utilize hardware-assisted virtualization to enable virtual machines to share a GPU, and further comprising at least two levels of in-package cache memory coupled to the coherent interconnect, wherein a last level of the in-package cache memory has a capacity of at least 500 KB.

In some implementations of the apparatus, the coherent interconnect is further coupled to at least two in-package High Bandwidth Memory (HBM) stacks, and the memory channels are a memory interface supporting at least one of Graphics Double Data Rate (GDDR) memory or High Bandwidth Memory (HBM).

In various implementations, a method for translating Compute Express Link (CXL) communications in a computing system, comprising: receiving, by a resource provisioning unit (RPU) from a first host, a first message comprising a first CXL opcode, a first Tag, and a first physical address; wherein the RPU is implemented in a chiplet; translating, by the RPU, the first message to a second message comprising a second Tag and a second physical address; transmitting the second message to a CXL root port (RP) over a die-to-die interconnect; receiving, by the RPU from the CXL RP over the die-to-die interconnect, a third message comprising a second CXL opcode and a third Tag; translating the third message to a fourth message comprising a fourth Tag; and transmitting the fourth message to the first host.

In some implementations of the method, the first message conforms to CXL.mem, the first CXL opcode is selected from MemRd, MemRdData, MemRdTEE, or MemRdDataTEE for memory reads; the first message is received via a CXL.mem Master-to-Subordinate request (M2S Req) channel; the fourth message is transmitted via a CXL.mem Subordinate-to-Master Data Response (S2M DRS) channel; and wherein the translating of the first physical address to the second physical address comprises mapping from a Host-managed Device Memory (HDM) decoder range to a memory range accessible by the CXL RP.

In some implementations of the method, the second message conforms to CXL.cache, the second CXL opcode is selected from RdCurr, RdOwn, RdShared, RdAny, or WrCur; the second message is transmitted via a CXL.cache Device-to-Host request (D2H Req) channel; and the third message is received via a CXL.cache Host-to-Device Response (H2D Rsp) channel.

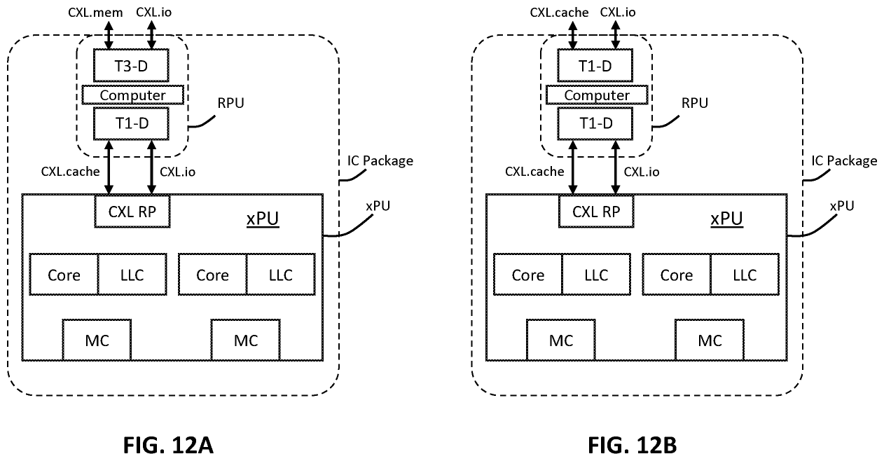

FIG. 12A and FIG. 12B illustrate two approaches for transforming an xPU design (such as an established CPU design) to a CXL memory device, which may enable it to serve as a building block for a Memory Expander or Memory Pool. In FIG. 12A, an RPU is integrated as a separate chiplet within the same IC package as the xPU, potentially allowing for a modular design approach that may provide flexibility in manufacturing and integration. The RPU may be coupled to the xPU's CXL RP via die-to-die interconnect, which may enable high-bandwidth and low-latency communication between the components. In one example, the RPU may include three main components, which are (i) A CXL Type-3 Device (T3-D) interface, supporting CXL.mem and CXL.io traffic, (ii) A computer, handling translations, and (iii) A CXL Type-1 Device (T1-D) interface, supporting CXL.cache and CXL.io traffic. In another example, current modern CPUs, such as Intel Sapphire Rapids (SPR), include one or more CXL RPs, but do not include a CXL EP as the CPU acts as the host in a CXL system. The RPU illustrated in FIG. 12A is coupled to the CPU's CXL RP and translates between CXL.mem (via CXL type-3 device) and CXL.cache (via CXL type-1 device), potentially allowing the CPU to function as a building block for a Memory Expander or a Memory Pool. FIG. 12B illustrates an alternative example wherein the RPU translates between first and second type-1 device interfaces.

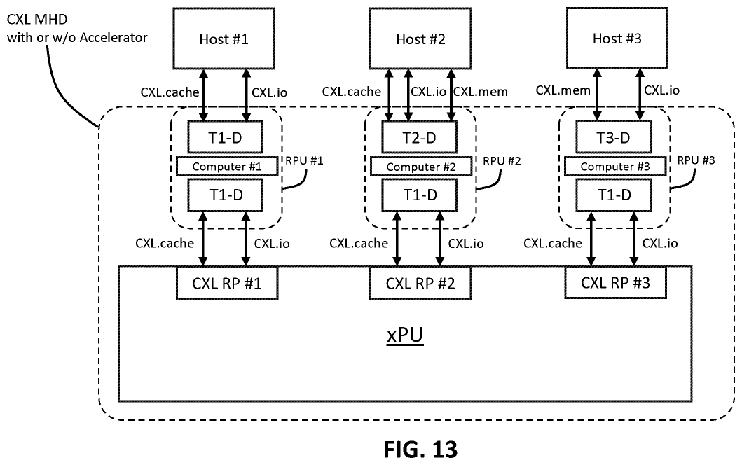

FIG. 13 illustrates an example of building a CXL Multi-Headed Device (MHD) Memory Pool based on a processing unit (xPU, such as a CPU, GPU, and/or a TPU) comprising three CXL RPs (#1 to #3) coupled to three RPUs (#1 to #3) via the symmetric CXL.cache and CXL.io interfaces. The diagram illustrates three hosts coupled to a system operating similar to a CXL MHD, which can be either with or without an accelerator. The hosts include CXL RPs that can be coupled to the CXL device types exposed by the RPUs. Host #1 is coupled to CXL MHD via CXL type-1 device through RPU #1 that translates between (i) CXL.cache messages and CXL.io packets with Host #1 and (ii) CXL.cache messages and CXL.io packets with CXL RP #1 of the xPU. It is noted that because transactions include messages, then it is also possible to describe the functionality of RPU #1 as translating between (i) CXL.cache and CXL.io transactions with Host #1 and (ii) CXL.cache and CXL.io transactions with CXL RP #1 of the xPU. Host #2 is coupled to CXL MHD via CXL type-2 device through RPU #2 that translates between (i) CXL.cache messages, CXL.mem messages, and CXL.io packets with Host #2 and (ii) CXL.cache messages, CXL.mem messages, and CXL.io packets with CXL RP #2 of the xPU. And Host #3 is coupled to CXL MHD via CXL type-3 device through RPU #3 that translates between (i) CXL.mem messages and CXL.io packets with Host #3 and (ii) CXL.cache messages and CXL.io packets with CXL RP #3 of the xPU. The CXL MHD may also include a CXL.mem interface, which is coupled to the device's internal memory. In the case where the CXL MHD includes an accelerator, the processor within the device can serve as the accelerator. The internal cache of the processor, particularly the Last Level Cache (LLC), can function as the cache for the accelerator in CXL.cache flows, maintaining coherency with the coupled hosts. The xPU in the diagram represents the processing unit that manages the overall operation of the CXL MHD, coordinating the communication between the coupled hosts, the RPUs, and the internal memory. In summary, this figure illustrates an architecture for building a CXL MHD Memory Pool using one or more xPUs with CXL RPs and no CXL EPs. The design incorporates RPUs to enable the coupling of (T3-D), (T2-D), and/or (T1-D) ports between the hosts and xPU in the CXL MHD. When an accelerator is included in the CXL MHD, the processor's internal cache, especially the LLC, may serve as the cache for the accelerator, maintaining coherency with the coupled hosts.

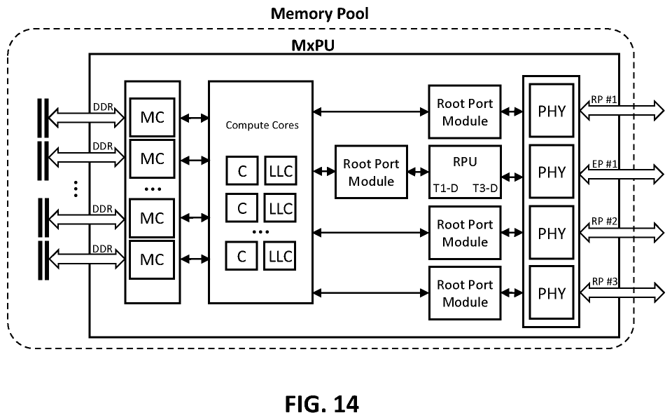

FIG. 14 illustrates an example of another approach wherein the RPU is embedded in the MxPU's silicon die, which may offer potential benefits in terms of reduced latency and improved performance through tighter coupling with the MxPU's internal components. In one example, this configuration includes: (i) Memory Controllers (MC) coupled to DDR interfaces coupled to DRAM, (ii) Compute Cores with associated caches and Last Level Caches (LLC), (iii) RP Core Logic blocks, (iv) An integrated RPU with T1-D and T3-D interfaces for translating between CXL.cache and CXL.mem, and (v) Physical layer (PHY) coupled, in the illustrated example, to three root ports and one T3-D endpoint. These approaches may leverage the xPU's/MxPU's large LLC to enhance memory read performance from a Multi-Headed Device (MHD), which may offer two potential advantages of (i) Improved read performance, wherein the relatively large LLC may provide better performance for memory reads from the MHD compared to typical CXL memory controllers, which often have smaller caches, and (ii) Flexible resource allocation, wherein an LLC provisioning policy may be implemented to allocate specific LLC resources for CXL memory flows, potentially allowing for optimized cache utilization based on the needs of different CXL ports or workloads, and/or allocating to certain CXL ports more cache resources than others. The remaining portion of the LLC may continue to be used by the processing cores and PCIe devices, maintaining compatibility with an established xPU configurations and potentially allowing for features such as Intel's Data Direct I/O (DDIO). It may enable the transformation of established xPUs designs, which typically include CXL root ports but no CXL endpoint s, to versatile CXL memory device designs.

Still referring to FIG. 14, some CPU vendors, such as Intel, provide CPUs with root ports (RPs) that implement the three protocols (e.g., CXL.io, CXL.cache, CXL.mem), and thus can connect to Type-1, Type-2, or Type-3 CXL Devices. Other CPU vendors, such as certain AMD CPUs, may support only CXL.io and CXL.mem on some of the CPU RPs, thus it can connect only to CXL type-3 devices. As a result, the top RP Module may support the three protocols, or a subset of the protocols (e.g., CXL.io and CXL.cache, or CXL.io and CXL.mem). The second RP module is coupled internally (which means a permanent connection) to an RPU that translates between Type-1 CXL Device (T1-D) and Type-3 CXL Device (T3-D). Therefore, the Second RP Module, which is coupled to the T1-D of the RPU, should support at least CXL.io and CXL.cache, and may support the three protocols. Optionally, the RP Modules may be instantiations of the same design module supporting the three protocols. Alternatively, different RP Modules may be instantiations of different design modules supporting a subset of the protocols.

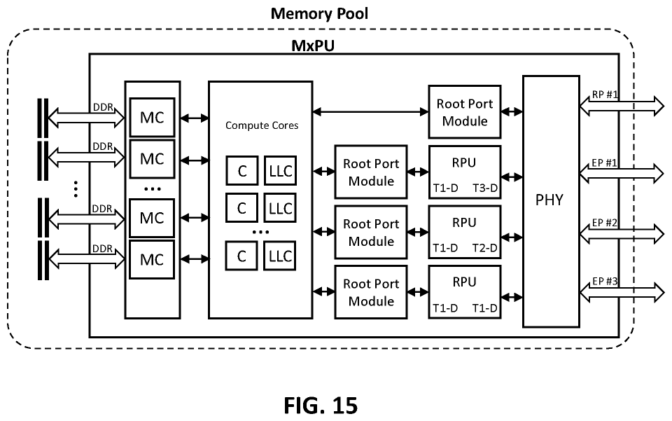

FIG. 15 illustrates an example of an MxPU including RPUs coupled to RP modules, wherein different RPUs translate between different combinations of CXL device types, such as CXL T1-D to T3-D, CXL T1-D to T2-D, or CXL T1-D to T1-D, providing flexibility in translation capabilities. The PHY module may include one or more PHY block blocks based on design requirements. FIG. 15 illustrates an example with a PHY block coupled to the RP module and the RPUs, while FIG. 14 illustrates an example with separate PHY blocks coupled to the different RP modules or RPUs.

In various implementations, an apparatus comprising: an integrated circuit package (IC package) comprising processing cores coupled to a resource provisioning unit (RPU) utilizing an interconnect protocol; wherein the RPU is configured to communicate with an entity external to the IC package according to a first protocol based on Compute Express Link (CXL), wherein the first protocol utilizes physical addresses within a first physical address space; wherein the RPU is further configured to translate between messages conforming to the first protocol and messages conforming to the interconnect protocol, wherein the interconnect protocol utilizes physical addresses within a second physical address space; and a root port (RP) configured to communicate with a CXL device according to a second protocol based on CXL, wherein the second protocol utilizes physical addresses associated with the second physical address space.

In some implementations of the apparatus, the first and second protocols are based on CXL.mem. In some implementations of the apparatus, the first protocol is based on CXL.mem, and the second protocol is based on CXL.io. In some implementations of the apparatus, the first protocol is based on CXL.mem, and the second protocol is based on CXL.cache. In some implementations of the apparatus, the interconnect protocol is based on a coherent interconnect protocol. In some implementations of the apparatus, the RPU is further configured to translate the physical addresses within the first physical address space to the physical addresses within the second physical address space. In some implementations of the apparatus, the apparatus further comprises memory channels, the memory channels are coupled to memory external to the IC package, and the memory having a capacity of at least 64 GB. In some implementations of the apparatus, the CXL device is configured to return data via a response path utilizing the second protocol, the interconnect protocol, and the first protocol.

In various implementations, a processor in an integrated circuit package (IC package), comprising: first and second ports configured to communicate according to first and second protocols based on Compute Express Link (CXL); wherein the first and second protocols are configured to utilize physical addresses within first and second non-identical physical address spaces, respectively; and processing cores, located inside the IC package, configured to utilize physical addresses associated with the second physical address space.

In some implementations, the processor further comprises memory channels coupled to the processing cores, the memory channels are coupled to memory external to the processor, and the memory having a capacity of at least 64 GB. In some implementations of the processor, the processor functions as a switch comprising switch ports. In some implementations of the processor, the first and second protocols are based on CXL.mem. In some implementations of the processor, the first protocol is based on CXL.mem, and the second protocol is based on CXL.io. In some implementations of the processor, the first protocol is based on CXL.mem, and the second protocol is based on CXL.cache. In some implementations, the processor further comprises a resource provisioning unit (RPU) configured to translate the physical addresses within the first physical address space to the physical addresses within the second physical address space. In some implementations of the processor, the first port is configured to communicate with a first entity; the first entity comprises a host, an accelerator, an xPU, a switch, or a consumer; the second port is configured to communicate with a second entity; and the second entity comprises a CXL memory, a CXL device, a switch, or a provider. In some implementations of the processor, the second port is configured to receive data from a device coupled to the second port, and wherein the processor is configured to return the data via a response path according to the second protocol and the first protocol.

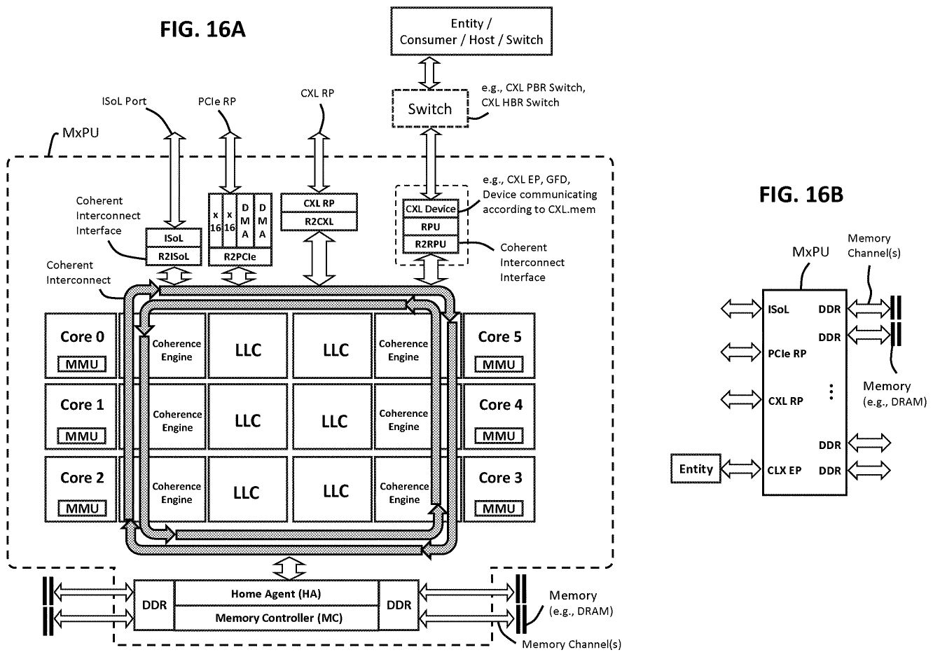

FIG. 16A illustrates an example of a system comprising a processor (such as an MxPU that may be derived from an established processor design) comprising processing cores and last level cache (LLC). The MxPU may include a CXL Device, such as a CXL EP, a Global Fabric-Attached Memory Device (GFD), or another type of device communicating according to a CXL protocol, such as CXL.mem. The MxPU may further include an ISoL port such as ARM CHI C2C, Intel QPI, or Intel UPI, a PCIe root port (PCIe RP), a CXL root port (CXL RP), and may be coupled to memory, such as DRAM, optionally via a memory controller and memory channels. The CXL device may communicate with an entity, such as a host, optionally via a switch, according to a CXL protocol, such as CXL.mem, wherein an RPU may perform physical address translations to enable the entity to access the memory. The illustrated RPU may be coupled to an on-chip ring-based coherent interconnect via a coherent interconnect interface, such as the illustrated Ring-to-RPU (R2RPU), which may be referred to as a bridge node in ARM-based examples, or as an interface logic in Intel-based examples. Alternatively, the RPU may be coupled to the coherent interconnect essentially directly. Similarly, the illustrated ISoL port may be coupled to the coherent interconnect via a coherent interconnect interface, such as a Ring-to-ISoL (R2ISoL). The PCIe root port (RP) may be coupled to the on-chip ring interconnect via a coherent interconnect interface, such as a Ring-to-PCIe (R2PCIe), and the CXL RP may be coupled to the ring interconnect via a coherent interconnect interface such as a Ring-to-CXL (R2CXL). The MxPU may be implemented as a monolithic die, as chiplets within an IC package, such as by utilizing separate compute die(s) and I/O die(s), or as components on a board, and may utilize a coherent interconnect, such as a ring-based or a mesh-based coherent interconnect. In other examples, the MxPU may utilize a mesh, a crossbar, or other types of interconnects.

FIG. 16B illustrates an example of an MxPU that may be derived from an established processor design. The MxPU may include external interfaces such as a CXL EP, CXL RP, PCIe RP, ISoL, and DDR. The CXL EP may be coupled to an entity, optionally via a switch, and may communicate with the entity according to a protocol based on CXL, such as CXL.mem.

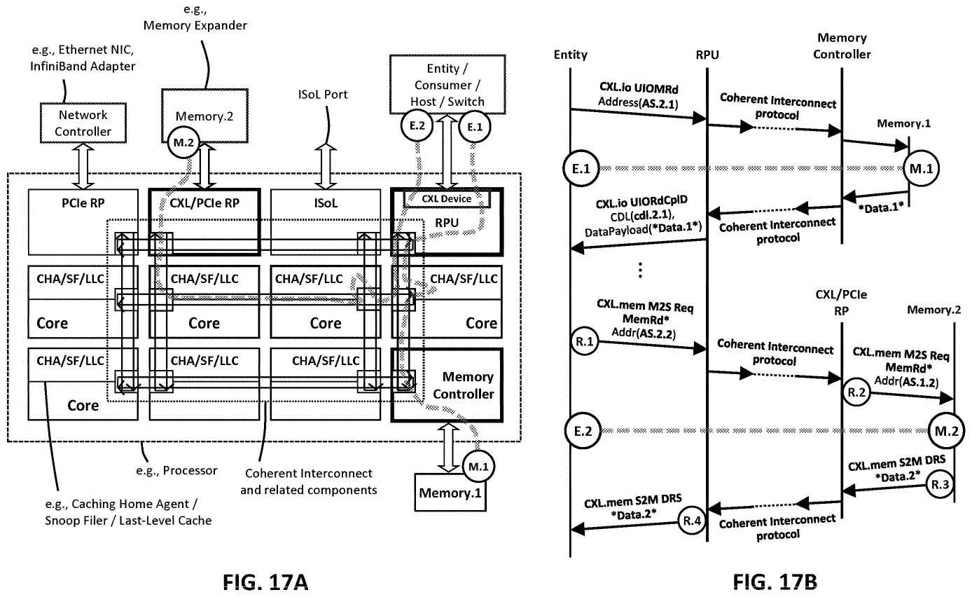

FIG. 17A illustrates an example of a system comprising a processor including a coherent interconnect, capable of enabling an external entity to access memory resources mapped to an address space utilized by the coherent interconnect, such as via one or more of the two illustrated paths denoted as (E.1)-(M.1) and (E.2)-(M.2). The processor may include processing cores, caching/home agent (CHA), snoop filter (SF), and last-level cache (LLC), optionally implemented as distributed slices coupled to the coherent interconnect. The processor may further include a PCIe RP that may be coupled to a Network Controller, such as an Ethernet NIC or an InfiniBand Adapter, a CXL/PCIe RP, a memory controller that may be coupled to a first memory (Memory.1), such as DRAM, and an ISoL port, such as a port utilizing NVIDIA NVLink-C2C, ARM CHI C2C, or Intel Coherent Processor Interconnect Protocol (ICPIP), e.g., Intel UPI. The processor may be coupled to a second memory (Memory.2), such as a CXL memory expander, and may further include an RPU that may expose a CXL device, such as a Global Fabric-Attached Memory (G-FAM) Device (GFD), or a Type-3/2/1 CXL device. The CXL device may expose an endpoint (EP), and may communicate with an entity, such as a host, according to at least one protocol based on CXL, such as CXL.mem, CXL.cache, and/or CXL.io, wherein the RPU may perform physical address translations to enable the entity to access the first memory, such as over the path (E.1)-(M.1), and/or access the second memory, such as over the path (E.2)-(M.2). The illustrated RPU may be coupled to the coherent interconnect, and may translate between the at least one protocol based on CXL and a protocol utilized by the coherent interconnect. The processor may be implemented as an IP block embedded into a silicon design, such as a switch or an accelerator. In other examples, the processor may be implemented as a monolithic die, as chiplets within an IC package, or as components on a board, and may utilize a mesh-based coherent interconnect, or in other examples may utilize a ring, a crossbar, a Network on Chip (NoC) or other types of coherent interconnects.

FIG. 17B illustrates an example of a transaction flow diagram (TFD) demonstrating two CXL requests issued by an entity, such as a host. The first CXL request comprises a CXL.io UIOMRd memory read request, and the second CXL request comprises a CXL.mem M2S request. The two CXL requests are processed by an RPU and forwarded, possibly using a protocol utilized by a coherent interconnect, to different memories mapped to the address space utilized by the coherent interconnect. The paths from the RPU to the different memories may traverse other components, such as CHA/SF/LLC slices, memory controllers, or in other examples traverse a home agent or a home node, optionally for resolving coherency. The RPU may perform physical address translations, such as from (AS.2.2) to (AS.1.2) to enable the entity to access the processor's memories. The processor may have multiple memory resources, such as first memory (Memory.1), which may be a DRAM coupled to a memory controller of the processor, and/or second memory (Memory.2), which may be a CXL memory expander coupled to a CXL/PCIe RP of the processor. The RPU may further perform additional translations, such as protocol translations from a protocol based on CXL, such as CXL.io, CXL.cache, or CXL.mem, to a protocol utilized by the coherent interconnect, and may send the optionally translated request to the coherent interconnect, requesting a read from memory. In some examples, the requested data may be provided by a processor cache, such as by an LLC, instead of by the memory. The data may then return via the coherent interconnect to the RPU, wherein the RPU may provide the requested data to the entity utilizing CXL.io UIORdCplD read completion with data, or utilizing CXL.mem S2M Data Response (DRS), depending on the CXL protocol utilized by the CXL request.

The TFD illustrates two exemplary transactions between the entity and the RPU, corresponding to two distinct memory read paths denoted as (E.1)-(M.1) and (E.2)-(M.2), carrying different CXL protocols, and different physical addresses mapped to different memory resources. The first exemplary transaction comprises CXL.io UIOMRd memory read request comprising physical address (AS.2.1), which the RPU translates and forwards via the coherent interconnect protocol and via the memory controller to the first memory (Memory.1), resulting in the retrieval of *Data.1*, that is sent to the entity via the coherent interconnect protocol and via the RPU using CXL.io UIORdCplD read completion with data. Alternatively, the first exemplary transaction comprises CXL.io MRd memory read request, wherein the data is sent to the entity via the coherent interconnect protocol and via the RPU using CXL.io CplD completion with data. The second exemplary transaction comprises a CXL.mem M2S request, denoted as (R.1), comprising physical address (AS.2.2), which the RPU may translate to physical address (AS.1.2) and forward to the second memory (Memory.2), via the coherent interconnect protocol and via the CXL/PCIe RP, utilizing a second CXL.mem M2S request, denoted as (R.2). *Data.2* is retrieved from the second memory (Memory.2) via a first CXL.mem S2M DRS, denoted as (R.3), and sent to the RPU via the coherent interconnect protocol. The RPU may then forward *Data.2* to the entity via a second CXL.mem S2M DRS, denoted as (R.4). The physical addresses (AS.2.1) and (AS.2.2) may refer to different memory regions within the address space utilized by the coherent interconnect, enabling the entity to access memory resources based on the RPU's translation capabilities.

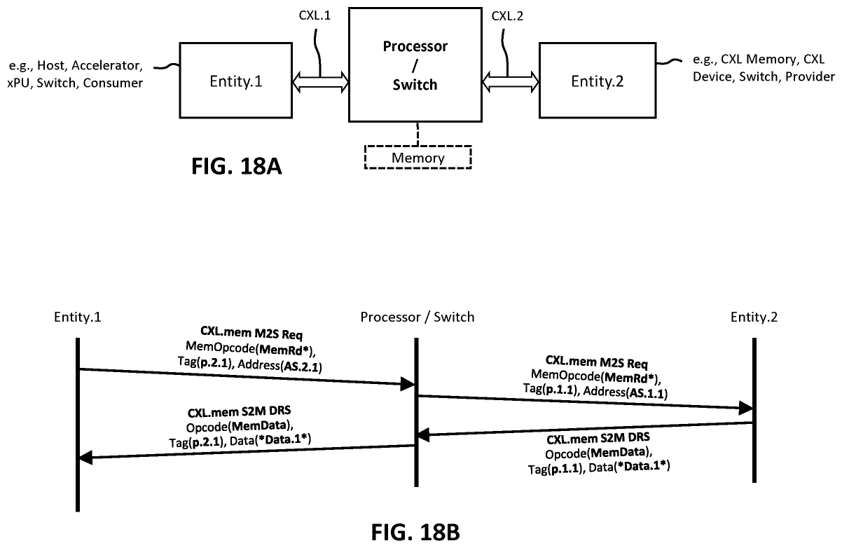

FIG. 18A illustrates an example of a system comprising a processor or a switch, which may be coupled to memory, wherein the processor may enable external entities to access resources coupled to the processor. The processor is coupled to a first entity (Entity.1), which may be a host, an accelerator, an xPU, or a second switch, wherein the processor may communicate with the first entity according to a first CXL protocol. The processor is further coupled to a second entity (Entity.2), which may be a CXL memory, a CXL device, or a third switch, wherein the processor may communicate with the second entity according to a second CXL protocol.

In some examples, the first and second CXL protocols may be associated with first and second physical address spaces, respectively, wherein the processor may perform address translations between addresses within the first and second physical address spaces, respectively. In other examples, the first and second CXL protocols may be associated with the same physical address space, wherein the processor may perform address translations between addresses within the same physical address space.

The processor may perform further translations, such as opcode, command, or TLP translations, e.g., translating between opcodes in requests conforming to the first CXL protocol, to opcodes in requests conforming to the second CXL protocol. The processor may further perform other translations, such as field translations between messages conforming to the first and second CXL protocols, such as Tag translations, traffic class (TC) translations, or cross-field translations such as Tag-CQID translations. In some examples, the processor may translate between protocols conforming to different CXL protocol revisions, such as translating between first CXL transactions conforming to CXL 1.1, which may be utilized by the first entity, and second CXL transactions conforming to CXL 2.0, which may be utilized by the second entity.

FIG. 18B illustrates an example of a TFD demonstrating translations performed by a processor, or by a switch, between first CXL.mem utilized for communicating with a first entity (Entity.1), such as a host, and second CXL.mem utilized for communicating with a second entity (Entity.2), such as a CXL device or CXL memory. The first entity may initiate a first CXL.mem transaction that includes a first CXL.mem M2S request comprising MemOpcode(MemRd*), Tag(p.2.1), and Address(AS.2.1). The processor may translate the first CXL.mem transaction to a second CXL.mem transaction that includes a second CXL.mem M2S request comprising MemOpcode(MemRd*), Tag(p.1.1), and Address(AS.1.1), and may send the second CXL.mem M2S request to the second entity. Upon receiving a response from the second entity, that may include a first CXL.mem S2M DRS comprising Opcode(MemData), Tag(p.1.1), and Data(*Data.1*), the processor may translate the first CXL.mem S2M DRS to a second CXL.mem S2M DRS comprising Opcode(MemData), Tag(p.2.1), and Data(*Data.1*).

The processor may perform further translations, such as opcode translations, e.g., translating between MemRd opcodes in requests conforming to the first CXL.mem, and MemRdTEE opcodes in requests conforming to the second CXL.mem, enabling CXL memory accesses with the Trusted Execution Environment (TEE) attribute. The processor may further perform other translations, such as field translations between messages conforming to the first and second CXL.mem, such as Tag translations and traffic class (TC) translations.

In some examples, the processor may act as a protocol endpoint and terminate the first CXL.mem transaction. The processor may issue the second CXL.mem transaction, optionally acting as an independent protocol initiator, such as a CXL host, and may utilize translated fields from the first CXL.mem transaction for constructing the second CXL.mem transaction. In other examples, the processor may maintain end-to-end transaction contexts of CXL.mem between the first entity and the second entity, without terminating the CXL.mem transactions, such as by preserving transaction-related identification fields such as Tags, and optionally translating other fields such as address field.

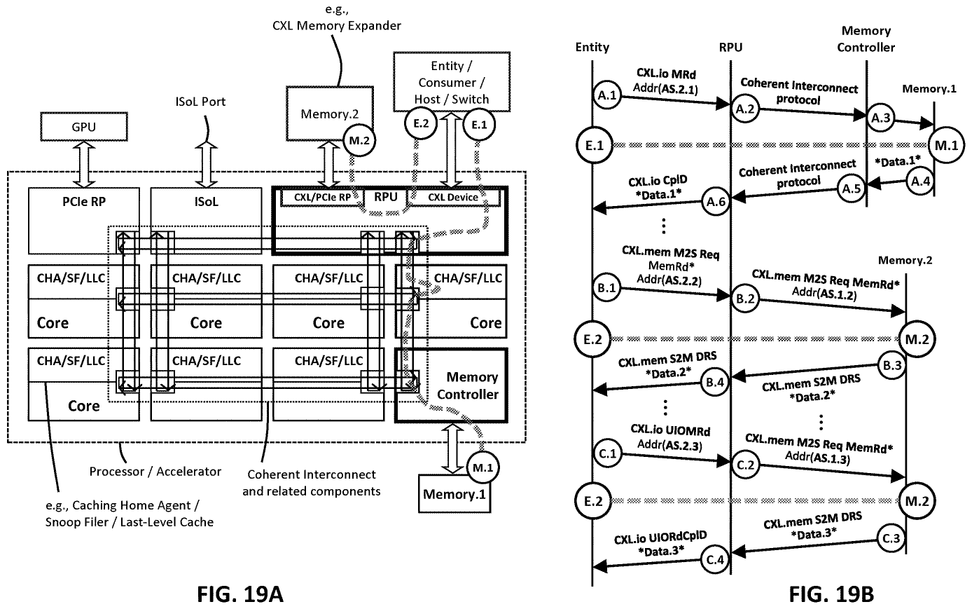

FIG. 19A illustrates an example of a system comprising a processor including a coherent interconnect, capable of enabling an external entity to access memory resources mapped to an address space utilized by the coherent interconnect, such as via one or more of the two illustrated paths (E.1)-(M.1) and (E.2)-(M.2). The processor may include processing cores, CHA, SF, and LLC, optionally implemented as distributed slices or tiles coupled to the coherent interconnect. The processor may further include a PCIe RP that may be coupled to a GPU, a memory controller that may be coupled to a first memory (Memory.1), such as DRAM, and an ISoL port, such as a port utilizing NVIDIA NVLink-C2C, ARM CHI C2C, or ICPIP, such as Intel UPI. The processor may further comprise an RPU, that may include a CXL device and a CXL/PCIe RP, wherein the CXL device may include a Global Fabric-Attached Memory (G-FAM) Device (GFD), or a Type-3/2/1 CXL device, and wherein the CXL/PCIe RP may be coupled to a second memory (Memory.2), such as a CXL memory expander. The CXL device may expose an endpoint (EP), and may communicate with an entity, such as a host or another device (e.g., via Peer-to-Peer/P2P), according to at least one protocol based on CXL, such as CXL.mem, CXL.cache, and/or CXL.io, wherein the RPU may perform physical address translations to enable the entity to access the first memory, such as over the path (E.1)-(M.1), and/or access the second memory, such as over the path (E.2)-(M.2). The illustrated RPU may be coupled to the coherent interconnect, and may translate between the at least one protocol based on CXL and a protocol utilized by the coherent interconnect.

FIG. 19B illustrates an example of a TFD demonstrating three CXL requests, such as CXL.io MRd memory read request, denoted as (A.1), CXL.mem M2S request, denoted as (B.1), and CXL.io UIOMRd memory read request, denoted as (C.1), received from an entity, processed and forwarded by an RPU, possibly using a protocol utilized by a coherent interconnect, to different memories mapped to the address space utilized by the coherent interconnect. In some examples, the paths from the RPU to the different memories may traverse other components, such as CHA/SF/LLC, optionally for resolving coherency. The RPU may perform physical address translations, such as when translating physical addresses from (AS.2.2) to (AS.1.2), or from (AS.2.3) to (AS.1.3), in order to enable the entity to access the processor's memories. The processor may have multiple memory resources, such as DRAM, denoted as (Memory.1), which may be coupled to a memory controller of the processor, and/or a CXL memory expander, denoted as (Memory.2), which may be coupled to a CXL/PCIe RP of the RPU. The RPU may further perform additional translations, such as protocol translations from a protocol based on CXL, such as CXL.io, CXL.cache, or CXL.mem, to a protocol utilized by the coherent interconnect, and may send the optionally translated request to the coherent interconnect, requesting a read from memory. Additionally or alternatively, the RPU may translate from a first protocol based on CXL to a second protocol based on CXL, such as from first CXL.mem to second CXL.mem, as illustrated on the path (B.1)-(B.2), or from CXL.io to third CXL.mem, as illustrated on the path (C.1)-(C.2). In some examples, the requested data may be provided by a processor cache, such as by an LLC, instead of by the memory. The data may then return from the memory to the RPU, wherein the RPU provides the requested data to the requesting entity such as utilizing CXL.io CplD completion with data, utilizing CXL.mem S2M Data Response (DRS), or utilizing CXL.io UIORdCplD read completion with data, depending on the CXL protocol utilized by the CXL request.

The TFD illustrates three exemplary transactions between the entity and the RPU, carrying different CXL protocols, and different physical addresses mapped to different memory resources. The first exemplary transaction corresponds to the memory read path denoted as (E.1)-(M.1), which includes CXL.io MRd memory read request, denoted as (A.1), carrying physical address (AS.2.1), which the RPU may translate to a read request conforming to a protocol utilized by the coherent interconnect. The RPU sends the translated request, denoted as (A.2), via the coherent interconnect, to a memory controller, that may convert the translated request to a memory access request, denoted as (A.3), and send it to the first memory (Memory.1), resulting in the retrieval from memory of *Data.1*, denoted as (A.4), which is then then sent to the RPU via the coherent interconnect protocol, denoted as (A.5), and from the RPU to the entity utilizing CXL.io CplD completion with data, denoted as (A.6).

The second exemplary transaction corresponds to the memory read path denoted as (E.2)-(M.2), which includes a first CXL.mem M2S request, denoted as (B.1), carrying physical address (AS.2.2), which the RPU may translate to a second CXL.mem M2S request, denoted as (B.2), carrying physical address (AS.1.2), and send the translated request to the second memory (Memory.2), resulting in the retrieval of *Data.2* that is sent to the RPU via a first CXL.mem S2M DRS, denoted as (B.3), and from the RPU to the entity via a second CXL.mem S2M DRS, denoted as (B.4).

The third exemplary transaction corresponds to the memory read path denoted as (E.2)-(M.2), which includes a CXL.io UIOMRd memory read request, denoted as (C.1), carrying physical address (AS.2.3), which the RPU may translate to a third CXL.mem M2S request, denoted as (C.2), carrying physical address (AS.1.3), and send the translated request to the second memory (Memory.2), resulting in the retrieval of *Data.3* that is sent to the RPU utilizing a third CXL.mem S2M DRS, denoted as (C.3), and from the RPU to the entity utilizing CXL.io UIORdCplD read completion with data, denoted as (C.4). It is noted that the physical addresses (AS.2.1), (AS.2.2), and (AS.2.2) may refer to different memory regions within the address space utilized by the coherent interconnect, enabling the entity to access multiple memory resources based on the RPU's translation capabilities.

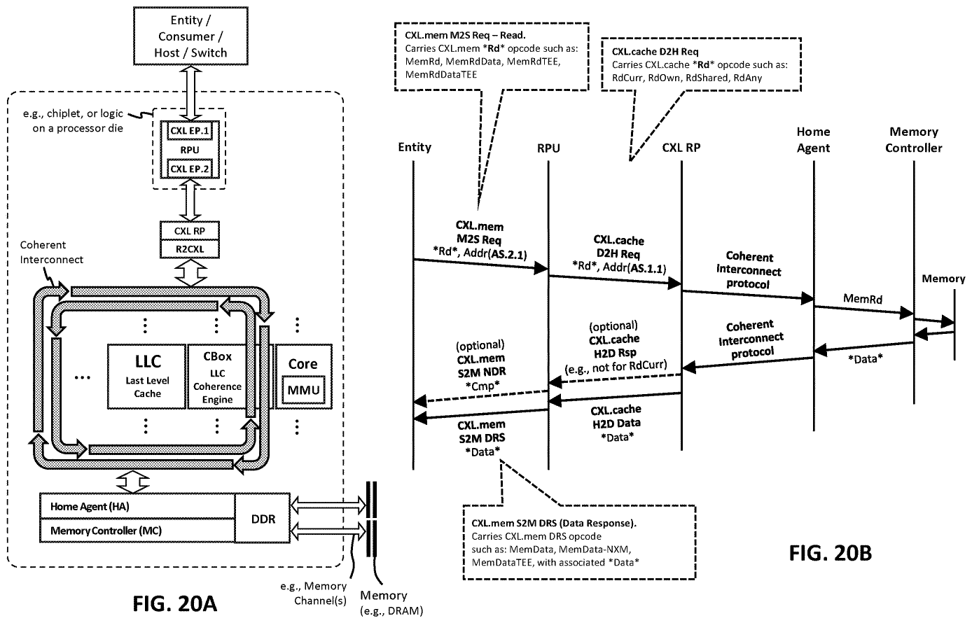

FIG. 20A illustrates an example of a system comprising a processor, including a coherent interconnect, capable of enabling an external entity to access memory resources mapped to the address space utilized by the coherent interconnect. Optionally, the processor is an MxPU derived from an established processor design that may include coherent interconnect (such as a ring-based or a mesh-based coherent interconnect), processing cores, LLC, a CXL RP, and a memory controller optionally coupled via memory channels to memory, such as DRAM. The CXL RP may be coupled to the coherent interconnect via a Ring-to-CXL (R2CXL) logic. An RPU, which may be included in the MxPU, performs address translations that may enable an entity such as a host to access the memory. The MxPU may expose to the entity, optionally via the RPU, a first CXL device, such as a Type-3 CXL device or a Type-2 CXL device, utilizing a first CXL endpoint (CXL EP.1). The first CXL device may communicate with the entity according to a protocol based on CXL, such as CXL.mem. The MxPU may further expose, optionally via the RPU and the CXL RP, a second CXL device such as a Type-1 CXL device or a Type-2 CXL device, utilizing a second CXL endpoint (CXL EP.2). In some examples, the RPU and its CXL devices may be implemented in a chiplet inside an IC package of a processor, such as inside an IC package of an MxPU, whereas in other examples, the RPU and its CXL devices may be implemented as functional blocks on the same die with the CXL RP, or split between processor dies or chiplets. Alternatively, the RPU may be implemented as a discrete component coupled to a processor component.

FIG. 20B illustrates an example of a TFD demonstrating a CXL.mem read request (M2S request *Rd*) received from an entity, such as a host or a switch, wherein the RPU may translate between CXL.mem and CXL.cache, and may further translate a physical address (AS.2.1) from a second host physical address space, carried in the CXL.mem M2S request, to a physical address (AS.1.1) from a first HPA space, carried in a CXL.cache D2H request, wherein the first HPA space is utilized by the processor and/or by the coherent interconnect. The RPU may perform further translations, such as opcode translations and Tag to CQID translations. The CXL.cache request, carrying the translated address (AS.1.1), is sent to the CXL RP for further processing and fetching of the requested data, such as from the LLC over the on-chip ring-based coherent interconnect, or from the DRAM via the memory controller. The data may then return over the coherent interconnect to the RPU, via the CXL RP, wherein the RPU may perform further translations between CXL.cache and CXL.mem and provide CXL.mem Data Response (DRS) and optionally CXL.mem No Data Response (NDR) to the requesting entity.

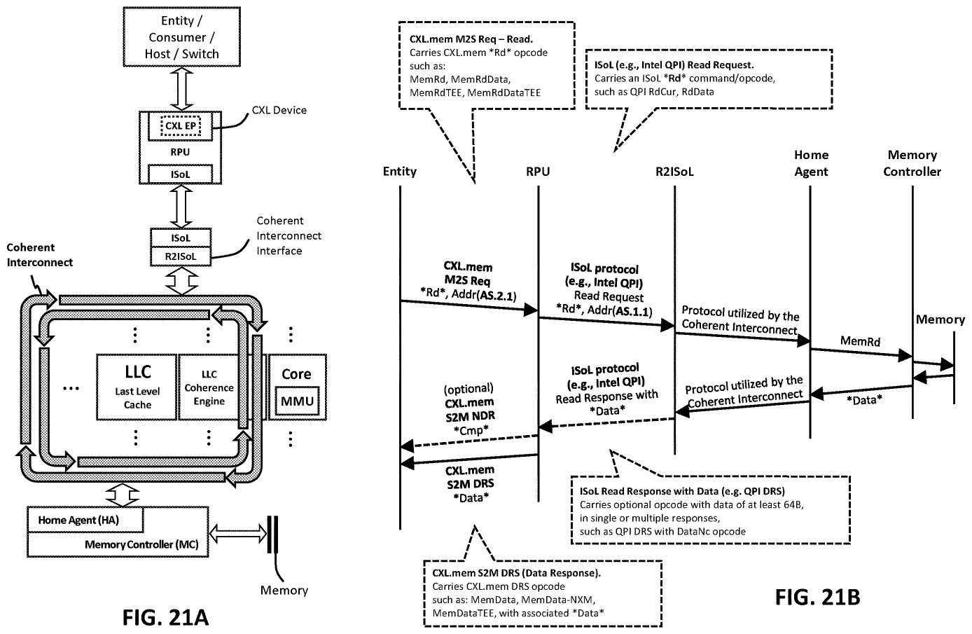

FIG. 21A illustrates an example of a system comprising a processor, including a coherent interconnect, capable of enabling an external entity to access memory resources mapped to the address space utilized by the coherent interconnect. Optionally, the processor is an MxPU derived from an established processor design that may include an RPU that may include, or be coupled to, a CXL device, such as a GFD, a CXL Type-3 device, or a CXL Type-2 device. The CXL device may include a CXL EP, wherein the RPU may be implemented as a chiplet, a logic on the processor die, a discrete component coupled to the processor, or other implementations. The processor may further include processing cores with MMUs, LLC, and LLC Coherence Engine (such as CBox) coupled via an on-chip coherent interconnect that may utilize a ring topology as one example. The processor may further include a Home Agent (HA) and Memory Controller (MC) coupled to memory, such as DRAM, optionally via memory channels. The RPU may be coupled to the coherent interconnect via an ISoL interface, such as Intel QPI, Intel UPI, or CHI C2C, and via a coherent interconnect interface, such as Ring-to-ISoL (R2ISoL) logic. The CXL device, which may reside within the RPU, may communicate with an entity, such as a host, according to a protocol based on CXL, such as CXL.mem, wherein the RPU performs address translations between the host's HPA space and the processor's physical address space to enable the host to access the memory and other resources accessible via the coherent interconnect. Alternatively, the figure may illustrate some examples of a two-socket (2S) or a two-processor (2P) system that may function as a memory switch or a memory pool, wherein the RPU may be embedded in the first processor coupled to the entity, and further coupled to a second processor via an ISoL interface, whereas the RPU enables the entity to access memory of the second processor, via the first processor and the ISoL interface.

FIG. 21B illustrates an example of a TFD demonstrating a CXL.mem M2S Read request received from an entity, such as a host or a switch. The request carries a CXL.mem read opcode such as MemRd, MemRdData, MemRdTEE, or MemRdDataTEE, along with a physical address (AS.2.1) from a second host physical address space utilized by the entity. The RPU translates the physical address (AS.2.1) to a physical address (AS.1.1) from a first HPA space utilized by the processor and/or the coherent interconnect. The RPU may also translate the CXL.mem request to an ISoL request (such as Intel QPI read request) including a read command/opcode such as QPI RdCur or RdData. The translated request is sent via the coherent interconnect to fetch the requested data, which may be retrieved from the LLC or from DRAM. The requested data returns to the RPU via the coherent interconnect and the ISoL interface using the ISoL protocol. The RPU then provides responses to the requesting entity including: CXL.mem S2M DRS carrying CXL.mem DRS opcodes such as MemData, MemData-NXM, or MemDataTEE with associated data, and optionally CXL.mem S2M NDR with a completion status. The ISoL read response may carry optional opcodes with data of at least 64 B, in single or multiple responses, such as QPI DRS with DataNc opcode.

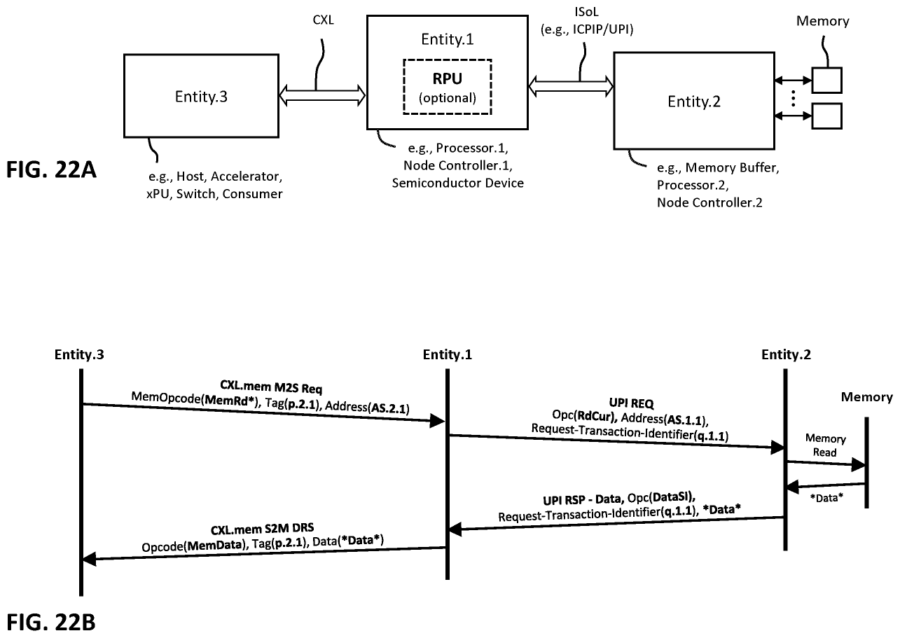

FIG. 22A illustrates an example of a system comprising a first entity (Entity.1), such as a first processor (Processor.1), a first node controller (Node Controller.1), or a semiconductor device, that may include an RPU. The first entity may be coupled to a third entity (Entity.3), which may be a host, an accelerator, an xPU, a switch (e.g., a CXL switch), or a resource consumer, wherein the first entity may communicate with the third entity according to a CXL-based protocol, such as at least one of CXL.mem, CXL.io, or CXL.cache. The first entity may be further coupled to a second entity (Entity.2), which may be a second processor (Processor.2), a memory buffer, or a second node controller (Node Controller.2), wherein the second entity may be coupled to a memory, and wherein the first entity may communicate with the second entity according to an ISoL protocol, such as ARM CHI C2C, a protocol utilizing an NVIDIA NVLink-C2C interconnect, or an Intel Coherent Processor Interconnect Protocol (ICPIP), such as Intel UPI. The first node controller (Node Controller.1) and the second node controller (Node Controller.2) may each include an ICPIP node controller, such as a UPI node controller (UNC), or an external node controller (e.g., XNC). The first entity, optionally via the RPU, may translate between the CXL-based protocol, such as CXL.mem, and the ISoL protocol, such as ICPIP, enabling the third entity to access resources coupled to the first entity, such as the memory that may be coupled to the second entity.

In some examples, the CXL-based protocol, such as CXL.mem, may be associated with a first address space, such as a first Host Physical Address (HPA) space, and the ISoL protocol, such as ICPIP, may be associated with a second address space, such as a System Physical Address (SPA) space or a second Host Physical Address (HPA) space; wherein the first entity, optionally via the RPU, may perform address translations between addresses within the first and second address spaces, respectively, such as between addresses within the first HPA space and addresses within the SPA space or within the second HPA space. In other examples, the CXL-based protocol, such as CXL.mem, and the ISoL protocol, such as ICPIP, may be associated with the same physical address space, such as with the same HPA space, the same SPA space, or with a global address space, a partitioned global address space (PGAS), a pod address space, a virtual pod address space, or a fabric address space; wherein the first entity, optionally via the RPU, may perform address translations between addresses within the same address spaces. The first entity (Entity.1), optionally via the RPU, may perform further translations, such as opcode, command, or TLP translations, e.g., translating between commands or opcodes in requests conforming to the CXL-based protocol (e.g. CXL.mem M2S Req MemRd) to opcodes in requests conforming to the ISoL Protocol (e.g., Intel UPI RdCur). The first entity, optionally via the RPU, may further perform other translations, such as translations between messages conforming to the CXL-based protocol and protocol data units (PDUs) conforming to the ISoL Protocol, Tag translations, traffic class (TC) translations, and/or cross-field translations, wherein the first entity, optionally via the RPU, may maintain tracking between Tags associated with the CXL-based protocol and Tags associated with the ISoL protocol, such as in order to associate responses with their corresponding requests.

FIG. 22B illustrates an example of a TFD demonstrating translations between CXL.mem traffic and ISoL traffic, such as ICPIP (e.g., Intel UPI) traffic. The translations may be performed by a first entity (Entity.1), such as a first processor (Processor.1), a first node controller (Node Controller.1), or a semiconductor device, optionally via an RPU. The CXL-based protocol may be utilized for communicating with a third entity (Entity.3), such as a host, and the ISoL protocol may be utilized for communicating with a second entity (Entity.2), such as a second processor (Processor.2), or a second node controller (Node Controller.2). The second entity may be coupled to a memory, such as DRAM, which may be mapped to a physical address space (PAS) utilized by the first entity. The third entity may initiate a CXL transaction that may include a CXL.mem M2S Req comprising MemOpcode(MemRd*), Tag(p.2.1), and Address(AS.2.1). The first entity, optionally via the RPU, may translate the CXL transaction to an ISoL (e.g., ICPIP) transaction, such as an Intel UPI transaction that may include a UPI request (REQ message class) comprising Opc(RdCur), Address(AS.1.1), and Request-Transaction-Identifier(q.1.1), wherein the Request-Transaction-Identifier (e.g., RTID) may denote a Tag, a transaction Tag, a transaction identifier, or another field or set of fields carried in UPI transactions which may serve to associate responses with their corresponding requests.

The first entity (Entity.1) may send the UPI request (REQ) to the second entity. Upon receiving a response from the second entity, that may include a UPI data response (“RSP-Data” message class, which may also be denoted by “RSP4-Data”) comprising Opc(DataSI), Request-Transaction-Identifier(q.1.1), and *Data*, the first entity, optionally via the RPU, may translate the UPI response (RSP-Data) to a CXL.mem S2M DRS comprising Opcode(MemData), Tag(p.2.1), and Data(*Data*). In some examples, the requested data may be provided by a processor cache instead of by the memory, such as where the requested data may be provided by an LLC that may be included in the first entity, or by an LLC that may be included in the second entity. In other examples, the first entity, optionally via the RPU, may translate the CXL transaction to an ICPIP transaction, such as an Intel UPI transaction, that may include message classes such as REQ, SNP, WB, RSP (such as RSP2 or RSP4), NCB, or NCS, that may include commands, operations, or opcodes (e.g., Opc), such as RdCode, RdCur, RdData, RdInv, RdInvOwn, SnpCode, SnpCur, SnpData, SnpInv, WbMtoS, WcWr, WcWrPtl, DataE, DataSI, or DataM_CmpO.

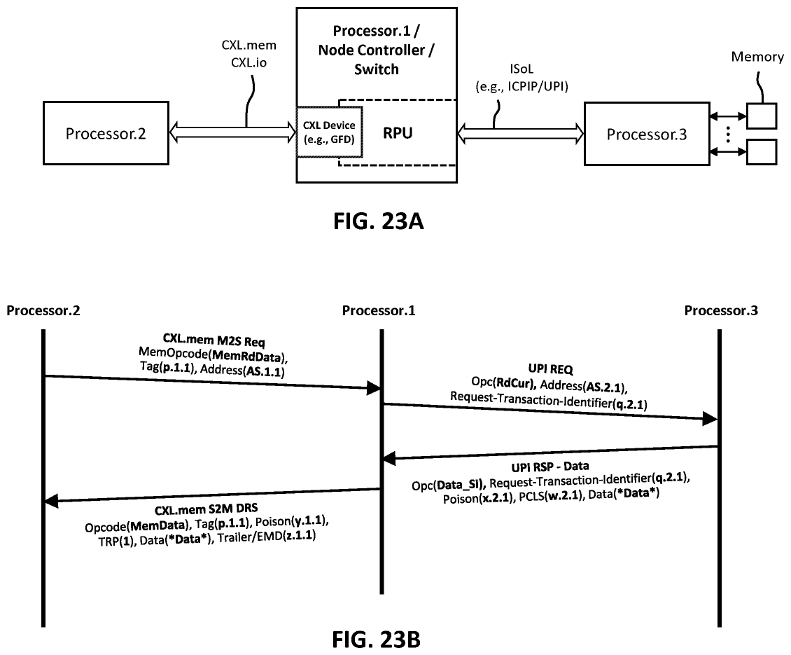

FIG. 23A illustrates an example of a system comprising a first processor (Processor.1), a node controller, or a switch, that may include an RPU and a CXL device, such as a Global Fabric-Attached Memory (G-FAM) Device (GFD), wherein the CXL device may be included in or coupled to the RPU. The first processor may be coupled to a second processor (Processor.2), wherein the first processor may communicate with the second processor, via the CXL device, according to a CXL-based protocol, such as at least one of CXL.mem, CXL.io, or CXL.cache. The first processor may be further coupled to a third processor (Processor.3) that may be coupled to memory, and wherein the first processor may communicate with the third processor according to an ISoL protocol, such as NVIDIA NVLink-C2C, ARM CHI C2C, or Intel Coherent Processor Interconnect Protocol (ICPIP), such as Intel UPI. The first processor, optionally via the RPU, may translate between the CXL-based protocol, such as CXL.mem or CXL.io, and the ISoL protocol, such as ICPIP (e.g., Intel UPI), enabling the second processor to access, via the CXL device, resources coupled to the third processor, such as the memory.

In some examples, the CXL-based protocol, may be associated with a first address space, such as a first Host Physical Address (HPA) space, and the ISoL protocol, such as ICPIP, may be associated with a second address space, such as a System Physical Address (SPA) space or a second Host Physical Address (HPA) space; wherein the first processor, optionally via the RPU, may perform address translations between addresses within the first and second address spaces, respectively, such as between addresses within the first HPA space and addresses within the SPA space or within the second HPA space. In other examples, messages conforming to the CXL-based protocol and messages conforming to the ISoL protocol may be associated with the same physical address space, such as with the same HPA space; wherein the first processor, optionally via the RPU, may perform address translations between addresses within the same address spaces. The first processor, optionally via the RPU, may perform further translations, such as protocol translations, opcode translations, command translations, TLP translations, or translations between messages conforming to the CXL-based protocol and PDUs conforming to the ISoL Protocol, Tag translations, traffic class (TC) translations, and/or cross-field translations; wherein the first processor, optionally via the RPU, may maintain tracking between Tags associated with the CXL-based protocol and Tags associated with the ISoL protocol, such as in order to associate responses with their corresponding requests.

FIG. 23B illustrates an example of a TFD demonstrating translations between CXL.mem and UPI. The illustrated translations are performed by a first processor (Processor.1), a node controller, or a switch, optionally via an RPU, between a CXL-based protocol, such as CXL.io and/or CXL.mem, utilized for communicating with a second processor (Processor.2), and an ISoL protocol, such as ICPIP (e.g., Intel UPI), utilized for communicating with a third processor (Processor.3) that may be coupled to memory, such as DRAM, which may be mapped to a physical address space (PAS) utilized by the first processor. The first processor may utilize translations, such as protocol translations, to convey indications, metadata, and other information, which may be related to the transaction, such as error and data corruption indications, such as poison, status indications, or directory information such as prior cacheline state (PCLS), which may be used to gather performance statistics. The second processor may initiate a CXL transaction that may include a CXL.mem M2S Req comprising MemOpcode(MemRdData), Tag(p.1.1), and Address(AS.1.1). The first processor, optionally via the RPU, may translate the CXL transaction to an ISoL (e.g., ICPIP) transaction, such as an Intel UPI transaction that may include UPI REQ comprising Opc(RdCur), Address(AS.2.1), and Request-Transaction-Identifier RTID(q.2.1), wherein the first processor may send the UPI REQ to the third processor.

Upon receiving a response from the third processor, that may include a UPI RSP-Data comprising Opc(Data_SI), Request-Transaction-Identifier (RTID) (q.2.1), Poison(x.2.1), PCLS(w.2.1) and Data(*Data*), the first processor, optionally via the RPU, may translate the UPI RSP-Data to a CXL.mem S2M DRS comprising Opcode(MemData), Tag(p.1.1), Poison(y.1.1), TRP(1), Data(*Data*), and Trailer/EMD(z.1.1), whereas TRP(1) indicates Trailer Present, i.e., indicating that a trailer is included in the message, wherein the first processor, optionally via the RPU, may utilize the CXL.mem S2M DRS trailer for conveying status information such as the PCLS, optionally as EMD (Extended Metadata) information. Other revisions of the CXL specifications may utilize a Byte-Enables Present (BEP) field instead of the Trailer Present (TRP) field. The first processor, optionally via the RPU, may perform further translations, such as translations of error indications, such as poison, from the ISoL (e.g., ICPIP/UPI) domain, to the CXL-based domain, wherein poison (e.g., a bit in the protocol message or PDU) may indicate that the data contains an error, and may be logged, ignored, or silently discarded, possibly causing Silent Data Corruption (SDC). The first processor, optionally via the RPU, may further perform other translations, such as translations between messages conforming to the CXL-based protocol and PDUs conforming to the ISoL Protocol (e.g., Intel UPI), Tag translations, traffic class (TC) translations, and/or cross-field translations.

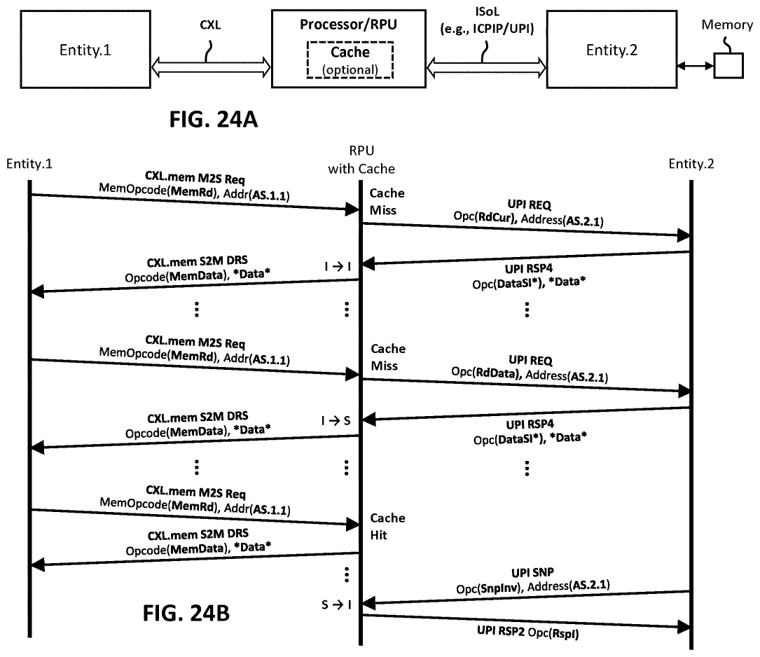

FIG. 24A illustrates an example of a system comprising a processor or an RPU, denoted as Processor/RPU, which may include a cache. The Processor/RPU may be coupled to a first entity (Entity.1), which may be a host, a second processor, a CXL Switch, or a resource consumer, wherein the Processor/RPU may communicate with the first entity according to a CXL-based protocol, such as at least one of CXL.mem, CXL.io, or CXL.cache. The Processor/RPU may be further coupled to a second entity (Entity.2), which may be a third processor, a node controller, or a memory buffer, wherein the second entity may be coupled to a memory, and wherein the Processor/RPU may communicate with the second entity according to an ISoL protocol, such as NVIDIA NVLink-C2C, ARM CHI C2C, or Intel Coherent Processor Interconnect Protocol (ICPIP), such as Intel UPI. The Processor/RPU may translate between the CXL-based protocol, such as at least one of CXL.io, CXL.mem, or CXL.cache, and the ISoL protocol, such as ICPIP, enabling the first entity to access resources coupled to the second entity, such as the memory. The Processor/RPU may cache data retrieved from the second entity and may respond to CXL requests received from the first entity with data from the cache, instead of issuing read requests to the second entity. Additionally or alternatively, the Processor/RPU may prefetch data from the second entity into the cache. The Processor/RPU may perform further translations between the CXL-based domain and the ISoL domain, such as protocol translations, address translations, opcode translations, command translations, TLP translations, and translations between messages conforming to the CXL-based protocol and PDUs conforming to the ISoL Protocol, Tag translations, traffic class (TC) translations, and/or cross-field translations; wherein the Processor/RPU may maintain tracking between Tags associated with the CXL-based protocol and Tags associated with the ISoL protocol, such as in order to associate responses with their corresponding requests.

FIG. 24B illustrates an example of a TFD demonstrating translations performed by a processor or an RPU, denoted as Processor/RPU, that may include a cache, between CXL-based traffic, such as at least one of CXL.io, CXL.mem, or CXL.cache, utilized for communicating with a first entity (Entity.1), and ISoL traffic, such as ICPIP (e.g., Intel UPI), utilized for communicating with a second entity (Entity.2) that may be coupled to memory, such as DRAM, wherein the memory may be mapped to a physical address space (PAS) utilized by the Processor/RPU. The Processor/RPU may translate between the CXL-based domain and the ISoL domain, such as translate between messages conforming to the CXL-based protocol and messages conforming to the ISoL protocol, for example translations between CXL.mem and ICPIP. The TFD illustrates three exemplary transactions between the first entity and the Processor/RPU. The first exemplary transaction may include CXL.mem M2S Req comprising MemOpcode(MemRd) and Address(AS.1.1), wherein the Processor/RPU may translate the request address (AS.1.1) to a translated address (AS.2.1) and may look up the data associated with the address and/or with the translated address in the cache before issuing a UPI request to the second entity. The lookup of the data may result in a cache miss, wherein the Processor/RPU may translate the CXL.mem M2S Req to UPI REQ comprising Opc(RdCur) and Address(AS.2.1), wherein the Processor/RPU may send the UPI REQ to the second entity. Upon receiving a response from the second entity, which may include UPI RSP4 comprising Opc(DataSI*) and *Data*, the Processor/RPU may translate the UPI RSP4 to a CXL.mem S2M DRS comprising Opcode(MemData) and *Data*, without storing the data retrieved from the second entity in the cache, denoted in the drawing by “I-to-I”, indicating that the cache state associated with the cacheline address remains invalid.

The second exemplary transaction may include CXL.mem M2S Req comprising MemOpcode(MemRd) and Address(AS.1.1), referencing the same address as the first exemplary transaction, wherein the Processor/RPU may translate the request address (AS.1.1) to a translated address (AS.2.1) and may look up the data associated with the address and/or with the translated address in the cache before issuing a UPI request to the second entity. The lookup of the data may result in a cache miss, wherein the Processor/RPU may translate the CXL.mem M2S Req to UPI REQ comprising Opc(RdData) and Address(AS.2.1), wherein the Processor/RPU may send the UPI REQ to the second entity. Upon receiving a response from the second entity, which may include UPI RSP4 comprising Opc(DataSI*) and *Data*, the Processor/RPU may translate the UPI RSP4 to a CXL.mem S2M DRS comprising Opcode(MemData) and *Data*, and may store the data retrieved from the second entity in the cache, denoted in the drawing by “I-to-S”, indicating that the cache state associated with the cacheline address transitioned from invalid to shared, possibly indicating that the cacheline data is shared between the Processor/RPU and the second entity.

The third exemplary transaction may include CXL.mem M2S Req comprising MemOpcode(MemRd) and Address(AS.1.1), referencing the same address as the first and the second transaction, wherein the Processor/RPU may translate the request address (AS.1.1) to a translated address (AS.2.1) and may look up the data associated with the address and/or with the translated address in the cache before issuing a UPI request to the second entity. The lookup of the data may result in a cache hit, wherein the Processor/RPU may respond to the request from the first entity with CXL.mem S2M DRS comprising Opcode(MemData) and *Data* from the cache, without sending a translated UPI REQ to the second entity. Following the third transaction, the second entity may invalidate the cacheline address (AS.2.1) associated with the UPI domain, which may be stored in the Processor/RPU cache. The second entity may send to the Processor/RPU a UPI SNP comprising Opc(SnpInv) and Address(AS.2.1), wherein the Processor/RPU may respond to the UPI SNP by sending to the second entity a UPI RSP (e.g., UPI RSP2) comprising Opc(RspI), indicating that the Processor/RPU invalidated the associated cacheline address from the cache, denoted in the drawing by “S-to-I”, indicating that the cache state associated with the cacheline address transitioned from shared to invalid.

In some examples, the Processor/RPU may perform cache lookups before performing translations related to the CXL request received from the first entity, or may perform cache lookups after performing some or all of the translations related to the CXL request received from the first entity. In some examples, the Processor/RPU may be further organize the cache and perform cache lookups according to addresses associated with the CXL-based domain (e.g., CXL.mem domain). Additionally or alternatively, the Processor/RPU may be further organize the cache and perform cache lookups according to translated addresses associated with the ISoL domain (e.g., UPI domain).

In AI inference systems, accelerators such as GPUs or TPUs may generate and consume large volumes of inference context data, including key-value (KV) cache data, model weight parameters, activation tensors, and embedding vectors. When the volume of inference context data exceeds the capacity of the accelerator's local memory, such as HBM, the data may be staged to external memory resources that provide larger capacity at lower cost, such as CXL memory devices, CXL memory pools, or GFDs. In environments where accelerators are coupled via a UALink switch and the CXL memory devices are accessible via CXL.mem, an RPU may translate between UPLI and CXL.mem to enable the accelerators to migrate inference context data between their local memory and the CXL memory devices across the UALink and CXL protocol domain boundaries. The accelerator may initiate migration by sending UPLI requests to the RPU via the UALink switch, and the RPU may translate these requests to CXL.mem M2S requests targeting the CXL memory device. The migration may be bidirectional: the accelerator may write inference context data to the CXL memory device when evicting data from local memory, and may read inference context data from the CXL memory device when the data is needed for active computation. The RPU may perform address translations between address spaces utilized by the UALink domain and the CXL domain, such as between NPA or SPA addresses and HPA addresses, and may further perform Tag and opcode translations between UPLI and CXL.mem message formats.

In various implementations, a method for migrating inference context data across protocol domain boundaries, comprising: sending, by an accelerator coupled to an Ultra Accelerator Link (UALink) switch, a UALink Protocol Level Interface (UPLI) request via the UALink switch to a resource provisioning unit (RPU), the UPLI request associated with the inference context data stored in a local memory of the accelerator, the UPLI request comprising a first physical address; translating, by the RPU, the UPLI request to a Compute Express Link (CXL) CXL.mem Master-to-Subordinate (M2S) request comprising a second physical address; and sending, by the RPU, the CXL.mem M2S request to a CXL memory device; wherein the inference context data is migrated between the local memory of the accelerator and the CXL memory device across a UALink protocol domain and a CXL protocol domain. The method may be utilized in AI inference systems where accelerator working memory, such as HBM, is insufficient to retain all inference context data simultaneously. The RPU may translate between UPLI and CXL.mem including translations of opcodes, commands, addresses, Tags, and additional fields. The migration may be performed by the accelerator without host intervention, such as when the accelerator determines that certain inference context data is no longer actively needed and may be offloaded to a lower-cost memory tier. Alternatively, the migration may be coordinated by a host or a scheduler that directs the accelerator to evict or fetch specific data. The UPLI request may include a write command when data is being evicted from local memory to the CXL memory device, carrying the inference context data on the UPLI Originator Data Channel. The UPLI request may alternatively comprise a read command when data is being fetched from the CXL memory device to local memory, in which case the data is returned via the CXL.mem S2M data response path and translated to a UPLI read response. The method may be implemented in hardware, firmware, software, or combinations thereof, and may be performed by various types of devices, such as a processor, a switch, a bridge, an RPU, or a semiconductor device.

In some implementations of the method, the inference context data comprises key-value (KV) cache data generated during attention computation in a transformer-based inference model, the KV cache data comprising key tensors and value tensors associated with one or more attention layers of the transformer-based inference model. The KV cache data may grow proportionally to the sequence length and the number of attention layers. As context lengths increase, the KV cache may consume a substantial portion of accelerator HBM, motivating migration of less-recently-accessed KV cache entries to CXL memory.

In some implementations of the method, the transformer-based inference model utilizes at least one of: (i) grouped query attention (GQA) wherein a plurality of query heads share a reduced number of key-value heads, or (ii) multi-latent attention (MLA) wherein the key tensors and the value tensors are compressed into a low-rank latent representation; and wherein the KV cache data corresponds to the reduced number of key-value heads or to the low-rank latent representation, respectively. GQA may reduce KV cache size by sharing key-value heads across multiple query heads, as utilized in models such as Llama. MLA may further compress the KV cache by projecting key and value tensors into a lower-dimensional latent space, as utilized in models such as DeepSeek. The reduced KV cache size per token may affect staging granularity and transfer efficiency.

In some implementations of the method, the inference context data comprises at least one of: model weight parameters, activation tensors generated during inference computation, or embedding vectors associated with an input sequence. Model weight parameters may be staged when different models or model components are loaded on demand, such as in multi-tenant serving or model-switching scenarios. Activation tensors may be checkpointed to CXL memory during long inference sequences. Embedding vectors, such as token embeddings or positional embeddings, may be pre-staged from CXL memory before inference begins.

In some implementations of the method, the accelerator executes a mixture-of-experts (MoE) inference model comprising a gating network and expert sub-networks, and wherein the inference context data comprises weight parameters of at least one expert sub-network of the expert sub-networks; and wherein the UPLI request is sent based on a routing decision of the gating network indicating that the at least one expert sub-network is to be activated or deactivated. In MoE models, only a subset of expert sub-networks may be active for any given input token. Inactive expert weights may be offloaded to CXL memory to free accelerator HBM capacity, and activated expert weights may be fetched from CXL memory when the gating network routes tokens to those experts. This dynamic staging may enable serving MoE models that are larger than the available HBM capacity.

In some implementations, the method further comprises sending, by the accelerator, a second UPLI request comprising a read command and a third physical address via the UALink switch to the RPU; translating, by the RPU, the second UPLI request to a second CXL.mem M2S request comprising a fourth physical address; sending, by the RPU, the second CXL.mem M2S request to the CXL memory device; receiving, by the RPU, a CXL.mem Subordinate-to-Master Data Response (S2M DRS) comprising second inference context data from the CXL memory device; translating, by the RPU, the CXL.mem S2M DRS to a UPLI read response (RdRsp) comprising the second inference context data; and sending, by the RPU, the UPLI RdRsp to the accelerator via the UALink switch; wherein the second inference context data is stored in the local memory of the accelerator. The fetch direction may be utilized when inference context data that was previously offloaded to the CXL memory device is needed again for active computation. The RPU may translate the CXL.mem S2M DRS, including by translating the Tag back to the original UPLI ReqTag and formatting the data as UPLI RdRspData. In some examples, the RPU may accumulate data from CXL.mem S2M DRS messages before sending a UPLI RdRsp, such as when the CXL.mem cacheline size differs from the UPLI transfer size.

In some implementations of the method, the CXL memory device comprises a Global Fabric-Attached Memory Device (GFD), the local memory comprises at least one of high-bandwidth memory (HBM) or High-Bandwidth Flash (HBF), the first physical address refers to a Network Physical Address (NPA) or a System Physical Address (SPA), and the second physical address refers to a Host Physical Address (HPA); and wherein the translating comprises translating the first physical address to the second physical address. The GFD may provide large-capacity memory accessible by both accelerators via the RPU and hosts via direct CXL.mem access. The address translation between NPA or SPA and HPA may be performed utilizing lookup tables, base-and-offset calculations, or programmable translation functions within the RPU.

In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In AI inference systems, a host such as a CPU may orchestrate the staging of inference context data between CXL memory devices and accelerators that reside in the UALink domain. The host may read inference context data from a CXL memory device via CXL.mem and write the data to an accelerator by sending a CXL.mem M2S request to an RPU, which translates the request to a UPLI request and forwards it to the accelerator via a UALink port. This host-initiated staging may be utilized in scenarios where the host manages a tiered memory hierarchy, determines which inference context data to pre-stage to accelerators based on scheduling policies, inference request queues, or predicted workload patterns, and coordinates data movement between the CXL and UALink protocol domains. The host may also orchestrate reading inference context data from accelerators via the RPU and writing it to CXL memory devices for longer-term retention. This bidirectional host-orchestrated staging may support a variety of inference architectures and model types, including transformer models with large KV caches, mixture-of-experts models with dynamic expert activation, disaggregated prefill and decode architectures, speculative decoding, hybrid attention and state-space models, multimodal models, and retrieval-augmented generation pipelines. In each case, the CXL memory device may serve as an intermediate staging area that bridges the capacity gap between accelerator working memory and the volume of inference context data associated with the workload.

In various implementations, a method for staging inference context data across protocol domain boundaries, comprising: reading, by a host, inference context data from a Compute Express Link (CXL) memory device via CXL.mem; sending, by the host, a CXL.mem Master-to-Subordinate (M2S) request to a resource provisioning unit (RPU), the CXL.mem M2S request associated with the inference context data and comprising a first physical address; translating, by the RPU, the CXL.mem M2S request to an Ultra Accelerator Link (UALink) Protocol Level Interface (UPLI) request comprising a second physical address; and sending, by the RPU, the UPLI request to an accelerator via a UALink port; wherein the inference context data is staged from the CXL memory device to a local memory of the accelerator across a CXL protocol domain and a UALink protocol domain. The host-initiated staging may enable the host to manage a tiered memory hierarchy comprising accelerator local memory as a working memory tier, host memory as an intermediate tier, and CXL memory devices as a capacity tier. The host may determine which inference context data to stage based on scheduling policies, inference request queues, or predictions about upcoming workload requirements. The RPU may be a discrete component, an IP block embedded in an accelerator, or a chiplet within an IC package. The CXL.mem M2S request may include a write command carrying the inference context data, and the translated UPLI request may carry the data on the UPLI Originator Data Channel to the accelerator. The RPU may perform address translations between HPA addresses utilized by the host and NPA or SPA addresses utilized by the UALink domain, and may further perform Tag and opcode translations between CXL.mem and UPLI message formats. The host may access the CXL memory device via CXL.mem without translation, and may access the accelerator via the RPU that translates between CXL.mem and UPLI. The method may be implemented in hardware, firmware, software, or combinations thereof.

In some implementations, the method further comprises reading, by the host, second inference context data from the accelerator, wherein the reading comprises the host sending a second CXL.mem M2S request to the RPU, the RPU translating the second CXL.mem M2S request to a second UPLI request comprising a read command and sending the second UPLI request to the accelerator via the UALink port, the RPU receiving a UPLI read response (RdRsp) comprising the second inference context data from the accelerator, and the RPU returning the second inference context data to the host; and writing, by the host, the second inference context data to the CXL memory device via CXL.mem. This direction may enable the host to evict inference context data from accelerator local memory to the CXL memory device when the data is no longer actively needed or when the local memory capacity is exceeded. The host may coordinate both staging and eviction to maintain a working set of inference context data in accelerator local memory that matches the current workload.

In some implementations of the method, the accelerator executes a mixture-of-experts (MoE) inference model comprising a gating network and expert sub-networks, and the second inference context data comprises weight parameters of an inactive expert sub-network of the expert sub-networks, the inactive expert sub-network identified based on a routing decision of the gating network. Evicting inactive expert weights to CXL memory may free accelerator HBM capacity for the active experts, enabling the system to serve MoE models whose total expert weight parameters exceed the HBM capacity.

In some implementations of the method, the second inference context data comprises key-value (KV) cache entries that have been evicted from the local memory of the accelerator based on at least one of: an access frequency, an access recency, or the KV cache entries exceeding a capacity of the local memory. Long-context inference models may generate KV cache entries that exceed the accelerator HBM capacity. Eviction policies based on access frequency or recency may retain the most relevant KV cache entries in HBM while offloading less-accessed entries to CXL memory for potential later retrieval.

In some implementations of the method, the inference context data comprises key-value (KV) cache data associated with a transformer-based inference model, and wherein the host stages the KV cache data from the CXL memory device to the local memory of the accelerator based on a scheduled inference request or a predicted inference request. The host may maintain a scheduling queue of inference requests and may pre-stage KV cache data associated with upcoming requests to reduce latency when the request is dispatched to the accelerator. Prediction of upcoming requests may be based on session affinity, user activity patterns, or model serving policies.

In some implementations of the method, the accelerator comprises a decode accelerator, the inference context data comprises key-value (KV) cache data generated during a prefill phase of an inference operation by a prefill accelerator, and the KV cache data is staged from the CXL memory device to the local memory of the decode accelerator for use in a decode phase of the inference operation; and wherein the CXL memory device serves as an intermediate storage between the prefill accelerator and the decode accelerator. In disaggregated inference architectures, the prefill phase and the decode phase may be performed by different accelerators to optimize resource utilization. The prefill accelerator may write the generated KV cache data to the CXL memory device, and the host may subsequently stage the KV cache data from the CXL memory device to the decode accelerator. The CXL memory device may thus serve as a shared staging area that decouples the prefill and decode phases across protocol domain boundaries.

In some implementations of the method, the accelerator performs speculative decoding comprising a draft model generating candidate token sequences and a verification model accepting or rejecting the candidate token sequences, and wherein the inference context data comprises at least one of: draft model weight parameters, draft model KV cache data, or verification context data associated with the speculative decoding. Speculative decoding may utilize a smaller draft model to generate candidate tokens that a larger verification model subsequently accepts or rejects. The draft model weight parameters or the draft model KV cache data may be staged from CXL memory to accelerator HBM when speculative decoding is activated for a given inference session.

In some implementations of the method, the inference context data comprises state data associated with a hybrid inference model, the hybrid inference model comprising attention layers that generate key-value (KV) cache data and state-space model layers that maintain recurrent state vectors; and wherein the staging comprises staging at least one of the KV cache data or the recurrent state vectors from the CXL memory device to the local memory of the accelerator. Hybrid models, such as those combining attention layers with Mamba-style state-space model (SSM) layers, may maintain both KV cache data for attention layers and recurrent state vectors for SSM layers. The staging may include both data types, which may have different sizes, access patterns, and staging priorities.

In some implementations of the method, the inference context data comprises visual embeddings generated by an image encoder or a video encoder of a multimodal inference model; and wherein the staging comprises staging the visual embeddings from the CXL memory device to the local memory of the accelerator for processing alongside text token embeddings by the multimodal inference model. Multimodal inference models may process both visual and textual inputs. Visual embeddings generated by an image or video encoder may be large and may be pre-computed and stored in CXL memory, then staged to the accelerator when a multimodal inference request is dispatched.

In some implementations of the method, the inference context data comprises pre-computed embeddings associated with retrieved documents in a retrieval-augmented generation (RAG) pipeline; and wherein the staging comprises staging the pre-computed embeddings from the CXL memory device to the local memory of the accelerator for concatenation with an input query during inference. In RAG pipelines, retrieved document embeddings may be pre-computed and stored in the CXL memory device as a large-capacity embedding store. When a query triggers retrieval, the relevant embeddings may be staged from the CXL memory device to the accelerator for concatenation with the query tokens before the generation phase.

In some implementations of the method, the inference context data comprises key-value (KV) cache entries associated with token positions in an input sequence, and the staging comprises staging a subset of the KV cache entries from the CXL memory device to the local memory of the accelerator, the subset selected based on the token positions being predicted to be accessed during a subsequent inference step; and wherein remaining KV cache entries associated with remaining token positions are retained in the CXL memory device. For long-context inference, the host may stage only the KV cache entries associated with token positions predicted to be attended during the next decoding step, retaining the remaining entries in CXL memory. This selective staging may reduce transfer volume and accelerator memory pressure while maintaining the full context available for on-demand retrieval.

In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In AI inference deployments, a system may include a cluster of accelerators coupled via a UALink switch, one or more CXL memory devices providing large-capacity memory, an RPU that translates between UPLI and CXL.mem, and a host that orchestrates workload scheduling and data movement. Such a system may be configured to migrate inference context data between accelerator local memory and the CXL memory devices across the UALink and CXL protocol domain boundaries, enabling the system to serve inference workloads whose aggregate inference context data exceeds the capacity of any single accelerator's local memory. The host may access the CXL memory devices via CXL.mem, while the accelerators access the same CXL memory devices via the RPU that translates between UPLI and CXL.mem. This architecture may support tiered memory management, where inference context data is staged between accelerator HBM, HBF, host memory, and CXL memory based on access patterns, scheduling policies, or memory capacity constraints.

In various implementations, a system comprising: an Ultra Accelerator Link (UALink) switch; accelerators coupled to the UALink switch, each accelerator of the accelerators comprising a local memory; a Compute Express Link (CXL) memory device; a resource provisioning unit (RPU) coupled to the UALink switch and to the CXL memory device, the RPU configured to translate between UALink Protocol Level Interface (UPLI) and CXL.mem; and a host coupled to the CXL memory device via CXL.mem; wherein the system is configured to migrate inference context data between the local memory of at least one accelerator of the accelerators and the CXL memory device across a UALink protocol domain and a CXL protocol domain. The system may enable both accelerator-initiated and host-initiated data migration across the protocol domain boundaries. The accelerators may communicate with one another and with the RPU via the UALink switch utilizing UPLI, while the host may communicate with the CXL memory device utilizing CXL.mem. The RPU may be implemented as a discrete component coupled to the UALink switch, as an IP block embedded within one of the accelerators, or as a chiplet within an IC package. The system may support various inference workloads, and the inference context data may include KV cache data, model weight parameters, activation tensors, embedding vectors, or other data generated or consumed during inference computation. The CXL memory device may include a CXL memory expander, a CXL memory pool, or a GFD.

In some implementations of the system, the at least one accelerator is configured to initiate migration of the inference context data by sending a UPLI request via the UALink switch to the RPU, and the RPU is configured to translate the UPLI request to a CXL.mem M2S request and send the CXL.mem M2S request to the CXL memory device. The accelerator may determine when to migrate inference context data based on local memory capacity utilization, access patterns, or workload scheduling signals received from the host or from other accelerators.

In some implementations of the system, the local memory comprises a first memory tier, the system further comprises host memory coupled to the host, the host memory comprising a second memory tier, and the CXL memory device comprises a third memory tier; and wherein the inference context data is migrated between the first memory tier and the third memory tier based on at least one of: access frequency, access recency, a capacity of the first memory tier, or a scheduling policy of the host. The tiered memory hierarchy may enable the system to retain actively-accessed inference context data in the highest-bandwidth tier (accelerator local memory) while staging less-accessed data to lower-cost, higher-capacity tiers (CXL memory). The second memory tier (host memory) may serve as an intermediate staging buffer.

In some implementations, the system further comprises a second CXL memory device and a CXL fabric coupling the RPU to the CXL memory device and the second CXL memory device; wherein at least one of the CXL memory device or the second CXL memory device comprises at least one of: a CXL memory expander, a CXL memory pool, or a Global Fabric-Attached Memory Device (GFD). The CXL fabric may include one or more CXL switches and may provide connectivity between the RPU and CXL memory devices. The RPU may route translated requests to specific CXL memory devices based on the physical addresses carried in the UPLI requests.

In some implementations of the system, the inference context data comprises key-value (KV) cache data associated with a transformer-based inference model, the local memory comprises high-bandwidth memory (HBM), and the at least one accelerator comprises at least one of: a graphics processing unit (GPU) or a tensor processing unit (TPU). GPUs and TPUs are accelerators commonly utilized for transformer-based inference workloads that generate substantial KV cache data. HBM provides the high-bandwidth, low-latency access needed for active inference computation, while the CXL memory device may provide the additional capacity needed for KV cache entries that are not actively accessed.

In environments where accelerators communicate utilizing NVLink-based protocols, such as GPUs coupled via NVLink or NVSwitches, the accelerators may similarly need to migrate inference context data to CXL memory devices that reside in a different protocol domain. An RPU may translate between NVLink-based protocol messages and CXL.mem messages to enable accelerators in the NVLink domain to stage inference context data to and from CXL memory devices. The RPU may be integrated into an active cable, an NVSwitch, or a discrete bridge device, and may perform address translations between NVLink addresses and CXL.mem addresses, as well as command and Tag translations between the two protocol domains. This NVLink-to-CXL.mem translation path may enable heterogeneous computing environments where different clusters of accelerators utilize different interconnect protocols while sharing access to common CXL memory resources.

In various implementations, a method for migrating inference context data across protocol domain boundaries, comprising: sending, by an accelerator, a request conforming to an NVLink-based protocol to a resource provisioning unit (RPU), the request associated with the inference context data stored in a local memory of the accelerator, the request comprising a first physical address; translating, by the RPU, the request to a Compute Express Link (CXL) CXL.mem Master-to-Subordinate (M2S) request comprising a second physical address; and sending, by the RPU, the CXL.mem M2S request to a CXL memory device; wherein the inference context data is migrated between the local memory of the accelerator and the CXL memory device across an NVLink protocol domain and a CXL protocol domain. The method may enable accelerators communicating according to an NVLink-based protocol to access CXL memory resources for staging inference context data. The RPU may translate between NVLink-based protocol messages and CXL.mem messages, including translations of addresses, commands, and identifiers. The first physical address may be an NVLink Network Address, and the second physical address may be an HPA utilized by the CXL memory device. The RPU may be integrated into an active cable, an NVSwitch, or a discrete bridge device. In some examples, the RPU may be positioned closer to the CXL port to optimize signal integrity, since CXL runs over PCIe electricals designed for shorter-reach connectivity while NVLink may incorporate signaling characteristics compatible with longer-reach interconnects.

In some implementations of the method, the accelerator is coupled to the RPU via an NVLink switch (NVSwitch), and the request conforming to the NVLink-based protocol is sent via the NVSwitch to the RPU. The NVSwitch may route the NVLink-based request from the accelerator to the RPU based on routing information carried in the request. The NVSwitch may couple accelerators to the RPU, enabling accelerators within the NVLink domain to access the CXL memory device for inference context data staging.

In some implementations of the method, the inference context data comprises key-value (KV) cache data generated during attention computation in a transformer-based inference model, and the local memory comprises high-bandwidth memory (HBM). KV cache data generated by NVLink-coupled accelerators during transformer-based inference may be staged to CXL memory devices when the KV cache exceeds the HBM capacity.

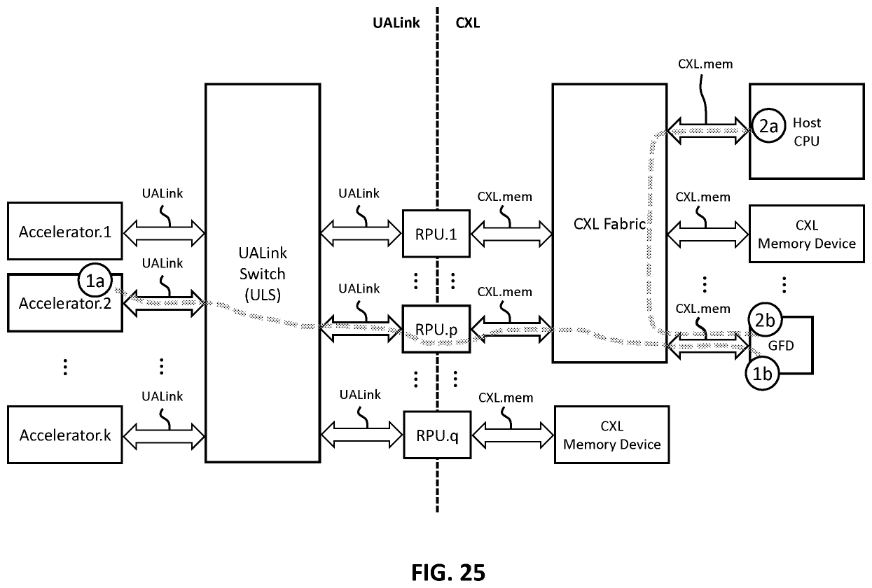

FIG. 25 illustrates an example of a system comprising a cluster of accelerators (e.g., GPUs or TPUs) interconnected by a UALink switch, an RPU coupled to the UALink switch, CXL memory devices coupled to the RPU via a CXL fabric, and a host coupled to the CXL memory devices via CXL.mem. Path 1a to 1b illustrates an accelerator-initiated data migration path. Accelerator.2 sends a UPLI request via the UALink switch to RPU.p. RPU. p translates the UPLI request to a CXL.mem M2S request and sends the CXL.mem M2S request to a GFD via the CXL fabric. The RPU may translate addresses between the UALink address space (e.g., NPA or SPA) and the CXL address space (e.g., HPA), and may translate opcodes, Tags, and additional fields between UPLI and CXL.mem message formats. In the write direction, the accelerator may evict inference context data from its local memory, such as HBM and/or HBF, to the GFD by sending a UPLI write request carrying the data on the Originator Data Channel. In the read direction, the accelerator may fetch inference context data from the GFD by sending a UPLI read request, and the RPU may receive a CXL.mem S2M DRS from the GFD, translate the CXL.mem S2M DRS to a UPLI RdRsp, and return the data to the accelerator via the UALink switch.

Path 2a to 2b illustrates a host-initiated access path. The host accesses the GFD via CXL.mem, without translation by the RPU. The host may read inference context data from the GFD via CXL.mem, and may subsequently write the inference context data to an accelerator by sending a CXL.mem M2S RwD to the RPU, which translates the CXL.mem M2S request to a UPLI request and sends the UPLI request to the accelerator via the UALink switch. Conversely, the host may read inference context data from an accelerator by sending a CXL.mem M2S request to the RPU, which translates the request to a UPLI read request, receives a UPLI RdRsp from the accelerator, and returns the data to the host; the host may then write the data to the GFD via CXL.mem. The host may thus orchestrate bidirectional data staging between the CXL memory devices and the accelerators across the CXL and UALink protocol domain boundaries.

In one example, the host may bring inference context data, such as KV cache data, from storage (e.g., NVMe or remote storage) into a CXL memory device such as the GFD. The accelerator may then fetch the KV cache data from the GFD to its local memory (e.g., HBM and/or HBF) for active inference computation. When the KV cache data is no longer actively accessed, or when the local memory capacity is exceeded, the accelerator may migrate the colder KV cache data from its HBM back to the GFD. In this manner, the system may maintain a tiered memory hierarchy where the accelerator HBM serves as a working memory tier for actively-accessed inference context data, and the CXL memory device serves as a capacity tier for less-frequently-accessed inference context data. The RPU may enable the data migration between these tiers by translating between UPLI and CXL.mem across the protocol domain boundaries.

The CXL memory devices shown in FIG. 25 may include CXL memory expanders, CXL memory pools, or GFDs, and may be coupled to the RPU via the CXL fabric, which may include one or more CXL switches. The RPU may route translated requests to specific CXL memory devices based on the physical addresses carried in the translated CXL.mem M2S requests. The system may support various types of inference context data, including KV cache data associated with transformer-based models, model weight parameters associated with mixture-of-experts models, activation tensors, embedding vectors, and other data generated or consumed during inference computation.

In various implementations, an apparatus comprising: a processor comprising a coherent interconnect, the coherent interconnect couples processing cores to memory controllers that are coupled to memory channels capable of supporting memory having a capacity of at least 64 GB; wherein the processor is configured to utilize physical addresses within a physical address space (PAS) to access the memory, and to execute an operating system (OS) that utilizes a virtual address space; a memory management unit (MMU) configured to enable the OS to access the memory, based on mapping addresses within the virtual address space to physical addresses within the PAS; a resource provisioning unit (RPU) comprising an Ultra Accelerator Link-based port (UALink-based port) configured to communicate with an entity coupled to the apparatus according to a UALink-based protocol; and wherein the RPU is further coupled to the coherent interconnect and configured to translate physical addresses associated with the UALink-based protocol to physical addresses within the PAS; whereby the physical address translations enable the entity to access the memory via the UALink-based port, the coherent interconnect, and the memory controllers. The address translations between the physical addresses may enable isolation between different address domains while allowing controlled access to system resources. The translation logic may support various mapping schemes including offset-based translation, page-table-based translation, or range-based translation. The RPU may include translation lookaside buffers (TLBs) or other caching mechanisms to optimize translation performance for frequently accessed address ranges.

In some implementations of the apparatus, the UALink-based protocol conforms to UALink Protocol Level Interface (UPLI), the physical addresses associated with the UPLI comprise network physical addresses (NPAs), and the physical addresses within the PAS comprise system physical addresses (SPAs) or host physical addresses (HPAs). Global or a flat addressing model may be utilized, wherein an address space may include addresses that may be utilized for accessing memory within a system domain, and may also include addresses associated with UPLI that may be utilized for accessing memory in different system domains, wherein physical address translations may be performed between physical addresses within that single address space. Alternatively, implementations may utilize physical address spaces, such as NPA spaces (wherein NPAs may be utilized for accessing memory in different system domains) and SPA spaces (wherein SPAs may be utilized for accessing memory within a system domain), wherein physical address translations may be performed from NPAs to SPAs. In some examples, the NPAs may represent addresses within a global or a flat UALink network address space that may span multiple nodes or devices, or may represent addresses within a destination UALink Accelerator referenced by a destination identifier in UPLI. SPAs or HPAs (an implementation choice) may represent the local addressing scheme utilized by the processor or by the system node (SN). The translation from NPAs to SPAs/HPAs may include routing information extraction, node identifier processing, and/or address offset calculations to map fabric-side addresses to local memory locations.

In some implementations of the apparatus, The apparatus of claim 1, wherein, in addition to the physical address translations, the RPU is further configured to translate between first fields conforming to UALink-based protocol message formats, and second fields conforming to message formats of a protocol utilized by the coherent interconnect.

In some implementations of the apparatus, the protocol utilized by the coherent interconnect is based on Coherent Hub Interface (CHI-based protocol), and the RPU is further configured to translate read requests corresponding to the UALink-based protocol to requests corresponding to the CHI-based protocol carrying ReadOnce for non-cacheable data access or ReadShared for cacheable data access. The selection between ReadOnce and ReadShared may be determined by cache allocation hints, memory region attributes, or explicit indicators in the UPLI request. The RPU may additionally translate UPLI write requests to other CHI write opcodes based on write granularity and coherency requirements. The translation may preserve transaction ordering by utilizing CHI's ordering rules and potentially implementing additional ordering enforcement logic when UALink ordering requirements exceed those provided by CHI.

In some implementations of the apparatus, the protocol utilized by the coherent interconnect is based on an Intel Coherent Processor Interconnect Protocol (ICPIP-based protocol) for scalable multiprocessors with a shared physical address space, and wherein the RPU is further configured to translate read requests corresponding to the UALink-based protocol to requests corresponding to the ICPIP-based protocol carrying RdCur opcodes, and maintain coherency state information for physical addresses within the PAS that are associated with the coherent interconnect. When the coherent interconnect is based on UPI protocol, the coherency state information maintained by the RPU may include caching states or similar cache coherency states. Examples of ICPIP include Intel's QPI, UPI, and future Intel's Coherent Processor Interconnect Protocols. The translation to ICPIP RdCur opcodes, such as UPI RdCur opcodes, may be accompanied by snoop responses handling when the requested data exists in other processor caches. The RPU may include state tracking mechanisms to optimize subsequent accesses to the same cachelines.

In some implementations of the apparatus, the protocol utilized by the coherent interconnect is based on Infinity Fabric protocol (IF-based protocol); and wherein the RPU is further configured to translate write requests corresponding to the UALink-based protocol to write commands corresponding to the IF-based protocol while preserving write ordering required by the entity. The preservation of write ordering may include tracking write dependencies and enforcing completion ordering as specified by the UALink memory model. The RPU may translate UPLI write requests that include Byte Enables (which indicate partial writes) to appropriate Infinity Fabric write command types while maintaining producer-consumer ordering relationships. For example, the UPLI 64-bit byte enable field (OrigDataByteEn), which allows for individual bytes within a data beat to written or not in a write transfer, may be translated by the RPU to the appropriate Infinity Fabric write command type.

In some implementations of the apparatus, the RPU is further configured to translate a request corresponding to the UALink-based protocol to at least one message corresponding to the protocol utilized by the coherent interconnect; and wherein the at least one message causes prefetch to a cache of the processor. The RPU may translate UPLI requests, such as UPLI prefetch hints that may be carried in vendor-defined commands, to messages of a protocol utilized by the coherent interconnect that effectively prefetch data into a cache of the processor, such as LLC Prefetch RFO (LlcPrefRFO), LLC Prefetch Code (LlcPrefCode), or LLC Prefetch Data (LlcPrefData) opcodes of a protocol based on Intra-Die Interconnect (IDI), which is the protocol used by some Intel processor cores.

In some implementations of the apparatus, the RPU is further configured to: translate Tags associated with transactions corresponding to the UALink-based protocol to Tags utilized by the coherent interconnect, and maintain a mapping between the Tags associated with the transactions and the Tags utilized by the coherent interconnect. The Tag translation logic may accommodate different Tag formats and sizes between the UPLI and coherent interconnect domains. Tags may be used to identify a transaction, such as when supporting outstanding requests in-flight through the RPU, or may be used to convey properties associated with messages or transactions, such as trace Tags used for debugging and performance measurements, or authorization Tags used for security. Tags may be referenced by different names in different examples, such as by the name Transaction Identifier (TxnID) in some ARM CHI implementations. The mapping between UPLI Tags and coherent interconnect Tags may include using on-silicon SRAM, content-addressable memory (CAM) or Ternary Content-Addressable Memory (TCAM) structures, hash tables, or indexed arrays. The RPU may handle Tag exhaustion scenarios by including flow control mechanisms that prevent new transactions when available Tags are depleted.

In some implementations of the apparatus, the RPU is further configured to: maintain a Tag allocation table to track outstanding transactions from the entity, allocate coherent interconnect Tags from a pool of available Tags upon receiving requests conforming to the UALink-based protocol, and release the Tags upon completion of corresponding transactions. The Tag allocation table may be sized to support the maximum number of outstanding transactions allowed by the UALink specification or by configured limits. The Tag pool management may implement various allocation techniques including round-robin, least-recently-used, or priority-based allocation. The RPU may monitor Tag utilization to detect potential bottlenecks and may include Tag recycling logic to handle long-latency transactions efficiently.

In some implementations of the apparatus, the entity is configured to access the memory utilizing read and write requests conforming to the UALink-based protocol, wherein the read and write requests are translated by the RPU; and the processing cores are configured to access entity-attached resources by issuing coherent interconnect requests that the RPU is further configured to translate to transactions conforming to the UALink-based protocol, wherein the transactions target the entity. The bidirectional access capability may enable various computing paradigms including memory pooling, memory sharing, resource disaggregation, and heterogeneous computing. When processing cores access entity-attached resources, such as High-Bandwidth Memory (HBM) and/or High-Bandwidth Flash (HBF) resources, the RPU may handle different memory attributes, caching policies, and ordering requirements between the two domains. The translation of coherent interconnect requests to transactions conforming to the UALink-based protocol may include protocol-specific adaptations to maintain correctness across domain boundaries.

In some implementations of the apparatus, the entity comprises entity-attached memory; and wherein the RPU is further configured to map a portion of the entity-attached memory into the PAS, enabling the processing cores to access the entity-attached memory utilizing load and store operations. The mapping of entity-attached memory into PAS may include establishing memory windows with specific attributes such as cacheability, write-combining behavior, and/or access permissions. The RPU may support dynamic remapping of entity-attached memory regions based on workload requirements or system configuration changes. The load and store operations from processing cores may be subject to memory ordering rules enforced by both the coherent interconnect and UPLI.

In some implementations of the apparatus, the RPU is further configured to enforce access control by comparing the physical addresses associated with the UALink-based protocol against a set of predetermined allowed address ranges for the entity, and blocking transactions that fall outside the predetermined allowed address ranges. The predetermined allowed address ranges may be configured by privileged software, firmware, or hardware configuration registers. The RPU may support different security contexts with different predetermined allowed address ranges for different entities or different operational modes. The blocking of unauthorized transactions may generate error responses, security exceptions, or logging events for system monitoring and debugging purposes.

In some implementations of the apparatus, the RPU is further configured to apply security filtering based on examination of transaction attributes associated with the UALink-based protocol, which include requester identification and access permissions, and selectively allowing or denying transactions based on preconfigured security policies. The security filtering may examine additional UPLI transaction attributes, such as vendor-defined commands or fields, virtual channel identifiers, traffic classes, or custom security tokens. The preconfigured security policies may be stored in secure storage within the RPU or loaded from trusted system firmware during initialization. The RPU may support dynamic policy updates under appropriate authentication and authorization mechanisms.

In some implementations of the apparatus, the RPU is further configured to: detect sequential access patterns in requests corresponding to the UALink-based protocol which are received from the entity, and issue prefetch requests that are routed via the coherent interconnect and the memory controllers to retrieve data in advance of anticipated entity requests. The prefetch mechanism may utilize various pattern detection algorithms including stride detection, stream detection, or machine learning-based prediction. The RPU may maintain prefetch buffers to store prefetched data and may implement prefetch throttling to prevent memory bandwidth saturation. The prefetch requests may be marked with lower priority than demand requests to minimize interference with the explicit memory accesses.

In some implementations of the apparatus, the memory comprises dynamic random-access memory (DRAM), and the entity comprises a graphics processing unit (GPU) or a central processing unit (CPU) configured to utilize the UALink-based port for accessing the memory; and wherein the RPU enables the entity to access the DRAM with cache-line granularity. An entity, such as a GPU or a CPU, may utilize the UALink port for high-bandwidth memory access to memory resources attached to the processor. Optionally, the cache-line granularity access may align with standard cacheline sizes such as 64 bytes, 128 bytes, or 256 bytes, enabling efficient data transfers between the entity and the DRAM. The RPU may support memory consistency maintenance, which includes coordination between the entity's memory model and the processor's memory model, with the RPU translating between different consistency requirements. The high-bandwidth memory access may be optimized utilizing features such as memory interleaving, bank-aware scheduling, or quality-of-service mechanisms that prioritize latency-sensitive or bandwidth-intensive access patterns from the GPU or CPU entity.

In some implementations of the apparatus, the RPU is further configured to coalesce coherent interconnect transactions targeting contiguous or nearby addresses into fewer requests corresponding to the UALink-based protocol; whereby the coalescing reduces transaction overhead and improves memory bandwidth utilization. The request coalescing may consider factors including address proximity, request types, and timing windows when determining which requests to combine. The RPU may include write combining buffers for write requests and may support read coalescing for sequential read patterns.

In some implementations of the apparatus, the RPU is further configured to utilize an intermediate protocol selected from Peripheral Component Interconnect Express (PCIe) or Compute Express Link (CXL) when translating between the UALink-based protocol and a protocol utilized by the coherent interconnect.

In various implementations, an apparatus comprising: a processor comprising a coherent interconnect, the coherent interconnect couples processing cores to memory controllers that are coupled to memory channels capable of supporting memory having a capacity of at least 64 GB; wherein the processor is configured to utilize physical addresses within a first physical address space (PAS1) to access the memory, and to execute an operating system (OS) that utilizes a virtual address space; a memory management unit (MMU) configured to enable the OS to access the memory, based on mapping addresses within the virtual address space to physical addresses within the PAS1; first and second resource provisioning units (RPUs) comprising first and second respective Ultra Accelerator Link-based ports (UALink-based ports) configured to communicate, according to a UALink-based protocol, with first and second respective entities coupled to the apparatus, whereby the first and second entities utilize second and third respective physical address spaces (PAS2, PAS3); and wherein the first and second RPUs are further coupled to the coherent interconnect; wherein the PAS1, the PAS2, and the PAS3 are different; and whereby the apparatus is capable of enabling the first and second entities to access portions of the memory via the first and second UALink-based ports, the coherent interconnect, and the memory controllers.

In some implementations of the apparatus, the first RPU is configured to translate physical addresses within the PAS2 to physical addresses within the PAS1; and wherein the second RPU is configured to translate physical addresses within the PAS3 to physical addresses within the PAS1; whereby the first and second RPUs enable the first and second entities to access the memory.

In some implementations of the apparatus, the UALink-based protocol conforms to UALink Protocol Level Interface (UPLI); and in addition to the physical address translations, the first and second RPUs are further configured to translate between first fields conforming to the UPLI message formats, and second fields conforming to second message formats of a protocol utilized by the coherent interconnect.

In some implementations of the apparatus, the protocol utilized by the coherent interconnect is based on Coherent Hub Interface (CHI-based protocol), and at least one of the first and second RPUs is further configured to translate UPLI read requests to CHI-based requests carrying ReadOnce for non-cacheable data access or ReadShared for cacheable data access.

In some implementations of the apparatus, the protocol utilized by the coherent interconnect is based on Intel's Coherent Processor Interconnect Protocol (ICPIP-based protocol) for scalable multiprocessors with a shared physical address space, and at least one of the first and second RPUs is further configured to translate read requests corresponding to the UPLI to requests corresponding to the ICPIP-based carrying opcodes based on RdCur.

In some implementations of the apparatus, the protocol utilized by the coherent interconnect is based on Infinity Fabric (IF-based); and wherein at least one of the first and second RPUs is further configured to translate write requests corresponding to the UPLI to write commands corresponding to the IF-based while preserving write ordering required by the respective entity.

In some implementations of the apparatus, at least one of the first and second RPUs is further configured to translate Tags associated with transactions corresponding to the UALink-based protocol to Tags utilized by the coherent interconnect, maintain a mapping between the Tags associated with transactions and the Tags utilized by the coherent interconnect, and translate response Tags associated with the coherent interconnect back to response Tags associated with the UALink-based protocol.

In some implementations of the apparatus, the first RPU maintains a first translation table for mapping addresses within the PAS2 to addresses within the PAS1, and the second RPU maintains a second translation table for mapping addresses within the PAS3 to addresses within the PAS1; wherein the first and second translation tables are different and provide isolation between memory accesses from the first and second entities.

In some implementations of the apparatus, the first RPU is configured to translate addresses within the PAS2 to a first subset of addresses within the PAS1, and the second RPU is configured to translate addresses within the PAS3 to a second subset of addresses within the PAS1, wherein the first and second subsets are non-overlapping.

In some implementations of the apparatus, the first RPU is configured to translate at least some addresses within the PAS2 to a shared subset of addresses within the PAS1, and the second RPU is configured to translate at least some addresses within the PAS3 to the same shared subset of addresses within the PAS1, enabling the first and second entities to access shared memory regions.

In some implementations of the apparatus, the PAS2 has a different size than the PAS3, and wherein the PAS2 and the PAS3 have different sizes than the PAS1; and wherein the first and second RPUs are further configured to dynamically modify the address translations between the PAS2 and the PAS1, and between the PAS3 and the PAS1, based on memory allocation requests or reconfiguration commands.

In various implementations, a method comprising: operating a processor comprising a coherent interconnect that couples processing cores to memory controllers that communicate with memory channels coupled to memory having a capacity of at least 64 GB; utilizing, by the processor, physical addresses within a physical address space (PAS) to access the memory; executing, by the processor, an operating system (OS) that utilizes a virtual address space; mapping addresses within the virtual address space to physical addresses within the PAS, which enables the OS to access the memory; communicating according to a protocol based on Ultra Accelerator Link (UALink-based protocol) with an entity via a UALink-based port; and performing physical address translations from physical addresses associated with the UALink-based protocol to physical addresses within the PAS; whereby the physical address translations enable the entity to access the memory via the UALink-based port, the coherent interconnect, and the memory controllers.

In some implementations of the method, the coherent interconnect utilizes a protocol based on Coherent Hub Interface (CHI-based protocol), and wherein, in addition to performing the physical address translations, further comprising: (a) translating between a first field conforming to the UALink-based protocol message format, and a second field conforming to the CHI-based protocol message format; and (b) translating UALink-based protocol read requests to CHI-based protocol requests carrying ReadOnce for non-cacheable data access or ReadShared for cacheable data access.

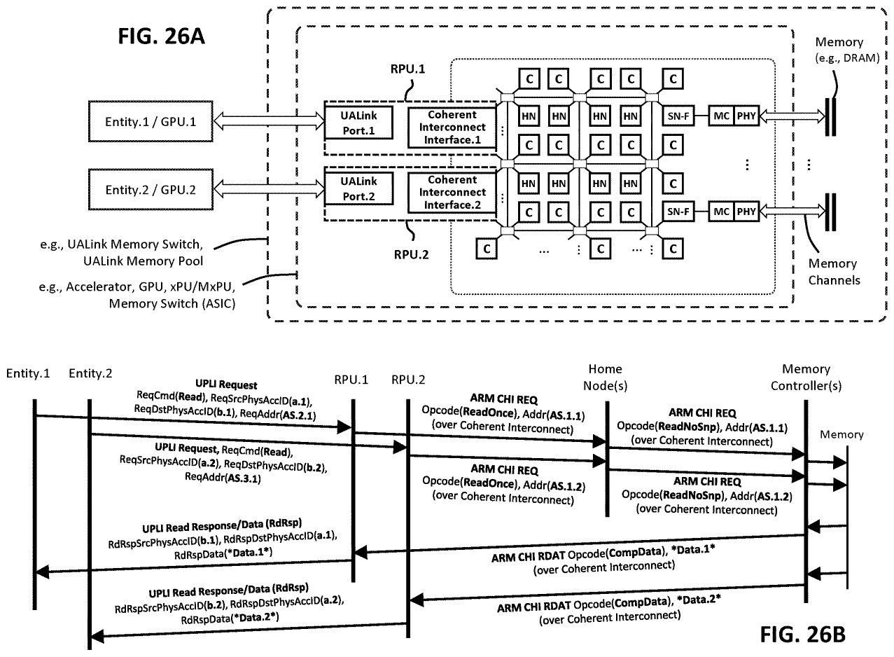

FIG. 26A illustrates an example of a system that may function as a UALink memory switch appliance or a UALink memory pool, and may include an accelerator, GPU, xPU/MxPU, or a memory switch ASIC, that is coupled to two entities denoted as Entity.1/GPU.1 and Entity.2/GPU.2. The accelerator/xPU includes processing cores and memory controllers coupled to a coherent interconnect that may be based on CHI. The accelerator/xPU utilizes translations, performed the RPUs, between UALink-based ports and the coherent interconnect. The first RPU (RPU.1) may enable Entity.1/GPU.1 to access, via the first UALink port and the coherent interconnect, resources mapped to a physical address space utilized by the coherent interconnect, such as memory resources of the accelerator/xPU. Correspondingly, the second RPU (RPU.2) may enable Entity.2/GPU.2 to access, via the second UALink port and the coherent interconnect, resources mapped to a physical address space utilized by the coherent interconnect, such as memory resources of the accelerator/xPU.

FIG. 26B illustrates an example of a TFD depicting a multi-entity memory access scenario wherein first and second entities/GPUs access memory mapped to one or more physical address spaces utilized by the coherent interconnect, through UPLI-to-ARM CHI translations. Entity.1/GPU.1 initiates a first UPLI request (Req) with ReqCmd(Read), ReqSrcPhysAccID(a.1) to identify the source entity, such as an accelerator or a GPU, ReqDstPhysAccID(b.1) to identify the destination entity/accelerator, and ReqAddr(AS.2.1) representing a UPLI request address, such as a network physical address (NPA) from a second physical address space. RPU.1 translates the first UPLI request to ARM CHI REQ carrying Opcode(ReadOnce) and Addr(AS.1.1) from a first physical address space utilized by the coherent interconnect. Concurrently or sequentially, Entity.2/GPU.2 may initiate a second UPLI request (Req) with ReqCmd(Read), ReqSrcPhysAccID(a.2), ReqDstPhysAccID(b.2), and ReqAddr(AS.3.1) representing a UPLI request address, such as a network physical address (NPA) optionally from a third physical address space or from the second physical address space. RPU.2 translates the second UPLI request to ARM CHI REQ carrying Opcode(ReadOnce) and Addr(AS.1.2) from the first physical address space utilized by the coherent interconnect. Both transactions flow through the coherent interconnect to one or more home nodes, which may send respective ARM CHI REQ messages to one or more memory controllers with Opcode(ReadNoSnp) and the addresses Addr(AS.1.1) and Addr(AS.1.2), respectively.

The memory controller(s) retrieve the requested data from the memory and send first and second ARM CHI RDAT messages with Opcode(CompData) carrying *Data.1* and *Data.2*, representing the data retrieved from the addresses AS.1.1 and AS.1.2, respectively. RPU.1 translates the first ARM CHI RDAT message to UPLI read response/data (RdRsp) with RdRspSrcPhysAccID(b.1), RdRspDstPhysAccID(a.1), and RdRspData(*Data.1*) for Entity.1/GPU.1. RPU.2 translates the second ARM CHI RDAT message to UPLI RdRsp with RdRspSrcPhysAccID(b.2), RdRspDstPhysAccID(a.2), and RdRspData(*Data.2*) for Entity.2/GPU.2. The example demonstrates how entities/GPUs may share access to the same memory through different RPUs that perform both translation between UPLI and ARM CHI, and physical address translations. Alternatively, the example may be viewed as two separate UPLI transactions that utilize the same coherent interconnect infrastructure to access the memory, wherein entities such as accelerators/GPUs may access the memory via a shared or a separate address space that may be translated to a shared coherent interconnect physical address space. Still alternatively, the response and read data paths may be implemented according to other designs, such as wherein the memory controller(s) may send the data to the home node(s) that send it to the respective RPUs, or the home node(s) send responses to the RPUs while the memory controller(s) send the data to the RPUs.

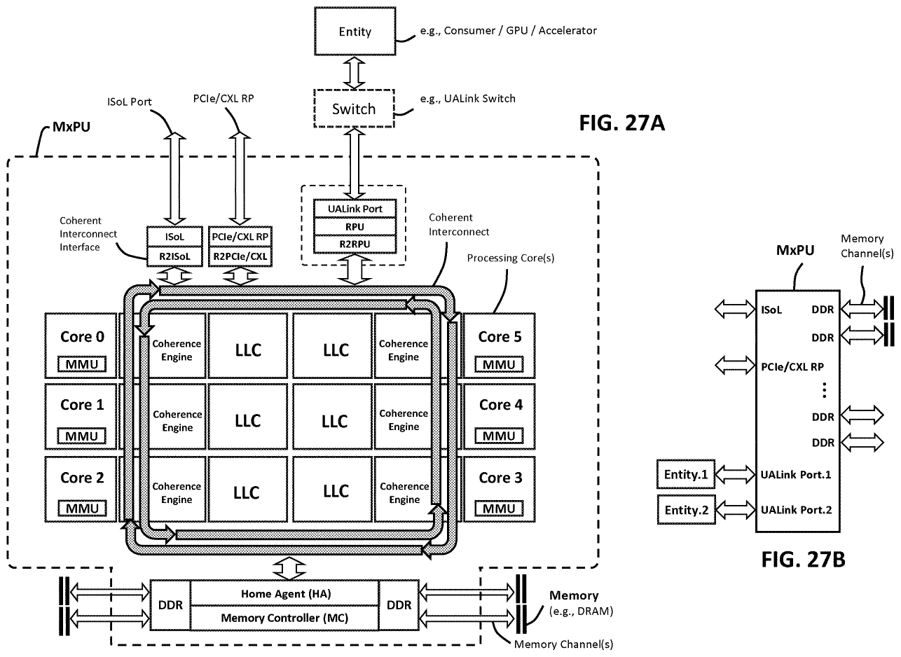

FIG. 27A illustrates an example of a system comprising a processor (such as an MxPU that may be derived from an established processor design) comprising processing cores, last level cache (LLC), and a coherent interconnect utilizing a topology structure of a ring. Alternatively, the coherent interconnect may utilize other topology structures such as a mesh, a crossbar, or a custom topology. The MxPU may include a UALink port, an ISoL port such as AMD Infinity Fabric, ARM CHI C2C, NVIDIA NVLink-C2C, or Intel UPI. The MxPU may further include a PCIe/CXL root port (PCIe/CXL RP), and may be coupled to memory, such as DRAM, optionally via a memory controller and memory channels. The UALink port may communicate with an entity, such as a GPU or a CPU, optionally via a switch, according to UPLI, wherein an RPU may perform physical address translations that may enable the entity to access the memory via the UALink port. The illustrated RPU is coupled to the on-chip ring interconnect via a coherent interconnect interface, such as a Ring-to-RPU (R2RPU). Alternatively, the RPU may be coupled to the on-chip ring interconnect essentially directly. Similarly, the illustrated ISoL port is coupled to the on-chip ring interconnect via a coherent interconnect interface, such as a Ring-to-ISoL (R2ISoL), and the PCIe/CXL root port (RP) is coupled to the on-chip ring interconnect via a coherent interconnect interface, such as a Ring-to-PCIe/CXL (R2PCIe/CXL). The MxPU may be implemented as a monolithic die, as chiplets within an IC package, such as by utilizing separate compute die(s) and I/O die(s), or as components on a board.

FIG. 27B illustrates an example of a system comprising a processor (such as an MxPU) comprising UALink ports, DDR channels, at least one optional PCIe/CXL RP, and at least one optional ISoL. The UALink ports may not share the same physical address space, may be coupled to entities, optionally via a switch, and may communicate with the entities according to UPLI.

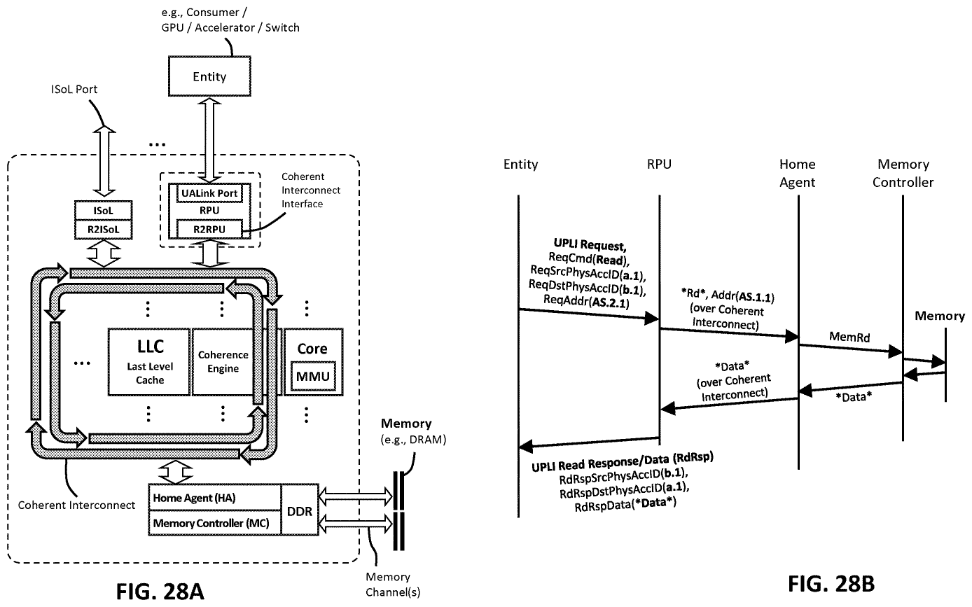

FIG. 28A illustrates an example of a system comprising a processor (such as an MxPU that may be derived from an established processor design) comprising processing cores, caches, and a coherent interconnect utilizing a topology structure of a ring. Alternatively, the coherent interconnect may utilize other topology structures such as a mesh, a crossbar, or a custom topology. The processor may further include an ISoL port such as ARM CHI C2C or Intel UPI, and a memory controller optionally coupled via memory channels to memory, such as DRAM. The processor may include a UALink port that may communicate with an entity such as a GPU or accelerator, according to UPLI, wherein an RPU may perform physical address translations to enable the entity to access the memory. The illustrated RPU is coupled to the coherent interconnect via a Ring-to-RPU (R2RPU) coherent interconnect interface. Alternatively, the RPU may be coupled to the on-chip ring interconnect essentially directly. Similarly, the illustrated ISoL port is coupled to the on-chip ring interconnect via a Ring-to-ISoL (R2ISoL) coherent interconnect interface. The processor may be implemented as a monolithic die, as chiplets within an IC package, such as by utilizing separate compute die(s) and I/O die(s), or as components on a board.

FIG. 28B illustrates an example of a TFD demonstrating a UPLI request (Req) received from an entity, such as a GPU or an accelerator, wherein the RPU may translate a physical address (AS.2.1) carried in the UPLI request, to a physical address (AS.1.1) utilized for accessing the memory. The RPU may perform further translations, such as protocol translations from UPLI to a protocol utilized by the processor's coherent interconnect, and may further send the optionally translated request to a home agent (also known as home node), and/or to a memory controller, requesting the read of address (AS.1.1). In some examples, the requested data may be provided by a processor cache, such as by an LLC, instead of being provided by the memory. The data may then return over the processor's coherent interconnect to the RPU, wherein the RPU provides UPLI read response/data (RdRsp) to the requesting entity.

Modern computing systems may require processors optimized for specific roles such as memory pooling, communication switching, and resource provisioning. These roles may not require the full computational capabilities of a general-purpose CPU, yet designing a new processor from scratch for each specific role involves substantial engineering effort, verification overhead, and time-to-market delays. By deriving a processor from an established CPU design and selectively removing unnecessary portions of the silicon die, it is possible to create cost-effective derivative processors that retain the communication and memory capabilities of the original design while reducing die area and power consumption. The implementation below addresses the challenges associated with selectively removing portions of a silicon die from an established CPU design. Termination circuits are implemented at interfaces between different silicon die areas to manage signal integrity, maintain coherent interconnect functionality, and provide electrical boundaries that accommodate variations in the dicing process. The termination circuits may be implemented during the floorplan partitioning stage, enabling the creation of multiple processor versions from a base design with minimal modifications to the original RTL design. The resulting processor retains communication ports such as CXL endpoints, CXL switch ports, and UALink ports, along with an RPU for address translation, enabling the processor to serve as a memory processor, communication switch, or resource provisioning node in multi-tier computing architectures.

In various implementations, a processor, derived from an established CPU design, comprising: memory channels capable of communicating with memory located outside the processor; processing cores, coupled via a coherent interconnect, configured to utilize a first physical address space to access the memory via the memory channels, and to respond to snoop requests that include physical addresses within the first physical address space; communication ports, selected from at least one of: Compute Express Link (CXL) endpoints, CXL switch ports, or UALink ports; wherein the communication ports are configured to receive messages comprising physical addresses within other physical address spaces; a resource provisioning unit (RPU) configured to translate physical addresses within the other physical address spaces to physical addresses within the first physical address space; and termination circuits implemented at interfaces of a first silicon die area comprising the communication ports, wherein the interfaces are configured to connect the first silicon die area with a second silicon die area that does not include the communication ports. The processor may be manufactured by modifying an established CPU design wherein termination circuits are placed at interfaces between different silicon die areas. The first silicon die area may contain the communication infrastructure including CXL endpoints, CXL switch ports, and/or UALink ports along with the RPU, while the second silicon die area may contain components that are not utilized for the processor's intended functionality. The coherent interconnect may implement cache coherency protocols such as MESI, MOESI, or proprietary coherency schemes to maintain data consistency across the processing cores. The RPU may perform real-time address translations to enable external entities to access memory resources through the communication ports while maintaining proper isolation between different physical address spaces. The termination circuits may serve as electrical boundaries at the first silicon die area that allow for flexible manufacturing options, including the ability to retain or remove the second silicon die area based on product requirements. The interfaces may remain functional whether or not the second silicon die area is physically present, as the termination circuits may manage signal integrity independently of the presence of the second silicon die area.

In some implementations of the processor, at least some of the termination circuits comprise an enable input configured to control signal propagation, wherein when the enable input is activated, the termination circuits block signal propagation on conductors designed to connect the first silicon die area with the second silicon die area, and when the enable input is deactivated, the termination circuits allow signal propagation between the first silicon die area and the second silicon die area. The enable input functionality may provide dynamic control over the termination circuits'behavior, allowing for configuration or manufacturing-time selection of different processor variants. When the enable input is activated, the termination circuits may effectively isolate the first silicon die area from the second silicon die area, creating electrical boundaries that prevent signal propagation across the interface. This isolation may be achieved utilizing various circuit techniques such as tri-state buffers, transmission gates, or analog switches that can disconnect the signal paths. When the enable input is deactivated, the termination circuits may become transparent to signal flow, allowing normal communication between the silicon die areas as if the termination circuits were not present. The enable input may be controlled utilizing various mechanisms including fuse programming, configuration registers, external pins, or firmware settings, providing flexibility in how the processor's functionality is configured.

In some implementations of the processor, the termination circuits are configured to block signal propagation between the second silicon die area and the first silicon die area, wherein for input signals, the termination circuits comprise pullup or pulldown circuits to provide a defined logical state, and wherein for output signals, the termination circuits block signal propagation to prevent antenna effects and/or short circuits. The termination circuits may have different implementations for handling input and output signals to maintain signal integrity and prevent electrical issues. For input signals that would normally come from the second silicon die area, pullup or pulldown circuits may be employed so that these inputs maintain a stable and predictable logical state rather than floating, which could cause metastability, increased power consumption, or unpredictable behavior in the receiving logic. The pullup circuits may connect the input to a positive voltage rail through a resistor, while pulldown circuits may connect to ground, with the choice between pullup and pulldown potentially depending on the default state requirements of the specific signals. For output signals from the first silicon die area, the termination circuits may include blocking mechanisms such as series switches or gates that prevent these signals from propagating to the removed or disconnected second silicon die area, thereby avoiding antenna effects that could cause electromagnetic interference or signal integrity issues, and preventing potential short circuits that could occur if output drivers were coupled to severed or improperly terminated conductors.

In some implementations, the processor further comprises conductors connecting the termination circuits to the second silicon die area, wherein the conductors are modified during a floorplan partitioning stage based on tolerance requirements of a dicing stage; and wherein the termination circuits are configured to maintain integrity of the coherent interconnect by: allowing signal passage to the second silicon die area when present, or performing a turnaround for data arriving on interconnect paths when the second silicon die area is removed. The conductors between the termination circuits and the second silicon die area may be designed with specific lengths and routing patterns that accommodate variations in the dicing process, wherein longer conductors may provide greater tolerance for dicing position variations while shorter conductors may minimize signal delay and area overhead. During the floorplan partitioning stage, these conductor lengths may be optimized based on the expected precision of the dicing equipment and the acceptable range of cut positions. The termination circuits may incorporate logic to maintain the coherent interconnect's functionality, particularly for ring-based or mesh-based interconnect topologies wherein data packets circulate through the entire network. When the second silicon die area is present, the termination circuits may act as pass-through elements, allowing data packets to flow normally through the interconnect. When the second silicon die area is removed, the termination circuits may implement turnaround functionality that receives incoming data packets and redirects them back into the interconnect, effectively shortening the interconnect path while maintaining logical continuity for proper packet routing and preventing deadlock conditions.

In some implementations of the processor, functional blocks in the first silicon die area not directly affected by removal of the second silicon die area maintain functional characteristics of their original Register Transfer Level (RTL) design; and interface blocks that directly connect between the first silicon die area and the second silicon die area have modified RTL designs comprising modifications to at least one of: signal routing, interface logic, or adaptations for maintaining functionality without the second silicon die area. The design methodology may minimize modifications to the established CPU design's RTL by concentrating changes in the interface blocks that directly interact with the potentially removed second silicon die area. Functional blocks in the first silicon die area that do not have direct connections to the second silicon die area may retain their original RTL implementation, which may reduce verification effort, maintain proven functionality, and minimize the risk of introducing new bugs. The interface blocks that have modified RTL designs may include changes to signal routing logic to redirect signals that would normally go to the second silicon die area, modifications to interface protocols to handle the absence of expected responses from the removed area, and adaptations to state machines or control logic that may need to operate differently when the second silicon die area is not present. These RTL modifications may be designed to be minimally invasive, potentially using conditional compilation or parameterization techniques that allow the same RTL source to support both configurations with and without the second silicon die area.

In some implementations of the processor, the modified RTL designs further comprise modifications to clock distribution networks to exclude the second silicon die area, and power management logic that is adjusted to account for removal of the second silicon die area. The clock distribution network modifications may include reconfiguring clock trees to eliminate branches that would have supplied clock signals to the second silicon die area, which may reduce clock network power consumption and potentially improve clock skew characteristics for the remaining portions of the processor. The power management logic modifications may encompass changes to power gating controls that would have managed power domains in the second silicon die area, updates to power state machines that no longer need to coordinate with components in the removed area, and adjustments to dynamic voltage and frequency scaling algorithms that may need to account for the reduced computational resources and power consumption characteristics of the modified processor.

In some implementations of the processor, manufacturing of the processor comprises physically removing the second silicon die area from a silicon die while retaining the communication ports in the first silicon die area, thereby reducing die size compared to the established CPU design. The processor may be derived from an established CPU design by physically removing the second silicon die area from the silicon die while retaining the communication ports supported by the established CPU design. This manufacturing process may reduce the overall die size, and potentially also the manufacturing costs, compared to the established CPU design, while preserving the full communication port functionality. By removing portions of the silicon die that do not affect the communication port operation, the design may be optimized for its intended purpose as a memory-centric processing unit in high-fanout, multi-tier memory pool scenarios. The retention of the communication ports, which may include CXL endpoints, CXL switch ports, and/or UALink ports, may enable the processor to establish connections with the same number of external entities as could be achieved with the established CPU design, thereby maintaining connectivity capabilities and facilitating efficient resource sharing among coupled entities.

In some implementations of the processor, manufacturing of the processor comprises physically removing the second silicon die area from a silicon die while retaining memory controllers supported by the established CPU design in the first silicon die area, thereby reducing die size compared to the established CPU design. The processor may be derived from an established CPU design such that the manufacturing process includes physically removing the second silicon die area from the silicon die while retaining memory controllers supported by the established CPU design. This manufacturing process may reduce the overall die size while preserving the full functionality of the memory controllers. By removing portions of the silicon die that do not affect memory controller operation, the design may be optimized for its intended purpose as a memory-centric processing unit in scenarios that maximize memory capacity. The retention of memory controllers may enable the processor to support the same memory capacity as the established CPU design. This may be beneficial for applications where memory capacity and bandwidth are more valuable than computational throughput, such as memory pooling and large-capacity memory tiering scenarios.

In some implementations of the processor, the RPU is further configured to perform physical address translations from a second host physical address (HPA) space, utilized by an entity coupled to at least one of the communication ports, to physical addresses within the first physical address space utilized by the processing cores. The RPU may perform address translations to enable memory access between different physical address spaces. The physical address translations may include maintaining translation tables, implementing content-addressable memories, or utilizing programmable address decoders that can map addresses within the second HPA space to corresponding physical addresses within the first physical address space. The entity utilizing the second HPA space may be an external host, accelerator, or another processor that accesses memory resources managed by the processor. The translation process may support various mapping schemes including linear offset mappings, windowed mappings, or more complex non-contiguous mappings, and may include access control to enforce memory protection boundaries between different entities.

In some implementations of the processor, the memory channels comprise at least four memory channels, and the second silicon die area comprises additional processing cores that were utilized in the established CPU design but are unnecessary for operation of the processor when functioning as a memory processor. The inclusion of at least four memory channels may provide substantial memory bandwidth to support the processor's role as a memory processor, wherein channels may operate in parallel to increase aggregate bandwidth and reduce access latency utilizing interleaving. The second silicon die area containing additional processing cores from the established CPU design may represent computational resources that, while useful in a general-purpose CPU context, may not be utilized when the processor is repurposed for memory-centric operations. The removal of these additional processing cores may reduce power consumption, decrease die area, and potentially improve yields while maintaining the memory access capabilities for the processor's intended use case.

In some implementations of the processor, the termination circuits are implemented during a floorplan partitioning stage that includes systematic division of an integrated circuit design into functional blocks, enabling creation of processor versions with distinct cutting locations between the first silicon die area and the second silicon die area. The implementation of termination circuits during the floorplan partitioning stage may provide flexibility in creating different processor variants from a base design. The floorplan partitioning stage may include evaluating the established CPU design to identify optimal boundaries between functional blocks where termination circuits can be inserted with minimal impact on the overall design. This systematic division may consider factors such as signal routing complexity, power domain boundaries, clock domain crossings, and functional dependencies between blocks. It may also enable a product family with different cost points and capabilities while leveraging a common design foundation and a reduced engineering effort for the variants.

In some implementations of the processor, the termination circuits are positioned adjacent to connection points between the first silicon die area and the second silicon die area to minimize length of unterminated signal paths and mitigate risks associated with signal integrity issues and electromagnetic coupling effects; and wherein the communication ports comprise at least one CXL endpoint configured to communicate according to CXL.mem. The adjacent positioning of termination circuits to the connection points may minimize the stub length of unterminated conductors, which may reduce signal reflections, minimize electromagnetic emissions, and improve overall signal integrity. The proximity of termination circuits to the boundary between silicon die areas may allow signals to be properly terminated within a short distance of where they would be interrupted by the removal of the second silicon die area, potentially reducing the risk of these unterminated segments acting as antennas or causing crosstalk with nearby signals. The inclusion of at least one CXL endpoint configured for CXL.mem may enable the processor to function as a CXL-attached memory device, wherein external hosts can access the processor's memory resources utilizing CXL.mem messages.

Manufacturing a processor derived from an established CPU design involves a series of fabrication steps that create the processor's functional components while introducing termination circuits at certain interfaces between silicon die areas. By incorporating termination circuits during the fabrication process, the method enables the creation of processor versions from a base design, including versions where portions of the silicon die are physically removed to reduce die area and cost. The fabrication process may be adapted to include various configurations of the termination circuits, supporting both pass-through and blocking modes depending on the target product variant. The method below may leverage existing semiconductor fabrication infrastructure and design tools to minimize the engineering effort for creating derivative processors. By preserving the established CPU design's RTL for functional blocks not directly affected by the removal of silicon die areas, and concentrating modifications in the interface blocks at the boundaries, the method may reduce verification overhead and time-to-market for the derivative processor products.

In various implementations, a method of manufacturing a processor derived from an established CPU design, the method comprising: fabricating circuitry for memory channels capable of communicating with memory located outside the processor; fabricating circuitry for processing cores coupled via a coherent interconnect, wherein the processing cores are configured to utilize physical addresses within a first physical address space to access the memory via the memory channels, and to respond to snoop requests that include physical addresses within the first physical address space; fabricating circuitry for communication ports selected from at least one of: Compute Express Link (CXL) endpoints, CXL switch ports, or UALink ports; wherein the communication ports are configured to receive messages comprising physical addresses within other physical address spaces; fabricating circuitry for a resource provisioning unit (RPU) configured to translate physical addresses within the other physical address spaces to physical addresses within the first physical address space; and fabricating termination circuits at interfaces connecting between: a first silicon die area comprising the communication ports, and a second silicon die area that does not include the communication ports. The method of manufacturing the processor may include modifying an established CPU design by placement of termination circuits that create defined boundaries between different silicon die areas. The fabrication process may include creating the first silicon die area containing the communication infrastructure and the RPU, while the second silicon die area may contain components from the established CPU design that are not utilized for the processor's intended functionality. The termination circuits may be fabricated during various stages of the manufacturing process, including during metallization layers where they can be integrated into the interconnect structure.

In some implementations of the method, fabricating the termination circuits comprises fabricating an enable input as part of at least some of the termination circuits, the enable input being configured such that when activated, the at least some of the termination circuits block signal propagation on conductors connecting the first silicon die area with the second silicon die area, and when deactivated, the at least some of the termination circuits allow signal propagation between the first silicon die area and the second silicon die area. The enable input may provide a configurable mechanism for selecting between pass-through and isolation modes during manufacturing or at runtime. The enable input may be implemented utilizing fuse elements, configuration registers, or external control signals, allowing different product variants to be produced from the same fabricated die by selectively activating or deactivating the termination circuits.

In some implementations of the method, the established CPU design is defined by a first Register Transfer Level (RTL) design, and the processor is defined by a second RTL design derived from the first RTL design by: preserving portions of the first RTL design corresponding to functional blocks in the first silicon die area not directly affected by removal of the second silicon die area to form part of the second RTL design; and modifying portions of the first RTL design corresponding to interface blocks that connect between the first silicon die area and the second silicon die area, to specify the termination circuits in the second RTL design. Deriving the second RTL design from the first RTL design may minimize the engineering effort by reusing verified design blocks where possible. The preserved portions may include processing core logic, memory controller interfaces, and communication port implementations that do not have direct dependencies on the second silicon die area. The modified portions may be limited to interface blocks at the boundary, where termination circuit logic is inserted to manage signal integrity and interconnect continuity.

In some implementations of the method, the fabricating of the termination circuits is performed at locations determined during a floorplan partitioning stage of a design modification process applied to the established CPU design, the floorplan partitioning stage comprising: systematically dividing an integrated circuit design corresponding to the established CPU design; identifying potential cut points between the first silicon die area and the second silicon die area; and optimizing placement for the termination circuits. The floorplan partitioning stage may evaluate multiple candidate cut points based on criteria such as signal density at the boundary, power domain alignment, clock domain boundaries, and the physical area overhead of the termination circuits. The optimization of termination circuit placement may balance signal integrity requirements against area and routing constraints, and may consider the tolerances of the downstream dicing process.

In some implementations, the method further comprises configuring the termination circuits to allow signal propagation between the first silicon die area and the second silicon die area for manufacturing a first version of the processor; and configuring the termination circuits to block signal propagation between the first silicon die area and the second silicon die area for manufacturing a second version of the processor. The method may support manufacturing versions of processors from a base design by configuring the termination circuits differently for different versions. For the first version of the processor, the termination circuits may be configured in a pass-through mode that allows normal signal propagation between the first and second silicon die areas, effectively creating a processor that retains the full functionality of the established CPU design. For the second version of the processor, the same termination circuits may be configured in a blocking mode that prevents signal propagation between the silicon die areas, creating a reduced-functionality processor optimized for specific use cases such as memory processing or communication switching. The ability to create different product variants from a set of masks may reduce development costs and time-to-market while enabling a broader product portfolio.

In some implementations of the method, for input signals the termination circuits comprise pullup or pulldown circuits to maintain a defined logical state, and for output signals the termination circuits block signals to prevent antenna effects or short circuits. The differentiated handling of input and output signals may address distinct electrical concerns at the boundary. Pullup or pulldown circuits on inputs may prevent floating states that could cause metastability or excess power draw, while blocking circuits on outputs may prevent electromagnetic emissions from unterminated signal stubs.

In some implementations, the method further comprises modifying conductors connecting the termination circuits to the second silicon die area based on tolerance requirements of a dicing stage. The conductor lengths and routing patterns may be adjusted to accommodate the precision of the dicing equipment. Longer conductors may provide greater tolerance for cut position variations, while shorter conductors may reduce signal delay and area overhead. The modification may also account for potential mechanical stress at the die edge during the dicing process.

In some implementations, the method further comprises maintaining integrity of the coherent interconnect by configuring the termination circuits to: allow signal passage to the second silicon die area when present, or perform a turnaround for data arriving on interconnect paths when the second silicon die area is removed. The coherent interconnect may utilize a ring-based or mesh-based topology where data packets circulate through the network. When the second silicon die area is present, the termination circuits may allow normal packet flow. When removed, the turnaround functionality may redirect packets back into the remaining interconnect, preserving logical continuity and preventing deadlock conditions that could otherwise arise from broken paths.

In some implementations of the method, the processor is manufactured based on a modified design created by: preserving Register Transfer Level (RTL) design of functional blocks in the first silicon die area not directly affected by removal of the second silicon die area, and modifying RTL design of interface blocks that connect between the first silicon die area and the second silicon die area. Preserving the RTL design of unaffected functional blocks may allow those blocks to retain their verified functionality without additional validation effort. The modifications to interface block RTL may be concentrated at the boundary between the silicon die areas, where termination circuit logic, signal rerouting, and interconnect turnaround functionality are introduced. This approach may minimize the scope of design changes and reduce the overall verification burden.

In some implementations of the method, the modifying of the RTL design is limited to signal routing modifications, interface logic modifications, and adaptations for maintaining functionality without the second silicon die area. Limiting the scope of RTL modifications to signal routing, interface logic, and functionality adaptations may reduce the risk of introducing regressions in unrelated portions of the design. This focused modification approach may also simplify the verification process by constraining the set of changed design elements.

In some implementations of the method, the modifying of the RTL design comprises at least one of: updating signal routing to accommodate the termination circuits, modifying clock distribution networks to exclude the second silicon die area, or adjusting power management logic to account for removal of the second silicon die area. The signal routing updates may redirect signals that would otherwise traverse the boundary between silicon die areas. The clock distribution network modifications may eliminate clock tree branches serving the removed area, potentially reducing power consumption and improving clock skew characteristics. The power management logic adjustments may update power gating controls, power state machines, and dynamic voltage and frequency scaling algorithms to reflect the reduced processor configuration.

In some implementations, the method further comprises verifying functionality of a resulting modified RTL design by: performing static timing analysis on the modified interface blocks, conducting functional simulations of the processor design, and comparing results with the established CPU design to verify equivalent performance in remaining functional blocks. The verification process for the modified RTL design may employ a methodology to confirm functional correctness and performance equivalence with the established CPU design. The static timing analysis on modified interface blocks may verify that the addition of termination circuits and modifications to signal routing do not introduce timing violations or degrade performance on affected paths. The functional simulations may include directed tests targeting the termination circuit behavior under various configurations, random testing to uncover corner cases, and system-level simulations to verify proper operation in the context of the complete processor design. The comparison with the established CPU design may involve running identical test suites on both designs and verifying that the remaining functional blocks exhibit identical behavior. This verification process may also include formal verification techniques to mathematically prove the equivalence of specific properties between the original and modified designs.

In some implementations, the method further comprises physically removing the second silicon die area while retaining the communication ports in the first silicon die area. The physical removal may be performed during the dicing stage, where the silicon wafer is cut to exclude the second silicon die area. The retention of communication ports in the first silicon die area may preserve the processor's ability to connect with external entities via CXL and/or UALink interfaces, maintaining the same connectivity as the established CPU design in a reduced die area.

In some implementations, the method further comprises physically removing the second silicon die area while retaining memory controllers supported by the established CPU design in the first silicon die area. The physical removal of the second silicon die area while retaining the memory controllers may allow the processor to support the same memory capacity as the established CPU design. This may be beneficial for applications where memory bandwidth and capacity are more valuable than computational throughput, such as memory pooling and large-capacity memory tiering scenarios.

FIG. 2C illustrates an example of a processor derived from an established CPU design, wherein termination circuits are implemented at interfaces between different silicon die areas. The processor may be manufactured using one of two exemplary approaches. A first approach is to remove a portion of the silicon design during the floorplan partitioning stage, resulting in a chip design that excludes the unnecessary part. A second approach is to physically chop the unnecessary part at the dicing stage, which includes physically cutting away a portion of the manufactured chip. The illustrated processor includes a first silicon die area comprising Memory Channels, an MMU, one or more CXL EPs, one or more CXL RPs, processing cores with LLCs, and an RPU. A second silicon die area comprises additional processing cores with their associated LLCs. To preserve the integrity of the remaining components (whether the portion is removed at the floorplan partitioning stage or at the dicing stage), termination circuits are added between the first and second silicon die areas to block signal propagation beyond specific physical points. The termination circuits are used to properly end signal paths, preventing reflections or unintended signal propagation. By adding the termination circuits at potential cut points, the design becomes more tolerant to variations in the physical dicing process, as signals are cleanly terminated regardless of the exact cut location within a certain range. Therefore, adding the termination circuits may also increase the permissible variance in the dicing process compared to an alternative solution that does not add such termination circuits.

The termination circuits may be implemented during the floorplan partitioning stage, which includes the systematic division of the integrated circuit design to large functional blocks. This implementation of termination circuits enables the creation of one or more chip versions with distinct cutting locations. For example, a first version of the integrated circuit may be designed with termination circuits positioned for cutting at a first predetermined location between the first and second silicon die areas, and a second version of the integrated circuit may be designed with termination circuits positioned for cutting at a second predetermined location. The termination circuits may be added adjacent to the connection or cutting points between the silicon die areas so that signals are properly terminated close to where they may be interrupted. This adjacency minimizes the length of unterminated signal paths, thereby mitigating risks associated with signal integrity issues and unintended electromagnetic coupling effects. In the illustrated example, the termination circuits form an interface region between the first silicon die area containing the communication ports (CXL EP, CXL RP/EP, CXL RP) and the second silicon die area containing the additional processing cores.

Optionally, at least some of the termination circuits incorporate an “enable” input that controls their operation when activated. The functionality of the termination circuits is such that when the enable input is activated, the termination circuit effectively blocks signal propagation between the first and second silicon die areas, whereas when the enable input is deactivated, the circuit allows signals to pass through unimpeded. This “enable” functionality that controls the chip's behavior allows for the selective activation or deactivation of certain signal paths depending on which version of the chip is being produced or utilized. For example, if there is a need to chop-out the second silicon die area containing optional processing cores coupled to the coherent interconnect, then the interconnect loops must be closed such that data can still circulate through the remaining portions of the coherent interconnect in the first silicon die area, maintaining the chip's functionality despite the removal of the second silicon die area. Thus, in this example the termination circuits operate in two modes: either allowing signal passage to the second silicon die area that exists after it, or performing a turnaround for the data arriving on the interconnect paths, effectively shortening the path logically. Additionally, the length of the conductors connecting the termination circuits to the optional logic in the second silicon die area (that may be chopped from a certain version of the chip) may be changed according to the required tolerance and properties of the dicing stage. Typically, signal ends are not left floating, especially not inputs that can lead to unstable or metastable states. Therefore, pullup or pulldown termination circuits are placed on the inputs so that the input is in a defined logical state. These circuits are designed such that they handle input signals even if they are floating due to the second silicon die area being cut. On the output, the termination circuits block the signals to prevent antennas or to prevent short circuits when the signals themselves were blocked already in the logical termination block.

One of the possible goals during the modification of an established CPU design to create the processor illustrated in FIG. 2C may be to modify the RTL as little as possible. RTL is a design abstraction representing the registers of a digital circuit and the operations performed on signals as they pass between these registers. Modifying RTL can have far-reaching effects on the chip's functionality and timing, and changes typically require re-verification of the entire design and re-synthesis of the affected portions. Thus, modifying the RTL can be time-consuming and may introduce new issues. By minimizing RTL changes, the design process becomes more efficient and less prone to errors. Additionally, large chip designs are often divided to smaller, manageable blocks that can be designed and synthesized separately, which allows for parallel development and easier management of complex designs. By implementing the chopping at the floorplan partitioning stage between the first and second silicon die areas, it is possible to isolate the effects to specific blocks, leaving others unchanged, which minimizes the scope of modifications and reduces the overall impact on the design and verification process. In the illustrated example, the first silicon die area retains the communication ports (CXL EP, CXL RP/EP, CXL RP) and the RPU for the processor's operation, while the second silicon die area containing additional processing cores may be optionally removed based on product requirements.

In various implementations, an apparatus comprising: a coherent interconnect that utilizes a protocol based on Coherent Hub Interface (CHI-based protocol), comprising an interconnect component configured to receive CHI-based messages; processing cores coupled via the coherent interconnect to memory controllers coupled to memory channels capable of supporting memory having a capacity of at least 64 GB; a resource provisioning unit (RPU) comprising an NVLink interface and a CHI interface; wherein the NVLink interface utilizes differential pairs and is capable of communicating according to an NVLink-based protocol with an entity external to the apparatus; wherein the CHI interface is coupled to the interconnect component; and wherein the RPU is configured to translate between messages conforming to the NVLink-based protocol and messages conforming to the CHI-based protocol to enable the entity to access resources via the NVLink interface and the coherent interconnect.

In some implementations of the apparatus, the RPU is further configured to: translate first physical addresses associated with the NVLink-based protocol to second physical addresses associated with the CHI-based protocol, and translate NVLink command encodings to corresponding CHI opcodes. The RPU may perform address translation from the NVLink domain to the CHI domain. The address translation may support different memory mapping schemes between the NVLink and CHI domains, while the command translation may preserve the intent of the transaction. For example, when translating an NVLink read request transaction, received from a GPU, to a CHI request transaction, targeting an xPU coherent interconnect, wherein the CHI transaction carries ReadOnce for obtaining a non-cacheable snapshot of the data, satisfying the intent of the I/O-coherent NVLink read request. The RPU may preserve the ordering requirements of the original NVLink traffic within the CHI-based protocol framework.

In some implementations of the apparatus, the resources are selected from at least one of: registers within the apparatus, SRAM, HBF, or HBM within the apparatus, at least some of the 64 GB of memory, network devices coupled to the apparatus, or storage devices coupled to the apparatus.

In some implementations of the apparatus, the RPU further comprises a request node which does not include a hardware-coherent cache, and wherein the request node is configured to communicate with the interconnect component according to the CHI-based protocol.

In some implementations of the apparatus, the request node is coupled to the interconnect component and is further configured to expose registers accessible utilizing memory-mapped I/O (MMIO) operations, to enable the entity to detect at least one of: node type, node configuration, or connection topology based on register inspection.

In some implementations of the apparatus, the request node is configured to expose the registers via Advanced Microcontroller Bus Architecture (AMBA) Advanced Peripheral Bus (APB) interface, to enable the entity to read the registers via the NVLink interface.

In some implementations of the apparatus, the request node comprises an I/O-Coherent Request Node (RN-I) or an I/O-Coherent Request Node with Distributed Virtual Memory (DVM) support (RN-D); and the RPU is configured to translate NVLink read requests to CHI read requests. The integration with ARM mesh architecture may allow the NVLink-coupled entity to participate in the broader system interconnect fabric, with interconnect components, such as crosspoints, providing routing decisions based on transaction addresses and types. The MMIO-accessible registers enable system firmware or diagnostic software to discover the structure of the coherent interconnect, the presence of request nodes and home nodes included in the RPU, verify correct node connections, detect NVLink translation capabilities in the RPU via additional register inspections, and configure operational parameters for the translation path.

In some implementations of the apparatus, the RPU further comprises a home node which does not include a Point of Coherence (PoC) and is not capable of processing snoopable requests, and wherein the home node is configured to communicate with the interconnect component according to the CHI-based protocol.

In some implementations of the apparatus, the home node comprises a I/O-coherent Home Node (HN-I), enabling the processing cores to access resources via the NVLink interface.

In some implementations of the apparatus, the RPU further comprises a request node and a home node, the request node couples the NVLink interface to the interconnect component, and the home node couples the NVLink interface to a second interconnect component. The RPU may implement routing decisions based on transaction types, directing memory access transactions from the NVLink domain through a request node, such as an RN-I node, while receiving, from a home node, such as an HN-I node, transactions targeting the NVLink domain. The apparatus may enable entities communicating according to NVLink-based protocol to perform I/O-coherent accesses to resources within a CHI-based system through appropriate non-coherent or I/O-coherent nodes. A request node, such as an RN-D node, may receive DVM transactions and generate a subset of CHI transactions without maintaining a hardware-coherent cache. The home node, such as an HN-I node, may process a limited subset of request types and manage ordering between I/O requests targeting the I/O subsystem without maintaining coherency utilizing snooping. The RPU may perform protocol-specific translations including command mapping, address formatting, address translations, orchestration and tracking of transaction IDs, and transaction sequencing between the NVLink and CHI domains.

In some implementations of the apparatus, the RPU further comprises an interconnect gateway configured to communicate with the interconnect component according to the CHI-based protocol, wherein the RPU is further configured to utilize a streaming interface protocol to enable connectivity between the NVLink interface and the coherent interconnect via the interconnect gateway.

In some implementations of the apparatus, the streaming interface protocol transports packets of an intermediate protocol; and wherein the RPU is further configured to translate between messages conforming to the intermediate protocol and messages conforming to the CHI-based protocol.

In some implementations of the apparatus, the intermedia protocol conforms to PCIe, and the RPU is further configured to translate a PCIe UIO memory read request utilizing a UIOMRd TLP type to a CHI REQ comprising ReadOnce.

In some implementations of the apparatus, the streaming interface protocol is based on Advanced Microcontroller Bus Architecture (AMBA) Credited eXtensible Stream (CXS); and wherein the interconnect gateway provides credit-based flow-control and supports bi-directional connectivity between the NVLink interface and the coherent interconnect.

In some implementations of the apparatus, the interconnect gateway comprises CXL/CCIX Gateway (CCG) comprising a link agent that supports the streaming interface protocol, providing flit packing and unpacking, end-to-end data integrity, and a flit-retry mechanism for reliability, availability and serviceability (RAS) containment when data corruption is detected.

In some implementations of the apparatus, the interconnect gateway comprises at least one of Coherent Multichip Link (CML) or Cache Coherent Interconnect for Accelerators (CCIX) Gateway (CXG); and wherein the gateway is configured to utilize a 32-bit cyclic-redundancy check (CRC-32) to protect transactions conforming to the streaming interface protocol.

In some implementations of the apparatus, the RPU comprises a request agent (RA) proxy configured to communicate with the interconnect component according to the CHI-based protocol, enabling the entity to access, via the NVLink interface, resources coupled to the coherent interconnect.

In some implementations of the apparatus, the RPU comprises a home agent (HA) proxy configured to communicate with the interconnect component according to the CHI-based protocol, enabling the processing cores to access resources via the NVLink interface.

In some implementations of the apparatus, the interconnect component comprises a crosspoint comprising at least four mesh ports and at least two device ports; and wherein the RPU is coupled to a device port of the at least two device ports.

In some implementations of the apparatus, the coherent interconnect comprises a scalable coherent fabric (SCF), the interconnect component comprises a Cache Switch Node (CSN), and the RPU is coupled to the CSN via the CHI interface. In some implementations, the xPU may be based on an NVIDIA SCF coherent interconnect that includes CSNs as a crosspoint, and an NVLink-C2C for connecting to an external entity, such as a GPU, via an NVLink interface.

In some implementations of the apparatus, the SCF comprises an SCF Cache partition (SCC); and wherein the RPU and the SCC are coupled to the CSN, providing the entity, via the NVLink interface, with low-latency access to caching resources of the apparatus.

In some implementations of the apparatus, the memory comprises dynamic random-access memory (DRAM), and the entity comprises an NVLink Switch, a GPU, or an accelerator.

In various implementations, a method comprising: operating a coherent interconnect that utilizes a protocol based on Coherent Hub Interface (CHI-based protocol), comprising an interconnect component that receives CHI-based messages; communicating, via the coherent interconnect, between processing cores and memory controllers that communicate with memory channels coupled to memory having a capacity of at least 64 GB; operating a resource provisioning unit (RPU) comprising an NVLink interface and a CHI interface, wherein the NVLink interface utilizes differential pairs and communicates according to an NVLink-based protocol with an entity external to the RPU, and wherein the CHI interface communicates with the interconnect component; and translating, by the RPU, between messages conforming to the NVLink-based protocol and messages conforming to the CHI-based protocol to enable the entity to access resources via the NVLink interface and the coherent interconnect.

In some implementations, the method further comprises translating, by the RPU, first physical addresses associated with the NVLink-based protocol to second physical addresses associated with the CHI-based protocol, and translating NVLink command encodings to corresponding CHI opcodes.

In some implementations of the method, the RPU comprises a request agent (RA) proxy, and further comprising communicating, by the RA proxy, with the interconnect component according to the CHI-based protocol, enabling the entity to access, via the NVLink interface, resources coupled to the coherent interconnect.

In some implementations of the method, the RPU comprises a home agent (HA) proxy, and further comprising communicating, by the HA proxy, with the interconnect component according to the CHI-based protocol, enabling the processing cores to access resources via the NVLink interface.

In various implementations, a system comprising: a coherent interconnect that utilizes a protocol based on Coherent Hub Interface (CHI-based protocol), comprising interconnect components configured to route CHI-based messages; processing cores coupled via the coherent interconnect to memory controllers coupled to memory channels coupled to memory having a capacity of at least 64 GB; resource provisioning units (RPUs) comprising external interfaces and CHI interfaces, wherein at least one of the external interfaces comprises an NVLink interface utilizing differential pairs for communication according to an NVLink-based protocol with one or more external entities; wherein the CHI interfaces are coupled to the interconnect components; and wherein the RPUs are configured to translate between protocols utilized by the external interfaces and the CHI-based protocol; whereby the translate enables the external entities to access system resources via the external interfaces and the coherent interconnect.

In some implementations of the system, the RPUs are configured to translate physical addresses from physical address spaces associated with their external interface protocol to addresses from physical address spaces associated with the CHI-based protocol, and to translate command encodings from the external interface protocol to command encodings from corresponding CHI opcodes.

In some implementations of the system, the RPUs comprise at least one of request agent (RA) proxies or home agent (HA) proxies configured to communicate with the interconnect components according to the CHI-based protocol; wherein the RA proxies enable external entities to access memory and I/O resources coupled to the coherent interconnect, and the HA proxies enable the processing cores to access external memory resources via the external interfaces, thereby implementing a distributed shared memory architecture.

In some implementations of the system, at least one of the RPUs comprises an interconnect gateway configured to communicate with a corresponding interconnect component according to the CHI-based protocol; wherein the interconnect gateway utilizes a streaming interface protocol to enable connectivity between the external interface associated with the at least one of the RPUs and the coherent interconnect via the at least one of the RPUs. The external interfaces associated with the RPUs may implement various protocol bridging architectures to enable communication between external entities and the coherent interconnect. In one example, an RPU may utilize proxy-based mechanisms such as Request Agent (RA) proxy and Home Agent (HA) proxy for NVLink translations. In alternative implementations, the RPUs may employ direct translation engines that perform stateless or stateful conversion between external protocols and CHI-based messages, transaction queuing and reordering mechanisms that handle protocol-specific ordering requirements, or address remapping units that maintain translation tables for converting between addresses from different physical address spaces. The RPUs may implement credit-based flow control, transaction tracking structures, or protocol-specific state machines that manage the lifecycle of transactions as they traverse between domains. These various implementation approaches may enable external entities to access system memory while system components access resources attached to the external entities.

Optionally, the architectural flexibility of the RPUs may enable multiple protocols to co-exist within the system utilizing various mechanisms. Different RPUs in the system may support UALink through UPLI message processing engines, CXL protocol through CXL.mem and/or CXL.cache transaction handlers, PCIe protocol through TLP processing units, or proprietary interconnect protocols through custom translation logic. The system may include RPUs configured for multi-protocol operation, such as multi-protocol RPUs embedded in a Fabric Processing Unit (FPU) or in a software-defined fabric processor, wherein an RPU implements protocol detection and routing logic, shared transaction buffers with protocol-specific handling, unified address translation units that support multiple addressing schemes, or configurable state machines that adapt to different protocol requirements. The streaming interface protocol utilized by the interconnect gateway may provide a common transport mechanism with protocol-agnostic packetization and framing, enabling these diverse protocols to efficiently communicate with the CHI-based coherent interconnect. The RPUs may implement protocol-specific optimizations such as transaction coalescing, speculative prefetching, or latency hiding techniques while maintaining protocol semantics and coherency requirements utilizing appropriate translation and synchronization mechanisms.

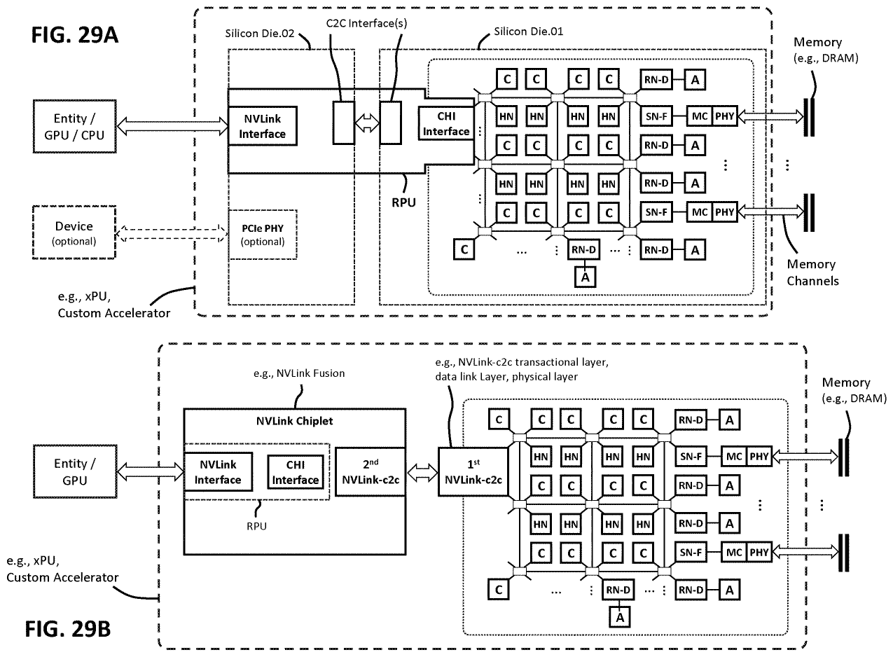

FIG. 29A illustrates an example of an xPU coupled to an entity such as a CPU or a GPU. The xPU includes an RPU which translates between NVLink traffic protocol and CHI-based traffic. The xPU further includes at least two silicon dies, wherein the first die includes a CHI interface of the RPU, and the second die includes an NVLink interface of the RPU. The second die may further include an optional PCIe PHY to communicate according to PCIe with a device external to the xPU. The first die and the second die are coupled by at least one C2C interface, utilizing chip-to-chip or die-to-die protocols such as CHI C2C or NVLink-C2C. The RPU may enable coherent memory access from the entity to the xPU, and optionally, from the device to the xPU.

FIG. 29B illustrates an example of an xPU coupled to an entity such as an NVIDIA Blackwell GPU. The xPU includes processing cores, acceleration cores, memory controllers, a coherent interconnect, and an NVLink chiplet, such as NVLink Fusion, that is coupled to the coherent interconnect via a first NVLink-C2C. The NVLink chiplet includes a second NVLink-C2C, and an RPU that translates between NVLink traffic and CHI-based traffic. The RPU includes an NVLink interface for coupling to the entity, and a CHI interface for coupling to the second NVLink-C2C. The NVLink-C2C interfaces are optionally integrated into NVLink-C2C controllers that includes transactional layers, data link layers and physical layers. The RPU may enable the GPU to access, via the NVLink interface, resources mapped to the physical address space utilized by the xPU coherent interconnect. Correspondingly, the RPU may enable the processing cores of the xPU to access, via the NVLink interface, resources of the GPU, such as HBM, High-Bandwidth Flash (HBF), or GDDR memory.

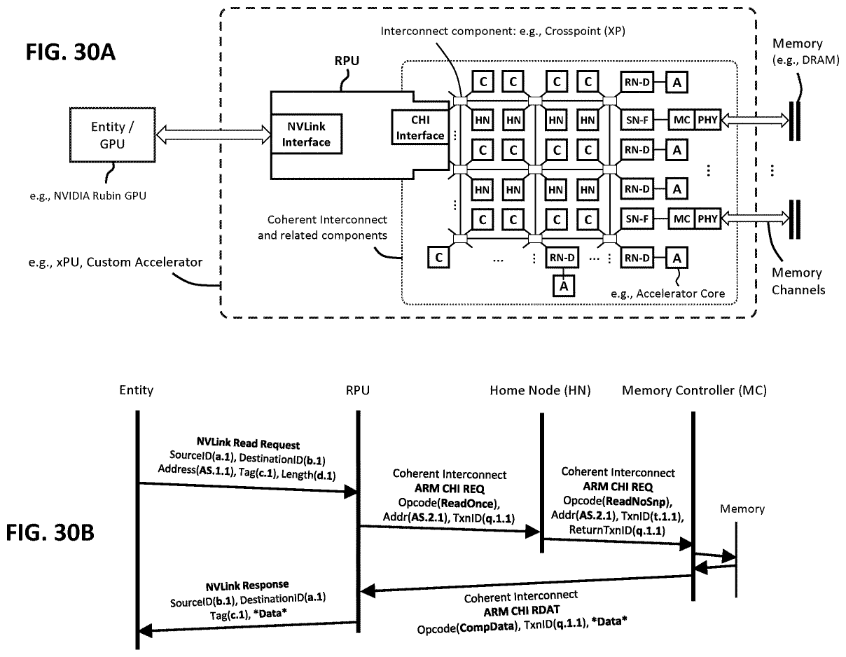

FIG. 30A illustrates an example of a system that translates between NVLink-based traffic and coherent interconnect CHI-based traffic. The NVLink connections are coupled via an RPU to an interconnect component such as a crosspoint (e.g., XP), which may serve as a fundamental building block of a coherent interconnect, providing switching or routing of CHI messages between participating elements such as request nodes, home nodes, gateways, protocol bridges, or other elements that connect to the coherent interconnect. The RPU may translate between NVLink traffic utilized by an entity, such as a GPU or a CPU, to CHI-based traffic utilized by the interconnect component, possibly eliminating intermediate protocol translations. Alternatively, the RPU may translate between an NVLink traffic and CHI traffic by utilizing intermediate protocols such as Advance Extensible Interface (AXI), or AXI Coherency Extensions Lite (ACE-Lite), or by utilizing streaming interface protocols such as Credited eXtensible Stream (CXS). Direct translation from NVLink to CHI may provide high-performance connectivity between a GPU coupled to the NVLink interface and memory coupled to the coherent interconnect, a performance gain that may be reflected via lower-latency accesses to memory and higher-bandwidth of reads and writes.

FIG. 30B illustrates an example of a transaction flow diagram (TFD) showing the translation of NVLink traffic to CHI traffic. An entity, such as a GPU or a CPU, initiates an NVLink read request, that is received by the RPU via the NVLink interface. The RPU translates the NVLink request to a CHI request carrying ReadOnce, optionally translating the physical address (AS.1.1) associated with NVLink to a physical address (AS.2.1) associated with CHI. The RPU may capture identification information associated with the NVLink request, such as source identifier of the requesting entity, and transaction Tag identifier, and may record the information together with identification information associated with the CHI request generated, such as the transaction ID (TxnID), in order to support the generation of an NVLink response for the NVLink request received from the entity. The RPU sends the CHI request, via the CHI interface, to an interconnect component, such as a crosspoint (e.g., an XP on a CHI coherent interconnect), that forwards the request to a home node. The home node processes the request and issues a CHI request carrying ReadNoSnp to a memory controller coupled to the coherent interconnect. The memory controller may read the requested data from memory, and may send the data to the RPU, or alternatively the memory controller may send the data to the home node, wherein the home node is responsible for sending the data to the RPU. When the RPU receives the data via the CHI interface, the RPU may issue an NVLink response with the data to the requesting entity, utilizing the identification information the RPU captured when processing and translating the NVLink request.

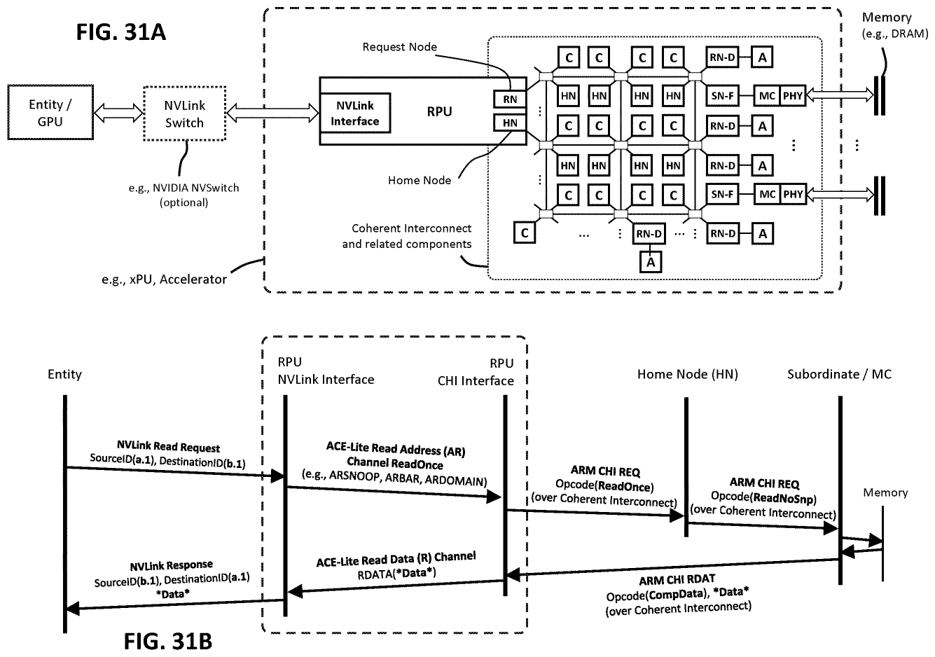

FIG. 31A illustrates an example of a system that translates between NVLink-based traffic and CHI-based traffic. The NVLink connections are coupled via an RPU to crosspoint (e.g., XP) interconnect components of the CHI coherent interconnect. The RPU may include request nodes (e.g., RNs), such as I/O-coherent RN-I nodes and/or RN-D, and/or home nodes (e.g., HNs), such as non-coherent HN-I nodes. This example enables external entities, such as GPUs, CPUs, or accelerators, which communicate utilizing NVLink traffic, to access resources within the ARM-based processor's coherent domain utilizing appropriate translations and routing, such as by an RPU translating from NVLink traffic utilized by a GPU entity, to CHI traffic, utilized by a crosspoint (XP) component of the CHI interconnect, wherein a request node or a home node provides the CHI interface for connecting to the XP.

FIG. 31B illustrates an example of an RPU that translates between NVLink traffic and CHI traffic, utilizing an intermediate protocol based on ARM Advanced Microcontroller Bus Architecture (AMBA) Advance Extensible Interface (AXI) Coherency Extensions Lite (ACE-Lite). The RPU may further translate physical addresses associated with NVLink to physical addresses associated with CHI. The RPU may process and translate the NVLink traffic, received from an NVLink interface, to ACE-Lite traffic for further processing, and send the ACE-Lite traffic to a request node (e.g., RN). The request node translates the ACE-Lite traffic to CHI traffic and provides a CHI interface for connecting to the coherent interconnect. In this example, the RPU receives from an entity, such as a GPU or a CPU, NVLink traffic that includes a read request. The RPU translates the NVLink traffic to an intermediate ACE-Lite ReadOnce, that is further translated by a request node to a CHI ReadOnce destined to a home node (e.g., HN). The home node processes the CHI ReadOnce and may issue a ReadNoSnp to a memory controller, for servicing the original read request received from the entity via the NVLink interface. The memory controller reads the requested data from memory, and may send the data via the coherent interconnect to the CHI interface of the RPU for delivery to the entity over the NVLink interface.

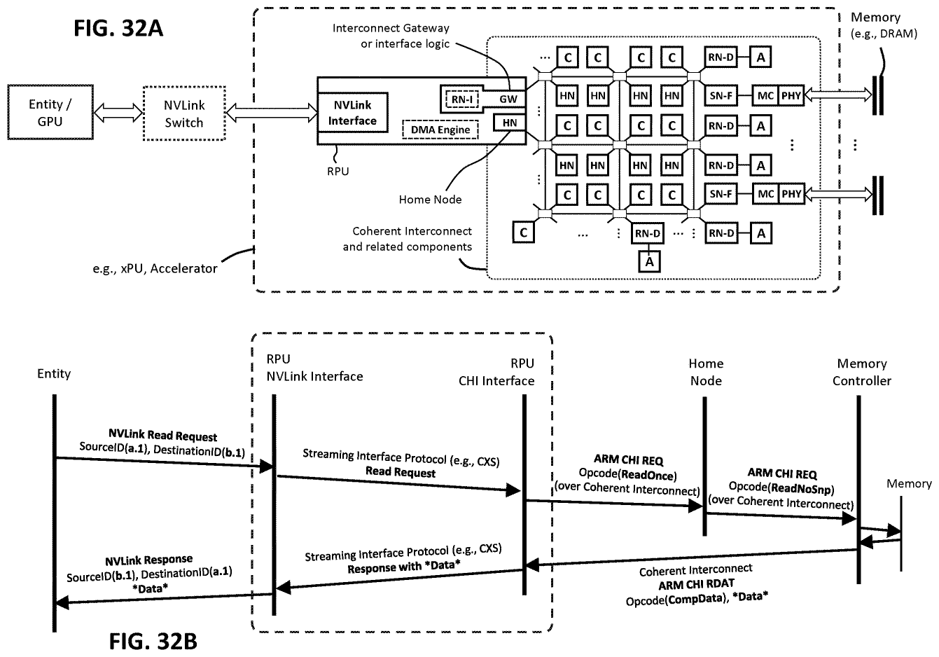

FIG. 32A illustrates an example of a system that translates between an interface based on NVLink, and interconnect components that communicate according to a protocol based on ARM CHI. The system enables entities, such as GPUs or CPUs, to access, via an optional NVLink switch, and an NVLink interface, resources coupled to the coherent interconnect. The NVLink connections are coupled, via an RPU, to crosspoint (e.g., XP) interconnect components of the coherent interconnect. The RPU may include a gateway or interface logic (marked GW in the figure), such as CXL/CCIX Gateway (CCG), Coherent Multichip Link (CML), Cache Coherent Interconnect for Accelerators (CCIX) Gateway (CXG), CHI C2C, or NVLink-C2C, that may include a CHI interface coupled to the coherent interconnect, enabling connectivity between the NVLink interface and the coherent interconnect, via the RPU. The gateway or interface logic may utilize a streaming interface protocol, such as Credited eXtensible Stream (CXS), to provide packing and un-packing of CHI C2C or an intermediate protocol over the streaming interface. The RPU may further include one or more request nodes (e.g., RN-I), home nodes (e.g., HN-I), optionally placed in the GW, that may enable DMA engines in the RPU to move blocks of data between the NVLink interface and the CHI interface. Examples of the gateway or interface logic include CCG, CML, CXG, CHI C2C, or NVLink-C2C.

FIG. 32B illustrates an example of an RPU that translates between NVLink traffic and CHI traffic. The RPU may further translate NVLink physical addresses to CHI physical addresses. The RPU utilizes a streaming interface protocol that may be based on ARM Advanced Microcontroller Bus Architecture (AMBA) Credited eXtensible Stream (CXS). Optionally, the RPU may utilize an intermediate protocol, such as CCIX, PCIe, or CXL, over the streaming interface protocol, and may translate from NVLink to intermediate protocol, and/or from the intermediate protocol to CHI. Optionally or alternatively, the RPU may include interfacing logic such as CHI C2C or NVLink-C2C, that may utilize a streaming interface protocol based on CXS.

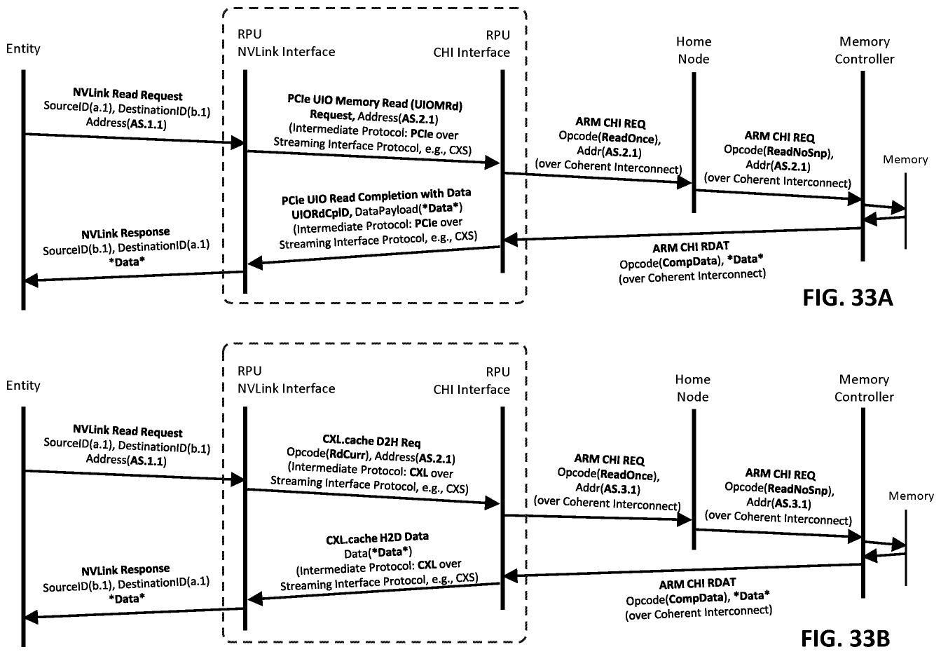

FIG. 33A illustrates an example of a TFD showing a read transaction from an entity such as a GPU to memory resources of an xPU or a memory pool, wherein an RPU provides translations between NVLink traffic, such as traffic based on a protocol utilizing NVLink5, and CHI traffic that may be utilized by the coherent interconnect of the xPU or the memory pool. The RPU may further translate physical addresses associated with NVLink to physical addresses associated with CHI, such as when translating from (AS.1.1) to (AS.2.1), optionally utilizing one stage of address translation. The RPU may utilize a streaming interface protocol, such as CXS, and may utilize PCIe as an intermediate protocol over the CXS streaming interface protocol, translating from NVLink to the PCIe intermediate protocol, and/or from the PCIe intermediate protocol to CHI.

The entity/GPU initiates the transaction by sending an NVLink read request carrying a physical address (AS.1.1) to the RPU, which translates the NVLink read request to a PCIe UIO Memory Read request utilizing a UIOMRd TLP type, optionally translating the physical address (AS.1.1) carried in the NVLink read request to a different physical address (AS.2.1) carried in the UIOMRd TLP. The RPU further translates the PCIe UIO Memory Read request to an ARM CHI REQ carrying ReadOnce and a physical address (AS.2.1 in the illustrated example), which is sent via the coherent interconnect to the Home Node (HN). The Home Node processes the request and sends a subsequent ARM CHI REQ with ReadNoSnp and the physical address (AS.2.1), to the Memory Controller (MC) for retrieving the requested data from memory. The Memory Controller accesses the memory and returns the data via an ARM CHI RDAT message carrying CompData and the requested data. The RPU receives the CHI response and translates it to the intermediate protocol, such as to PCIe UIO Read Completion with Data, utilizing a UIORdCplD TLP type, and further translates from the intermediate protocol to an NVLink response carrying the data, which is sent back to the entity/GPU via the NVLink interface, completing the read transaction.

When the RPU provides address translations, these address translations may take place during a stage wherein the RPU translates from NVLink to an intermediate protocol, such as PCIe or CXL. Additionally or alternatively, address translations may take place during a stage wherein the RPU translates from the intermediate protocol, such as PCIe or CXL, to CHI. In some examples, the RPU may perform address translations in stages, such as from a physical address (AS.1.1) in an NVLink request, to physical address (AS.2.1) in a PCIe request or a CXL request, and to physical address (AS.3.1) in a CHI request, optionally providing physical address space isolation between the NVLink domain, the intermediate protocol domain, and the CHI domain. Opcodes, TLP types, or intermediate protocols shown in this example, serve as an example. Other examples may utilize other TLP types such as MRd for a PCIe or CXL request, CplD for PCIe or CXL response, and other intermediate protocols such as CXL.mem or CXL.io.

FIG. 33B illustrates an example of a TFD showing a read transaction from an entity such as a GPU to memory resources of an xPU or a memory pool, wherein an RPU translates between NVLink traffic, such as traffic based on a protocol utilizing NVLink5, and CHI traffic that may be utilized by the coherent interconnect of the xPU or the memory pool. The RPU may further translate physical addresses associated with NVLink to physical addresses associated with CHI, such as when translating from (AS.1.1) to (AS.3.1), optionally utilizing two stages of address translation with an intermediate address (AS.2.1) that may be associated with an intermediate protocol. The RPU utilizes a streaming interface protocol, such as CXS, and may utilize CXL as an intermediate protocol over the CXS streaming interface protocol, translating from NVLink to the CXL intermediate protocol, and/or from the CXL intermediate protocol to CHI.

The entity/GPU initiates the transaction by sending an NVLink read request carrying a physical address (AS.1.1) to the RPU, which translates the NVLink read request to a CXL.cache D2H request comprising RdCurr, optionally translating the physical address (AS.1.1) carried in the NVLink read request to a different physical address (AS.2.1) carried in the CXL.cache D2H request, wherein (AS.2.1) may be an intermediate address associated with the intermediate protocol. The RPU further translates the CXL.cache D2H request to an ARM CHI REQ carrying ReadOnce, optionally translating the physical address (AS.2.1) carried in the CXL.cache D2H request to a different physical address (AS.3.1), carried in the ARM CHI REQ, which is sent via the coherent interconnect to the Home Node (HN). The Home Node processes the request and sends a subsequent ARM CHI REQ with ReadNoSnp and the physical address (AS.3.1), to the Memory Controller (MC) for retrieving the requested data from memory. The Memory Controller accesses the memory and returns the data via an ARM CHI RDAT message carrying CompData and the requested data. The RPU receives the CHI response and translates it to the intermediate protocol, such as to CXL.cache H2D Data, and further translates from the intermediate protocol to an NVLink response carrying the data, which is sent back to the entity/GPU via the NVLink interface, completing the read transaction.

When the RPU provides address translations, these address translations may take place during a stage wherein the RPU translates from NVLink to an intermediate protocol, such as PCIe or CXL. Additionally or alternatively, address translations may take place during a stage wherein the RPU translates from the intermediate protocol, such as PCIe or CXL, to CHI. In some examples, the RPU may perform address translations in stages, such as from a physical address (AS.1.1) in an NVLink request, to physical address (AS.2.1) in a PCIe request or a CXL request, and to physical address (AS.3.1) in a CHI request, optionally providing physical address space isolation between the NVLink domain, the intermediate protocol domain, and the CHI domain. Opcodes, TLP types, or intermediate protocols shown in this example, serve as an example. Other examples may utilize other opcodes, such as CXL.cache RdShared or CXL.cache RdAny, other TLP types such as MRd for a PCIe or CXL request, CplD for PCIe or CXL response, and other intermediate protocols such as CXL.mem or CXL.io.

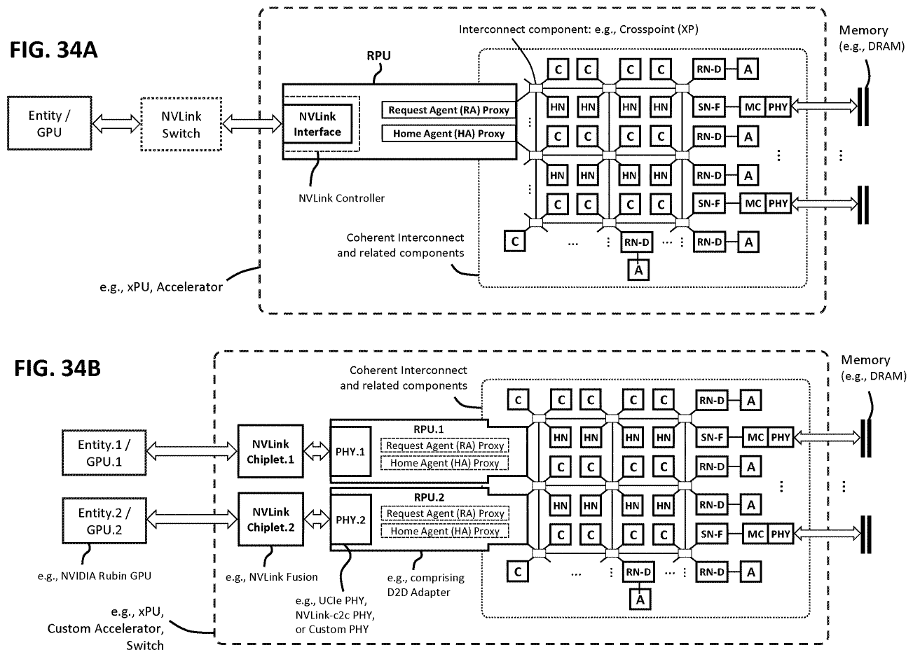

FIG. 34A illustrates an example of a system comprising an external entity coupled to an optional NVLink switch coupled to a processor comprising (such as an xPU) comprising an RPU comprising an NVLink interface, a Request Agent (RA) Proxy, and a Home Agent (HA) Proxy. The RPU may further comprise an NVLink controller, wherein the NVLink controller may include the NVLink interface. The RPU may be coupled to an interconnect component, such as a crosspoint (e.g., XP), optionally via the RA Proxy and/or the HA Proxy, wherein the RPU may communicate with the interconnect component according to a CHI-based protocol. The RPU may be further coupled, via the NVLink interface, and optionally via an NVLink switch, to an external entity, such as a GPU, wherein the RPU may communicate with the external entity according to an NVLink-based protocol. The RPU may translate between messages conforming to the NVLink-based protocol and messages conforming to the CHI-based protocol, possibly enabling the external entity to access resources of the xPU, such as xPU local memory (e.g., DRAM), and/or enabling the xPU to access resources of the external entity, such as remote memory coupled to the entity. The Request Agent (RA) proxy may receive requests that originate outside of the coherent interconnect, such as from remote agents, from the NVLink interface, from the NVLink controller, from an attached accelerator die, or from a remote chip, wherein the RA proxy may represent such remote initiators as a proxy when communicating with the coherent interconnect, e.g., by utilizing a Source ID (SrcID) namespace and a Transaction ID (TxnID) namespace associated with the coherent interconnect. The Home Agent (HA) proxy may own an address window backed by memory that may be placed on another chip or silicon die, such as on the external entity, wherein the HA proxy may enable processing cores of the xPU to access resources coupled to the external entity, such as memory (e.g., HBM and/or HBF).

FIG. 34B illustrates an example of a system comprising an xPU, such as a custom accelerator, that may utilize translations between NVLink and CHI, wherein the xPU may utilize NVLink for communicating with a first entity and with a second entity, which may each be a GPU external to the xPU, and wherein the xPU may further utilize CHI for intra-xPU communications between xPU resources coupled to a coherent interconnect of the xPU. The xPU may include first and second NVLink chiplets, or silicon dies, such as NVLink Fusion, coupled to the first and second entities, respectively. The first and second NVLink chiplets may be further coupled to first and second RPUs, respectively, via first and second physical layers (PHYs), respectively. The first and second RPUs may each include a Die-to-Die (D2D) adapter, a Request Agent (RA) Proxy, and/or a Home Agent (HA) proxy, wherein each RPU may communicate with the coherent interconnect, via the RA Proxy and/or the HA Proxy. The first and second PHYs may each include a UCIe PHY, an NVLink-C2C PHY, or a custom PHY.

The translations between NVLink and CHI may enable the first and/or the second entity to access resources coupled to the coherent interconnect of the xPU; and may further enable processing cores of the xPU to access resources coupled to the first and/or second entity. The translations between NVLink and CHI may further enable the xPU to perform as a switch, such as an NVLink switch, that may utilize NVLink to enable communication between the first entity and the second entity. The first entity may communicate with the second entity via the xPU, such as via the first NVLink chiplet, the first RPU, the coherent interconnect, the second RPU, and the second NVLink chiplet. Similarly, the second entity may communicate with the first entity via the xPU, such as via the second NVLink chiplet, the second RPU, the coherent interconnect, the first RPU, and the first NVLink chiplet.

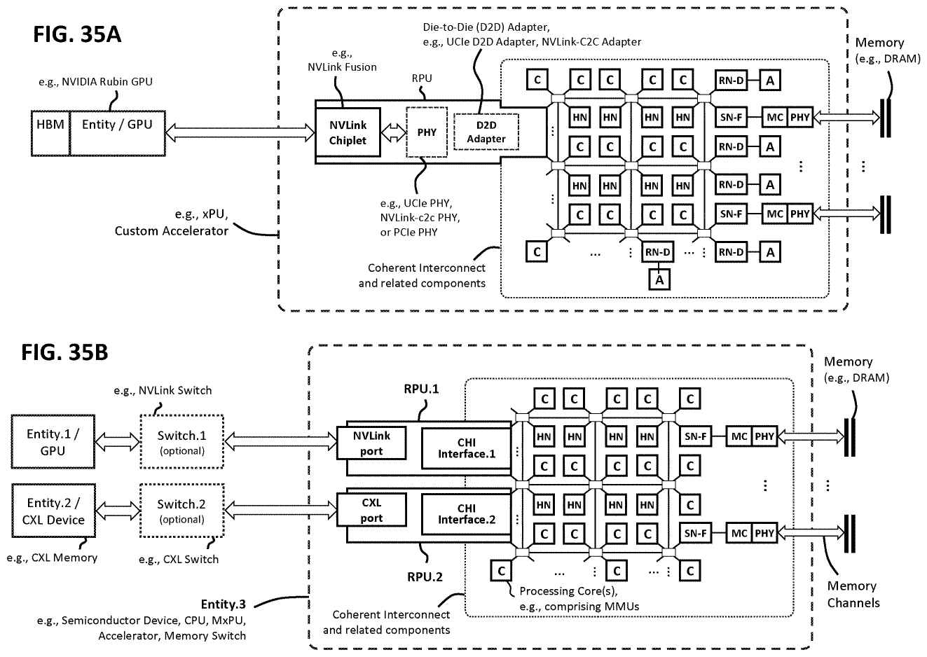

FIG. 35A illustrates an example of a system comprising an xPU comprising an RPU that translates between NVLink traffic and CHI traffic. The RPU may include a die-to-die (D2D) adapter, such as UCIe D2D adapter or NVLink-C2C adapter, which may perform at least one of: (1) Serve as an interfacing logic coupling the coherent interconnect and a die-to-die link; (2) Packetize CHI C2C into flits that can be streamed out to another chip or die, and correspondingly, handle de-packetization in the reverse direction; (3) Provide a CHI interface for connecting to an interconnect component such as a crosspoint (e.g., XP); or (4) Couple to a PHY such as a UCIe PHY, an NVLink-C2C PHY, or a PCIe PHY, for connecting to an NVLink chiplet, such as NVLink Fusion.

FIG. 35B illustrates an example of a system comprising a third entity (Entity.3), such as a semiconductor device, a CPU, an MxPU, an accelerator, or a memory switch, wherein the third entity may be coupled to a memory, such as DRAM, optionally via memory channels. The third entity may include a coherent interconnect, a first RPU (RPU.1) comprising an NVLink port and a first CHI interface (CHI Interface.1), and a second RPU (RPU.2) comprising a CXL port and a second CHI interface (CHI Interface.2). The third entity may be coupled, via the NVLink port and optionally via a first switch (Switch.1), such as an NVLink switch or an NVSwitch, to a first entity (Entity.1), such as a GPU, wherein the third entity may be further coupled, via the CXL port and optionally via a second switch (Switch.2), which may be a CXL switch, to a second entity (Entity.2), such as a CXL device (e.g., CXL memory). The third entity may utilize translations between NVLink and CHI that may enable the first entity to access the memory of the third entity, wherein the third entity may further utilize translations between CXL and CHI that may enable the second entity to access the memory of the third entity.

In some examples, the translations between NVLink and CHI, and the translations between CXL and CHI, may enable the third entity to perform as a switch, such as a multi-protocol switch or a hybrid switch, enabling communication between the first entity and the second entity, which may enable the GPU to utilize the CXL memory. For example, the first entity may communicate with the second entity via the third entity, such as via the first RPU comprising the NVLink port and the first CHI interface (CHI Interface.1), via the coherent interconnect, and via the second RPU that includes the CXL port and the second CHI interface (CHI Inetrface.2). In another example, the second entity may communicate with the first entity via the third entity, such as via the second RPU, the coherent interconnect, and the first RPU.

In some examples, the third entity may enable communication between the NVLink domain and the CXL domain, such as communication between NVLink ports and CXL ports, or communication between NVLink interfaces and CXL ports, whereas in other examples the communication between the NVLink domain and the CXL domain may be restricted, optionally by an access control list (ACL), such as to a subset of the NVLink ports and/or to a subset of the CXL ports. Additionally or alternatively, communication between the NVLink domain and the CXL domain may be restricted to a subset of allowed address regions associated with one or more address spaces, or may be restricted to a subset of allowed protocols, such as CXL.mem (e.g., not allowing CXL.cache transactions).

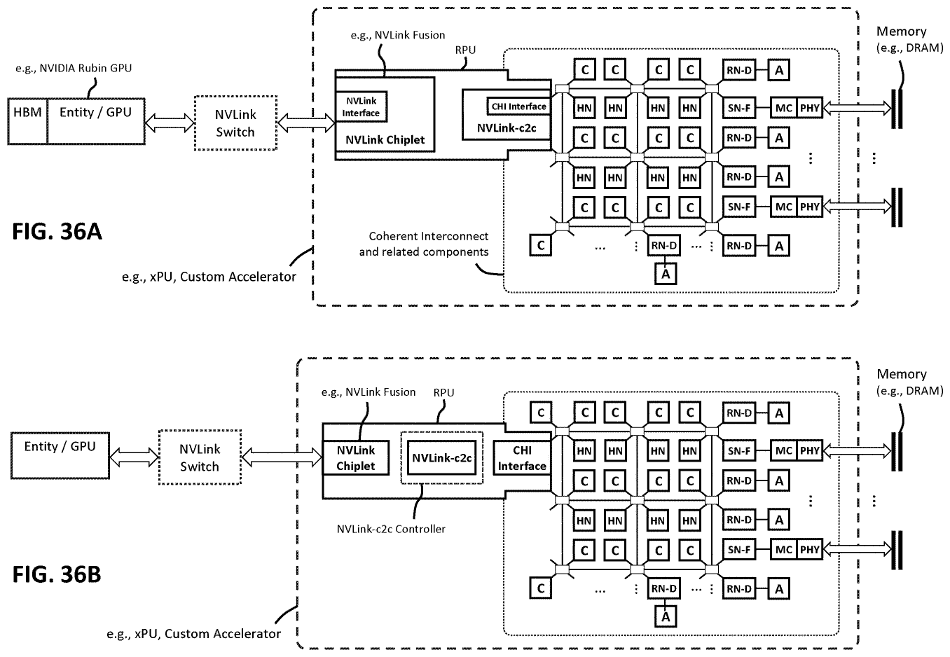

FIG. 36A illustrates an example of a system comprising an xPU or a custom accelerator, coupled to an entity such as a GPU, optionally via an NVLink switch. The xPU includes an RPU which translates between an NVLink traffic and CHI traffic. The RPU includes an NVLink chiplet, such as NVLink Fusion, that provides an NVLink interface for coupling to the external entity. The RPU further includes an NVLink-C2C for coupling the NVLink chiplet to the coherent interconnect, wherein the NVLink-C2C utilizes a CHI interface for connecting to at least one crosspoint of the coherent interconnect. The RPU may provide bi-directional memory access between the xPU and the GPU, enabling the xPU to read from the GPU's HBM, and enabling the GPU to read from DRAM coupled to the xPU. Alternatively, the RPU may provide unidirectional memory access, enabling the GPU to access xPU memory but not vice-versa, such as by exposing at least some of the xPU resources as a memory expander or a memory pool for use by the GPU.

FIG. 36B illustrates an example of a system comprising an xPU coupled to an entity such as a GPU. The xPU includes an RPU which translates between NVLink traffic and CHI-based traffic, wherein the RPU includes a CHI interface for coupling to a coherent interconnect, an NVLink-C2C logic, optionally integrated into an NVLink-C2C controller that includes a transactional layer, a data link layer and a physical layer. The RPU further includes an NVLink chiplet, such as NVLink Fusion, for coupling to the GPU, wherein the NVLink chiplet is further coupled to the coherent interconnect via the NVLink-C2C logic, optionally communicating with at least one crosspoint interconnect component according to a protocol based on ARM CHI.

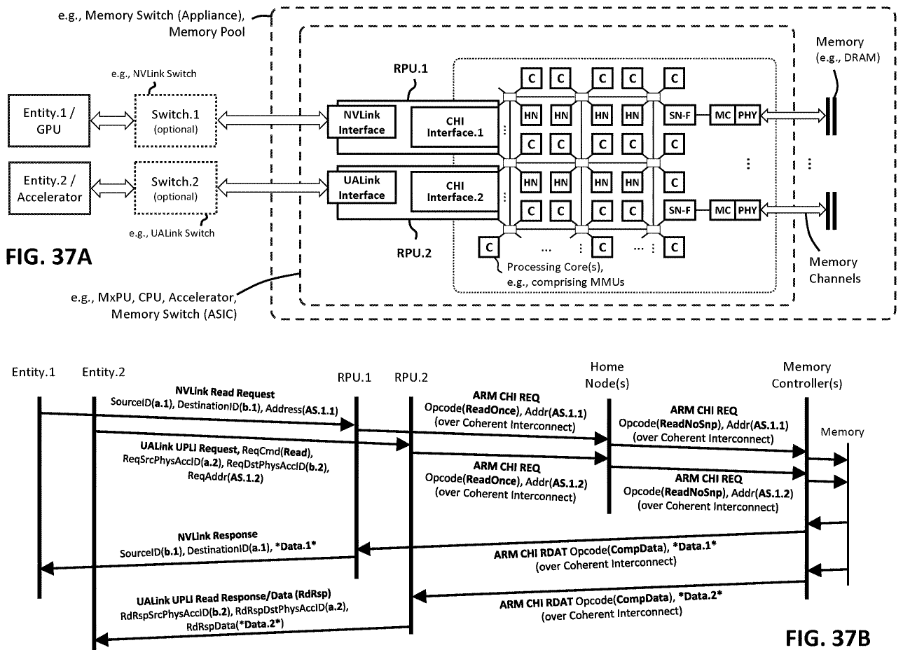

FIG. 37A illustrates an example of a system that may function as a multi-protocol memory switch appliance or a multi-protocol memory pool, and may include an MxPU, CPU, accelerator, or a memory switch ASIC, that may be coupled to two entities, optionally via switches: (1) Entity.1/GPU via an optional first switch (Switch.1), such as an NVLink switch or NVSwitch, and (2) Entity.2/Accelerator via an optional second switch (Switch.2), such as a UALink switch. The MxPU includes processing cores and memory controllers coupled to a coherent interconnect that may be based on CHI. The MxPU may utilize different translations for the external interfaces, performed by different RPUs, such as between NVLink-based interfaces and the MxPU coherent interconnect, or between UALink-based interfaces and the MxPU coherent interconnect. The first RPU (RPU.1) may enable Entity.1/GPU to access resources mapped to a physical address space utilized by the MxPU coherent interconnect, wherein the access is via the optional first switch, the NVLink interface and the MxPU coherent interconnect. Examples of resources mapped to the physical address space utilized by the MxPU coherent interconnect include DRAM or other memory resources of the MxPU. Correspondingly, the second RPU (RPU.2) may enable Entity.2/Accelerator to access, via the optional second switch, the UALink interface and the MxPU's coherent interconnect, resources mapped to a physical address space utilized by the MxPU's coherent interconnect, such as DRAM or other memory resources of the MxPU.

FIG. 37B illustrates an example of a TFD depicting a multi-entity memory access scenario wherein a GPU/first entity and an accelerator/second entity access memory mapped to one or more address spaces utilized by the coherent interconnect (CohInterMappedMemory) utilizing heterogeneous protocol message translations. Entity.1/GPU.1 initiates an NVLink request: Read with SourceID(a.1) to identify the source GPU, DestinationID(b.1) to identify the destination, and Address(AS.1.1) representing a physical address, such as an NVLink network address. RPU.1 translates the NVLink request to ARM CHI REQ carrying Opcode(ReadOnce) while preserving Addr(AS.1.1) unchanged. Concurrently or sequentially, Entity.2/Accelerator may initiate a UALink UPLI request (Req) with ReqCmd(Read), ReqSrcPhysAccID(a.2) to identify the source accelerator, ReqDstPhysAccID(b.2) to identify the destination, and ReqAddr(AS.1.2) representing a request address, such as a network physical address (NPA). RPU.2 translates the UALink UPLI request to ARM CHI REQ carrying Opcode(ReadOnce) while preserving Addr(AS.1.2) unchanged. Both transactions flow through the coherent interconnect to one or more home nodes, which may send respective ARM CHI REQ messages to one or more memory controllers with Opcode(ReadNoSnp) and the addresses Addr(AS.1.1) and Addr(AS.1.2), respectively. The memory controller(s) retrieve the requested data from the CohInterMappedMemory and send first and second ARM CHI RDAT messages with Opcode(CompData) carrying Data.1* and *Data.2*, representing the data retrieved from the addresses AS.1.1 and AS.1.2, respectively. RPU.1 translates the first ARM CHI RDAT message to NVLink response with SourceID(b.1), DestinationID(a.1), and Data.1* for Entity.1/GPU. RPU.2 translates the second ARM CHI RDAT message to UALink UPLI read response/data (RdRsp) with RdRspSrcPhysAccID(b.2), RdRspDstPhysAccID(a.2), and RdRspData(*Data.2*) for Entity.2/Accelerator.

The illustrated example demonstrates how heterogeneous entities utilizing different protocols may share access to the same CohInterMappedMemory through different RPUs that translate messages between different protocols while preserving the physical addresses. Alternatively, the illustrated example may be viewed as separate NVLink and UALink transactions that utilize the same coherent interconnect infrastructure to access the CohInterMappedMemory. Still alternatively, the response and read data paths may be implemented according to other designs, such as wherein the memory controller(s) may send the data to the home node(s) that send it to the respective RPUs, or the home node(s) send responses to the RPUs while the memory controller(s) send the data to the RPUs.

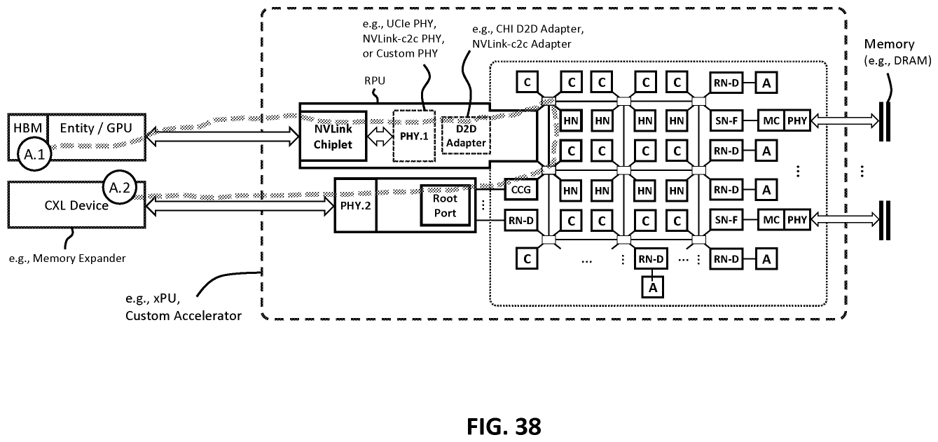

FIG. 38 illustrates an example of a heterogeneous computing system comprising an xPU or custom accelerator that utilizes an ARM-based mesh architecture with protocol interconnections. The xPU comprises a coherent interconnect implemented as a mesh topology with crosspoints (XP) that route transactions between various system components. Processing cores (C) are distributed throughout the mesh architecture and coupled to the coherent interconnect via the crosspoints. Home nodes are positioned within the mesh, optionally including HN-I nodes that may handle I/O-coherent transactions and HN-F nodes that may manage fully coherent transactions. System Node Fully coherent (SN-F) nodes are coupled to memory controllers (MC) which interface with external memory via physical layers (PHYs). The memory may be DRAM accessible through the memory channels. An entity comprising an NVIDIA Rubin GPU with integrated HBM is coupled to the xPU coherent interconnect via an NVLink chiplet. The NVLink chiplet, which may be an NVLink Fusion chiplet or custom PHY, is coupled utilizing a first physical layer (PHY.1, such as a UCIe PHY) to a die-to-die (D2D) adapter, which may be a CHI D2D Adapter or an NVLink-C2C Adapter, that enables communication between the NVLink chiplet and the coherent interconnect. The NVLink chiplet may provide the NVLink physical layer interface and may additionally provide higher protocol layers including the NVLink data link layer and transaction layer functionality.

Moreover, a CXL device, which may be a memory expander, may be coupled to the xPU coherent interconnect via a second physical layer (PHY.2) and a root port. The root port provides the interface between the CXL device and the coherent interconnect, enabling the CXL device to be discovered and configured by the system. The xPU architecture may enable the GPU to access memory resources of the CXL memory expander utilizing translations performed by the RPU and the coherent interconnect. The transaction path denoted as A.1 to A.2 in the figure illustrates a memory access flow that may represent an NVLink read transaction initiated by the GPU. The transaction may traverse from the GPU through the NVLink chiplet to the ARM mesh interconnect, wherein the RPU may translate the NVLink read request to a CHI transaction compatible with the ARM mesh interconnect. The CHI transaction may then be routed through the coherent interconnect to the appropriate home node and subsequently to the root port, wherein it may be further translated to a CXL.mem MemRd transaction for delivery to the CXL memory expander (A.2). The xPU may additionally comprise accelerator cores that may perform specialized computation tasks and may access both the GPU-attached HBM and the CXL-attached memory through the coherent interconnect.

### Terminology

The term “Compute Express Link” (CXL) refers to currently available and/or future versions, variations and/or equivalents of the standard as defined by the CXL Consortium. CXL Specification Revisions 1.1, 2.0, 3.0, 3.1, 3.2, and 4.0 are herein incorporated by reference in their entirety.

The term “PCI Express” (PCIe) refers to currently available and/or future versions, variations and/or equivalents of the standard as defined by PCI-SIG (Peripheral Component Interconnect Special Interest Group). PCI Express Base Specification Revisions 5.0, 6.0, 6.1, and 6.2 are herein incorporated by reference in their entirety.

The term “Ultra Accelerator Link” (UALink) refers to currently available and/or future versions, variations and/or equivalents of the UALink Specification as defined by the Ultra Accelerator Link Consortium, Inc. UALink_200 Rev 1.0 Specification and its subsequent revisions are herein incorporated by reference in their entirety.

The term “Universal Chiplet Interconnect Express” (UCIe) refers to currently available and/or future versions, variations and/or equivalents of the standard as defined by the UCIe Consortium. UCIe Specification Revisions 1.0, 1.1, 2.0, and 3.0 are herein incorporated by reference in their entirety.

The term “Resource Provisioning Unit” (RPU) refers to a physical and/or logical processing module comprising or coupled to at least two interfaces and/or ports. The RPU may be implemented in various hardware, firmware, and/or software configurations, such as an ASIC, an FPGA, a logical and/or physical module inside a CPU/GPU/TPU/MxPU, a hardware accelerator, a host, a device, a controller, a switch, a memory pool, and/or a network node. The RPU may be implemented as a single module, a single computer, and/or as a distributed computation entity running on a combination of computing machines, such as ASICs, FPGAs, hosts, servers, network devices, CPUs, GPUs, accelerators, fabric managers, and/or switches. Unless the context indicates otherwise, descriptions of the RPU as comprising its interfaces and/or ports, descriptions of the RPU as being coupled to such elements, and descriptions of such elements as being part of or separate from the RPU, may be used herein interchangeably. Furthermore, references to the RPU performing operations may encompass both direct implementation by the RPU and indirect implementation through components coupled to or associated with the RPU, unless specifically distinguished by the context.

Various implementations described herein involve interconnected computers. The term “computer” refers to a device, an integrated circuit (IC), or a system that includes at least a processor or processing element, memory to store instructions or data, and a communication interface. This definition encompasses a wide range of implementations, including but not limited to: traditional computers, mobile devices, embedded systems, specialized computing elements (such as GPUs, FPGAs, ASICs, and DSPs), System-on-Chip (SoC) designs, network nodes, RPUs, MxPUs, and ICs incorporating processing capabilities, memory, and a communication interface. The processor may be of any type, including single-core or multi-core microprocessors, embedded controllers, accelerators, or any combination thereof. The memory may include volatile or non-volatile storage media. The communication interface allows the processor to send and/or receive data, signals, or instructions, and may include memory interfaces, buses, interconnects, network interfaces, or other arrangements facilitating data exchange. References to a “computer” or a “processor” include any collection of one or more computers and/or processors that individually or jointly execute one or more sets of computer instructions, meaning that the singular term “computer” is intended to imply one or more computers, which jointly perform the functions attributed to “the computer”.

It is noted that in an apparatus comprising interconnect interfaces and/or ports, the computer may be implemented as part of one or more of the interconnect interfaces and/or ports, as a separate component, or as a combination thereof. Unless the context indicates otherwise, operations attributed to the computer may be performed by one or more of the interconnect interfaces and/or ports, and conversely, relevant operations attributed to one or more of the interconnect interfaces and/or ports may be performed by the computer. This interchangeability applies to relevant processing operations described in this specification in relation to elements such as the computer, RPU, MxPU, xPU, switch, or the interconnect interfaces and/or ports.

The term “memory pool” refers to a system, an apparatus, a device, and/or a logically or physically distinct collection of resources that may incorporate, manage, or otherwise control memory capacity (such as volatile memory (e.g., DRAM) and/or non-volatile memory), and that may provide the capability to provision, allocate, deallocate, expose, share, map, and/or otherwise make available portions or aspects of its memory capacity for use, access, sharing, allocation, and/or consumption by one or more entities external to the memory pool. Such entities may include, but are not limited to, hosts, servers, processors, accelerators, computing devices, virtual machines, containers, processes, applications, services, operating systems, hypervisors, or other memory pools. Memory pool encompasses relevant implementations that perform functions related to memory resource aggregation, management, provisioning, and/or sharing, irrespective of its commercial designation, physical form factor, architectural design, interconnection method, communication protocol(s), or implementation methodology. A memory pool may also be capable of running workloads, applications, and/or computational tasks, thereby functioning as both a memory entity and a compute entity. Furthermore, a memory pool may be implemented as a logical entity that borrows, aggregates, or otherwise utilizes memory resources from other entities (such as hosts, devices, or other memory pools), rather than solely relying on dedicated physical memory resources under its direct control.

Depending on the context, the term “inter-socket link” (ISoL) may refer to any current or future high-speed communication link, interconnect, protocol, and/or architecture that facilitates data transfer between processors, such as CPUs, GPUs, TPUs, accelerators, DSAs, and/or other types of processing units. The interface points for these technologies may be collectively referred to as “ISoL ports”, though they may have technology-specific designations. ISoL encompasses direct inter-processor links, switched fabric designs, node controller-based topologies, optical interconnects, and/or heterogeneous computing interconnects linking different processor types. These interconnects support various processor arrangements including those soldered to PCBs, installed in motherboard sockets, or integrated as separate dies within chiplet-based designs.

Non-limiting examples of ISoL technologies include Intel's Coherent Processor Interconnect Protocol (ICPIP) for scalable multiprocessors with a shared physical address space, such as Ultra Path Interconnect (UPI); AMD's Infinity Fabric (IF) and its underlying External Global Memory Interconnect (xGMI); ARM's Coherent Hub Interface chip-to-chip (CHI C2C); NVIDIA's NVLink and NVLink chip-to-chip (NVLink-C2C); Ultra Accelerator Link (UALink); Ethernet for Scale-Up Networking (ESUN), and Scale Up Ethernet (SUE), including SUE-based Protocol Data Units (PDUs) such as SUE PDU, SUE Lite PDU, or PDUs based on future revisions of SUE. Each of these technologies, their successors, and other technologies developed in the future, implements specific port, interface, and protocol designs for inter-processor communication. The interface points for these technologies may have technology-specific designations, such as “UPI port” or “UPI link” for Intel processors, “IF link” or “xGMI link” for AMD processors, “NVLink port”, “NVLink link”, or “NVLink interface” for NVIDIA GPUs, or “UALink port”, “UPLI interface”, or “UPLI interface port” for UALink implementations.

A Cache-Coherent Chip-to-Chip Interconnect (CCCI) refers to a subset of ISoL that enables communication between processors while maintaining cache coherency across chips. CCCI may connect various types of processing units, such as CPUs to CPUs, GPUs to GPUs, CPUs to GPUs, or other combinations of processing units, and may implement cache coherency protocols such as MESI (Modified, Exclusive, Shared, Invalid), MOESI (Modified, Owned, Exclusive, Shared, Invalid), or other coherency schemes. The cache coherency support provided by CCCI may enable the processing units to efficiently share data, maintain memory consistency, and coordinate access to shared resources. Examples of ISoL technologies that function as CCCI include Intel's UPI, AMD's xGMI and Infinity Fabric, ARM's CHI C2C, and NVIDIA's NVLink-C2C.

The term “Physical Layer” or “PHY” refers to hardware and protocol responsible for transmission and reception of signals, typically in the context of data communication wherein raw data bits are converted to physical signal representations, and vice versa, to be sent and received over a target medium such as copper twin-axial (Twinax) cabling, fiber optics, PCB traces for chip-to-chip (C2C) communication, or a silicon interposer for die-to-die (D2D) connectivity. The physical layer (PHY) is typically associated with the lower layer, or layer 1, of the Open System Interconnection (OSI) reference model, and may include, but is not limited to, sub-layers such as a Physical Coding Sublayer (PCS), a Physical Medium Attachment (PMA), and a Physical Medium Dependent (PMD). Examples of physical layers may include the Flex Bus Physical Layer as specified in the various CXL specifications, the collection of physical layers defined by the IEEE 802.3 Working Group, sometimes collectively referred to as “802.3 PHY”, “Ethernet PHY”, or “IEEE 802.3 PMA” when referring to sub-layers of the PHY, such as a PMA. Other PHYs may include UALink physical layers, such as UALink_200 Rev 1.0 that is based on IEEE 802.3dj (D1.4 ), NVIDIA NVLink physical layers, Ultra Ethernet Transport (UET) physical layers, or other appropriate current or future communication technologies.

When referring to fields, operations, or operation types associated with communication protocols, the terms “opcode”, “command”, “TLP type”, “request”, “request type”, “transaction”, and “transaction type” may be used herein interchangeably as long as they refer to the same operation, and unless a particular context specifies otherwise. This interchangeable usage may apply to data indicative of operation types (such as a field or a set of fields) within messages, packets (such as TLPs), flits, phits, frames, protocol data units (PDUs), or other protocol data structures, as well as descriptions of protocol operations, requests, transactions, or communications across different communication protocols. For example, a “CXL.cache DirtyEvict opcode”, a “CXL.cache DirtyEvict command”, and a “CXL.cache DirtyEvict request” may refer to the same operation where a device communicates with a host, such as via a D2H request message, asking the host to evict a full 64-byte modified cacheline from the device. Likewise, an “ARM CHI ReadOnce opcode”, an “ARM CHI ReadOnce command”, an “ARM CHI ReadOnce request”, and an “ARM CHI ReadOnce transaction” may refer to the same operation that specifies a read within the CHI framework, whether referring to the actual field within a CHI message or to the operation itself. Similarly, a “UPLI read command”, a “UPLI read opcode”, a “UPLI read request”, and a “UPLI read transaction” may refer to the same operation, field, or set of fields within a UPLI message that indicates a read within the UPLI framework.

The CXL Specifications use terms such as message, transaction, command, opcode, request, and response in contexts that sometimes overlap. For example, “MemRd message”, “MemRd command”, and “MemRd opcode” may refer to similar or related concepts. Similarly, “CXL.mem message”, “CXL.mem transaction”, “CXL.mem request”, and “CXL.mem response” may be used in overlapping contexts. Accordingly, depending on the context, this specification may use such terms broadly. Additionally, references to CXL messages may encompass CXL transactions, and vice versa. Moreover, the CXL Specifications occasionally describe CXL.cache and CXL.mem using various terms such as protocols, channels, interfaces, or transactional interfaces, which may be used herein interchangeably depending on the context.

Depending on the context and implementation, the terms “UALink requests”, “UALink UPLI requests”, and “UPLI requests” may be used herein interchangeably. The interchangeable use of these terms reflects that UPLI constitutes the protocol layer of UALink communications, and unless a particular context requires distinction between the physical layer aspects and the protocol layer aspects, these terms may refer to the same underlying communication transactions within the UALink ecosystem.

In the context of ARM CHI implementations, the terms “CHI messages”, “CHI packets”, and “CHI flits” may be used herein interchangeably, unless a particular context specifies otherwise. The ARM AMBA CHI Architecture Specification defines communication granularity at different layers, including transactions at the protocol layer, packets at the network layer, and flow control units (flits) at the link layer. For CHI, packets may include a single flit, which may contribute to the interchangeable use of these terms. When referring to CHI communications herein, any of these terms may be used to describe CHI protocol-level communications without implying limitations to a specific layer or format.

The terms “port” and “interface” may be used herein interchangeably unless the context requires distinction between them. Depending on the context, a port may refer to a physical or logical connection point configured to support communication with or within components, devices, or systems. A port may include, be included in, or be coupled to various interface types, may support one or more communication protocols and/or may refer to various specialized port types depending on the context. For example, the following pairs may be used herein interchangeably unless a particular context specifies otherwise: CHI interface and CHI port, CXL interface and CXL port, UALink interface and UALink port, and NVLink interface and NVLink port.

The term “Coherent Hub Interface” (CHI) as used herein is intended to encompass presently available and future versions, variations, revisions, and equivalent implementations of the CHI interconnect architecture, including AMBA 5 CHI and subsequent issues or architectural extensions published or adopted by ARM or by other entities that may extend CHI. Unless stated otherwise, translating between CHI and another protocol, such as translating between CHI and CXL, refers to converting CHI-related protocol data units (PDUs), such as CHI requests, CHI snoop requests, CHI data responses, and CHI snoop responses, to corresponding PDUs of the other protocol, such as to CXL.cache requests and responses, or to CXL.mem requests and responses, and vice versa, optionally including field value translations between the CHI domain and the other protocol domain, such as addresses, transaction identifiers, and/or cache state indications.

The term “NVLink” as used herein is intended to encompass previous, current, and future versions, variations, revisions, and equivalent implementations of NVIDIA's NVLink interconnect, including NVLink-C2C, NVLink used with NVSwitch and/or NVLink Switch fabrics, and other NVLink-related implementations that provide a high-bandwidth, low-latency, scalable interconnect between GPUs, between GPUs and CPUs, and/or between other types of processing units. Unless stated otherwise, translating between NVLink and another protocol, such as translating between NVLink and CXL, refers to converting NVLink-related protocol data units (PDUs), such as NVLink requests and NVLink responses, to corresponding PDUs of the other protocol, such as to CXL.io requests and completions, or to CXL.mem requests and responses, and vice versa, optionally including field value translations between the NVLink domain and the other protocol domain, such as Tags, error indications, and/or addresses.

### General Considerations

Asterisks (*) may be utilized as wildcard notations within the context of an implementation and/or an example, such as for representing a subset of relevant operations within a broader set of operations that may be indicated by opcodes, TLP types, commands, requests, request types, transactions, or transaction types, collectively referred to in this specific paragraph as “operation types”. The subset of relevant operations may include operation types that are relevant to the revisions or standards being discussed, encompassing both existing operation types and potential future operation types that may be introduced in subsequent versions of the applicable interconnect standards, including CXL, UALink, ESUN, SUE, PCIe, UCIe, ARM CHI, ARM AXI, or protocol implementations based on NVLink technology, provided they are applicable and relevant to the implementation in question. For example, the wildcard operation type ReadOnce* may represent a subset of relevant requests or transactions within the ARM CHI specifications, which may include, but is not limited to: ReadOnce, ReadOnceCleanInvalid, and ReadOnceMakeInvalid. Similarly, the wildcard operation type MemRd* may represent a subset of relevant opcodes within the CXL standard, which may include, but is not limited to: MemRd, MemRdData, MemRdFwd, MemRdTEE, MemRdDataTEE, or other opcodes that may be introduced in future CXL standard revisions, provided they are relevant to the implementation under consideration. Likewise, the wildcard operation type *Rd* may represent a broader subset of relevant operations across different protocols or different standards, which may encompass, but is not limited to: (1) ReadNoSnp, ReadOnce, ReadClean, ReadShared, ReadUnique and MakeReadUnique commands in ARM CHI; (2) UIOMRd and MRd TLP types in CXL.io; (3) RdCurr, RdOwn, RdShared, RdAny, and RdOwnNoData opcodes in CXL.cache; (4) MemRd, MemRdData, MemRdFwd, MemRdTEE, MemRdDataTEE, MemSpecRd, or MemSpecRdTEE opcodes in CXL.mem; (5) read commands in UALink UPLI; (6) memory read TLP types in PCIe; (7) read-class operations in SUE; or (8) read request types in NVLink-based protocol implementations. The examples listed for each protocol are non-limiting and are intended to encompass future operation types that may be introduced in subsequent revisions of the applicable standards, provided they are relevant to the implementations. The wildcard notation does not extend to operation types that are irrelevant to the implementation in question, even if such operation types exist within the broader specifications of the respective standards.

The wildcard form “*Data*” may be utilized for denoting essentially the same underlying information (“the Data”) irrespective of its representation, state, or protocol encoding. *Data* may encompass functionally equivalent forms and transformations of “the Data”, such as encoding, packetization, encapsulation, serialization, scrambling, compression, encryption, segmentation, or splitting, and their respective reverse transformations, represented in a suitable structure, manner, form, or format that may be carried by or interoperate with the applicable interconnect standard specifications, such as CXL, UALink, ESUN, SUE, PCIe, UCIe, ARM CHI, ARM AXI, or NVLink-based protocol implementations. For example, *Data* may refer to the same essential data payload when carried across different hops of a communication path that may each use different encryption, such as when one hop utilizes CXL Integrity and Data Encryption (CXL IDE) and another hop utilizes a different encryption mechanism or no encryption, or when different encryption keys are used on different interconnect links or channels. *Data* may further encompass the same essential data payload when carried in PDUs associated with the same or different protocols, such as: a CXL.mem S2M Data Response (DRS), a CXL.cache H2D Data message, a PCIe Completion with Data (CplD), a PCIe UIO Read Completion with Data (UIORdCplD), a UALink UPLI Data Beat carrying Read Response Data, or an NVLink data transmission. *Data* may also denote PDUs having collectively essentially the same payload, such as when splitting a 128 B cacheline into two 64 B transfers carried in two separate messages, or when an RPU splits a request for a large data block into smaller requests for translation to another protocol that supports a smaller maximum transfer size per request.

Depending on the context, each line, arrow, label, and/or box illustrated in the figures may represent one or more lines, arrows, labels, and/or boxes. For example, a single arrow representing a *Rd* operation in CXL, UALink UPLI, ESUN, SUE, PCIe, or an NVLink-based protocol may encompass one or more read or data messages relevant to the specific implementation and applicable standard, even though each may be represented by a single arrow. Additionally, optional messages, such as completion, acknowledgment, or response messages in the respective standards, may be explicitly depicted or implicitly included within the mandatory messages or their equivalents.

It is specifically noted that the transaction flow diagrams (TFDs) presented herein are schematic representations, which means that the number, order, timings, dimensions, and other properties of the information illustrated in the TFDs are non-limiting examples. Every modification, variation, or alternative allowed by a current or future Specification mentioned in the TFD (such as CXL, UALink, ESUN, SUE, PCIe, UCIe, CHI, AXI, etc.) that is relevant to a diagram, is also intended to be included within the scope of said diagrams. Furthermore, the scope of these diagrams extends to encompass implementations that may deviate from the strict specifications mentioned in the TFDs due to factors such as hardware bugs, relaxed designs, or implementation-specific optimizations.

Herein, terms such as send/sending, receive/receiving, communicate/communicating, or exchange/exchanging when used to describe elements (e.g., computer, RPU, MxPU, processor, semiconductor device, switch, port, interface) involved in data, message, packet, or other information exchanges, may refer to direct or indirect operation(s) that facilitate information transfer to/from/between such elements. When a first element is said to send information to a second element, it is not required to directly transmit the information from the first element to the second element; similarly, when a first element is said to receive information from a second element, the first element is not required to directly obtain the information from the second element. Instead, the elements may initiate, cause, make available, control, direct, participate in, or otherwise facilitate such transfer. The information transfer may occur directly or indirectly utilizing one or more intermediary components, such as switches, retimers, redrivers, bridges, and/or protocol translators, and may include routing, forwarding, encryption, buffering, protocol conversion, or other suitable data transfer mechanisms over a suitable communication path and/or connection. Similarly, sentences in the form of “a port/interface configured to communicate with an entity” refer to direct or indirect coupling between the port/interface and the entity.

As used herein, “mounted to” refers to a physical coupling between components, such as cards, boards, or devices, where a first component is mechanically secured or attached to a second component through a suitable mounting mechanism. The physical mounting may be direct or may involve intermediate mounting structures, and encompasses components that are mounted on, mounted in, mounted within, mounted through, mounted under, mounted alongside, or mounted via a mechanical coupling arrangement. The physical mounting connection may include an electrical connection integrated with the mechanical mounting mechanism, such as when a card is inserted into a slot with integrated electrical contacts. Alternatively, the electrical connection between mounted components may be established through a separate element from the mechanical mounting structure. Non-limiting examples of such separate electrical connection elements may include: cables (such as MCIO cables, SlimSAS cables, or power cables), sockets, card edge connectors, PCIe connectors, CXL connectors, backplane connectors, EDSFF connectors, OCP connectors, QSFP-DD connectors, or other electrical interconnects suitable for establishing electrical communication between the mounted components.

References to a protocol “based on” a specific standard or an industry standard (such as a protocol based on CXL, a CXL-based protocol, a protocol based on UALink, a UALink-based protocol, a protocol based on NVLink, an NVLink-based protocol, a protocol based on CHI, a CHI-based protocol, a protocol based on Ethernet, an Ethernet-based protocol, a protocol based on PCIe, or a PCIe-based protocol) are intended to encompass protocols that conform to the referenced standard, as well as protocols that maintain the fundamental communication logic and essential functional characteristics of the referenced standard while potentially incorporating modifications, extensions, or variations. Non-limiting examples of such variations may include protocols that utilize renamed, reordered, or modified fields while preserving the same or similar message formats; protocols that implement essentially the same logical operations utilizing equivalent command sequences or opcodes; protocols that preserve the essential addressing schemes, routing logic, and coherency models; vendor-specific implementations that add proprietary extensions while maintaining core functionality; protocols that implement subsets of the full standard specification; or protocols that adapt the standard for different physical layers or transport mechanisms while maintaining the essential protocol properties. For example, a CXL-based protocol may encompass implementations that rename CXL.mem opcodes but preserve their memory access properties, add vendor-defined fields to CXL message formats while maintaining backward compatibility, or that implement CXL transaction flows over alternative physical layers such as IEEE 802.3 PMA or UCIe. A UALink-based protocol may encompass implementations that add vendor-defined fields, packets, or commands while preserving the essential accelerator-to-accelerator communication model. A PCIe-based protocol may encompass implementations that utilize non-PCIe physical layers or carrier protocols for transferring PCIe TLPs. An NVLink-based protocol may encompass implementations that extend or modify the command encoding while maintaining the fundamental interconnect functionality.

References to a protocol-based port (such as CXL-based port, UALink-based port, NVLink-based port, or PCIe-based port) are intended to encompass ports that communicate according to the referenced protocol or according to a protocol based on the referenced protocol. A protocol-based port may communicate over the protocol's native physical layer, over alternative physical and/or transport layers, or according to the protocol encapsulated within, tunneled over, or transported over other protocols or interconnect technologies. For example, a CXL-based port may refer to a standard CXL port communicating over PCIe physical layer, a port communicating according to CXL over a physical layer based on IEEE 802.3 PMA, or a port communicating according to CXL over UCIe. A UALink-based port may communicate over its native physical layer, over UCIe, over ESUN, or over SUE. Similarly, an NVLink-based port may communicate over its native physical layer, over UCIe, over ESUN, or over SUE.

The drawings presented herein are schematic representations, meaning that the number, order, timings, dimensions, connections, and other properties of the elements illustrated in the drawings are non-limiting examples. Depending on the context, elements (such as lines, arrows, boxes, blocks, symbols, or labels) illustrated in the drawings may represent one or more actual elements. For example, a single box in a block diagram may represent multiple hardware components or software modules, a single arrow in a flowchart may represent multiple process steps or data transfers, and a single line in a circuit diagram may represent multiple electrical connections. Every modification, variation, or alternative allowed by current or future relevant specifications, standards, or common practices in the field is intended to be included within the scope of said drawings. Furthermore, the scope of the drawings extends to encompass implementations that may deviate from strict specifications due to factors such as hardware bugs, relaxed designs, implementation-specific optimizations, or practical constraints, provided such deviations do not fundamentally alter the underlying principles of the implementation.

A computer program (also referred to as software, firmware, or executable logic) encompasses any set of instructions, logic, or data structures executable or interpretable by a computing device. This includes compiled or interpreted code, scripts, and machine-learning models (e.g., neural network weights, biases, and configurations). The computer program may be deployed as a standalone application, autonomous agent, service, microservice, container, or distributed module, and may be organized within any storage architecture, including file systems, object storage, or memory-mapped configurations. The program may reside locally, in a distributed network, or a cloud environment, and may utilize static or dynamic execution paradigms.

As used herein, “non-transitory computer-readable medium” refers to any tangible medium capable of storing instructions, code, or data for access by a computing device, excluding transitory propagating signals. This encompasses all forms of volatile and non-volatile memory, including semiconductor memory (e.g., RAM, Flash, RRAM, MRAM), magnetic storage, optical storage, and emerging persistent storage technologies. The medium may be integral to a device, removable, or distributed across multiple locations (e.g., a distributed database or cloud storage). The instructions, logic, or data structures may be pre-installed or downloaded to the medium via a communication network, such as the Internet. A computer program product comprises such a non-transitory medium containing content that, when accessed by one or more processors, performs the disclosed methods.

The “computer-implemented methods” described herein refer to method operations executed by processing hardware based on logical instructions, firmware, and/or hardwired logic. The processing hardware may include general-purpose processors, ASICs, FPGAs, or other hardware logic that implements the method operations through software execution, firmware execution, dedicated circuitry, or combinations thereof. The execution environment may be centralized or distributed, encompassing standalone devices, networked systems, cloud-based platforms, edge computing nodes, virtualized or containerized environments, and hybrid combinations thereof. The instructions or logic defining the method may be stored on one or more non-transitory computer-readable media, encoded in hardware description languages, and/or implemented in circuit logic.

Unless specifically requiring a particular implementation form, functionality described as implemented in hardware may alternatively be implemented in software, firmware, or a combination thereof, and vice versa. Similarly, functions described as performed by a single component may be distributed across multiple components, and functions described as distributed may be consolidated into a single component. The allocation of functions between hardware and software, or between centralized and distributed implementations, does not limit the scope of the implementations unless explicitly required.

The methods, algorithms, logics, processes, operations, and system functions described herein are not limited by a particular order, timing, sequence, grouping, or a specific implementation or example described or illustrated unless expressly stated otherwise. Steps, operations, and functions may be performed in any reasonable order, simultaneously or sequentially, in parallel or series, and may be combined, separated, modified, rearranged, omitted, supplemented, or distributed across multiple systems or components based on particular implementation requirements. Any process descriptions, steps, or blocks in flowcharts or other illustrations should be understood as potentially representing modules, segments, portions of code, or operations that may be executed in any reasonable order, combination, or concurrently, and are not necessarily limited to the particular sequence depicted.

Phrases such as “an implementation”, “various implementations”, “some implementations”, “one or more implementations”, “an embodiment”, “some embodiments”, “one embodiment”, “an aspect”, “a configuration”, “an example”, and similar phrases are used herein for convenience and do not imply that a disclosure relating to such phrase(s) is essential to the subject technology or that such disclosure applies to all implementations of the subject technology. Phrases such as “an implementation”, “some implementations”, or “various implementations” may refer to one or more implementations and vice versa, and this applies similarly to other foregoing phrases. Distinct references, including terms such as “one implementation”, “another implementation”, “various implementations”, or “some implementations”, do not necessarily denote separate implementations. Such references may describe the same implementation from different perspectives, highlight various aspects of a single implementation, or pertain to distinct implementations. References to examples or instances are to be understood as non-limiting.

Sentences in the form of “X is indicative of Y” mean that X includes information correlated with Y and/or describing Y, up to the case wherein X equals Y. Sentences in the form of “provide/receive an indication (of whether X happened)” may refer to any indication method. The word “most” of something is defined as above 51% of the something (including 100% of the something). The words “portion”, “subset”, “region”, and “area” of something refer to a value between a non-zero fraction of the something and 100% of the something, inclusive; they indicate an open-ended claim language, thus, for example, sentences in the form of “a portion of the memory” or “a subset of the memory” encompass anything from just a small part of the memory to the entire memory, optionally together with additional memory region(s). Sentences in the form of “access the memory” encompass accessing at least a portion of the memory, where the portion may range from a minimal addressable unit to the entire memory capacity, indicating an open-ended claim language. “Coupled” indicates direct or indirect connection, cooperation, and/or interaction, such as direct or indirect physical contact, electrical connection, and/or software and/or hardware interface; the connection between coupled elements may (or may not) involve one or more of passive components, active components, translations, modulation change, modifications to schemes, message alterations, and/or other conversions to the data or signals being transmitted.

The use of “a” or “an” refers to one or more things. The phrase “based on” indicates an open-ended claim language, and encompasses “based, at least in part, on”. Additionally, stating that a value is calculated “based on X” and following that, in a certain implementation, that the value is calculated “also based on Y”, means that in the certain implementation, the value is calculated based on X and Y. Variations of the terms “utilize” and “use” indicate an open-ended claim language, such that sentences in the form of “detecting X utilizing Y” are intended to mean “detecting X utilizing at least Y”, and sentences in the form of “use X to calculate Y” are intended to mean “calculate Y based on X”. The terms first, second, and so forth serve merely as ordinal designations, and shall not be limited in themselves. The phrases “at least one of A or B” and “at least one of A and B” are intended to be interpreted broadly to encompass A alone, B alone, or a combination of both A and B; this interpretation applies regardless of the number of items in a list, or whether the items are connected by the conjunction ‘and’ or ‘or’. A predetermined, predefined, or preselected value is a fixed value and/or a value determined before performing a calculation that utilizes the predetermined value. When appropriate, the word “value” may indicate a predetermined value. The word “threshold” indicates a threshold whose value, and/or the logic used to determine whether the threshold is reached, is established prior to performing the computation that utilizes the threshold, whether the threshold value is fixed, predefined, or dynamically determined.

In the context of RPUs and/or translations, references to “first” and “second” protocols may denote either distinct protocol types, which are different protocols with differing opcodes and functionalities (such as CXL.mem vs. CXL.cache, PCIe vs. NVLink, or UALink vs. SUE), or different instantiations of the same protocol type operating in separate domains or with distinct configurations (such as a first CXL.mem utilizing a first physical address space vs. a second CXL.mem utilizing a second physical address space).

The implementations of an invention may include a variety of combinations and/or integrations of the features of the implementations. Although some implementations may describe serial operations, the implementations may perform certain operations in parallel and/or in different orders from those described. Moreover, the use of repeated reference numerals and/or letters in the text and/or drawings is for the purpose of simplicity and clarity and does not in itself dictate a relationship between the various implementations and/or configurations discussed. Components and/or modules referred to by different reference numerals may or may not perform the same (or similar) functionality, and the fact they are referred to by different reference numerals and/or letters does not mean that they may not have same or similar functionalities.

Certain features of the implementations, which may have been, for clarity, described in the context of separate implementations, may also be provided in various combinations in a single implementation. Conversely, various features of the implementations, which may have been, for brevity, described in the context of a single implementation, may also be provided separately or in any suitable sub-combination. Implementations described in conjunction with specific examples are presented by way of example, and not limitation. Moreover, it is evident that many alternatives, modifications, and variations will be apparent to those skilled in the art. It is to be understood that other implementations may be utilized and structural changes may be made without departing from the scope of the implementations.

The drawings depict some of the couplings between elements, but not necessarily all. The depiction of elements as separate entities may be done to emphasize different functionalities of elements that may be implemented by the same software and/or hardware. Programs and/or elements illustrated and/or described as being single may be implemented via multiple programs and/or involve multiple hardware elements possibly in different locations. The implementations are not limited in their applications to the details of order, or sequence of method steps, or to details of implementation of the devices, set in the description, drawings, or examples. Individual blocks illustrated in the drawings may be functional in nature and therefore may not necessarily correspond to discrete hardware elements.

In implementations where the first domain and the second domain may be associated with the same physical address space, the translator may utilize the address in the transaction associated with the first protocol for generating the address in the transaction associated with the second protocol, possibly copying the address value as is between the messages, or adjusting for address width differences between the messages by zero-extending or truncating unused upper address bits. For example, when translating between CXL-based traffic and ISoL traffic such as UPI, wherein both requests utilize the same physical address space, an address such as (AS.1.1) in a CXL.mem request may be utilized to generate the corresponding address (AS.2.1) in a UPI request. Similarly, when translating between CHI-based traffic and PCIe traffic that share the same physical address space, or between NVLink traffic and CHI traffic in certain configurations, the translator may perform comparable address formatting operations without changing the underlying memory location being referenced. Hence, in relevant contexts, notations in the form of (AS.1.1) and (AS.2.1) used in the drawings may refer to the same address represented in different protocols, such as the address (AS.1.1)=00-00-CA-FE in a protocol that utilizes 32-bit address fields, which corresponds to the address (AS.2.1)=00-00-00-00-00-00-CA-FE in a protocol that utilizes 64-bit address fields.

Claims in the form of “A non-transitory computer-readable medium comprising instructions which, when executed by a processor, cause the processor to perform the method of claim X” are intended to encompass physical storage media capable of storing instructions, including but not limited to semiconductor memory, magnetic storage, optical storage, and other persistent storage technologies. The instructions may be in any form capable of directing a processor to perform the method, including but not limited to compiled code, interpreted code, bytecode, firmware, as well as other forms of directives such as natural language directives, declarative specifications, model parameters or configurations, and symbolic representations, among other formats that may be suitable for processing by processors, AI modules, neural processing units, or other current or future processing architectures. The processor may include any processing unit capable of executing or interpreting stored instructions, including but not limited to CPUs, microprocessors, microcontrollers, DSPs, GPUs, neural processing units, AI accelerators, and quantum processing units. The stored instructions may cause a single processor to perform the method, or may cause the processor to coordinate with one or more additional processors to collectively perform the method in a distributed manner.

Claims in the form of “One or more integrated circuits configured to perform the method of claim X, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages” are intended to encompass hardware implementations that execute, implement, realize, or carry out method steps through circuitry, programmable circuitry, stored instructions executed by processing elements, or distributed across multiple chiplets. The first alternative covers implementations based on processing units designed to execute arbitrary software instructions, including but not limited to CPUs, microprocessors, and application processors, that execute software or firmware to perform the method, with communication interfaces enabling data exchange with other system components. The second alternative covers implementations where specialized circuitry provides hardware acceleration or dedicated processing capabilities, including but not limited to ASICs, FPGAs, PLDs, and SoC devices, wherein the functionality is implemented using electronic and/or photonic components, programmable logic, or combinations thereof. The third alternative covers chiplet-based implementations where the method is performed by one or more semiconductor dies designed for integration within multi-chip modules or system-in-package configurations. These chiplets may reside within a single package or across multiple packages, communicating via inter-chiplet protocols such as UCIe, AIB, CHI-C2C, or other die-to-die interfaces when within the same package, or via package-to-package interfaces when distributed across different packages. The packages may utilize various integration technologies, including but not limited to 2.5D silicon interposers, 3D stacking, organic substrates, and embedded bridge technologies. The method may be partitioned across multiple chiplets with different chiplets implementing different portions, or a single chiplet may implement the complete method.

Claims in the form of “An active cable comprising first and second pluggable modules coupled by a physical medium; wherein the active cable further comprises hardware circuitry, integrated into the active cable, configured to perform the method of claim X” are intended to encompass cable assemblies that include active electronic components capable of processing and modifying signals during transmission. Such claims cover cables having connectors at each end designed for insertion into corresponding receptacles, connected by a transmission medium that may include copper conductors, optical fibers, or other signal-carrying media. The electronic components performing the method may be incorporated anywhere within the cable assembly, including within either or both of the pluggable connectors, or positioned along the cable between segments of the physical medium. The implementation may utilize fixed circuit arrangements, programmable logic, firmware, or combinations thereof. The electronic components may perform the entire method within the cable or may work in conjunction with other processing elements to implement the complete functionality.

Claims in the form of “An apparatus configured to operate as a switch, wherein the apparatus comprises switching circuitry and is configured to perform the method of claim X” are intended to encompass apparatus that selectively routes signals, data, or communications between ports while also performing the method. Such claims cover traditional switching devices with dedicated switch ports as well as processor-based switches and other architectures that achieve switching functions through alternative port configurations. The ports through which data enters or exits the switching function may include physical ports, logical ports, virtual ports, or other port types appropriate for the switching architecture. The apparatus may include homogeneous ports supporting a single protocol or heterogeneous ports supporting different protocols, speeds, or functionalities. The method operations are performed as part of the switching functionality through hardware, firmware, and/or logic contained within the apparatus.

Accordingly, this disclosure is intended to embrace all such alternatives, modifications, and variations that fall within the spirit and scope of the appended claims and their equivalents.

We claim:

1. A modified processing unit (MxPU) comprising:
memory channels capable of communicating with memory located outside the MxPU;
a silicon die comprising (i) processing cores, coupled via a coherent interconnect, configured to utilize a first physical address space to access the memory via the memory channels, and (ii) a repurposed area occupying a space equivalent to at least one processing core;
a communication port, selected from a Compute Express Link (CXL) endpoint, a CXL switch port, an NVLink port, or a UALink port, configured to receive messages comprising physical addresses within a second physical address space;
a resource provisioning unit (RPU) configured to translate physical addresses within the second physical address space to physical addresses within the first physical address space; and
wherein the repurposed area, which was originally designed to accommodate at least one processing core, accommodates at least one of the communication port or the RPU.

2. The MxPU of claim 1, wherein the repurposed area comprises a repurposed impaired area comprising at least one electrically disabled processing core.

3. The MxPU of claim 1, wherein the at least one of the communication port or the RPU draws operating power through a power rail originally designed to supply power to the repurposed area.

4. The MxPU of claim 1, wherein the repurposed area comprises a repurposed impaired area, and wherein the at least one of the communication port or the RPU receives a clock signal through a clock distribution network originally designed to provide clock signals to the repurposed impaired area.

5. The MxPU of claim 1, wherein the at least one of the communication port or the RPU is coupled to the coherent interconnect via an interconnect port originally designed for coupling the repurposed area to the coherent interconnect.

6. The MxPU of claim 1, further comprising a memory management unit (MMU); wherein the memory located outside the MxPU comprises at least 64 GB of dynamic random-access memory (DRAM) coupled via the memory channels, wherein the first physical address space is a Host Physical Address (HPA) space, and the MMU is configured to map addresses within a virtual address space, utilized by an operating system of the MxPU, to physical addresses within the first physical address space.

7. The MxPU of claim 6, wherein the processing cores are configured to execute instructions compatible with an x86 instruction set architecture; and further comprising at least three levels of in-package cache memory coupled to the coherent interconnect, and wherein a third level of the in-package cache memory has a capacity of at least 4 MB.

8. The MxPU of claim 6, wherein the processing cores are configured to execute instructions compatible with a RISC-based instruction set architecture selected from ARM instruction set architecture or RISC-V instruction set architecture, and further comprising at least two levels of in-package cache memory coupled to the coherent interconnect, and wherein a last level of the in-package cache memory has a capacity of at least 4 MB.

9. The MxPU of claim 1, wherein the processing cores comprise streaming multiprocessors (SM) configured to execute instructions compatible with NVIDIA's Compute Unified Device Architecture (CUDA) parallel computing platform, and wherein a number of the streaming multiprocessors exceeds 50.

10. The MxPU of claim 1, wherein a design of the MxPU was derived from an established CPU or GPU design comprising a second silicon die, and wherein the silicon die of the MxPU has a die size within ±9 % of the die size of the second silicon die of the established CPU or GPU design.

11. The MxPU of claim 1, wherein a design of the MxPU was derived from an established CPU or GPU design, and the MxPU retains memory controllers of the established CPU or GPU design.

12. The MxPU of claim 1, wherein a design of the MxPU was derived from an established CPU or GPU design that included CXL root ports, and the MxPU retains the CXL root ports of the established CPU or GPU design.

13. The MxPU of claim 1, further comprising an inter-socket link (ISoL) configured to utilize addresses within the first physical address space, wherein the ISoL couples the MxPU to a second MxPU and enables the processing cores to access a second memory coupled via second memory channels to the second MxPU.

14. The MxPU of claim 13, wherein the ISoL is selected from an interconnect based on: AMD Infinity Fabric, NVIDIA NVLink-C2C, ARM CHI C2C, or Intel UPI.

15. The MxPU of claim 1, wherein the communication port comprises the CXL endpoint, and further comprising a second CXL endpoint configured to communicate with a second entity, wherein the second entity utilizes addresses within a third physical address space, and the RPU is further configured to translate physical addresses within the third physical address space to physical addresses within the first physical address space to enable the second entity to access at least a portion of the memory.

16. The MxPU of claim 1, wherein the repurposed area comprises the at least one of the communication port or the RPU and a remaining unassigned area, and wherein the remaining unassigned area is utilized for at least one of on-die decoupling capacitors or spare standard cells.

17. The MxPU of claim 1, wherein the communication port comprises an NVLink port, and the second physical address space comprises a network address space.

18. The MxPU of claim 17, wherein the first physical address space comprises a GPU physical address space, and the RPU is further configured to translate physical addresses within the network address space to physical addresses within the GPU physical address space.

19. The MxPU of claim 17, wherein the MxPU further comprises a second silicon die coupled to the silicon die within an integrated circuit package of the MxPU, and wherein the second silicon die comprises an NVLink Fusion chiplet that includes the NVLink port and at least a portion of the RPU.

20. The MxPU of claim 17, further comprising a CXL root port coupled to the coherent interconnect, wherein the RPU is configured to translate messages received via the NVLink port into messages based on CXL, and to forward the translated messages to the coherent interconnect via the CXL root port.

21. The MxPU of claim 1, wherein the MxPU comprises NVLink ports, and the repurposed area accommodates at least some of the NVLink ports.

22. The MxPU of claim 1, wherein the second physical address space comprises a Network Physical Address (NPA) space, and the messages comprise UALink-based messages.

23. The MxPU of claim 1, wherein the second physical address space comprises a Network Physical Address (NPA) space, the first physical address space comprises a System Physical Address (SPA) space, and wherein the RPU is further configured to translate physical addresses within the NPA space to physical addresses within the SPA space.

24. The MxPU of claim 1, wherein the second physical address space comprises a Network Physical Address (NPA) space, the first physical address space comprises a Host Physical Address (HPA) space, and wherein the RPU is configured to translate physical addresses within the NPA space to physical addresses within the HPA space.

25. The MxPU of claim 1, wherein the MxPU comprises UALink ports, and the repurposed area accommodates at least some of the UALink ports.

26. The MxPU of claim 1, wherein the memory located outside the MxPU comprises at least 8 GB of dynamic random-access memory (DRAM) coupled via the memory channels, and the communication port comprises CXL endpoints located in the repurposed area, enabling the MxPU to function as a CXL Multi-Headed Device (MHD).

27. A method for improving manufacturing yield of processor devices, comprising:
identifying at least one processing core area in a processor design for repurposing as an impaired area;
configuring the processor design to exclude the at least one processing core area from functional testing requirements while retaining a same die size;
implementing at least one of a communication port or a resource provisioning unit (RPU) in the impaired area, wherein the communication port is selected from a Compute Express Link (CXL) endpoint, a CXL switch port, an NVLink port, or a UALink port, and the RPU is configured to translate between physical addresses associated with different physical address spaces; and
manufacturing processor devices based on the configured processor design, whereby defects occurring within the impaired area do not cause rejection of the processor devices during production testing.

28. A method for operating a modified processing unit (MxPU), comprising:
utilizing, by processing cores of the MxPU coupled via a coherent interconnect, a first physical address space to access memory located outside the MxPU via memory channels;
receiving, via a communication port selected from a Compute Express Link (CXL) endpoint, a CXL switch port, an NVLink port, or a UALink port, messages comprising physical addresses within a second physical address space;
translating, by a resource provisioning unit (RPU), physical addresses within the second physical address space to physical addresses within the first physical address space; and
operating at least one of the communication port or the RPU from a silicon die area that excludes at least one processing core present in an established processor design from which the MxPU was derived.

29. The method of claim 28, wherein the communication port comprises the CXL endpoint configured to communicate with an entity according to a protocol based on CXL, the first physical address space is a first Host Physical Address (HPA) space utilized by the processing cores, the second physical address space is a second Host Physical Address (HPA) space utilized by the entity, and the translating comprises performing host-to-host physical address translations from the second HPA space to the first HPA space.

30. The method of claim 28, further comprising receiving, via a second communication port, second messages comprising physical addresses within a third physical address space utilized by a second entity; and translating, by the RPU, physical addresses within the third physical address space to physical addresses within the first physical address space to enable the second entity to access at least a portion of the memory.
